(19) United States
(12) Patent Application Publication
(10) Pub. No.: US 2026/0226746 A1
(43) Pub. Date: Aug. 6, 2026

(54) STEEL PERGOLA

(71) Applicant: ZHEJIANG ZHENGTE CO., LTD., Linhai, Zhejiang (CN)

(72) Inventors: Patrick van Lierop, Linhai Zhejiang (CN); Younghui Chen, Linhai Zhejiang (CN)

(21) Appl. No.: 19/151,565

(22) PCT Filed: Jan. 26, 2024
(86) PCT No.: PCT/CN2024/074162

§ 371 Date: Jul. 28, 2025

Related U.S. Application Data
(60) Provisional application No. 63/441,746, filed on Jan. 27, 2023.

(51) Int. Cl. E04F 10/10

(52) U.S. Cl. CPC E04F 10/10

(57) ABSTRACT

Disclosed are example embodiments of a device having at least one of a five-device-in-one anti-twisting anti-warping anti-vibrating cost-saving production-increasing corner and noise-canceling wind-dissipating louver, which is economical to produce and ship, and can be quickly and easily assembled and disassembled. Particularly, the present invention relates to a five-device-in-one anti-twisting anti-warping anti-vibrating cost-saving production-increasing corner and noise-canceling wind-dissipating louver (for being adapted to pergola, RV, house, solar panel, and concert stage), which includes at least one of anti-twisting anti-warping cost-saving production-increasing outer corner system, Leaf-filtering-and-breaking cost-saving production-increasing auto-centering inner corner system, Double-gutter-supporting-and-locking post system, Anti-twisting anti-warping 4-opposite-direction-securing post-plate system, Rainwater-shedding rainwater-directing louver systems, Cost-saving production-increasing noise-canceling wind-dissipating louver end systems, Automatic-multi-louver-shuttling system, and Cost-saving production-increasing rainwater-shedding leaf-filtering beam systems.

### CROSS REFERENCE TO RELATED APPLICATIONS

The present application is a national stage entry of PCT Patent Application No. PCT/CN 2024/074162, filed Jan. 26, 2024, which claims priority to U.S. Provisional Patent Application No. 63/441,746, filed Jan. 27, 2023, both of which are incorporated herein by reference in their entireties for all purposes. The present application also is related to U.S. patent application Ser. No. 18/424,554, filed Jan. 26, 2024, which is incorporated herein by reference in its entirety for all purposes.

### TECHNICAL FIELD

The disclosure relates generally to the field of patio equipment, and specifically and not by way of limitation, some embodiments are related to a pergolas or pergola components.

### BACKGROUND

A number of pergola corners have been introduced. Some examples are provided below.

U.S. Pat. No. 4,572,695, issued Feb. 25, 1986, to Tyrell T. Gilb describes a jointing connector made from a sheet metal blank for connecting two to four wood members such as 2×4's. The connector includes a palm portion, and a finger portion with six distinct finger members. Each finger may be bent in the field by workmen to accommodate the particular jointing of the wood members. Preferably, the connector is bent in a U-shape at the factory. Three types of nail openings are provided including circular, slotted and directional slotted tab openings. The different types of openings with the configuration of the connector enable workmen to use the same connector in nearly a universal application to all types of jointing configurations. Further, the use of the special nail openings and the connector permit many of the nails to be used in double shear applications so that the connection value is doubled.

U.S. Pat. No. 5,170,977, issued Dec. 15, 1992, to Connie L. McMillan describes a corner bracket including a first, second, third, and fourth wall member, each arranged in accordion edge-to-edge relationship relative to one another oriented ninety degrees relative to one another, with an “L” shaped bracket mounted to the bottom edge of the first and second floor walls. The “L” shaped brackets define spaced gaps to receive base plates therebetween for securement to a corner post.

U.S. Pat. No. 5,186,571, issued Feb. 16, 1993, to Walter G. Hentzschel describes a fence rail section with a metal bracket for attaching a rail to a post. The bracket is symmetrical and sized to conform to the maximum and minimum cross-sectional dimensions of the rail. Extending from the base portion of the bracket are a pair of L-shaped ears and a rectangular tab which cooperate to define a socket to receive an end of the rail either laterally or longitudinally. Exposed-post fences are readily erected using these brackets.

U.S. Pat. No. 5,312,078, issued May 17, 1994, to Thomas R. Marsh describes a corner brace which can support an inner cabinet shelf during shipping of the cabinet, and serves to secure a cabinet top in place. The brace is comprised of an angle member having a pair of arm members oriented substantially perpendicularly to one another. The arm members have a flat planar top edge portion oriented substantially parallel with one another. A shelf member interconnects each of the arm member front portions at a position spaced beneath the arm member top edge portions, the shelf member having a bottom portion and a flat planar top portion oriented parallel with the arm member top edge portions. The shelf member has an outer edge portion interconnecting the arm members, and also has an opening formed therein between the top portion and the bottom portion. An elongate reinforcing rib member is connected to the shelf member bottom portion adjacent the outer edge portion, the rib member interconnecting and extending continuously between the arm members. A reinforcing boss member is formed on the shelf member bottom portion around the opening to further rigidify the brace.

U.S. Pat. No. 5,732,507, issued Mar. 31, 1998, to Gregory Edwards describes a louvre for a louvre assembly comprising a profile having a plurality of optionally useable pivot mounting positions each of which is selectively adapted to be utilized to mount the louvre in an assembly of adjacent louvres. Anyone of the remaining pivot mounting positions is selectively adapted to be utilized to control the pivotable orientation of the louvre in the assembly. Each louvre comprises an up-turned lip at one edge thereof and a down-turned lip at the other edge thereof. These lips serve to prevent ingress of water to the area below the assembly which forms an openable roof structure. An alternative louvre comprises a pair of like formed, elongate, resilient surface profile sections, each having disposed at opposed lateral edges thereof mutual inter-engagement means, which upon flexure of the respective sections during assembly results in inter-engagement of the sections. A prefabricated core having tapered or otherwise lateral edges is located between the surface profile sections.

U.S. Pat. No. 5,771,646, issued Jun. 30, 1998, to Joseph DeSouza describes a wood railing assembly attached to the top of a wood deck having rim joists and top deck boards. The railing has vertical posts and horizontal rails mounting spindles, and all of the posts are notched at the bottom. The corner post is attached by the use of a bracket extending all the way around the bottom end portion of the post with flanges extending on the outer surface of the rim joists. Lag screws extend through the bottom end through the bracket, with some of the lag screws extending through the post end of the joists and other lag screws extending directly into the joists to clamp the bracket in place. The side post uses a bracket assembly having an outer channel having a face and sides that enclose the exposed portion of the bottom end and receive machine screws extending through the plate, the lower end, the joists, and through a backing plate, where suitable nuts are used to clamp the assembly together as a unit.

U.S. Pat. No. 6,401,395, issued Jun. 11, 2002, to Angelo Gabriele describes a plastic louver for a shutter comprising a main louver body with end caps which are made separately from the louver body. The louver body before receiving the end caps has open ends, each of which is defined by a surrounding mouth wall and each end cap has an end face which is bordered by an outside edge wall of the end cap. The end caps are fitted into the louver ends such that the outside edge walls of the end caps are positioned interiorly of the louver end mouth walls. This construction gives the plastic louver a one-piece wooden look.

U.S. Pat. No. 6,640,516, issued Nov. 4, 2003, to Thomas C. Thompson describes an improved metal connector that securely ties together sheathing and underlying structural members on a building to prevent hurricane and earthquake damage. The connector has alternating sheathing tabs for securing multiple sheets of sheathing. Connected underneath the sheathing tabs, a rib separates the sheathing and correctly spaces each adjoining sheet with a slight gap to avoid buckling. Below the rib, rafter webs alternate with the sheathing tabs to prevent movement of the sheathing and rafter. The large surface area and precise nail holes on the sheathing tabs avoid sheathing splitting and assures correct attachment to the underlying structural member.

U.S. Pat. No. 6,675,534, issued Jan 13, 2004, to Norbert Marocco describes a shutter having a rectangular frame and shutter blades mounted parallel to one another across said frame, the blades being rotatable between open and closed positions, and having a control recess formed in one of the side frames, control bodies within the control recess connected to respective shutter blades, for rotating respective said blades, links connecting the control bodies, and, fastening clamps on the control bodies for adjustably fastening respective said control bodies to respective links, so as to align all of the control bodies into predetermined rotational positions, and in which the links communicate rotational movement of any one blade through the control bodies to all the blades.

U.S. Pat. No. 6,701,669, issued Mar. 9, 2004, to Kim Charles Yorganson describes an improved louver rotation mechanism for use in a louvered shutter having a frame and a plurality of rotating louver rotationally engaged in the frame. The device features one or a plurality of rack gears slidably engaged in one of the vertical stiles of the frame. The racks are geared about their exterior sides to concurrently engage gears formed on the louver axles of the louvers and a geared knob assembly operatively mounted in the stile such that a twist of the handle of the knob assembly is communicated to at least one of the racks which in turn twists the louvers. When two racks are used of equal weight they function as a counterweight in their engagement with the louvers thereby stabilizing them. Optionally a brake mechanism may be included in the knob assembly to hold the louvers stationary, and the brake mechanism may also function as a clutch to prevent damage to the louvers if force is applied to the louvers sufficient to overcome the clutch. Additionally, the louver axles may be cooperatively engaged with both stiles to prevent bowing of the stiles.

U.S. Pat. No. 7,328,533, issued Feb. 12, 2008, to David Harold Coleman describes an apparatus for opening and closing window shutter slats or louvers converting rotary motion by a knob or electric motor into rotary motion of one of the slats. The apparatus is attached to a frame structure that is included with the window shutter and which surrounds the slats. A connecting rod that is pivotally attached to all of the slats pivots all of the slats an amount that is nearly equal to that of the one slat. The knob includes a first shaft that is attached to a drive gear in an enclosure which turns a driven gear. The driven gear is attached to a second shaft which is adapted to turn a pin end of the one slat. The motor is adapted to rotate one of the slats directly. Retrofit use and use in newly manufactured shutters is described. The apparatus can also be used to pivot open the shutter with respect to a pair of hinges that pivotally attach the shutter to a surrounding support structure.

U.S. Pat. No. 7,335,096, issued Feb. 26, 2008, to Haim Perez describes a louver type roof structure including a plurality of elongated parallel slats mounted on slat hinges pivotally supported on carrier beams transverse to the slats. The slats are pivotable between a closed position in which their longitudinal adjacent edges overlap each other, and an open position in which the slats are spaced apart. The slat hinges are mounted to the slats at their lower surface and allow pivoting of the slats between the closed position and an extreme open position by an angle of at least 90°, preferably 110°. The pivoting axis of the slat hinge is disposed substantially under the longitudinal edge of the slat which is overlapped by the adjacent slat. The roof structure may comprise a border slat adapted to be displaced when urged by an adjacent slat when the latter pivots towards its extreme open position.

U.S. Pat. No. 7,353,636, issued Apr. 8, 2008, to Richard N. Anderson describes a shutter that utilizes a rack and pinion mechanism for tilting the louvers of the shutter. The rack and pinion mechanism preferably is hidden within the stiles of the shutter. In a preferred embodiment, the louvers of the shutter may be installed and removed without disassembling the assembled frame and rack and pinion mechanism.

U.S. Pat. No. 7,389,609, issued Jun. 24, 2008, to Kim Charles Yorgason describes a louver rotation mechanism for use in rotating a louvered shutter having louvers rotationally engaged with a frame. The device features one or a plurality of gear modules which are positionable to a fixed location on one or a plurality of rack bars. The gear modules may be spaced on the rack bars to any number of positions wherein they will engage with louver gears from an array of louvers engaged with the frame. A high degree of customization is provided by allowing the use of the rack bars with any number of different sized louvers at different spacings in a frame by simply adjusting the positions of the rack modules for operative engagement with the louver gears.

U.S. Pat. No. 7,398,620, issued Jul. 15, 2008, to Terry V. Jones describes a universal system (100) for support and positioning of building structural support members (20, 30) including at least one longitudinally extended base plate (110) and at least one fixing member (120, 122). The base plate (110) has a plurality of slotted openings (116) formed therethrough. The fixing member (120, 122) has a pair of longitudinally spaced upstanding support members (1202, 1222) defining a structural member receiving space (118) therebetween. At least one of the upstanding support members (1202) is formed with a pair angularly extending flanges (132) that are elastically angularly displaceable to pass through a respective slotted opening (116) having corresponding portions (1164) at a different angle (C), and then return to their original angle (D) to prevent reversibly passing back through the slot (116).

U.S. Pat. No. 7,634,889, issued Dec. 22, 2009, to Edward R. diGirolamo describes an attachment for connecting two building members together such as a header and an adjoining support member. The attachment includes a plate having an engaging surface for extending across and in engagement with the two building members. At least one L-shaped bracket projects from the plate. The L-shaped bracket includes first and second tabs that form an angle of approximately 90° and which are offset with respect to the plate. The first and second tabs as well as the plate are adapted to be secured to the two building members.

U.S. Pat. No. 7,712,283, issued May 11, 2010, to Scott Gadd describes a bracket system for assembling playground equipment including a plurality of deck support brackets, at least two vertical frame brackets, at least two horizontal frame brackets, a swing bracket, and at least two ladder brackets. The deck support brackets secure horizontal deck support beams to vertical frame beams at first points along the vertical frame beams. The vertical frame brackets attach to at least two adjacent vertical frame beams at second points above the first points. The at least two horizontal frame brackets fix at least one horizontal frame beam to the at least two adjacent vertical frame beams at the second points; the horizontal frame brackets and the vertical frame brackets interconnect. The swing bracket fastens a swing support beam to the at least one horizontal frame beam at a third point along the at least one horizontal frame beam. The at least two ladder brackets connect a ladder to one of the horizontal deck support beams.

U.S. Pat. No. 7,921,602, issued Apr. 12, 2011, to Viken Ohanesian describes a shutter assembly including a stile having a solid core and a plastic outer cover. Holes are formed in the plastic outer cover and aligned with an axial groove formed in the solid core to receive a slotted louver pin. The louver pin includes a pair of arms that provide a sufficient compression fit in the axial groove of the stile while enabling each louver to rotate freely. Separate stile end caps are formed to be flush with the edges of the ends of the plastic cover. Each louver includes louver edges and opposite end caps which are substantially flush with the louver edges. A method of manufacturing a shutter assembly is also provided.

U.S. Pat. No. 8,028,494, issued Oct. 4, 2011, to Andrew Denn describes a connector sleeve 22 for connecting two beams 2,4 together in the construction industry which is quick and easy to use and which may be moved or removed if required. The sleeve 22 comprises opposing walls 25,26 for receiving the end portions of two beams 2,4 therebetween and clamping means 32 integrally mounted on one of the opposing walls 25,26. The clamping means 32 is configured to releasably engage the beams 2,4 in use so as to fix their location relative to each other. A modular connection assembly for connecting two beams is also disclosed herein.

U.S. Pat. No. 8,082,693, issued Dec. 27, 2011, to Mario M Marocco describes an arch shutter having a frame with an arch frame portion, and often with a linear lower frame portion, and louvres extending from side to side of the arch portion, parallel to the linear lower frame portion, and having a frame section of predetermined width, and bevel portions formed at each end of each louvre, the bevel portions removing a portion at each end of each louvre for providing clearance for rotation of each louvre without interfering with arch frame portion, and pivot pins inserted through drillings in the frame from the exterior.

U.S. Pat. No. 8,161,682, issued Apr. 24, 2012, to Mario M Marocco describes a shutter having a rectangular frame, and louvres, and with a side pull bar located along one edge of the frame and connected to the adjacent ends of the louvres, the louvres being pivotally mounted in the frame in parallel relation to one another, and being rotatable between open and closed positions, and having a pull bar having a plurality of hinge assemblies, a hinge sleeve member at one end on each louvre, each respective hinge assemblies being engaged with a respective sleeve member, and an anti-rotation formation on each sleeve member engaging the interior of its respective louvre so as to retain said sleeve member in its respective louvre.

U.S. Pat. No. 8,413,389, issued Apr. 9, 2013, to Alessandro Frigerio describes an openable covering construction for pergolas and verandas, characterized in that said openable covering construction comprise a plurality of adjoining and partially overlapping bands longitudinally mounted on a supporting frame by a driving system allowing each said bands to be rotated about a longitudinal axis thereof parallel to a sloping side of said covering construction, said driving system driving said bands to at least two positions, a closed position, thereat said bands are partially overlapped onto one another and substantially parallel to the covering construction plane, and an opened position thereat each said band is rotated to a substantially vertical condition with respect to said covering plane, each said band comprising a section member including a contoured surface including, at a side thereof, a perpendicular side wall and, at an opposite side thereof, a channel defining curved wall, thereby a surface directly exposed to rain of said covering construction forms a water collecting and disposal of channel.

U.S. Pat. No. 8,443,569, issued May 21, 2013, to Stanley K. Sias describes an improved connector and connection joining a plurality of supported structural members, preferably four roof trusses or rafters to a supporting structural member, preferably a header or girder truss. The connector is formed with a plurality of seat members, preferably four, that are joined to back member sections at angular junctures stiffened by shallow embossments. Variations can have three or five seat members.

U.S. Pat. No. 8,533,996, issued Sep. 17, 2013, to Lawrence Matthew Stone describes a shutter drive apparatus adapted such that the movement of any one shutter louver of a tilt-rod-less shutter results in the corresponding movement of all of the louvers of the shutter. The apparatus is preferably mounted within a tilt-rod-less shutter comprising a shutter frame having at least top and bottom horizontal rails, at least a first side stile and a second side stile, and a plurality of louvers rotatably mounted within the stiles such that a first end of the louvers are freely rotatable within the first side stile, and such that a second end of the louvers are drivably engaged to the apparatus. The apparatus includes a plurality of pinion gears, a face strip, opposing drive strips, and a retainer strip. Each louver is drivably engaged to a different pinion gear and each pinion gear is drivably engaged to the drive strips.

U.S. Pat. No. 8,800,239, issued Aug. 12, 2014, to WeiHong Yang describes a three-dimensional jacket-plate connector connecting at least two members. Each member comprises wide-flanged steel I-beam section. The jacket-plate connector comprises first and second three-dimensional jacket plates.

U.S. Pat. No. 8,833,030, issued Sep. 16, 2014, to Steven Zimmerman describes a subassembly is positioned transverse in between two adjacent roof elements or wall elements. The subassembly includes a bracket; a construction element; and a fastener securing the bracket to the construction element. An extension tab of the bracket extends over a top surface of a roof element or a wall element. Multiple ones of the brackets installed in a roof element or a wall element define a line of compression blocking.

U.S. Pat. No. 8,857,106, issued Oct. 14, 2014, to Wendell B. Colson describes a shutter having plural substantially similar louvers, including a first louver having a first louver end, with a first end cap molded with a first gear projecting away from the louver. The louver includes a second louver end, widthwise opposing the first end, having a retractable boss projecting away from the louver. A frame includes a first stile and a widthwise opposing second stile, a top rail and a height-wise opposing bottom rail, defining a shutter fenestration. The first stile has a first widthwise inner-facing wall, which has plural height-wise spaced gear openings, each releasably receiving one gear and having a diameter that is at least as large as an addendum circle for the gear. The second stile has a second widthwise inner-facing wall, which has plural height-wise spaced boss openings for releasably receiving one retractable boss. Accordingly, the louvers are removably disposed in the shutter fenestration.

U.S. Pat. No. 9,038,314, issued May 26, 2015, to Lin Chen describes an adjusting apparatus in a sash to turn slats automatically while the sash is being opened. The adjusting apparatus includes a plurality of first engaging members, a driven unit, and a driving unit. The first engaging members are connected to the slats respectively. The driven unit is connected to the frame of the sash for reciprocation, and has a second engaging member, wherein all the first engaging members are engaged with the second engaging member. The driving unit is connected to the carrier and the driven unit respectively to drive the driven unit to move while the sash is being opened. The first engaging members are turned by the second engaging member when the driven unit is moved by the driving unit to turn the slats from the first position to the second position.

U.S. Pat. No. 9,422,715, issued Aug. 23, 2016, to C. Scott Selzer describes a louvered roof assembly including a support frame and several panels mounted between the support frames. The panels are pivotally coupled to the support frame for rotation about an axis. Each of the panels has a first end and a second end. A linear drive mechanism is coupled to each of the panels. The linear drive mechanism is mounted within at least one of the beams of the support frame and includes an actuator arm mounted to one of the support members.

U.S. Pat. No. 9,556,639, issued Jan. 31, 2017, to David Lewis Hunt describes a portable shelter framing system. The portable shelter framing system includes a plurality of corner support members; a plurality of crossbeam members, each of the crossbeam members configured to be connected between a pair of the plurality of corner support members without the use of tools; and a plurality of roof frame members, each of the roof frame members configured to be coupled to one of the plurality of corner support members or one of the plurality of crossbeam members without the use of tools. In one or more embodiments, the portable shelter framing system further includes a plurality of connecting members, each of the connecting members configured to couple a respective one of the plurality of roof frame members to a respective one of the plurality of corner support members or to a respective one of the plurality of crossbeam members without the use of tools.

U.S. Pat. No. 9,631,426, issued Apr. 25, 2017, to Martin Caspa describes an automatic window blind system with gear driven window blind control. A solar power with back up battery provides energy to operate the window blinds and a light emitting diode strip that changes light colors depending upon daylight and night conditions. A plurality of toothed rack drives is driven by and drives rack gears in ensuring a positive operation of window blind hooks in pivoting window blinds that snap into the window blind hooks. A printed wiring board assembly controls functions and is accompanied by a rack sensor that cooperates with an optical sensor. The optical sensor and the rack sensor automatically position window blinds based upon light intensity.

U.S. Pat. No. 9,732,553, issued Aug. 15, 2017, to Ken Rotchell describes a shutter assembly including a plurality of shutter panels arranged side-by-side. Each shutter panel has a respective plurality of louvers and a respective operable tilt mechanism configured to adjust the tilt angle of the respective plurality of louvers. A control shaft operates the tilt mechanisms. The control shaft is configured to drive simultaneously the respective tilt mechanisms of all of the plurality of shutter panels.

U.S. Pat. No. 10,202,766, issued Feb. 12, 2019, to Samuel Fox describes a rafter bracket configured to connect a vertical post to a rafter and beam(s). The rafter bracket may include lower vertical side plates, a horizontal plate, and upper vertical side plates. The horizontal plate may be perpendicular to the upper and lower vertical side plates and may separate the upper vertical side plates from the lower vertical side plates. The horizontal plate and lower vertical side plates may create a lower cavity that receives the vertical post. Meanwhile, the rafter may be positioned on one of the upper vertical side plates and positioned between two of the upper vertical side plates and may be angled at an acute angle relative to the vertical post as well as the upper and lower vertical side plates. One or more of the lower vertical side plates may receive lateral plates that define a lateral cavity receiving the beam.

U.S. Pat. No. 10,247,215, issued Apr. 2, 2019, to Albert Chubak describes an apparatus including a bracket, planar supports, and a restraining hook. The bracket includes a first bracket plate and a second bracket plate. The first bracket plate is physically connected to the second bracket plate and is disposed at a specified interior angle to the second bracket plate. Each planar support is formed by bending a corresponding bracket plate inward along a support outer bend as a substantially right angle to the bracket plate, with the planar support disposed toward an interior of the bracket. The restraining hook is in physical communication with the second bracket plate. The restraining hook includes a first hook plate disposed substantially perpendicular to the second bracket plate and a second hook plate in physical communication with the first hook plate and disposed substantially parallel to the second bracket plate.

U.S. Pat. No. 10,280,617, issued May 7, 2019, to Stephen Monty describes a structural connector for fastening structural components together including a floor. Two spaced sidewalls extend from respective sides of the floor, the floor and the sidewalls defining a channel in which a first of the structural components can be received. The sidewalls are configured so that the sidewalls can be fastened to the first structural component. A positioning arrangement is operatively arranged with respect to the floor so that the floor can be positioned on the second structural component for fastening to the second structural component U.S. Pat. No. 10,253,556, issued Apr. 9, 2019, to Joseph M. Downey describes a damper providing varying damping force. The damper may include a housing and a rotary member rotatably received the housing. The rotary member may rotate within the housing between defined end points of travel to define an angular range of travel of the rotary member. An outermost surface of the rotary member may be spaced inwardly from an inner surface of the housing defined between the end points of travel to define a gap between the outermost surface of the rotary member and the inner surface of the housing throughout the angular range of travel. The gap may vary in dimension depending on a rotational position of the rotary member to provide varying damping rates within the angular range of travel of the rotary member.

U.S. Pat. No. 10,422,140, issued Sep. 24, 2019, to Danny P. Mitchell describes a support assembly for a screen enclosure including a collar device having a sleeve section with a central passageway for receiving an upright post of the enclosure and permitting the sleeve section to be adjustably positioned and fastened to the post. At least one channel is attached exteriorly to the sleeve section for receiving and being secured to a respective structural beam such that the beam is supported by and extends transversely to the upright post. The structural beam includes wide front and back face sections interconnected by narrow top and bottom side sections. At least one of the face sections has a spline groove formed longitudinally therethrough for receiving a screen panel and complementary spline component to secure the screen panel to the structural beam.

U.S. Pat. No. 10,443,245, issued Oct. 15, 2019, to Helmut Sprotofski describes louver drive systems and methods for using the same comprising a load bearing shell, an adjustable shell, louvers, and a louver device mechanism.

U.S. Pat. No. 10,724,229, issued Jul. 28, 2020, to Larry Randall Daudet describes an improved connection between supporting and supported structural members, particularly between the sheathing and framing members of curtain walls, wherein the connector is an angular member having first and second plates joined at an angular junction and the second plate is formed with a plurality of elongated slots and the fastening in the elongated slot closest to the angular juncture is reinforced.

U.S. Pat. No. 10,724,236, issued Jul. 28, 2020, to David G. Weaver describes Louvered roof systems with one or more louvers. Such louvers can be combined in an assembly that is movable between an open condition and a closed condition. In the closed condition, louvers in the assembly engage one another. In such engagement, a leg extending generally transversely from one louver may include a wing that extends generally transversely to the leg and that abuts a surface of an adjacent louver. Additionally, or alternatively, in such engagement, a leg extending transversely from one louver may be received in a notch in an adjacent louver.

U.S. Pat. No. 10,731,378, issued Aug. 4, 2020, to Fonda Crandall describes a brace adapted to secure a fence rail to a fence post. This brace may optionally be installed onto an existing fence. The present invention may also be installed on a new fence. The brace may be adapted to support fences with cylindrical fence posts or rectanguloid fence posts and rectanguloid fence rails. Optional embodiments include braces for fence corner pieces. The brace may further optionally be adapted to secure fences on a steep incline. The invention includes a first fence rail brace member adapted to connect to 2 or more sides of a first fence rail; the first fence rail brace member is fused to a first side of a fence post brace member, the fence post brace member being adapted to connect to 2 or more sides of the fence post.

U.S. Pat. No. 10,851,544, issued Dec. 1, 2020, to Dee Volin describes a multi-function wind-directing rainwater-sealing automatic-multi-screen-raising-and-lowering multi-screen-securing fruit-drying-and-sorting truck-tonneau-covering rainwater-channeling-and-collecting leaf-filtering height-and-angle-adjustable louvered pergola comprises: opposing end caps, wind-directing-and-rainwater-sealing-louver-blade multi-screen-securing leading and trailing edges, and rainwater-and-wind-sealing rattle-preventing insulation strips, attached and/or molded to wind-directing-and-rainwater-sealing multi-screen-securing louver blades, which automatically raise and lower sun shade and video projection screens, control the duration of fruit-drying, provide fruit sorting function, and provide a full-content-viewing truck-bed tonneau cover, insertion axels are inserted into stanchions, cradle axels being inserted between cradle caps and rotation cradles, stanchions and rotation cradles screwed to first and second rainwater-channeling-and-leaf-filtering side gutter beams, with rainwater-channeling-and-leaf-filtering end gutter beams fit into gutter-beam cradles and are clamped to corner posts by gutter-beam-securing bars into securing-bar slots, corner posts are capped and protected by corner-post 1-shaped caps, multi-louver-control bar rotatably connects to multi-louver-control axels and multi-louver-control linkage arm connected to transmission upper axel connected to worm-gear transmission connected to transmission lower axel connected to coupling loop, controlled by removable-collapsible-and-stowable automatic-multi-screen-raising-and-lowering multi-louver-control crank tool, discrete rainwater gutters filter rainwater and leaves through drain holes and are molded to first and second rainwater-channeling-and-leaf-filtering side gutter beams, within the corner posts, the discrete-leaf-filtering tubes, and spouts, rainwater-draining spout holes, base-plate covers secure to corner-post base plates, which are screwed to corner posts, height-and-angle-adjustable tube screws compensate for uneven terrain and are screwed into corner-post base plates, anchoring screws are inserted through anchoring-screw holes.

U.S. Pat. No. 10,988,926, issued Apr. 27, 2021, to Nigel Mitchell describes an apparatus comprising a roof panel (20) and control system (14), the roof panel comprising one or more cover portions that are moveable between open and closed positions for opening and closing the roof panel. The control system comprises an actuator (40) for moving the cover portions between the open and closed positions, a mains power supply input, and an emergency power store. The control system is configured to receive one or more signals indicative of an emergency, to power the actuator from the mains power supply when the signals indicate there is no emergency, and to power the actuator from the emergency power store when the signals indicate there is an emergency.

U.S. Pat. No. 11,007,832, issued May 18, 2021, to Michael s. Rebick, describes a hitch mount assembly which supports, transports, and stores one or more of a plurality of attachment members and accessories about a mounting surface or frame of a vehicle, a trailer, or a watercraft trailer without using an existing hitch receiver. The hitch mount assembly comprises at least one mounting bracket having at least one base tube having opposing open ends, two mounting plates defining a plurality of bores, and a plurality of fasteners for securing the two mounting plates to the frame; a plurality of attachment members selectively arranged about the base tube forming a kit; and a plurality of hitch pins for securing the components of the hitch mount assembly. The components of the hitch mount assembly may be configured into a variety of ways to form one or more hitch mounting kits that supports, transports, and/or stores accessories.

U.S. Pat. No. 11,047,168, issued Jun. 29, 2021, to Wei-Ting Hsu describes a shutter including a frame, a first blade set, a second blade set, a power source and a blade driving system. The frame has a frame body. The first blade set and the second blade set are disposed on the frame body of the frame. The power source is disposed in the frame body. The blade driving system connects the power source, the first blade set and the second blade set for rotating the first blade set and/or the second blade set to rotate.

U.S. Pat. No. 11,047,169, issued Jun. 29, 2021, to Michael S. Holford describes a shutter panel for an architectural opening. The shutter panel may include a frame and a louver rotatably coupled to the frame. The louver may be automatically closable based on an angular orientation of the louver. The shutter panel may include a closure device operably associated with the louver. The closure device may be actuated based on the angular orientation of the louver. The shutter panel may include a damping device operably associated with the louver. The damping device may be actuated based on the angular orientation of the louver. The shutter panel may include a tension device operably associated with the louver.

U.S. Pat. No. 11,091,914, issued Aug. 17, 2021, to Caihua Shan describes a louver canopy comprising a frame with a top disposed with parallel rafters; a plurality of louvers rotationally connected between the rafters and sequentially arranged along a length direction of the rafters, the louvers are disposed at intervals and parallel to each other, each of the louvers includes an elongated flashing; a baffle connected to a first long side of the flashing; an elongated first guide groove formed between the baffle and the flashing; When the louvers rotate to a closed state, an opening of the first guide groove faces upward, and a second long side of the flashing passes over a top of the baffle of an adjacent louver of the louvers and positions above the first guide groove of the adjacent louver.

U.S. Pat. No. 11,105,085, issued Aug. 31, 2021, to Sam Thomas Hensen describes a column cap connector for mounting and securing a beam to a post of a building including a central web portion and upwardly extending walls disposed along longitudinal edges thereof, wherein a lower portion of the beam fits within the walls, downwardly extending legs formed from the seat and alternatively from the seat and the walls of the connector attach the connector to the post with projecting tabs attached to the seat to support the connector on the post.

U.S. Pat. No. 11,118,349, issued Sep. 14, 2021, to Samuel Montoya describes a rafter reinforcement bracket apparatus for securing rafters to strengthen a wood frame roof including a bendable strap configured to conform to a rafter bottom side of a pair of opposing rafters and a beam between the pair of rafters. A left and right bracket are coupled to a strap top side adjacent a strap front edge and a strap back edge, respectively. Each has a perpendicular portion extending perpendicularly from the strap and an upper portion extending perpendicularly from the perpendicular portion and lying in a plane parallel to a plane of the strap. Each of the strap, the left bracket, and the right bracket has a plurality of mounting holes extending therethrough. Each of the mounting holes is configured to receive a fastener to fix the apparatus to the pair of opposing rafters and the beam.

U.S. Pat. No. 11,118,727, issued Sep. 14, 2021, to Simon McKechnie describes a bracket assembly (2) for bracing a building component (3, 71) to a building structure (42), the assembly comprising a first connecting portion (4) having at least two protruding portions (6, 8) joined by a joining portion (10), each protruding portion (6, 8) connectable to a respective bracing element (44, 46) and a second connecting portion (12) having at least one depending portion (16, 18) and linked to said first connecting portion (4), said at least one depending portion (16, 18) for connection to said building component (3, 71).

U.S. Pat. No. 11,149,438, issued Oct. 19, 2021, to Hal Torman describes an improved louvered panel assembly having a louver panel with at least a first louver and a second louver and a pivot bar that extends therebetween. A control arm is secured between the pivot bar and an operator to rotate the louver panel between open and closed positions. The first and second louvers include a central receiver that receives a first bearing surface to rotate the louvers about a rotational axis extending therethrough. A leading projection extends from the first louver and is rotated downward as the first louver operates between open and closed positions. A trailing projection extends from the second louver and is rotated upward as the second louver operates between open and closed positions. An elongated track is positioned below the louver panel and is spaced from the louver panel by a flap structure having a sealing membrane.

U.S. Pat. No. 11,168,481, issued Nov. 9, 2021, to Frederick Rieber describes a louver system including a louver assembly mounted to a frame. The louver assembly includes first and second side members mounted to respective side elements of the frame, and a number of slat subassemblies with respective slat bodies that are rotatable about respective axes of rotation thereof. The slat bodies are rotatably held between the first and second side members by pivot pins. The pivot pins include one or more extended pivot pins, for securing the louver assembly to the side elements of the frame. Each extended pivot pin extends between inner and outer ends thereof. The outer end is formed to be partially positioned in a selected one of the side elements, and to engage an outer side of the selected side element. The inner end is formed for location in a selected one of the slat bodies, to rotatably secure the selected slat body between the side elements.

U.S. Pat. No. 11,214,954, issued Jan. 4, 2022, to Jacek Styre describes a modular framework having a plurality of elongated structural members interconnected by brackets. Each of the brackets includes at least one tubular socket to receive a structural member, and an array of holes is provided on a face of the socket to permit connection of an attachment to the bracket to support ancillary components.

U.S. Pat. No. 11,326,392, issued May 10, 2022, to Eric Guy Tostee describes a louvre shutter comprising louvres 20 rotatably mounted in a frame on louvre axles, and a louvre drive system that, in summary, comprises a rack and pinion gear system including an externally operable rack assembly and a set of pinion gears 28 mounted to the louvre axles. The rack is externally operable rack and is reciprocably mounted in the drive system housing 42, 48. The pinion gears 28 mounted to the louvre axles are engaged with the rack such that reciprocation of the rack rotates the louvre 20 relative to the frame.

U.S. Pat. No. 11,459,816, issued Oct. 4, 2022, to Antonio V. Madureira describes window lite assemblies and methods for installing the assemblies. The assemblies described herein are configured to be installed in new and existing buildings, especially in building corners, while leaving some or all of the horizontal structural members such as headers and sills in place.

U.S. Publication No. 2004/0079034, issued Apr. 29, 2004, to William F. Leek describes a connector and method of using the connector for making a structural connection between two structural members joined at an angle. The connector is bent in the field to allow the connector to be used in both left-hand and right-hand connections. The connector is preferably formed from metal with an integral gusset at the longitudinal line of juncture. The connector is preferably attached to the structural members by a plurality of fasteners. The gusset reinforces the connection against forces acting perpendicular to the longitudinal line of juncture and the plurality of fasteners reinforce the connection against angular displacement of the structural members perpendicular to the longitudinal line of juncture.

U.S. Publication No. 2011/0308063, issued Dec. 22, 2011, to Arnold Feeleus describes a connector for use in forming a joint between pieces of finished lumber features interconnected sleeves having respective open ends facing in different directions at outer ends of the sleeves opposite interconnected inner ends thereof for receiving ends of respective pieces of finished lumber. Each sleeve has four sides, two of which are defined by opposing side walls that are each flexible relative to a third wall interconnecting the two opposing side walls so that the opposing side walls are movable toward and away from one another to selectively change a width of a fourth side of the sleeve to accommodate variation between different pieces of finished lumber. A fourth side wall portion on each of the opposing side walls extends toward the other side wall to present an area through which at least one fastener is passable into the respective piece of lumber.

U.S. Publication No. 2018/0363287, issued Dec. 20, 2018, to Samuel Fox describes a connection device for supporting a plurality of beams comprising a plate, a first side support and a second side support, with each side support including a top portion extending from the plate in a first direction and a bottom portion extending from the plate in a second direction substantially opposite the first direction. Included are a first guide and a second guide with each guide attaching to the plate and each side support. Each guide includes a top portion extending from the plate in the first direction and a bottom portion extending from the plate in the second direction. The plate, the top portion of each side support, and the top portion of each guide define a top cavity shaped to accept one of the beams. Further, the plate, the bottom portion of each side support, and the bottom portion of each guide define a bottom cavity shaped to accept one of the beams.

U.S. Publication No. 2019/0195007, issued Jun. 27, 2019, to Tony Yen describes a gear driven louver shutter system, wherein each louver of the shutter system is attached to the end of a pinion on at least one end. A plurality of teeth of each pinion is engaged with a gear track disposed within each frame member. When one louver is adjusted, all the louvers in the shutter system will move accordingly, due to the movement of the gear strip rotating the pinions in that frame member at the same rate.

U.S. Design Patent No. D 845,116, issued Apr. 9, 2019, to Jason Thomas Wokutch provides an ornamental design for a stud framing guide.

U.S. Design Patent No. D887,025, issued Jun. 9, 2020, to Jacek Styre provides an ornamental design for a connector for a modular Structure.

U.S. Design Patent No. D901,937, issued Nov. 17, 2020, to Gerald N. Hunsburger provides an ornamental design for an end cap for an architectural covering.

CN U.S. Pat. No. 107,532,418, issued Jan. 24, 2020, to China, describes a connector having a frame and a complementary column attachment pressure plate for coupling to the frame. The frame and the complementary column attachment pressure plate together form a hollow body. The hollow body has a top end, a bottom end, and sides, the top end having an opening. The frame and the complementary column attachment pressure plate have complementary apertures for receiving fasteners for attaching a column receivable within the hollow body from the top end. A joist plate is coupled to the frame and a joist affixing pressure plate is adapted to be coupled to the joist plate. The joist plate and the joist affixing pressure plate have complementary apertures for receiving fasteners for affixing a joist. The connector can be used for the construction of modular buildings and units.

### SUMMARY

Disclosed are example embodiments of a device having at least one of a five-device-in-one anti-twisting anti-warping anti-vibrating cost-saving production-increasing corner and noise-canceling wind-dissipating louver, which is economical to produce and ship, and can be quickly and easily assembled and disassembled. Particularly, embodiments relate to a five-device-in-one anti-twisting anti-warping anti-vibrating cost-saving production-increasing corner and noise-canceling wind-dissipating louver (for being adapted to pergola, RV, house, solar panel, and concert stage), which includes at least one of anti-twisting anti-warping cost-saving production-increasing outer corner system, Leaf-filtering-and-breaking cost-saving production-increasing auto-centering inner corner system, Double-gutter-supporting-and-locking post system, Anti-twisting anti-warping 4-opposite-direction-securing post-plate system, Rainwater-shedding rainwater-directing louver systems, Cost-saving production-increasing noise-canceling wind-dissipating louver end systems, Automatic-multi-louver-shuttling system, and Cost-saving production-increasing rainwater-shedding leaf-filtering beam systems.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1-FIG. 2 illustrate perspective views demonstrating components and the assembly of anti-twisting anti-warping cost-saving production-increasing outer corner system 101 and leaf-filtering-and-breaking cost-saving production-increasing auto-centering inner corner system 105.

FIG. 3-FIG. 7 illustrate perspective views demonstrating additional applications of the five-device-in-one anti-twisting anti-warping anti-vibrating cost-saving production-increasing corner and noise-canceling wind-dissipating louver being used to reinforce, to connect, and to support horizontal posts, vertical posts, and gutters to shed rainwater and leaves from a pergola, an RV, stage, house, and solar array, respectively.

FIG. 8 illustrates a perspective view demonstrating how the five-device-in-one anti-twisting anti-warping anti-vibrating cost-saving production-increasing corner and noise-canceling wind-dissipating louver can be used to support an awning when attached to a building.

FIG. 9-FIG. 13 illustrate perspective, side, and top views demonstrating how leaf-filtering-and-breaking cost-saving production-increasing honeycomb grate 107 can be used to support a solar panel, an outdoor speaker, an outdoor light, and be used to filter and break-up leaves, respectively.

FIG. 14 illustrates a perspective view demonstrating the anti-twisting and anti-warping capabilities of anti-twisting anti-warping cost-saving production-increasing outer corner 102, cost-saving production-increasing inner corner parapet 106, leaf-filtering-and-breaking cost-saving production-increasing honeycomb grate 107, anti-twisting anti-warping cost-saving production-increasing auto-centering bracket 109, and anti-twisting anti-warping anti-vibrating 90-degree-double-yokes 110b.

FIG. 15-FIG. 45 illustrates perspective, front, side, and top views demonstrating components and assembly of the five-device-in-one anti-twisting anti-warping anti-vibrating cost-saving production-increasing corner and noise-canceling wind-dissipating louver.

FIG. 46-FIG. 50 illustrate perspective views demonstrating various functions of the five-device-in-one anti-twisting anti-warping anti-vibrating cost-saving production-increasing corner and noise-canceling wind-dissipating louver being used to reinforce, to connect, and to support horizontal posts, vertical posts, and gutters to shed rainwater and leaves from a pergola, an RV, stage, house, and solar array, respectively.

FIG. 51 illustrates a perspective view demonstrating the functions of the five-device-in-one anti-twisting anti-warping anti-vibrating cost-saving production-increasing corner and noise-canceling wind-dissipating louver being used to support an awning when attached to a building.

FIG. 52-FIG. 56 illustrate perspective, side and top views demonstrating functions of leaf-filtering-and-breaking cost-saving production-increasing honeycomb grate 107 being used to support a solar panel, an outdoor speaker, an outdoor light, and be used to filter and break-up leaves, respectively.

FIG. 57 illustrates a perspective view demonstrating the anti-twisting and anti-warping functions of anti-twisting anti-warping cost-saving production-increasing outer corner 102, cost-saving production-increasing inner corner parapet 106, leaf-filtering-and-breaking cost-saving production-increasing honeycomb grate 107, anti-twisting anti-warping cost-saving production-increasing auto-centering bracket 109, and anti-twisting anti-warping anti-vibrating 90-degree-double-yokes 110b.

FIG. 58 illustrates a perspective view of five-device-in-one anti-twisting anti-warping anti-vibrating cost-saving production-increasing corner and noise-canceling wind-dissipating louver.

FIG. 59-FIG. 60 illustrate perspective views of cost-saving production-increasing right-side louver end 131 and cost-saving production-increasing left-side louver end 130, respectively.

FIG. 61-FIG. 64 illustrate perspective views demonstrating how noise-canceling rainwater-draining axle bore 132 and triple wind-dissipating tunnels 133 can dissipate wind.

FIG. 65-FIG. 112 illustrate perspective, side, back, front, bottom, and top views demonstrating various components and assembly of five-device-in-one anti-twisting anti-warping anti-vibrating cost-saving production-increasing corner and noise-canceling wind-dissipating louver.

FIG. 113-FIG. 121 illustrate perspective, top, and side views demonstrating components and functionality of automatic-multi-louver-shuttling system 138.

FIG. 122-FIG. 131 illustrate perspective, and side views demonstrating components and functionality of cost-saving production-increasing rainwater-shedding leaf-filtering beam systems 147 for shedding rainwater.

FIG. 132-FIG. 155 illustrate perspective views demonstrating how noise-canceling rainwater-draining axle bore 132 and triple wind-dissipating tunnels 133 can dissipate wind.

FIG. 156-FIG. 160 illustrate perspective views demonstrating components of automatic-multi-louver-shuttling system 138.

FIG. 161-FIG. 166 illustrate perspective, top, and front views demonstrating components and assembly of rainwater-shedding rainwater-directing louver systems 124 and cost-saving production-increasing noise-canceling wind-dissipating louver end systems 129.

FIG. 167-FIG. 198 illustrate equivalent variations of the five-device-in-one anti-twisting anti-warping anti-vibrating cost-saving production-increasing corner and noise-canceling wind-dissipating louver.

FIG. 199-FIG. 202 illustrate equivalent applications of the five-device-in-one anti-twisting anti-warping anti-vibrating cost-saving production-increasing corner and noise-canceling wind-dissipating louver (being used to support a gutter to shed water from an RV, concert stage, house, and solar panel in the directions of arrows 156, 157, 158, and 159, respectively).

FIG. 203 illustrates an equivalent application of the five-device-in-one anti-twisting anti-warping anti-vibrating cost-saving production-increasing corner and noise-canceling wind-dissipating louver being used to support an awning when attached to a building.

FIG. 204-208 illustrate equivalent applications of leaf-filtering-and-breaking cost-saving production-increasing honeycomb grate 107 being used to support a solar panel, an outdoor speaker, an outdoor light, and being used to filter leaves and other debris.

FIG. 209 illustrates equivalent applications of anti-twisting anti-warping cost-saving production-increasing auto-centering bracket 109 providing anti-twisting and anti-warping abilities to retain original shape and size of the five-device-in-one anti-twisting anti-warping anti-vibrating cost-saving production-increasing corner and noise-canceling wind-dissipating louver.

FIG. 210-FIG. 215 illustrate equivalent variations of the five-device-in-one anti-twisting anti-warping anti-vibrating cost-saving production-increasing corner and noise-canceling wind-dissipating louver.

FIG. 216-FIG. 269 illustrate equivalent variations of components of five-device-in-one anti-twisting anti-warping anti-vibrating cost-saving production-increasing corner and noise-canceling wind-dissipating louver.

FIG. 270-FIG. 325 illustrate equivalent applications of the five-device-in-one anti-twisting anti-warping anti-vibrating cost-saving production-increasing corner and noise-canceling wind-dissipating louver.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

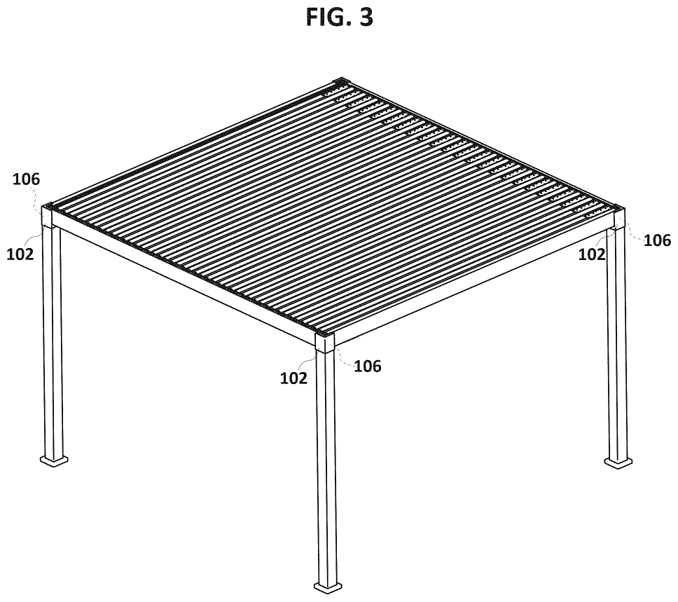

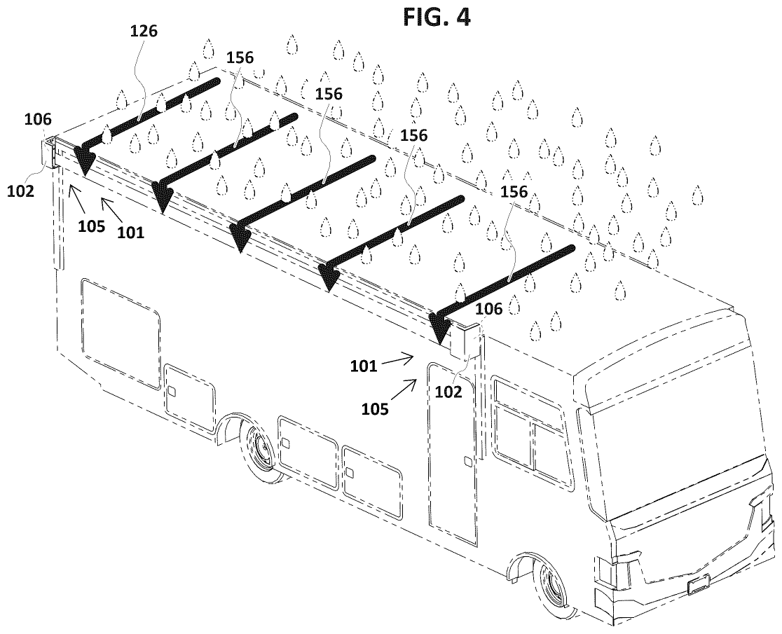

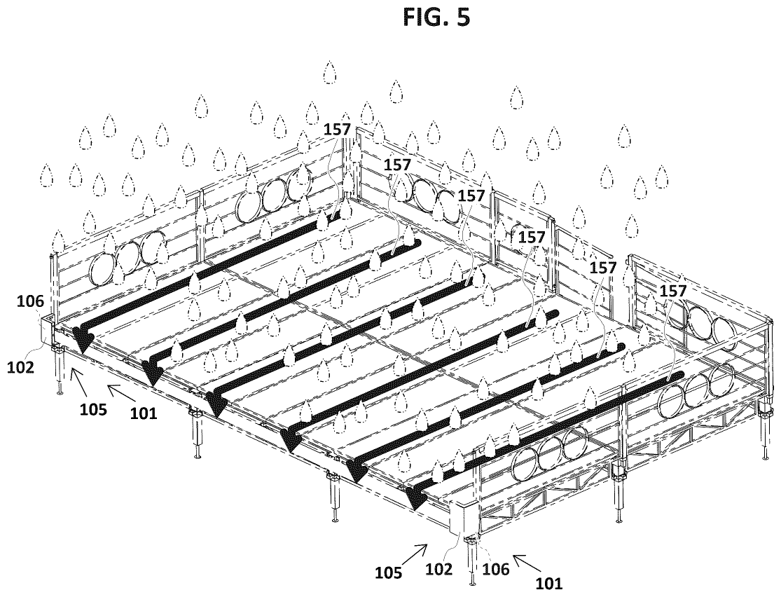

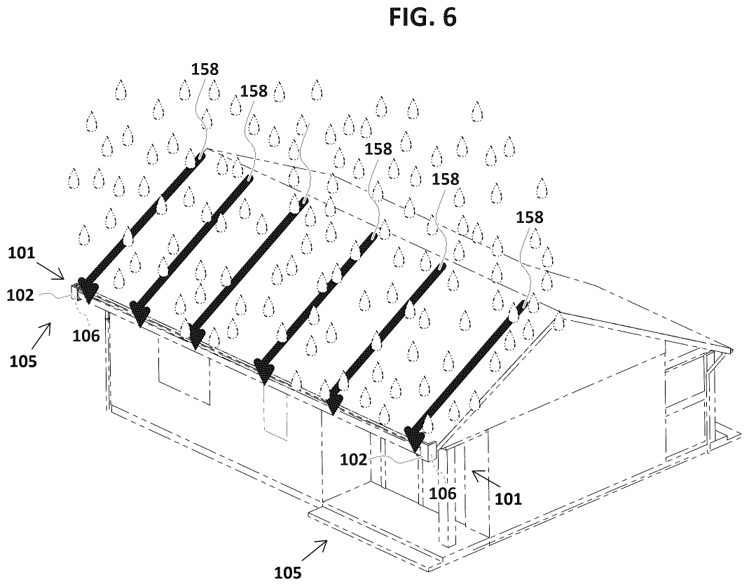

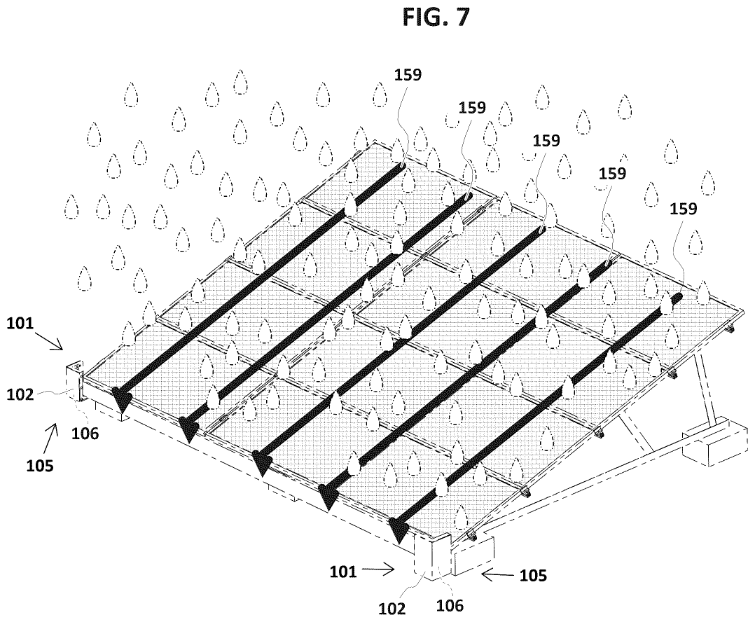

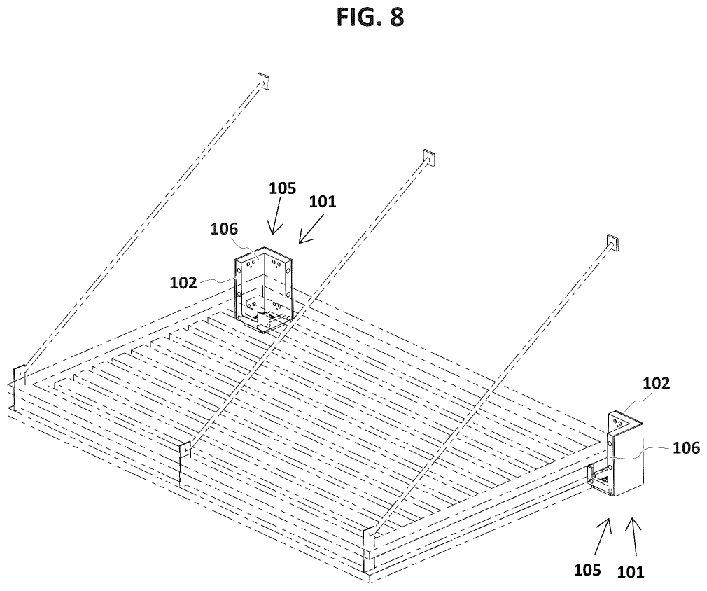

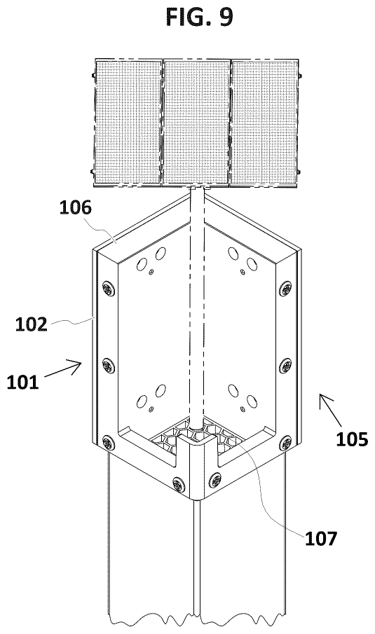

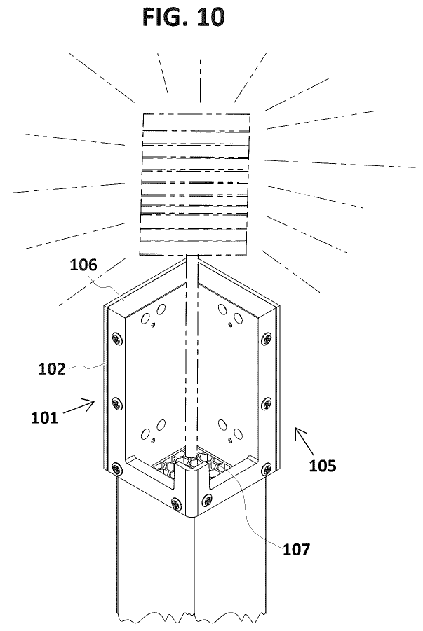

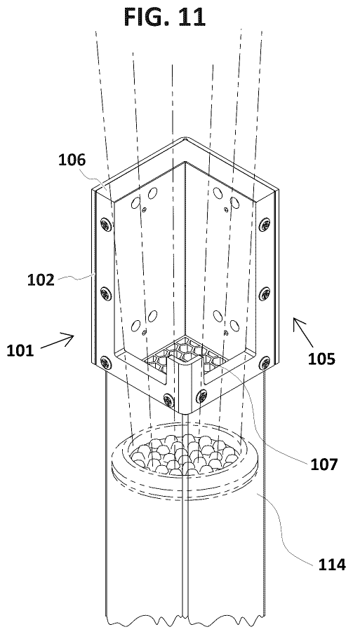

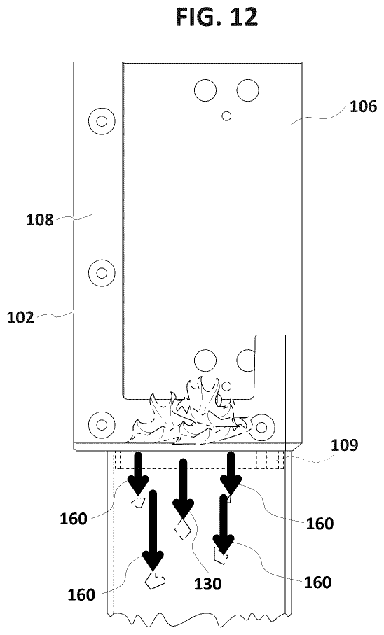

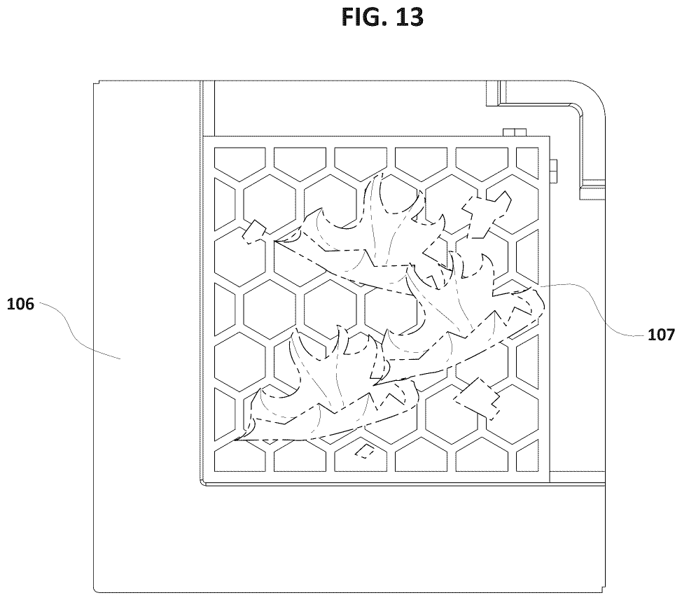

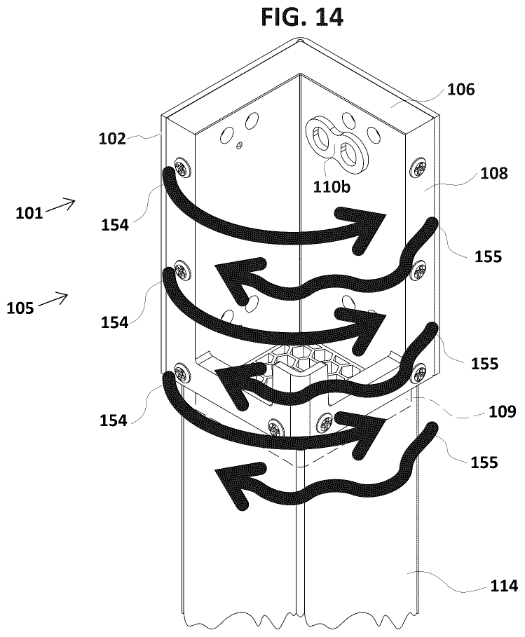

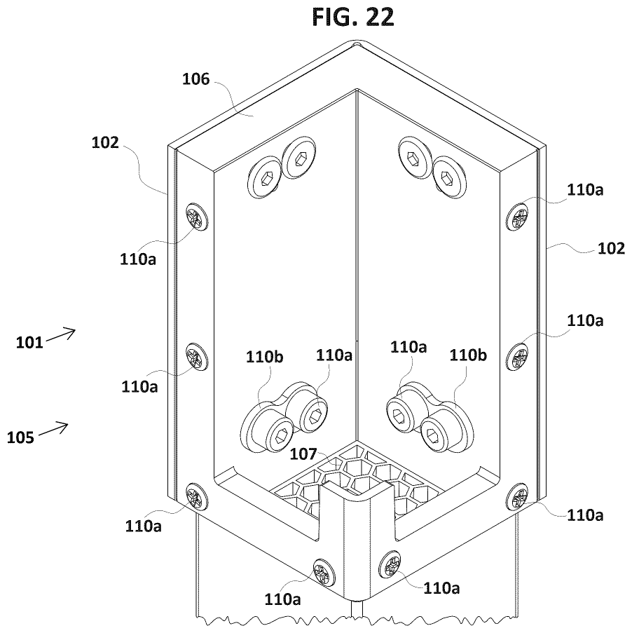

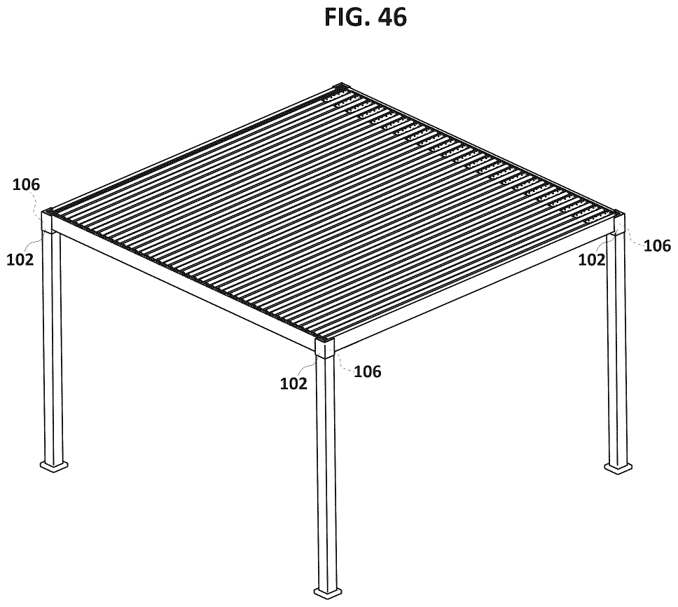

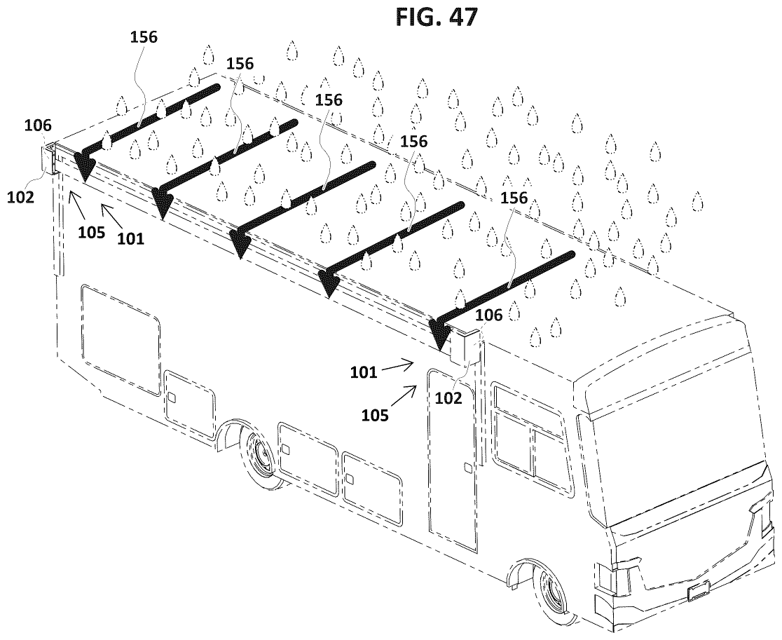

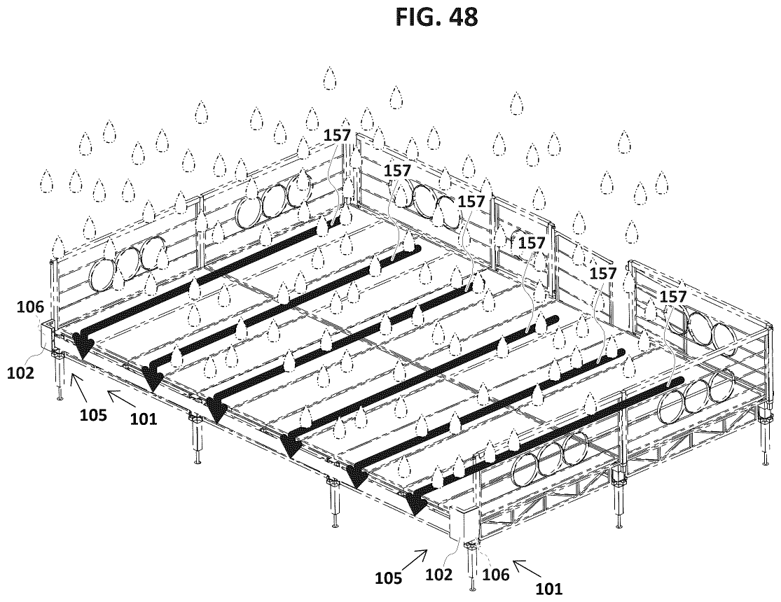

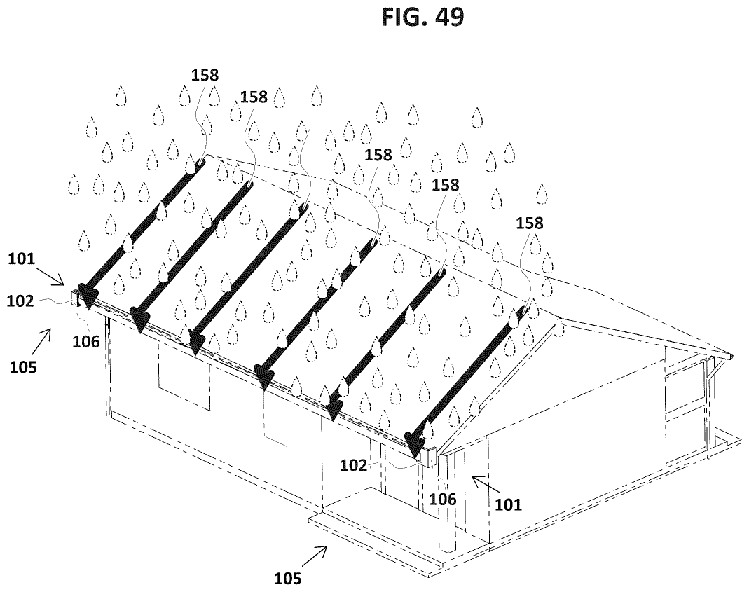

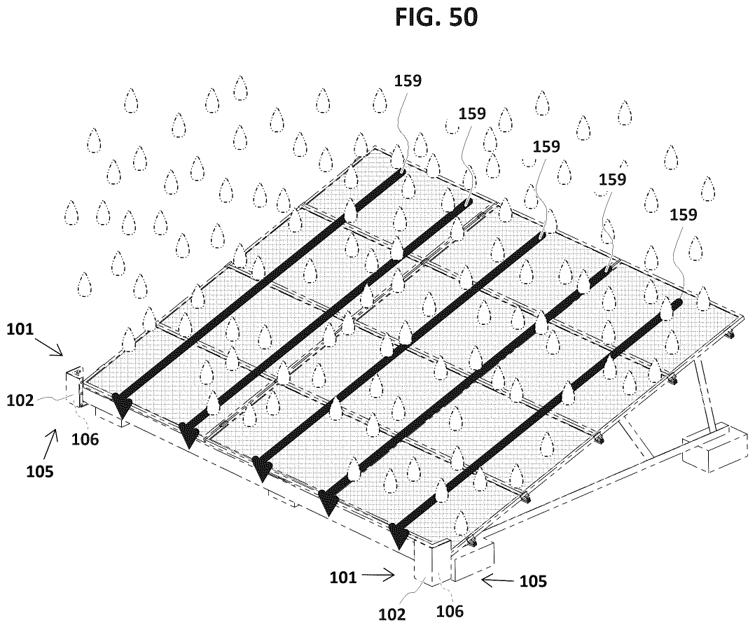

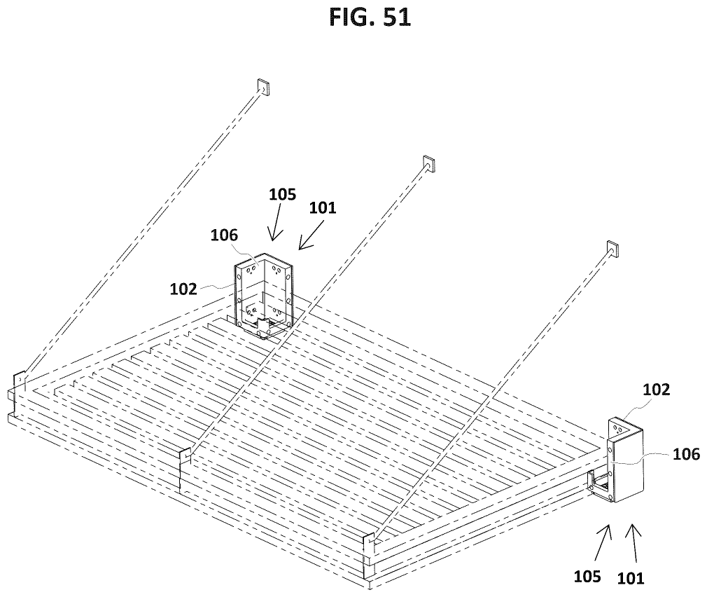

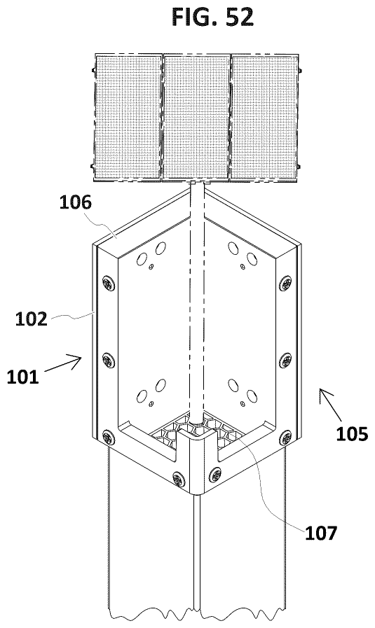

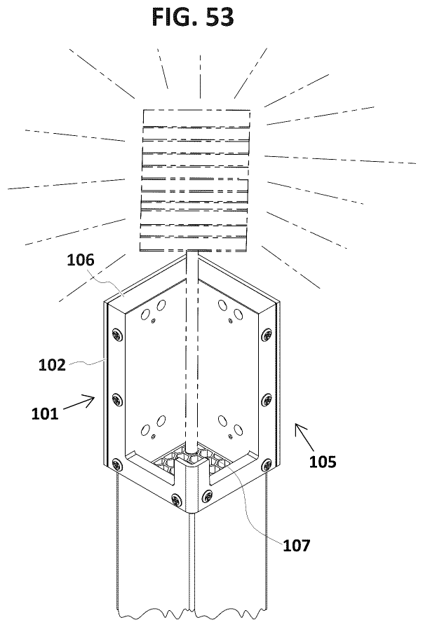

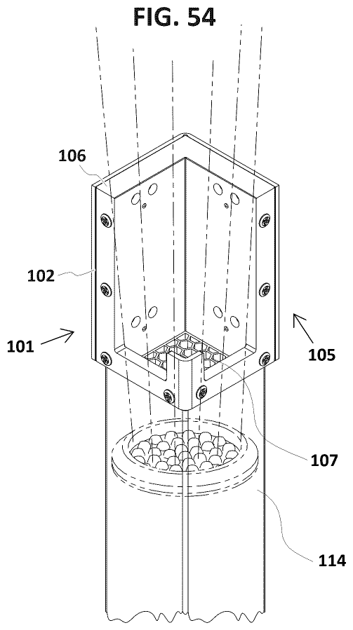

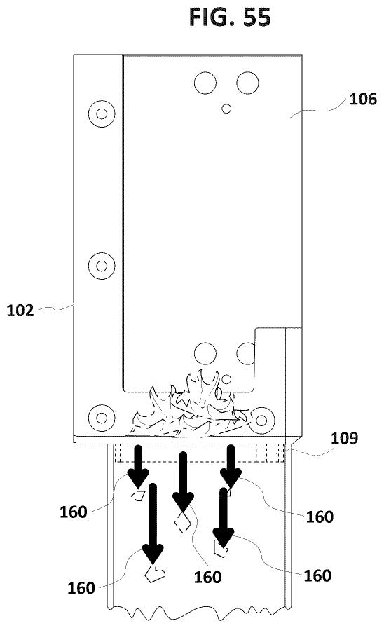

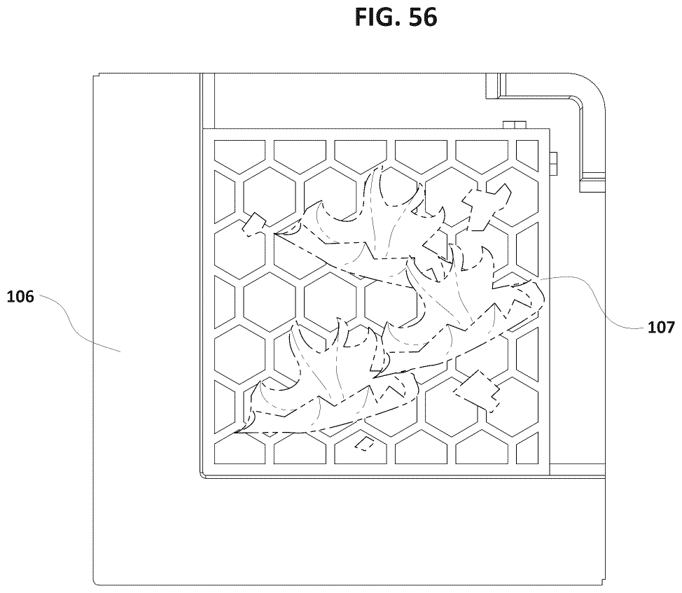

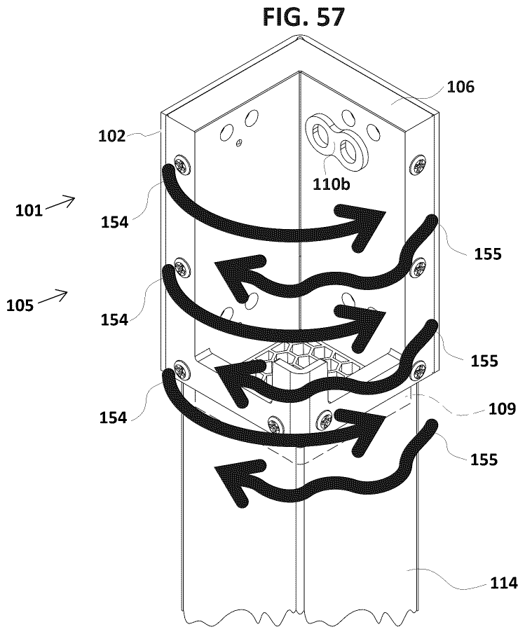

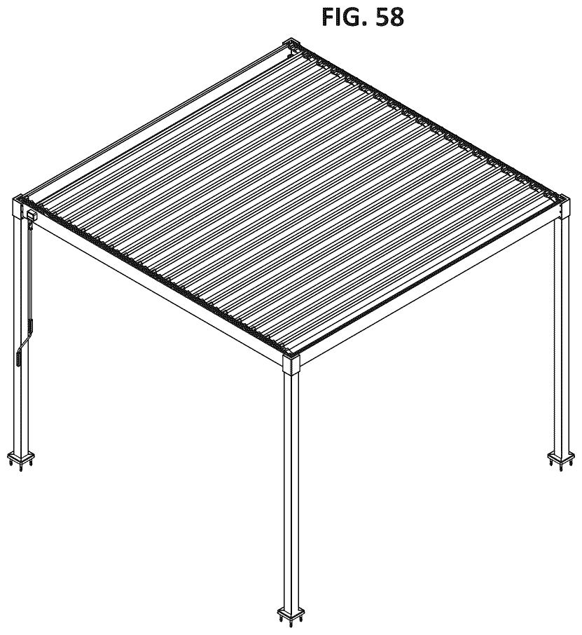

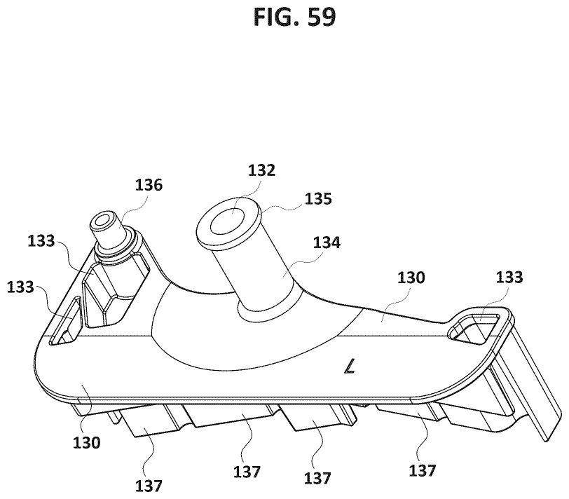

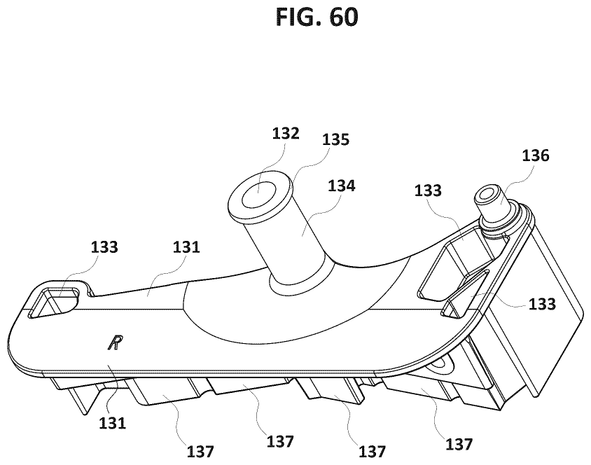

The prior art have failed to solve many problems associated with such pergola, as follows:
1) No prior art mention or disclose any pergola, having anti-twisting anti-warping cost-saving production-increasing outer corner 102. Therefore, the prior art of pergola are: Not capable of providing anti-twisting and anti-warping reverse tension to retain the original shape and size of the five-device-in-one anti-twisting anti-warping anti-vibrating cost-saving production-increasing corner and noise-canceling wind-dissipating louver in the directions of arrows 154, and 155 (see FIG. 14, and FIG. 57); Not capable of saving cost by being injection-molded in a single piece; and
Not capable of increasing production capabilities by being injection-molded in a single piece.
2) No prior art mention or disclose any pergola, having cost-saving production-increasing inner corner parapet 106. Therefore, the prior art of pergola are: Not capable of being used to support a pergola or an RV gutter to shed rainwater therefrom in the direction of arrow 156 (see FIG. 3, FIG. 4, FIG. 46, and FIG. 47); Not capable of being used to support a concert stage gutter to shed rainwater from a concert stage in the direction of arrow 157 (see FIG. 5, and FIG. 48); Not capable of being used to support a house gutter to shed rainwater from a house in the direction of arrow 158 (see FIG. 6, and FIG. 49); Not capable of being used to support a solar panel gutter to shed rainwater from a solar panel in the direction of arrow 159 (see FIG. 7, and FIG. 50); Not capable of being used to support an awning when attached to a building (see FIG. 8, and FIG. 51); Not capable of saving cost by being injection molded in a single piece; and Not capable of increasing production capabilities by being injection molded in a single piece.
3) No prior art mention or disclose any pergola, having leaf-filtering-and-breaking cost-saving production-increasing honeycomb grate 107. Therefore, the prior art of pergola are: Not capable of filtering leaves and other debris from getting inside double-gutter-supporting-and-locking post 114 (see FIG. 12, FIG. 13, FIG. 55, and FIG. 56); Not capable of breaking up leaves and other debris to prevent large leaves from getting into double-gutter-supporting-and-locking post 114 in the direction of arrow 160 (see FIG. 12, FIG. 13, FIG. 55, and FIG. 56); Not capable of securing a solar panel (see FIG. 9, and FIG. 52); Not capable of securing an outdoor speaker (see FIG. 10, and FIG. 53); Not capable of securing an outdoor light for illuminating through leaf-filtering-and-breaking cost-saving production-increasing honeycomb grate 107 (see FIG. 11, and FIG. 54); Not capable of saving cost by being injection molded in a single piece; and Not capable of increasing production capabilities by being injection molded in a single piece.
4) No prior art mention or disclose any pergola, having anti-twisting anti-warping anti-vibrating 90-degree-double-yokes 110b. Therefore, the prior art of pergola are: Not capable of anti-vibrating while in use by cushioning cost-saving production-increasing inner corner parapet 106 (see FIG. 14, and FIG. 22); and Not capable of absorbing vibrations caused by wind while in use.
5) No prior art mention or disclose any pergola, having double-gutter-supporting-and-locking post 114. Therefore, the prior art of pergola are: Not capable of supporting an RV gutter to shed rainwater from an RV in the direction of arrow 156 (see FIG. 4, and FIG. 47); Not capable of supporting a concert stage gutter to shed rainwater from a concert stage in the direction of arrow 157 (see FIG. 5, and FIG. 48); Not capable of supporting a house gutter to shed rainwater from a house in the direction of arrow 158 (see FIG. 6, and FIG. 49); Not capable of supporting a solar panel gutter to shed rainwater from a solar panel in the direction of arrow 159 (see FIG. 7, and FIG. 50); and Not capable of supporting an awning when attached to a building (see FIG. 8, and FIG. 51).
6) No prior art mention or disclose any pergola, having post-top double-gutter-supporting-and-locking parapet-mounting flange 115. Therefore, the prior art of pergola are: Not capable of supporting an RV gutter to shed rainwater from an RV in the direction of arrow 156 (see FIG. 4, and FIG. 47); Not capable of supporting a concert stage gutter to shed rainwater from a concert stage in the direction of arrow 157 (see FIG. 5, and FIG. 48); Not capable of supporting a house gutter to shed rainwater from a house in the direction of arrow 158 (see FIG. 6, and FIG. 49); Not capable of supporting a solar panel gutter to shed rainwater from a solar panel in the direction of arrow 159 (see FIG. 7, and FIG. 50); and Not capable of supporting an awning when attached to a building (see FIG. 8, and FIG. 51).

No prior art mention or disclose any pergola, having anti-twisting anti-warping 4-opposite-direction-securing post-mounting flanges 120. Therefore, the prior art of pergola are: Not capable of providing anti-twisting and anti-warping reverse tension to retain the original shape and size of the five-device-in-one anti-twisting anti-warping anti-vibrating cost-saving production-increasing corner and noise-canceling wind-dissipating louver in the directions of arrows 154, and 155 (see FIG. 14, and FIG. 57); Not capable of securing double-gutter-supporting-and-locking post 114 to anti-twisting anti-warping 4-opposite-direction-securing post plate 119.

No prior art mention or disclose any pergola, having cost-saving production-increasing left-side louver end 130. Therefore, the prior art of pergola are: Not capable of saving cost by being injection molded in a single piece, eliminating unnecessary hardware; and Not capable of increasing production by being injection molded in a single piece, eliminating unnecessary hardware. No prior art mention or disclose any pergola, having cost-saving production-increasing right-side louver end 131. Therefore, the prior art of pergola are: Not capable of saving cost by being injection molded in a single piece, eliminating unnecessary hardware; and Not capable of increasing production by being injection molded in a single piece, eliminating unnecessary hardware.

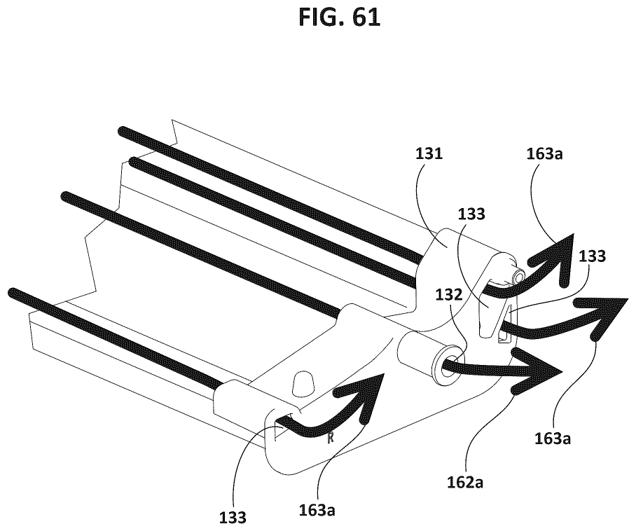

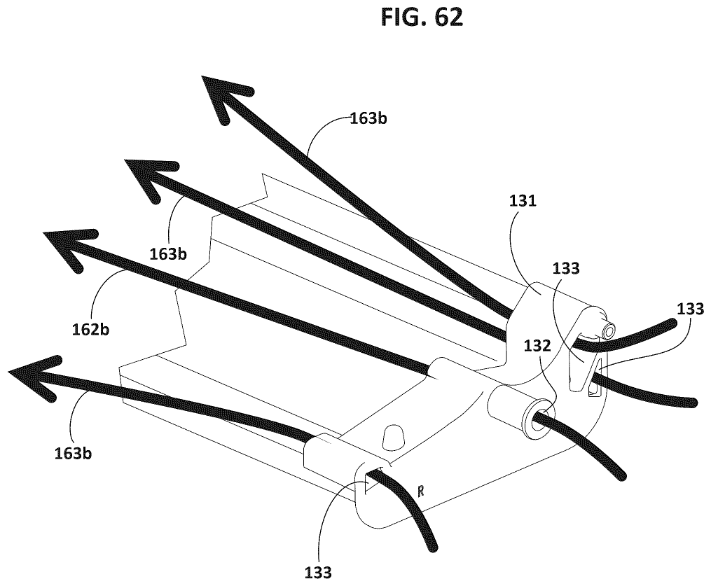

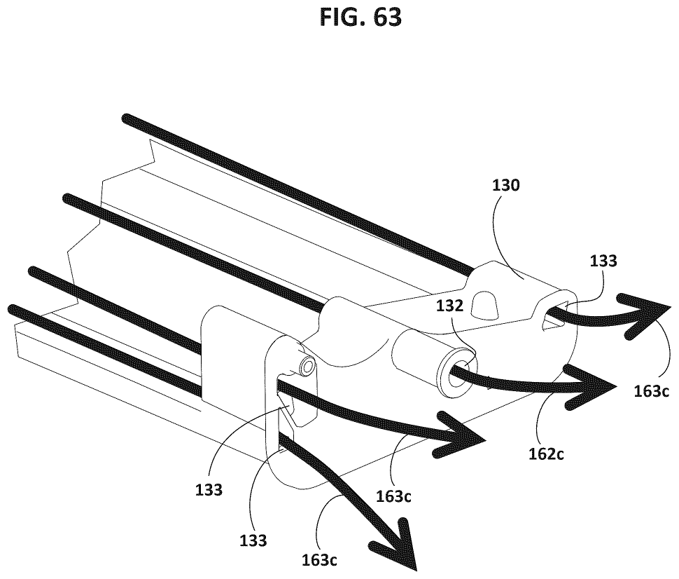

No prior art mention or disclose any pergola, having noise-canceling rainwater-draining axle bore 132. Therefore, the prior art of pergola are: Not capable of draining rainwater away from rainwater-shedding louver 125 in the directions of arrows 162a and 162b (see FIG. 61-FIG. 64); and Not capable of dissipating wind away from rainwater-shedding louver 125 in the directions of arrows 162a and 162b (see FIG. 61-FIG. 64).

No prior art mention or disclose any pergola, having triple wind-dissipating tunnels 133. Therefore, the prior art of pergola are: Not capable of draining rainwater away from rainwater-shedding louver 125 in the directions of arrows 163a-163d (see FIG. 61-FIG. 64); and Not capable of dissipating wind away from rainwater-shedding louver 125 in the directions of arrows 163a-163d (see FIG. 61-FIG. 64).

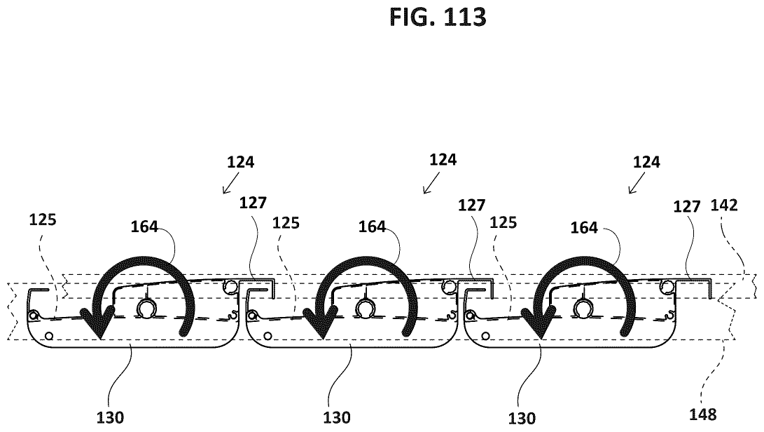

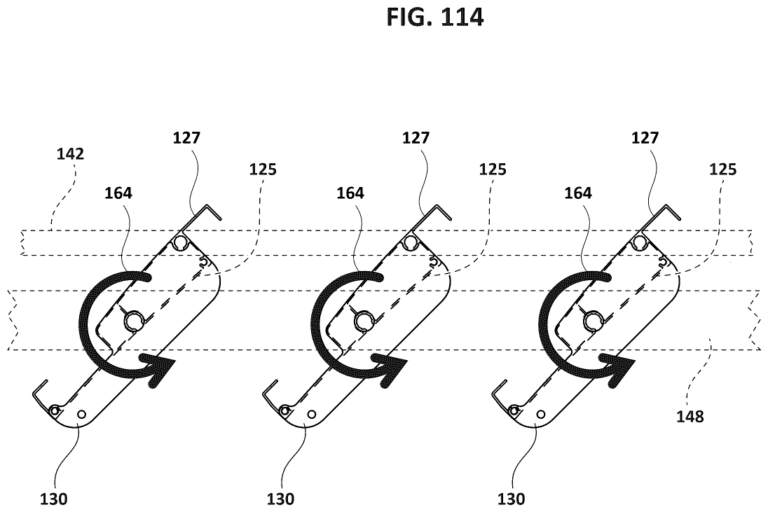

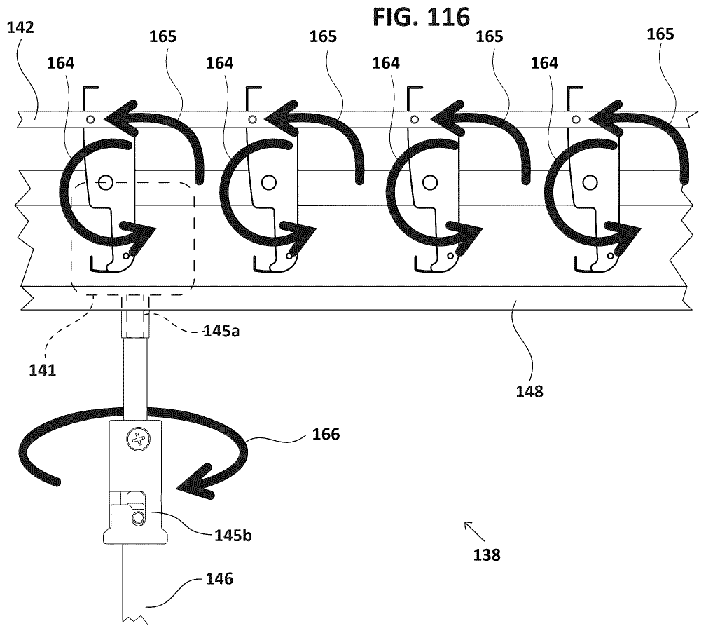

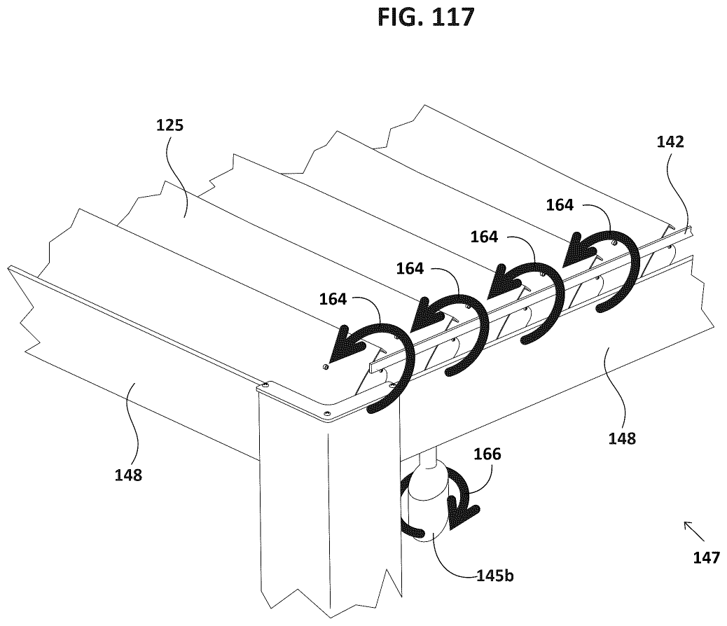

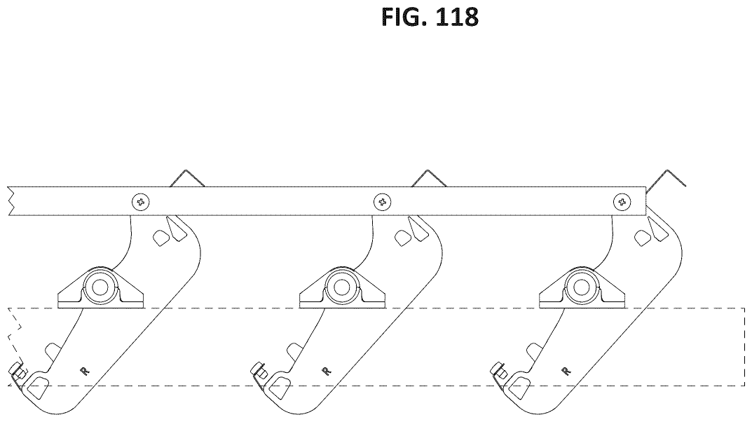

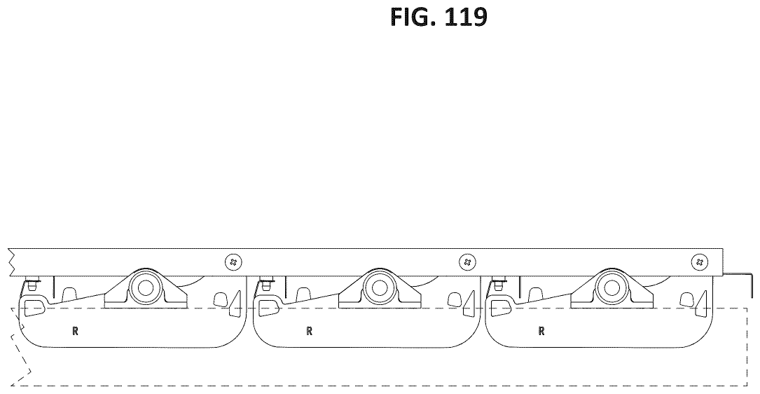

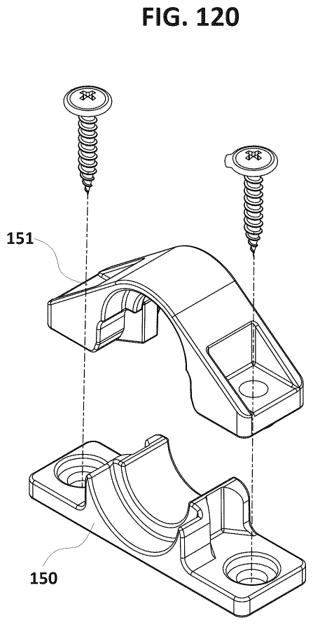

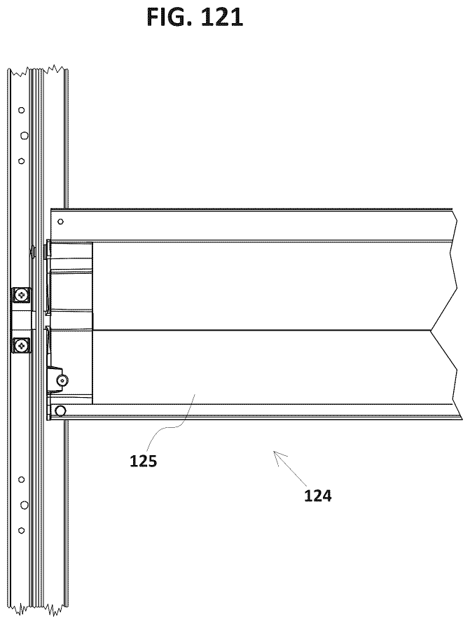

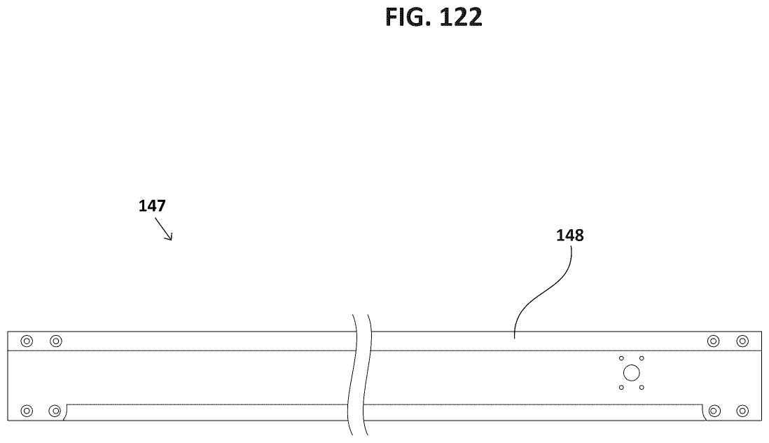

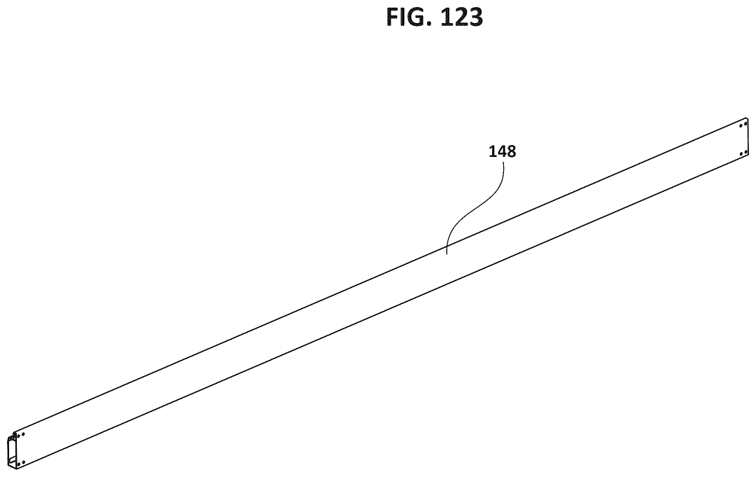

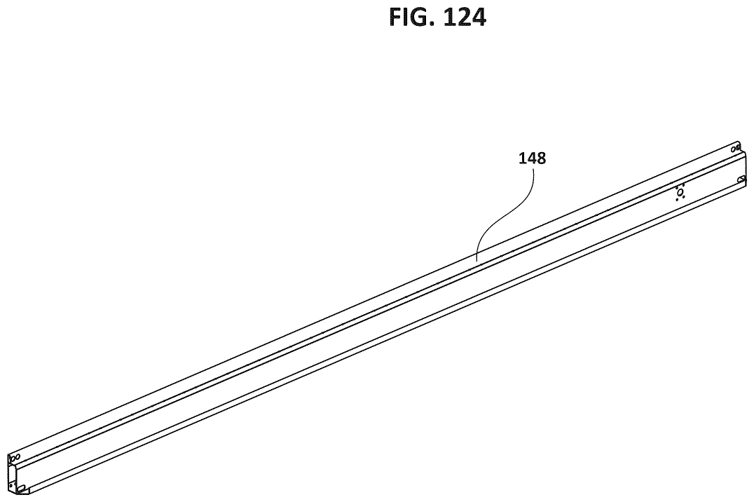

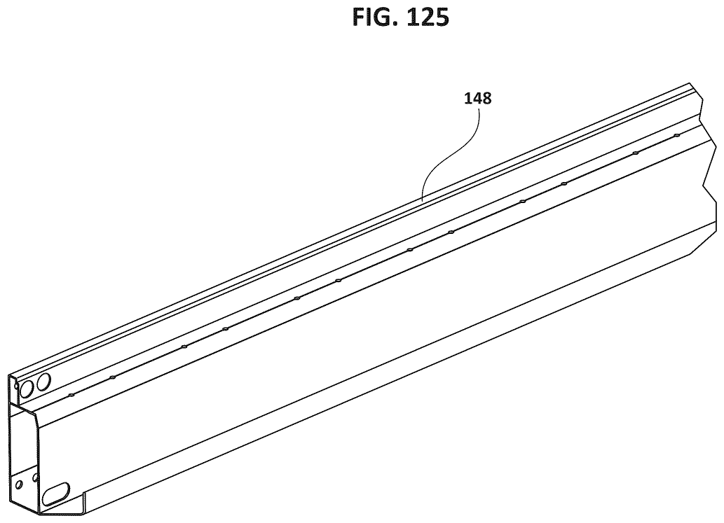

No prior art mention or disclose any pergola, having cost-saving production-increasing anti-noise louver axle 134. Therefore, the prior art of pergola are: Not capable of saving cost by being injection molded in a single piece, eliminating unnecessary hardware; Not capable of increasing production by being injection molded in a single piece, eliminating unnecessary hardware; and Not capable of providing location for cost-saving production-increasing left-side louver end 130 or cost-saving production-increasing right-side louver end 131 to pivotably rotate in the direction of arrow 164 (see FIG. 113, FIG. 114, FIG. 116, and FIG. 117). Not capable of noise-cancelling when rotated between noise-canceling axle saddle 150 and noise-canceling axle clamp 151 in the direction of arrow 157 (see FIG. 113, FIG. 114, FIG. 116, and FIG. 117).

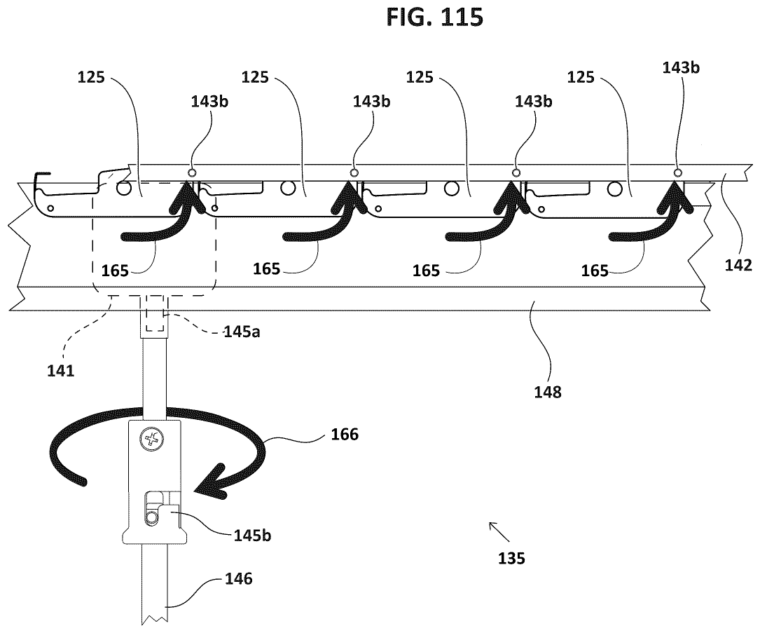

No prior art mention or disclose any pergola, having cost-saving production-increasing anti-noise shuttling axle 136. Therefore, the prior art of pergola are: Not capable of saving cost by being injection molded in a single piece, eliminating unnecessary hardware; and Not capable of increasing production by being injection molded in a single piece, eliminating unnecessary hardware; Not capable of providing location for automatic-multi-louver-shuttling multi-louver-conjoining control-bar 142 to be pivotably attached in the direction of arrow 165 (see FIG. 115 and FIG. 116).

No prior art mention or disclose any pergola, having quadruple snap-locking tails 137. Therefore, the prior art of pergola are: Not capable of saving cost by being injection molded in a single piece, eliminating unnecessary hardware; Not capable of increasing production by being injection molded in a single piece, eliminating unnecessary hardware; and Not capable of snap-locking to rainwater-shedding louver 125 without need for hardware.

### Objects and Advantages of the Invention

Some embodiments of the present invention substantially depart from the conventional concepts and designs of the prior art. In doing so, an embodiment provides a five-device-in-one anti-twisting anti-warping anti-vibrating cost-saving production-increasing corner and noise-canceling wind-dissipating louver (for being adapted to pergola, RV, house, solar panel, and concert stage), having many new and significant features, functions, and advantages, which overcome all the disadvantages of the prior art, as follows:
1) In some embodiments, it is an object of an embodiment to provide the five-device-in-one anti-twisting anti-warping anti-vibrating cost-saving production-increasing corner and noise-canceling wind-dissipating louver, having anti-twisting anti-warping cost-saving production-increasing outer corner 102. Therefore, the five-device-in-one anti-twisting anti-warping anti-vibrating cost-saving production-increasing corner and noise-canceling wind-dissipating louver are: Capable of providing anti-twisting and anti-warping reverse tension to retain the original shape and size of the five-device-in-one anti-twisting anti-warping anti-vibrating cost-saving production-increasing corner and noise-canceling wind-dissipating louver in the directions of arrows 154, and 155 (see FIG. 14, and FIG. 57); Capable of saving cost by being injection-molded in a single piece; and Capable of increasing production capabilities by being injection-molded in a single piece.
2) In some embodiments, it is another object of an embodiment to provide the five-device-in-one anti-twisting anti-warping anti-vibrating cost-saving production-increasing corner and noise-canceling wind-dissipating louver, having cost-saving production-increasing inner corner parapet 106. Therefore, the five-device-in-one anti-twisting anti-warping anti-vibrating cost-saving production-increasing corner and noise-canceling wind-dissipating louver are: Capable of being used to support a pergola or an RV gutter to shed rainwater therefrom in the direction of arrow 156 (see FIG. 3, FIG. 4, FIG. 46, and FIG. 47); Capable of being used to support a concert stage gutter to shed rainwater from a concert stage in the direction of arrow 157 (see FIG. 5, and FIG. 48); Capable of being used to support a house gutter to shed rainwater from a house in the direction of arrow 158 (see FIG. 6, and FIG. 49); Capable of being use to support a solar panel gutter to shed rainwater from a solar panel in the direction of arrow 159 (see FIG. 7, and FIG. 50); Capable of being used to support an awning when attached to a building (see FIG. 8, and FIG. 51); Capable of saving cost by being injection molded in a single piece; and Capable of increasing production capabilities by being injection molded in a single piece.
3) In some embodiments, it is still another object of an embodiment to provide the five-device-in-one anti-twisting anti-warping anti-vibrating cost-saving production-increasing corner and noise-canceling wind-dissipating louver, having leaf-filtering-and-breaking cost-saving production-increasing honeycomb grate 107. Therefore, the five-device-in-one anti-twisting anti-warping anti-vibrating cost-saving production-increasing corner and noise-canceling wind-dissipating louver are: Capable of filtering leaves and other debris from getting inside double-gutter-supporting-and-locking post 114 (see FIG. 12, FIG. 13, FIG. 55, and FIG. 56); Capable of breaking up leaves and other debris to prevent large leaves from getting into double-gutter-supporting-and-locking post 114 in the direction of arrow 160 (see FIG. 12, FIG. 13, FIG. 55, and FIG. 56); Capable of securing a solar panel (see FIG. 9, and FIG. 52); Capable of securing an outdoor speaker (see FIG. 10, and FIG. 53); Capable of securing an outdoor light for illuminating through leaf-filtering-and-breaking cost-saving production-increasing honeycomb grate 107 (see FIG. 11, and FIG. 54); Capable of saving cost by being injection molded in a single piece; and Capable of increasing production capabilities by being injection molded in a single piece.
4) In some embodiments, it is a further object of an embodiment to provide the five-device-in-one anti-twisting anti-warping anti-vibrating cost-saving production-increasing corner and noise-canceling wind-dissipating louver, having anti-twisting anti-warping anti-vibrating 90-degree-double-yokes 110b. Therefore, the five-device-in-one anti-twisting anti-warping anti-vibrating cost-saving production-increasing corner and noise-canceling wind-dissipating louver are: Capable of anti-vibrating while in use by cushioning cost-saving production-increasing inner corner parapet 106 (see FIG. 14, and FIG. 22); and Capable of absorbing vibrations caused by wind while in use.
5) In some embodiments, it is a further object of an embodiment to provide the five-device-in-one anti-twisting anti-warping anti-vibrating cost-saving production-increasing corner and noise-canceling wind-dissipating louver, having double-gutter-supporting-and-locking post 114. Therefore, the five-device-in-one anti-twisting anti-warping anti-vibrating cost-saving production-increasing corner and noise-canceling wind-dissipating louver are: Capable of supporting an RV gutter to shed rainwater from an RV in the direction of arrow 156 (see FIG. 4, and FIG. 47); Capable of supporting a concert stage gutter to shed rainwater from a concert stage in the direction of arrow 157 (see FIG. 5, and FIG. 48); Capable of supporting a house gutter to shed rainwater from a house in the direction of arrow 158 (see FIG. 6, and FIG. 49); Capable of supporting a solar panel gutter to shed rainwater from a solar panel in the direction of arrow 159 (see FIG. 7, and FIG. 50); and Capable of supporting an awning when attached to a building (see FIG. 8, and FIG. 51).
6) In some embodiments, it is another further object of an embodiment to provide the five-device-in-one anti-twisting anti-warping anti-vibrating cost-saving production-increasing corner and noise-canceling wind-dissipating louver, having post-top double-gutter-supporting-and-locking parapet-mounting flange 115. Therefore, the five-device-in-one anti-twisting anti-warping anti-vibrating cost-saving production-increasing corner and noise-canceling wind-dissipating louver are: Capable of supporting an RV gutter to shed rainwater from an RV in the direction of arrow 156 (see FIG. 4, and FIG. 47); Capable of supporting a concert stage gutter to shed rainwater from a concert stage in the direction of arrow 157 (see FIG. 5, and FIG. 48); Capable of supporting a house gutter to shed rainwater from a house in the direction of arrow 158 (see FIG. 6, and FIG. 49); Capable of supporting a solar panel gutter to shed rainwater from a solar panel in the direction of arrow 159 (see FIG. 7, and FIG. 50); and Capable of supporting an awning when attached to a building (see FIG. 8, and FIG. 51). It is yet another further object of an embodiment to provide the five-device-in-one anti-twisting anti-warping anti-vibrating cost-saving production-increasing corner and noise-canceling wind-dissipating louver, having anti-twisting anti-warping 4-opposite-direction-securing post-mounting flanges 120. Therefore, the five-device-in-one anti-twisting anti-warping anti-vibrating cost-saving production-increasing corner and noise-canceling wind-dissipating louver are: Capable of providing anti-twisting and anti-warping reverse tension to retain the original shape and size of the five-device-in-one anti-twisting anti-warping anti-vibrating cost-saving production-increasing corner and noise-canceling wind-dissipating louver in the directions of arrows 154, and 155 (see FIG. 14, and FIG. 57); Capable of securing double-gutter-supporting-and-locking post 114 to anti-twisting anti-warping 4-opposite-direction-securing post plate 119. It is still yet another further object of an embodiment to provide the five-device-in-one anti-twisting anti-warping anti-vibrating cost-saving production-increasing corner and noise-canceling wind-dissipating louver, having cost-saving production-increasing left-side louver end 130. Therefore, the five-device-in-one anti-twisting anti-warping anti-vibrating cost-saving production-increasing corner and noise-canceling wind-dissipating louver are: Capable of saving cost by being injection molded in a single piece, eliminating unnecessary hardware; and Capable of increasing production by being injection molded in a single piece, eliminating unnecessary hardware.

In some embodiments, it is still yet another further object of an embodiment to provide the five-device-in-one anti-twisting anti-warping anti-vibrating cost-saving production-increasing corner and noise-canceling wind-dissipating louver, having cost-saving production-increasing right-side louver end 131. Therefore, the five-device-in-one anti-twisting anti-warping anti-vibrating cost-saving production-increasing corner and noise-canceling wind-dissipating louver are: Capable of saving cost by being injection molded in a single piece, eliminating unnecessary hardware; and Capable of increasing production by being injection molded in a single piece, eliminating unnecessary hardware.

In some embodiments, it is still yet another further object of an embodiment to provide the five-device-in-one anti-twisting anti-warping anti-vibrating cost-saving production-increasing corner and noise-canceling wind-dissipating louver, having noise-canceling rainwater-draining axle bore 132. Therefore, the five-device-in-one anti-twisting anti-warping anti-vibrating cost-saving production-increasing corner and noise-canceling wind-dissipating louver are: Capable of draining rainwater away from rainwater-shedding louver 125 in the directions of arrows 162a and 162b (see FIG. 61-FIG. 64); and Capable of dissipating wind away from rainwater-shedding louver 125 in the directions of arrows 162a and 162b (see FIG. 61-FIG. 64).

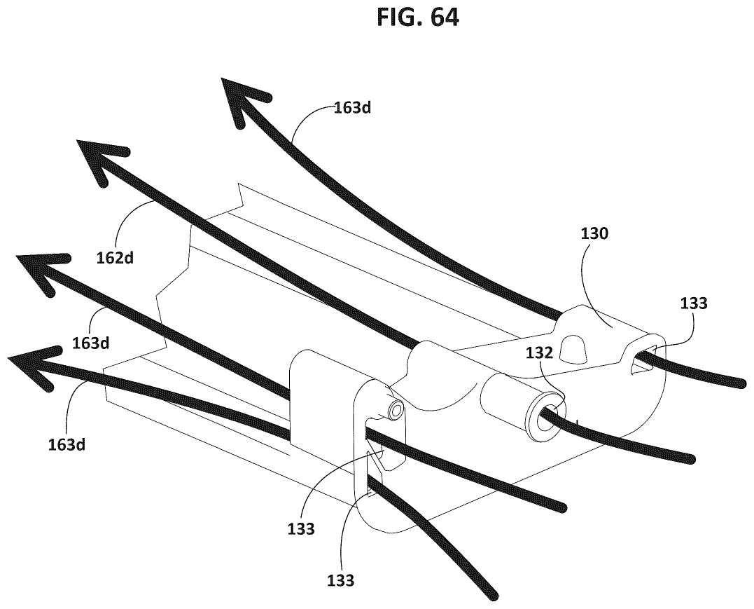

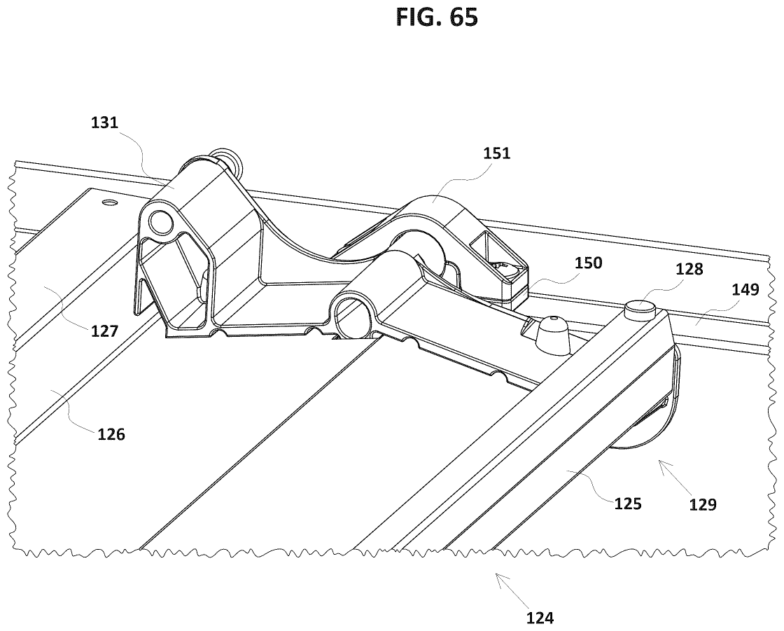

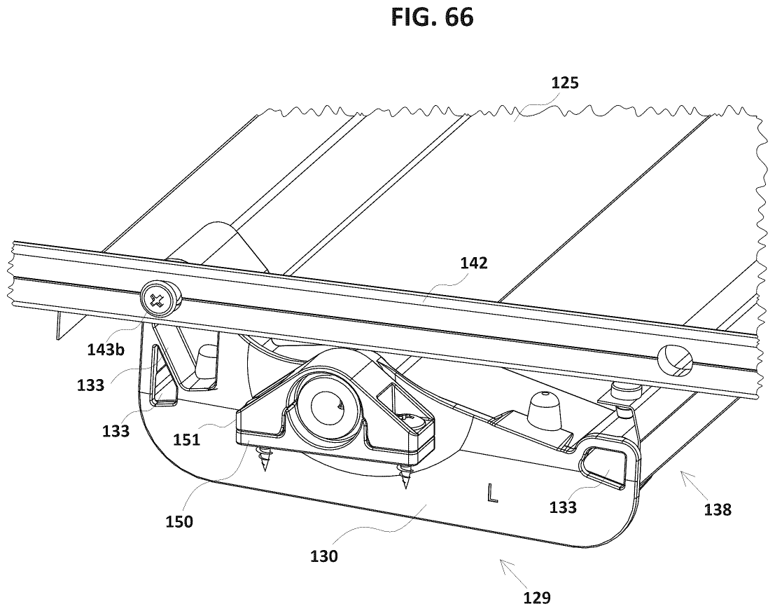

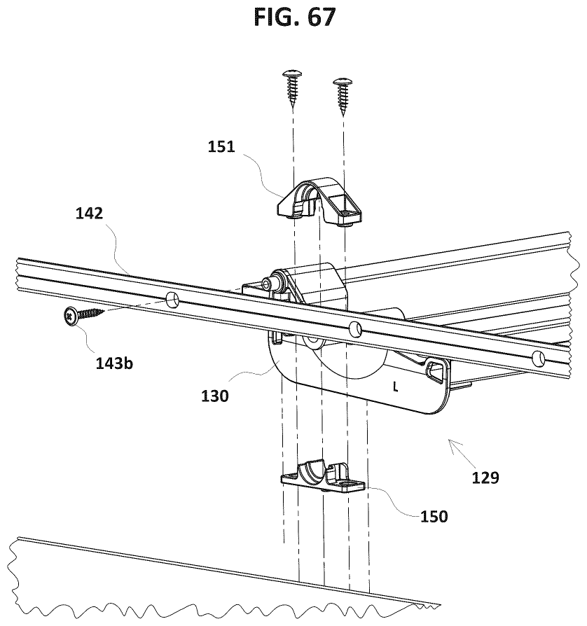

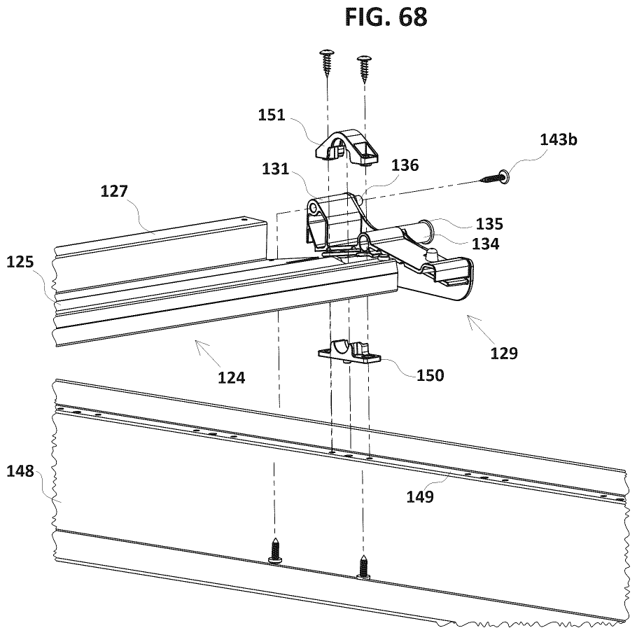

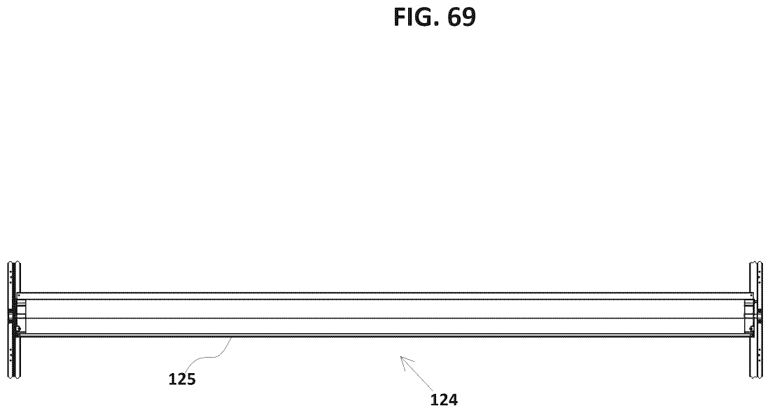

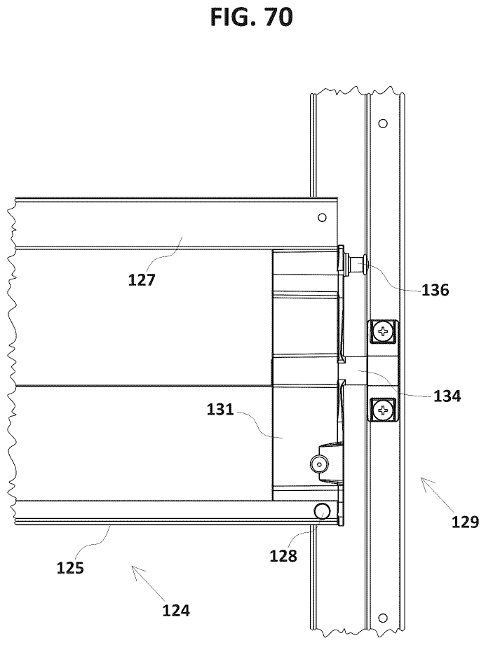

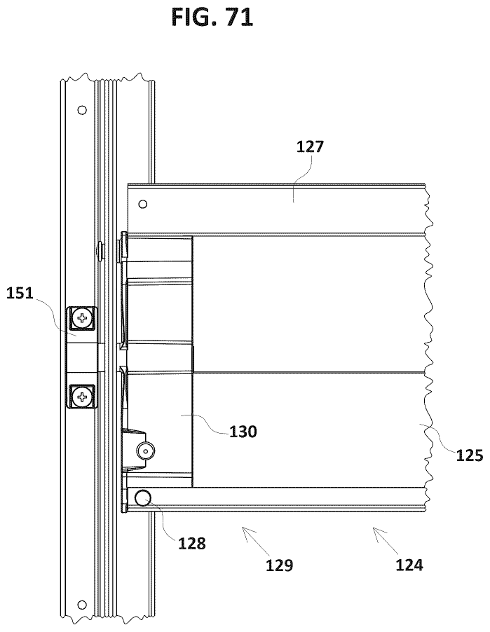

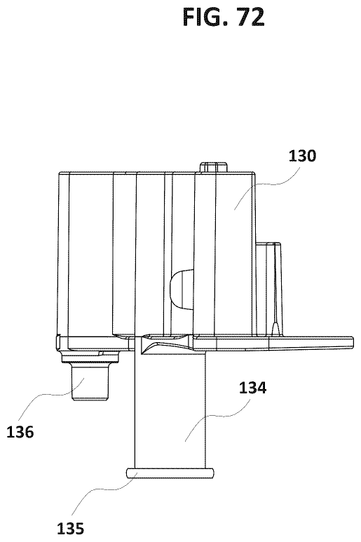

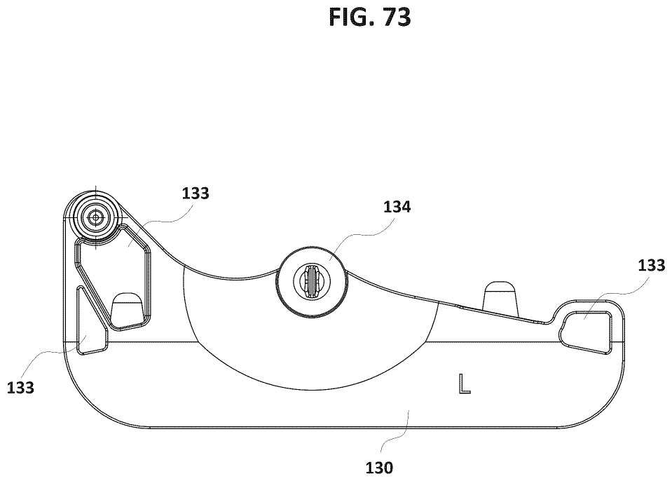

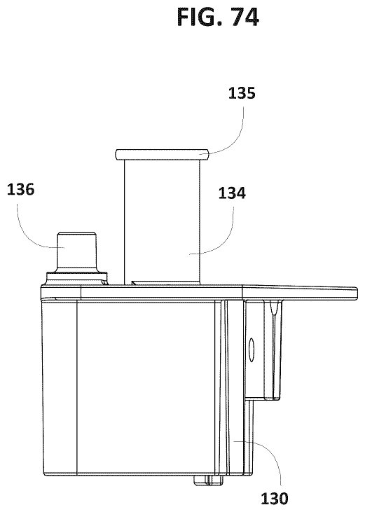

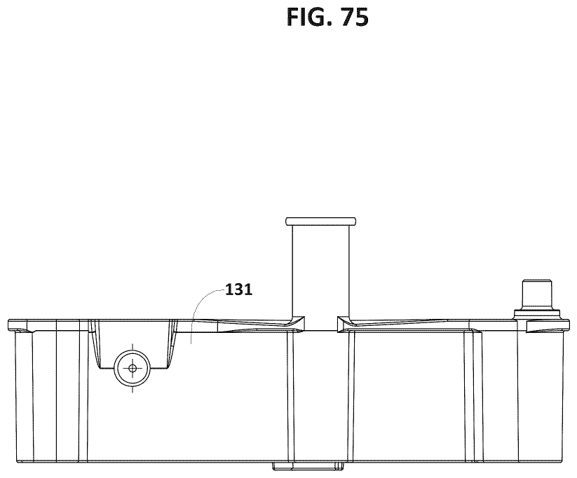

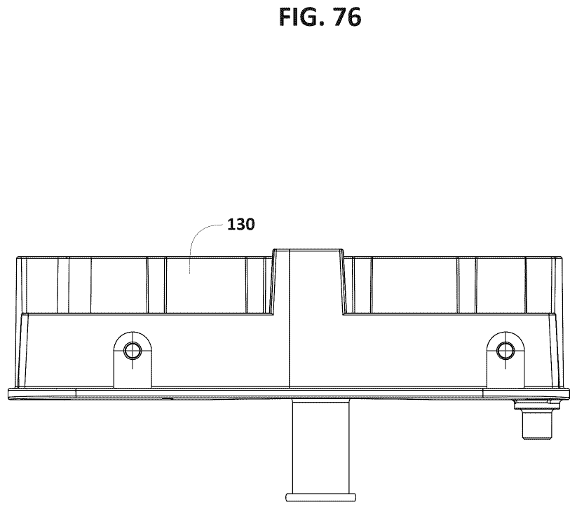

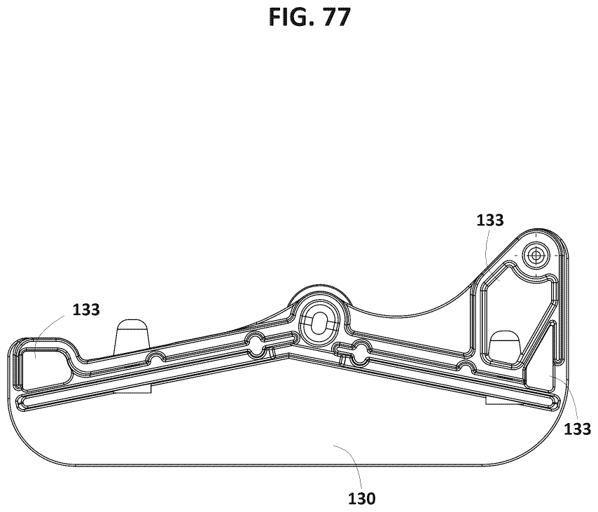

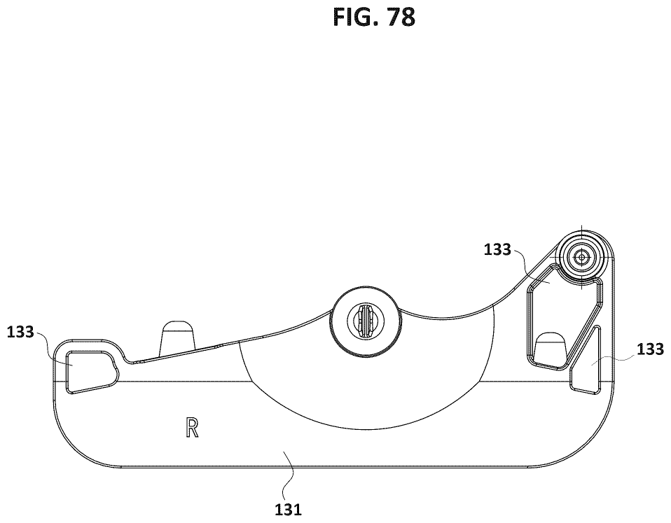

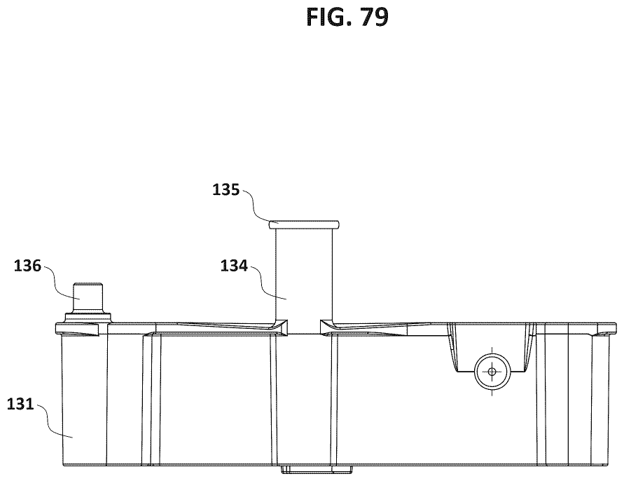

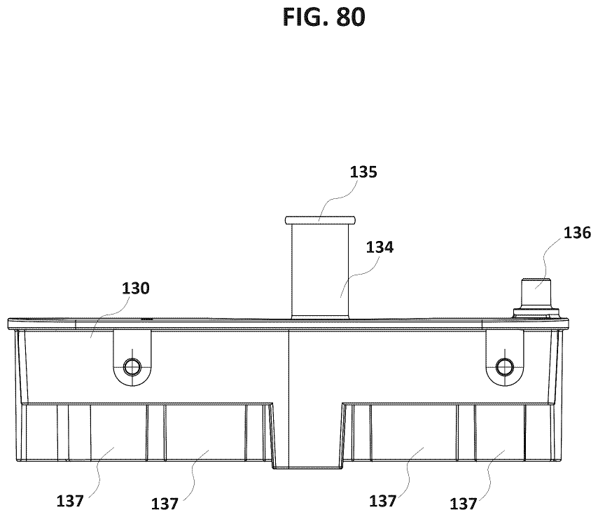

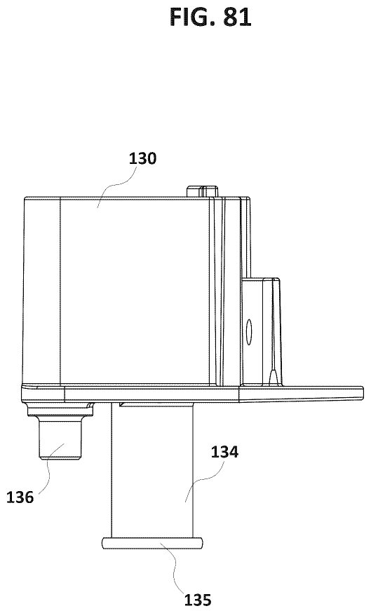

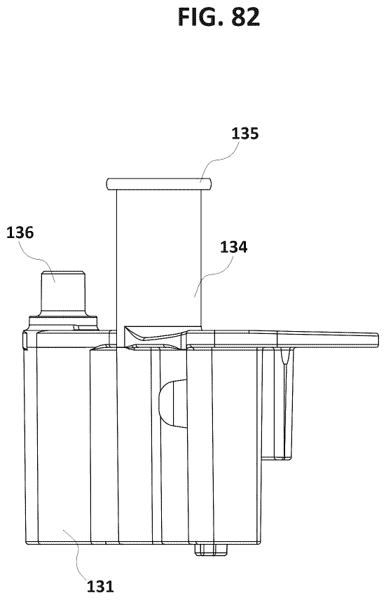

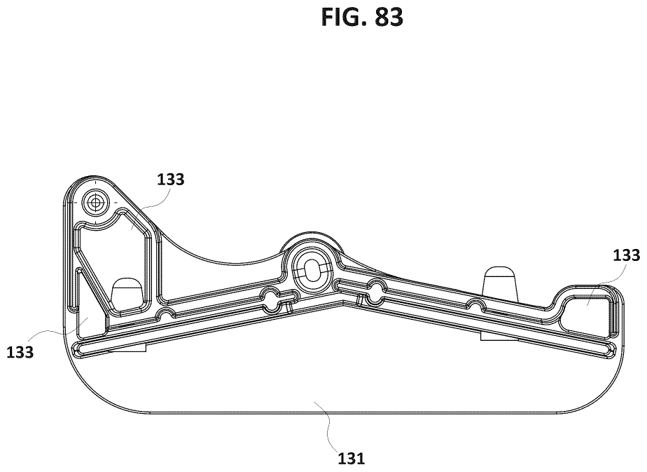

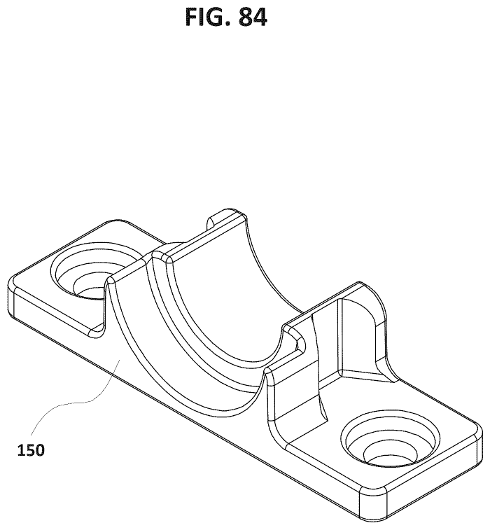

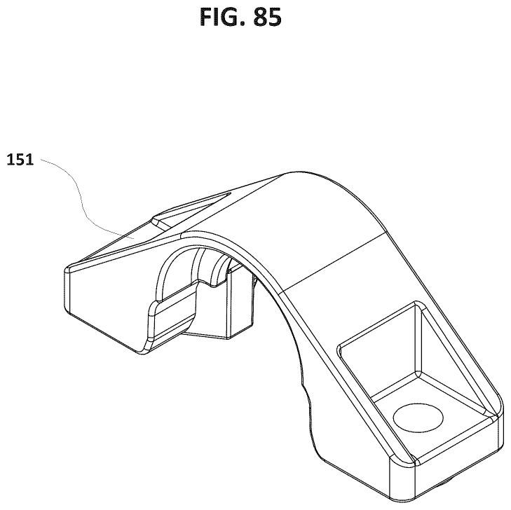

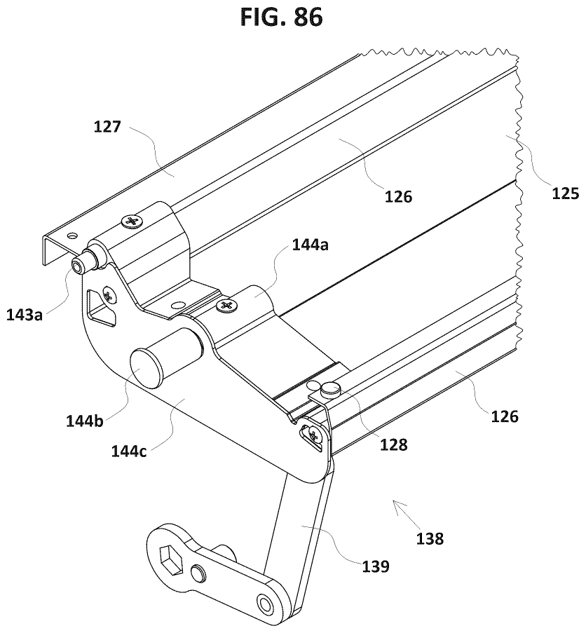

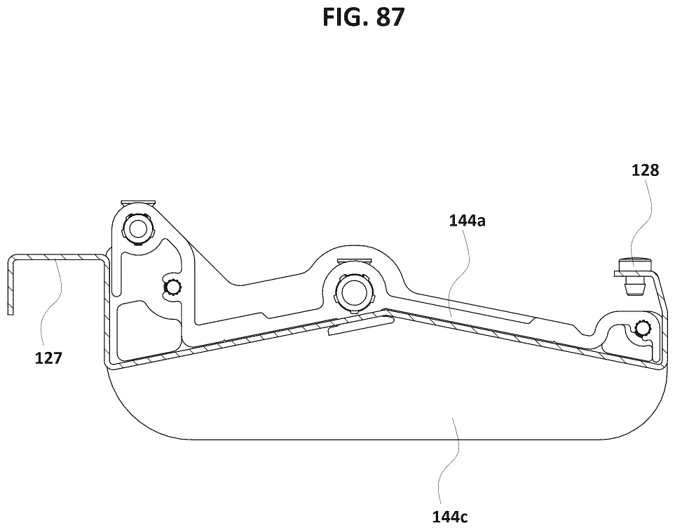

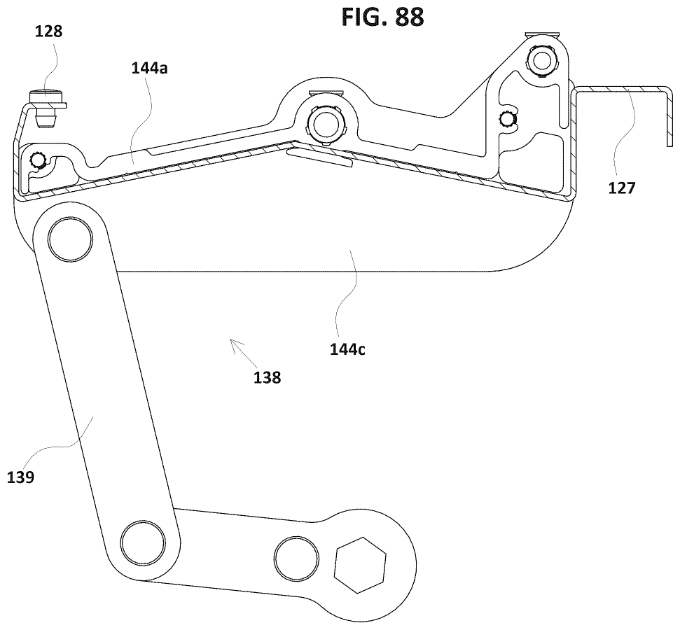

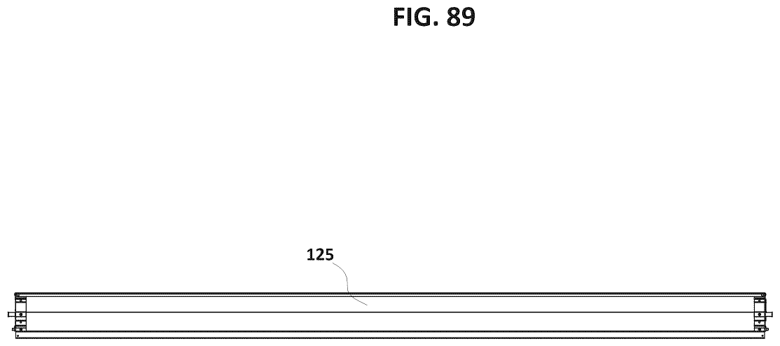

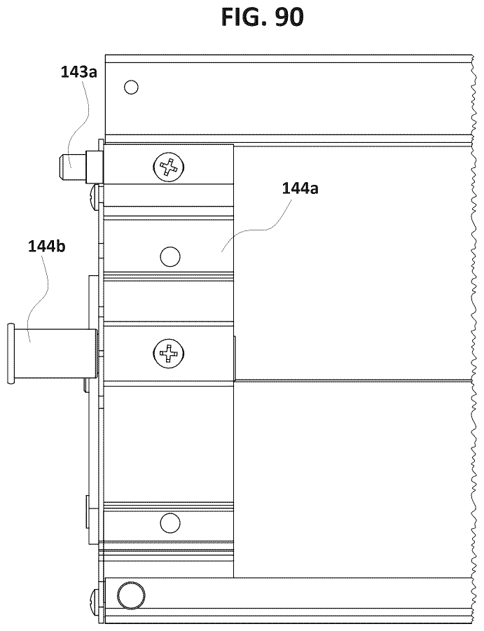

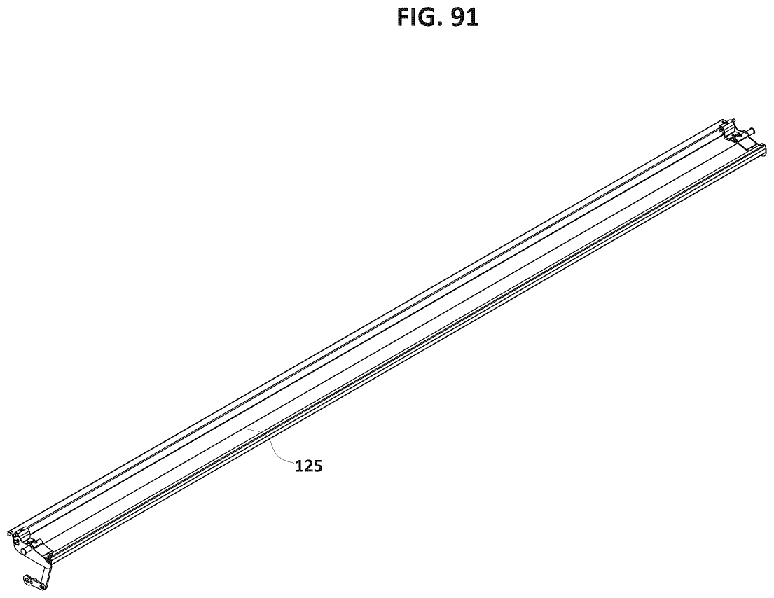

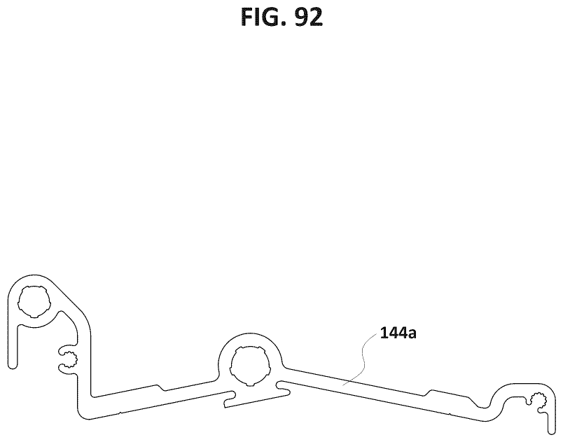

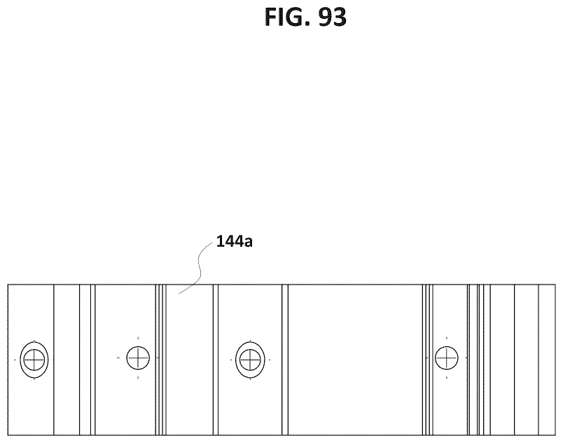

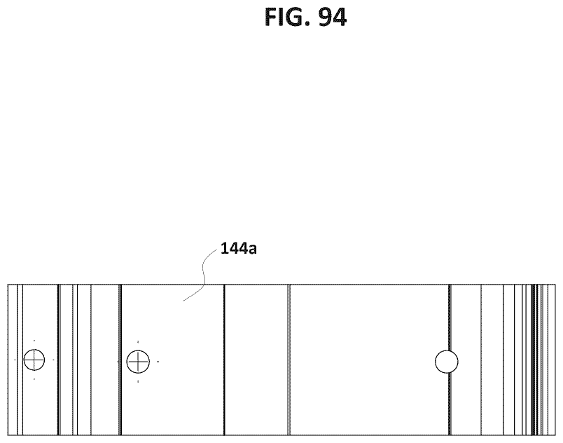

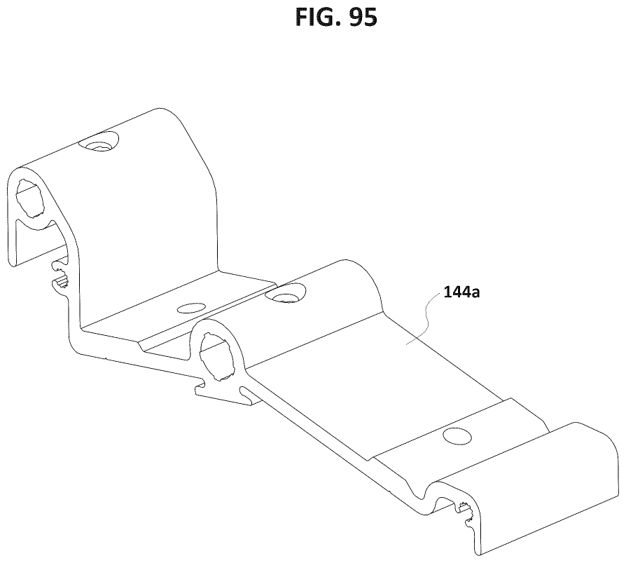

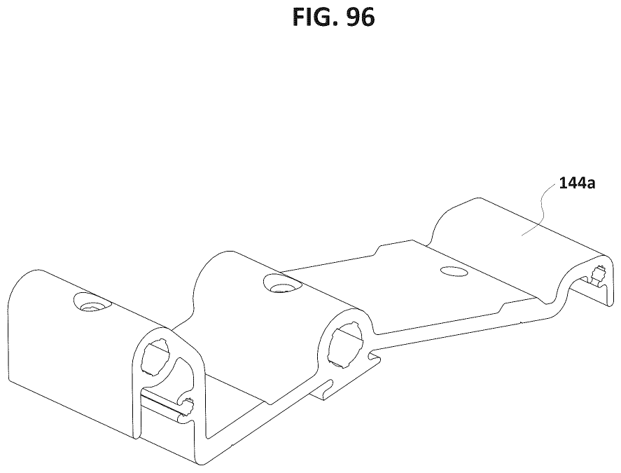

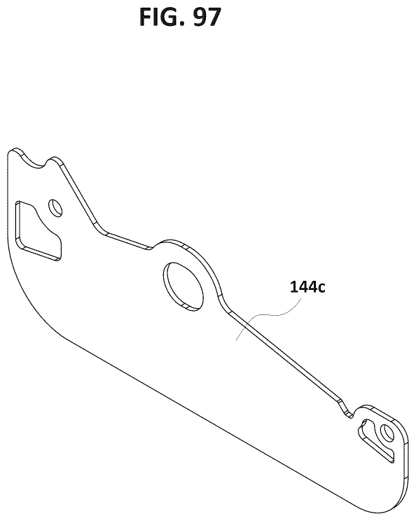

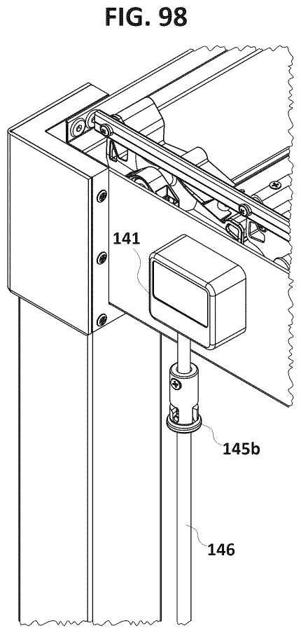

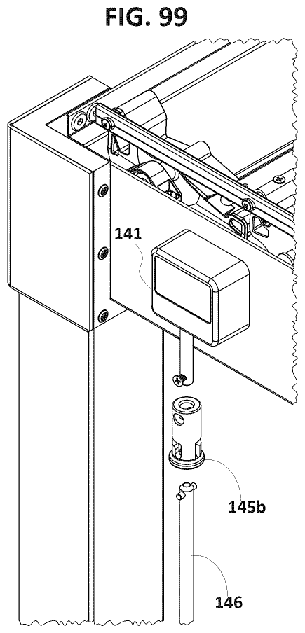

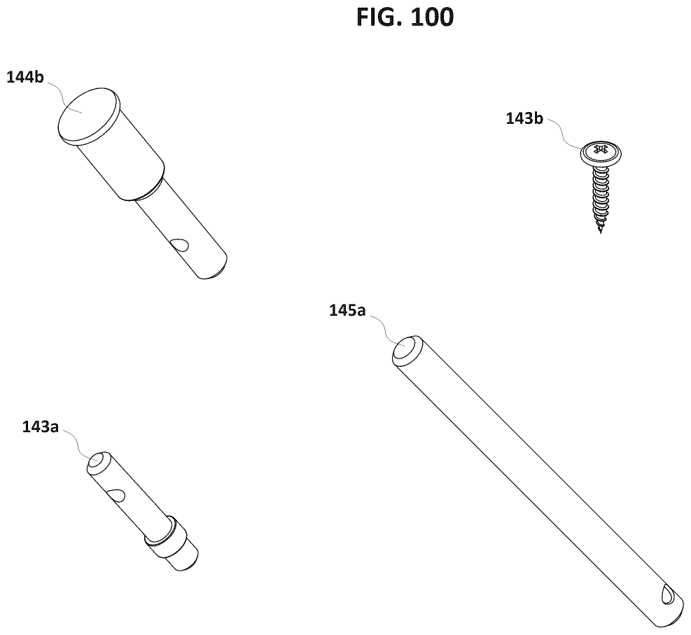

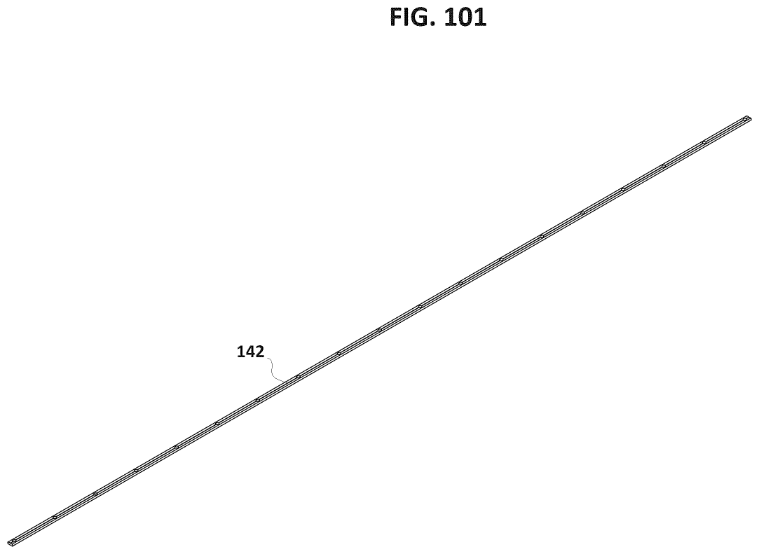

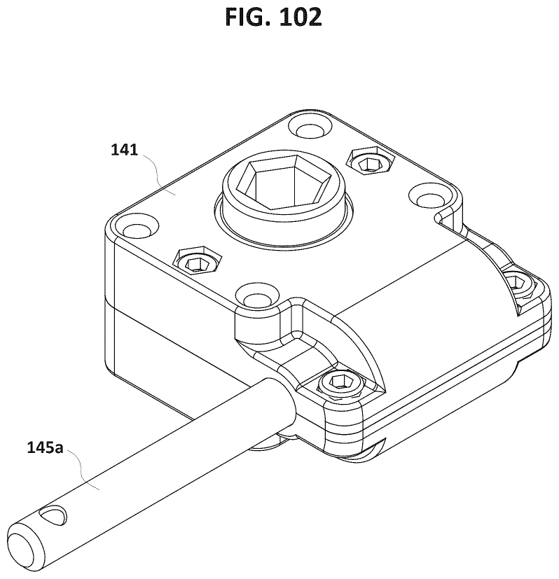

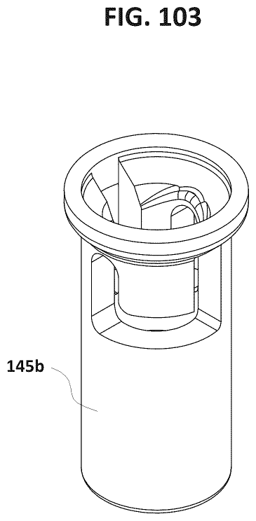

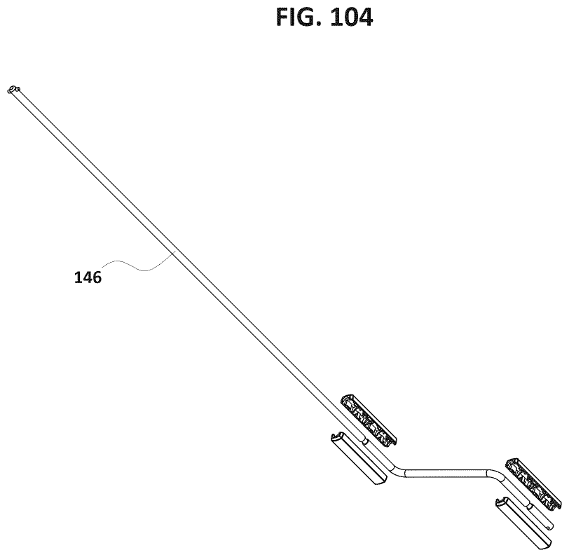

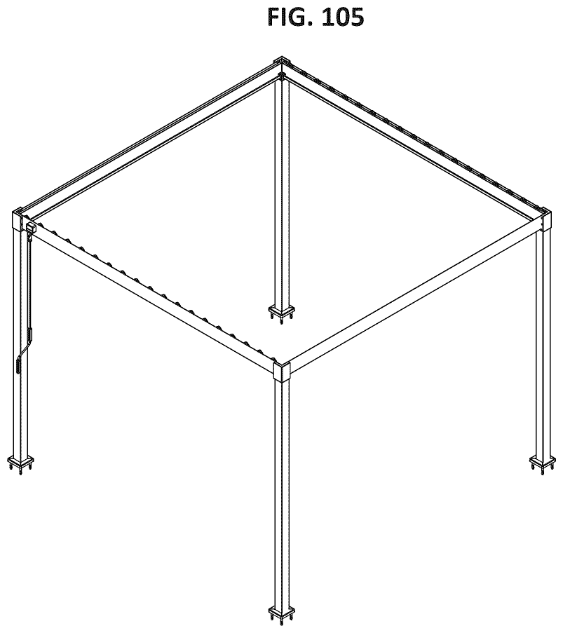

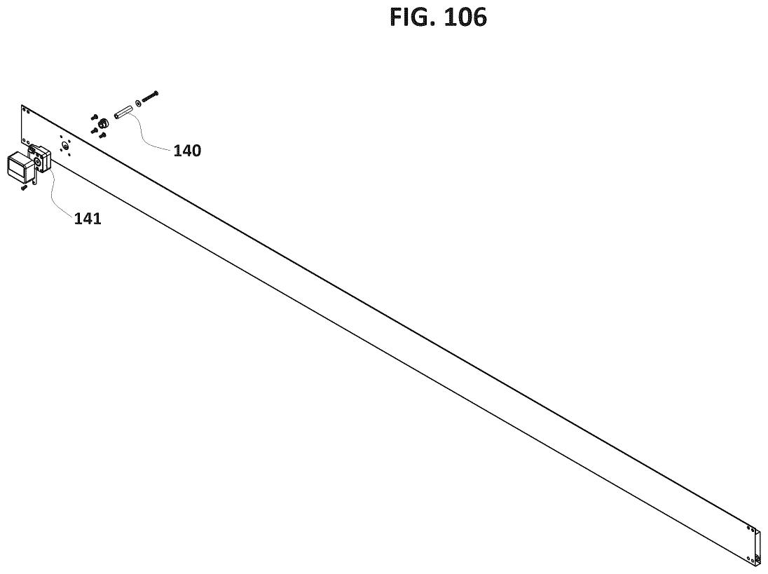

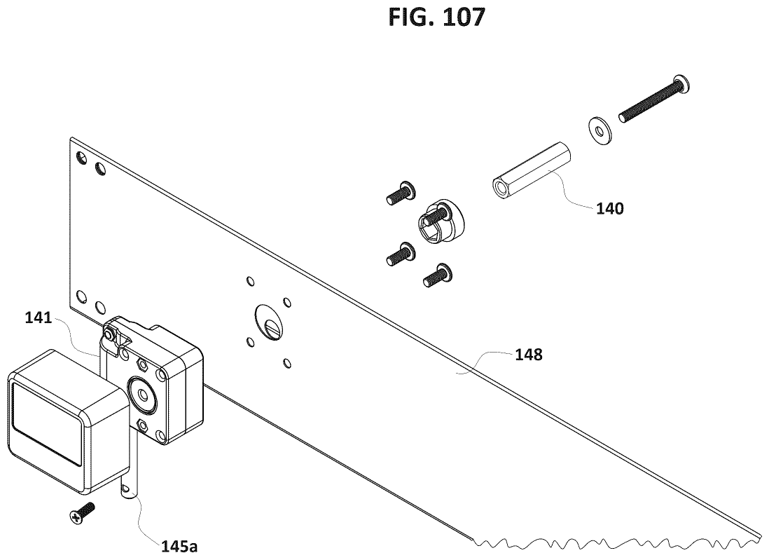

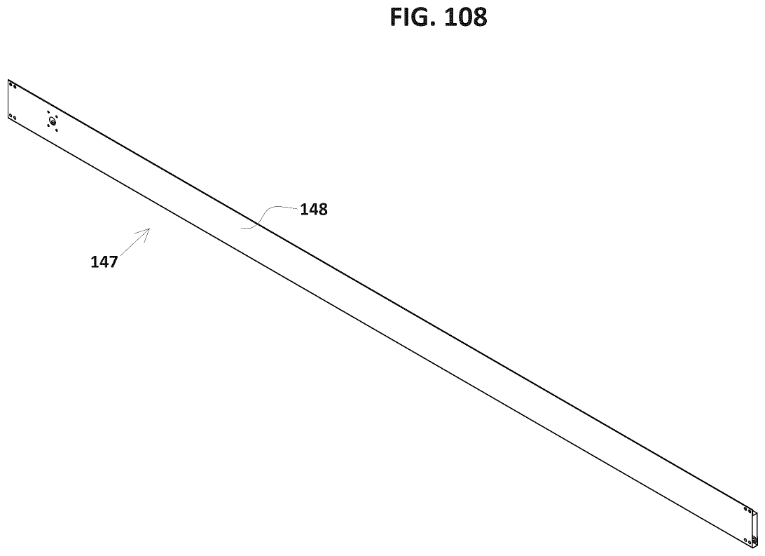

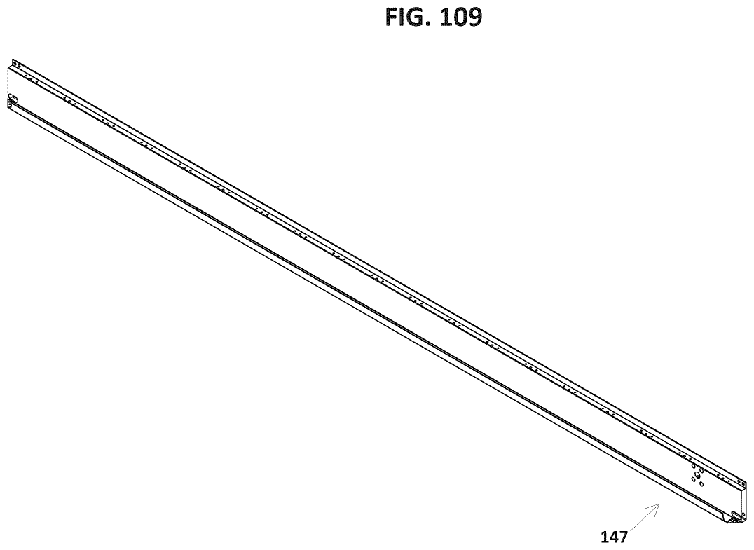

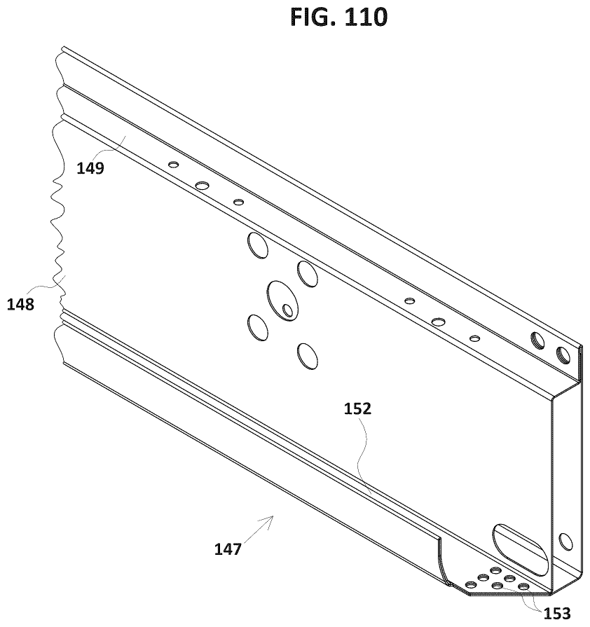

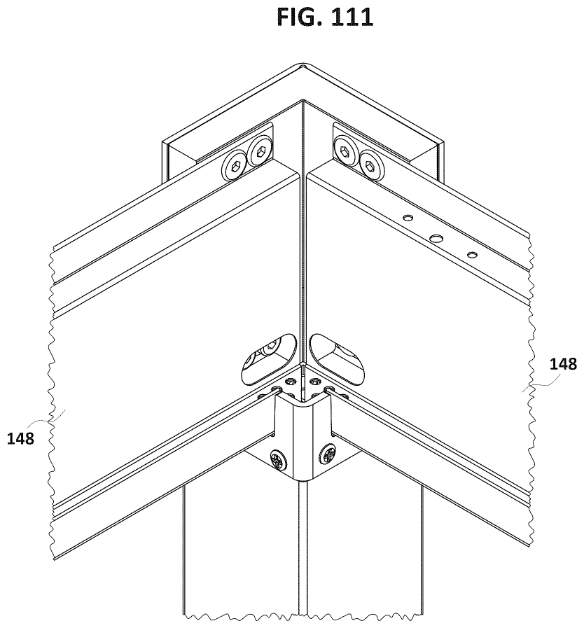

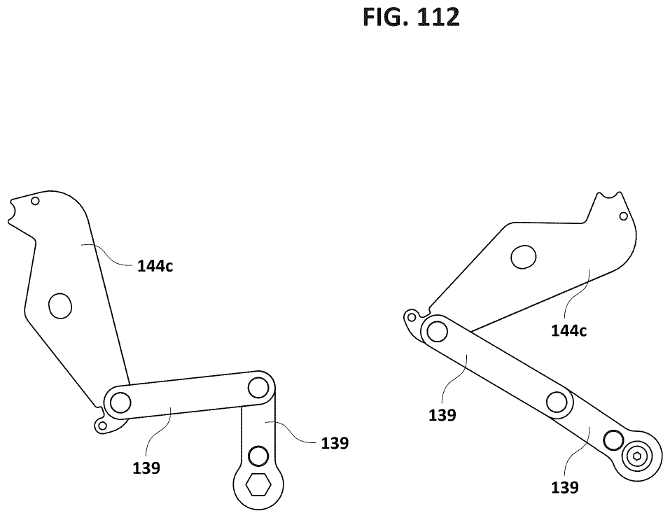

In some embodiments, it is still yet another further object of an embodiment to provide the five-device-in-one anti-twisting anti-warping anti-vibrating cost-saving production-increasing corner and noise-canceling wind-dissipating louver, having triple wind-dissipating tunnels 133. Therefore, the five-device-in-one anti-twisting anti-warping anti-vibrating cost-saving production-increasing corner and noise-canceling wind-dissipating louver are: Capable of draining rainwater away from rainwater-shedding louver 125 in the directions of arrows 163a-163d (see FIG. 61 FIG. 64); and Capable of dissipating wind away from rainwater-shedding louver 125 in the directions of arrows 163a-163d (see FIG. 61-FIG. 64).

In some embodiments, it is still yet another further object of an embodiment to provide the five-device-in-one anti-twisting anti-warping anti-vibrating cost-saving production-increasing corner and noise-canceling wind-dissipating louver, having cost-saving production-increasing anti-noise louver axle 134. Therefore, the five-device-in-one anti-twisting anti-warping anti-vibrating cost-saving production-increasing corner and noise-canceling wind-dissipating louver are: Capable of saving cost by being injection molded in a single piece, eliminating unnecessary hardware; Capable of increasing production by being injection molded in a single piece, eliminating unnecessary hardware; and Capable of providing location for cost-saving production-increasing left-side louver end 130 or cost-saving production-increasing right-side louver end 131 to pivotably rotate in the direction of arrow 164 (see FIG. 113, FIG. 114, FIG. 116, and FIG. 117). Capable of noise-cancelling when rotated between noise-canceling axle saddle 150 and noise-canceling axle clamp 151 in the direction of arrow 164 (see FIG. 113, FIG. 114, FIG. 116, and FIG. 117).

In some embodiments, it is still yet another further object of an embodiment to provide the five-device-in-one anti-twisting anti-warping anti-vibrating cost-saving production-increasing corner and noise-canceling wind-dissipating louver, having cost-saving production-increasing anti-noise shuttling axle 136. Therefore, the five-device-in-one anti-twisting anti-warping anti-vibrating cost-saving production-increasing corner and noise-canceling wind-dissipating louver are: Capable of saving cost by being injection molded in a single piece, eliminating unnecessary hardware; and Capable of increasing production by being injection molded in a single piece, eliminating unnecessary hardware; Capable of providing location for automatic-multi-louver-shuttling multi-louver-conjoining control-bar 142 to be pivotably attached in the direction of arrow 165 (see FIG. 115 and FIG. 116)

In some embodiments, it is still yet another further object of an embodiment to provide the five-device-in-one anti-twisting anti-warping anti-vibrating cost-saving production-increasing corner and noise-canceling wind-dissipating louver, having quadruple snap-locking tails 137. Therefore, the five-device-in-one anti-twisting anti-warping anti-vibrating cost-saving production-increasing corner and noise-canceling wind-dissipating louver are: Capable of saving cost by being injection molded in a single piece, eliminating unnecessary hardware; Capable of increasing production by being injection molded in a single piece, eliminating unnecessary hardware; and Capable of snap-locking to rainwater-shedding louver 125 without need for hardware.

In some embodiments, the five-device-in-one anti-twisting anti-warping anti-vibrating cost-saving production-increasing corner and noise-canceling wind-dissipating louver (for being adapted to pergola, RV, house, solar panel, and concert stage) comprises: Anti-twisting anti-warping cost-saving production-increasing outer corner system, Leaf-filtering-and-breaking cost-saving production-increasing auto-centering inner corner system, Double-gutter-supporting-and-locking post system, Anti-twisting anti-warping 4-opposite-direction-securing post-plate system, Rainwater-shedding rainwater-directing louver systems, Cost-saving production-increasing noise-canceling wind-dissipating louver end systems, Automatic-multi-louver-shuttleing system, and Cost-saving production-increasing rainwater-shedding leaf-filtering beam systems.

### Component

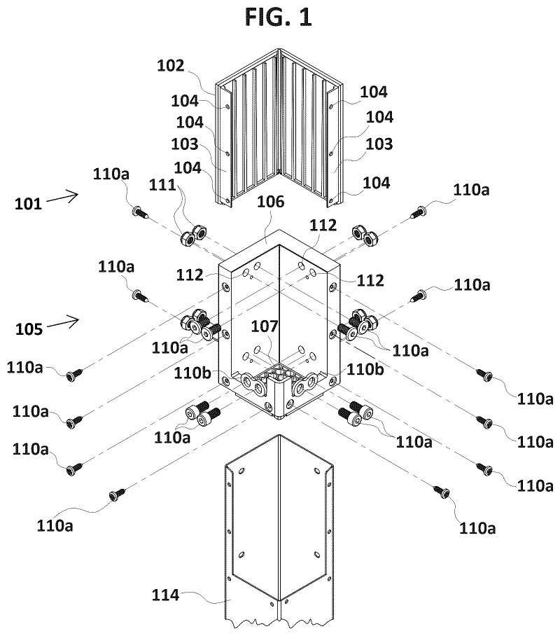

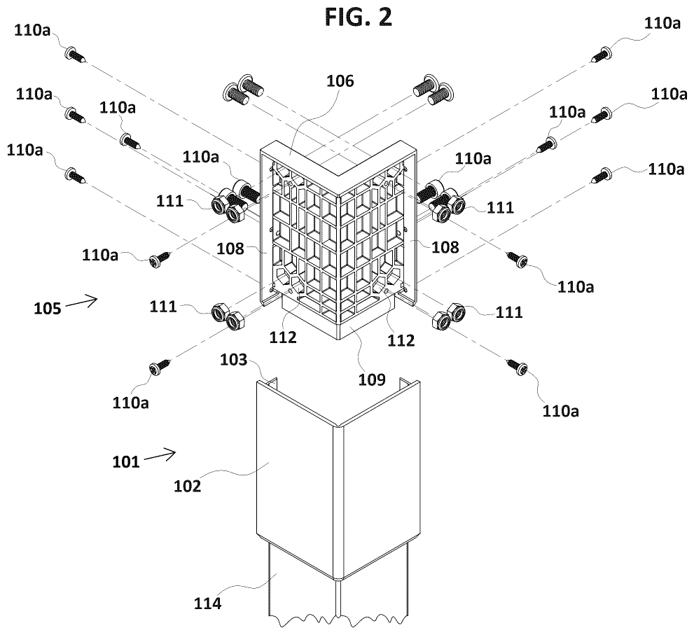

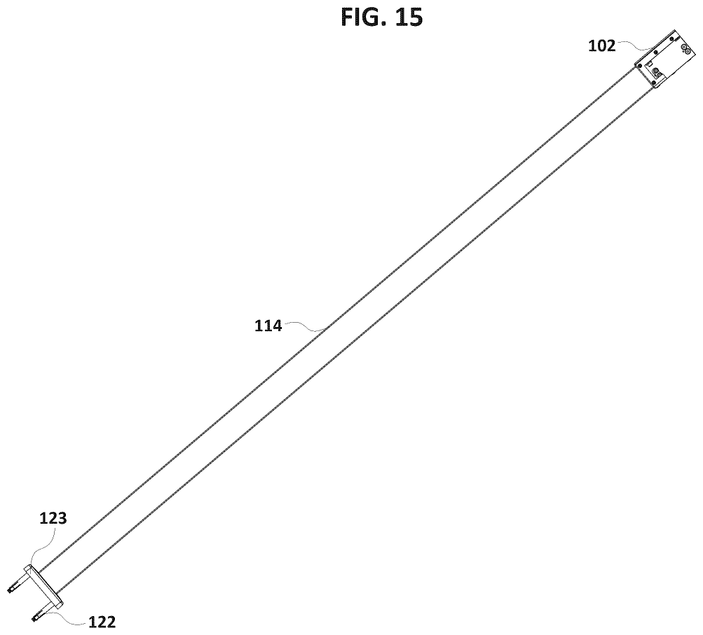

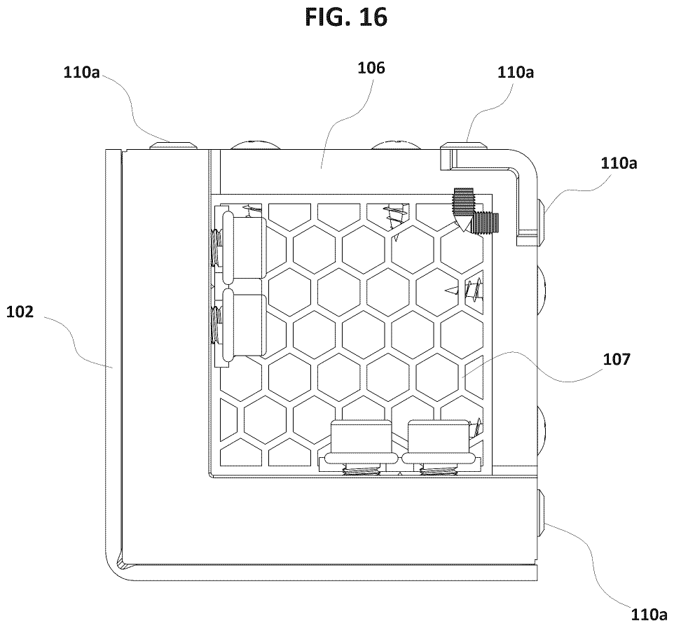

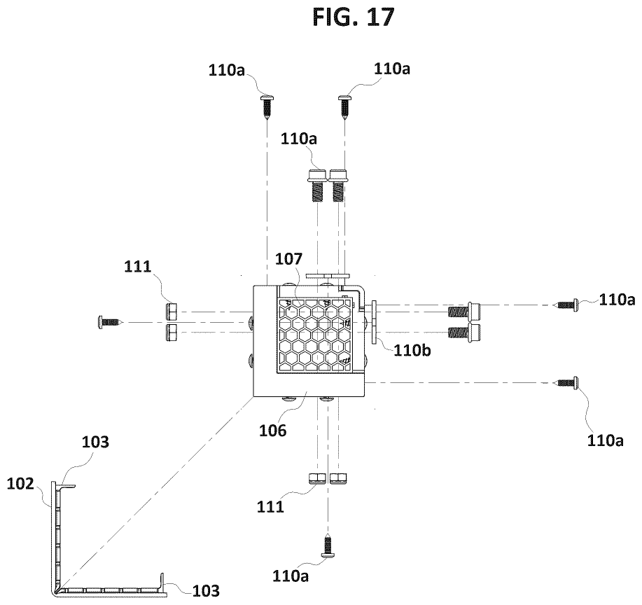

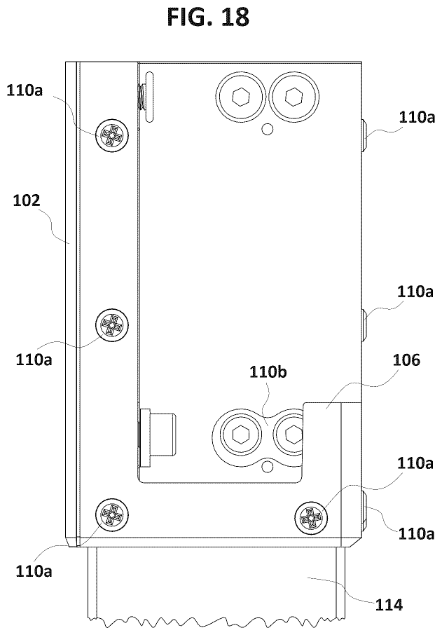

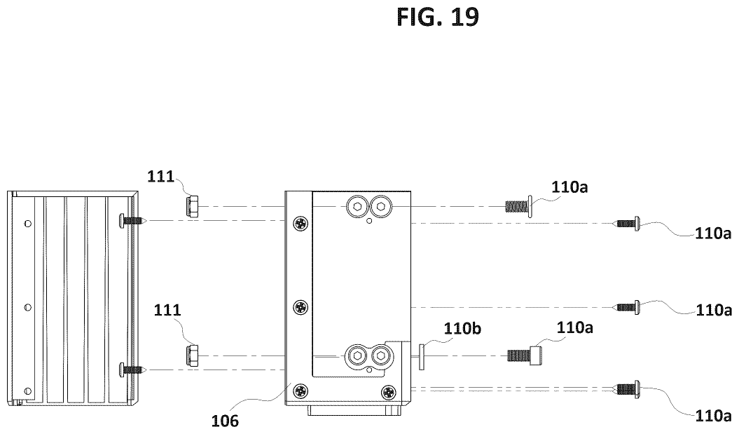

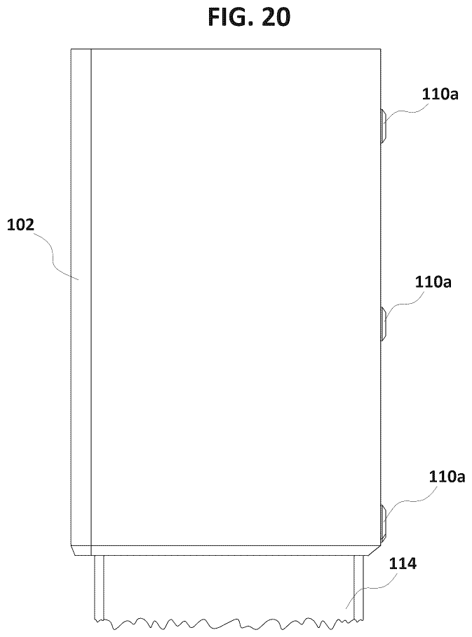

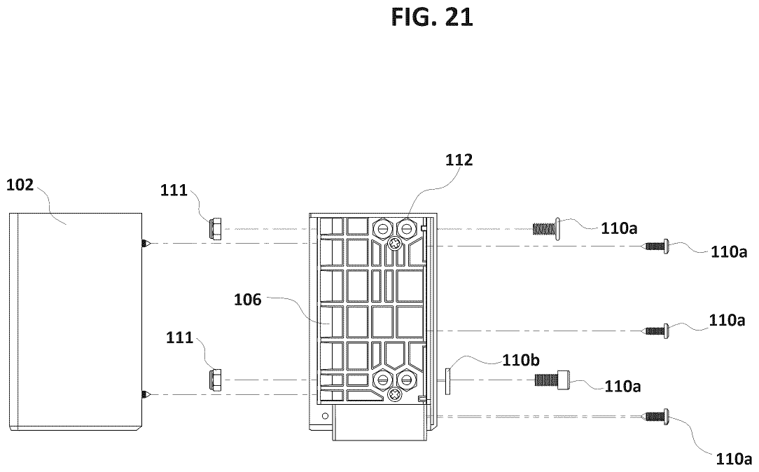

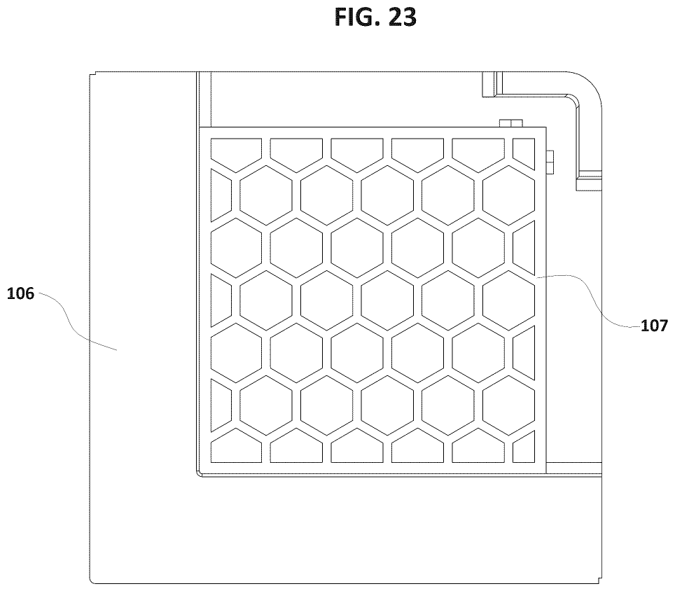

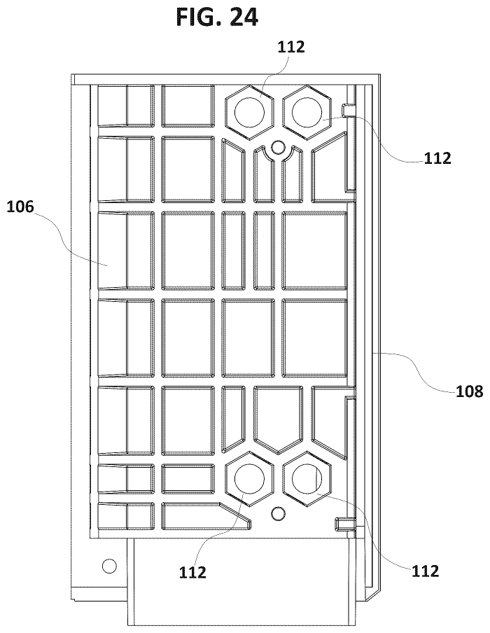

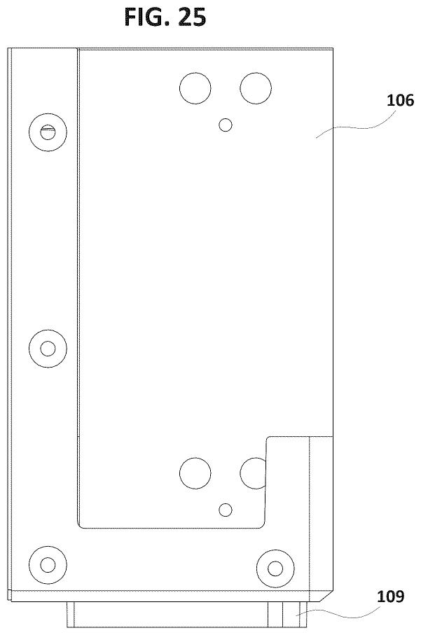

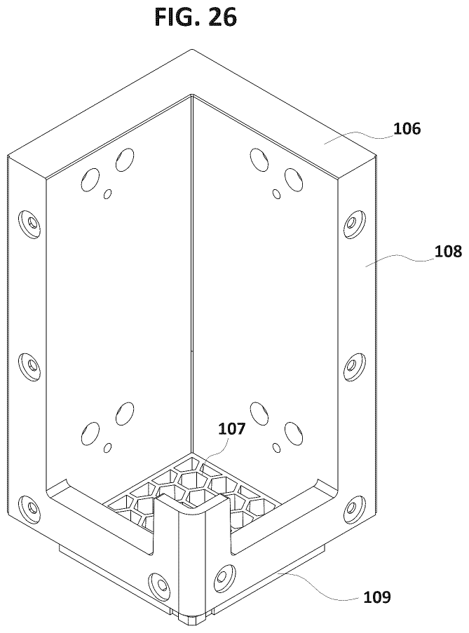

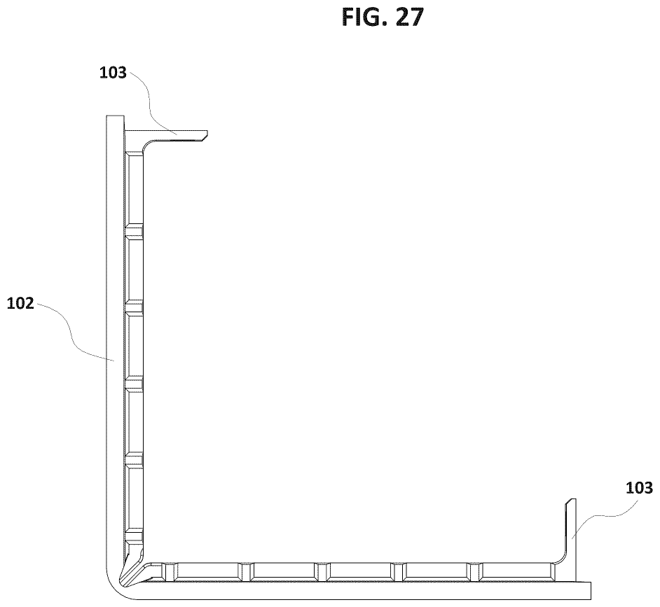

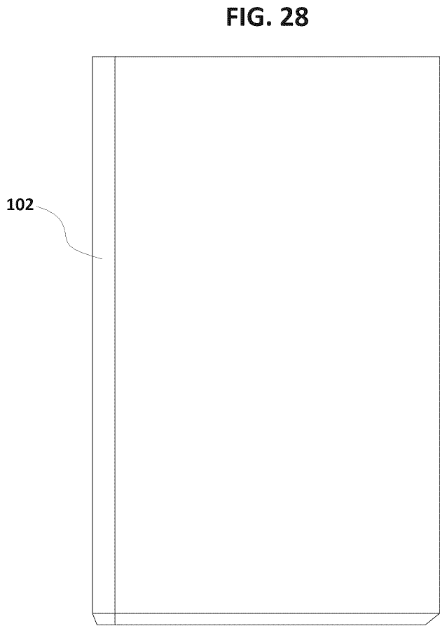

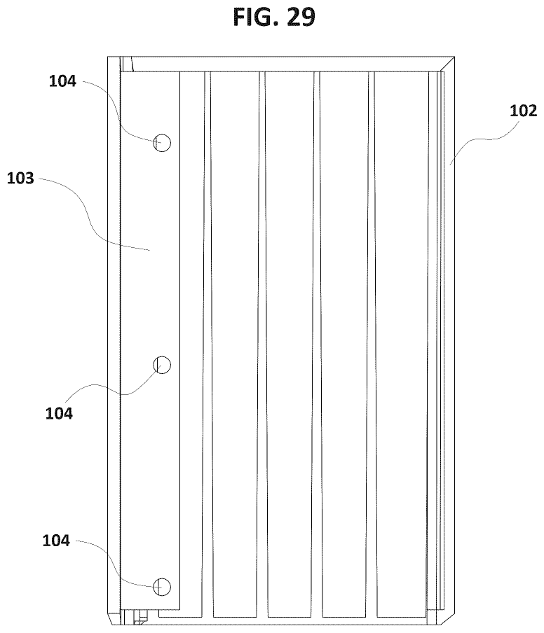

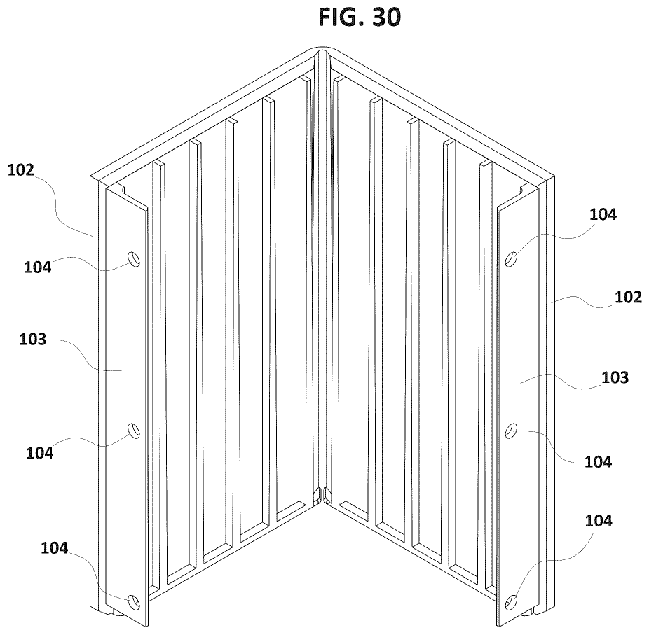

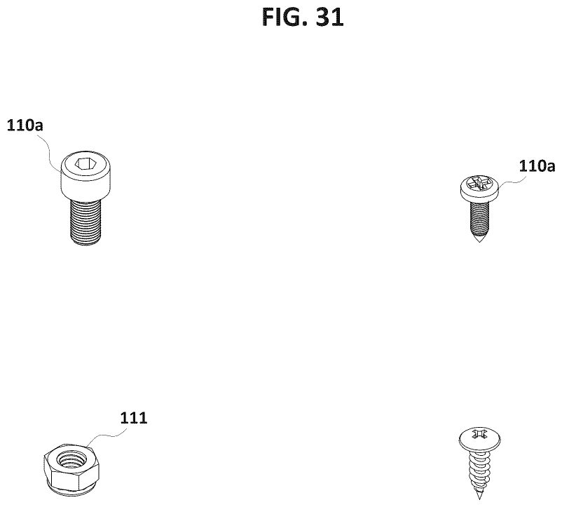

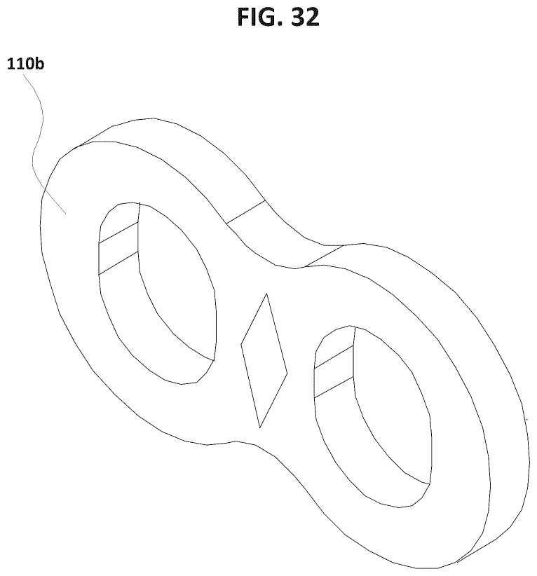

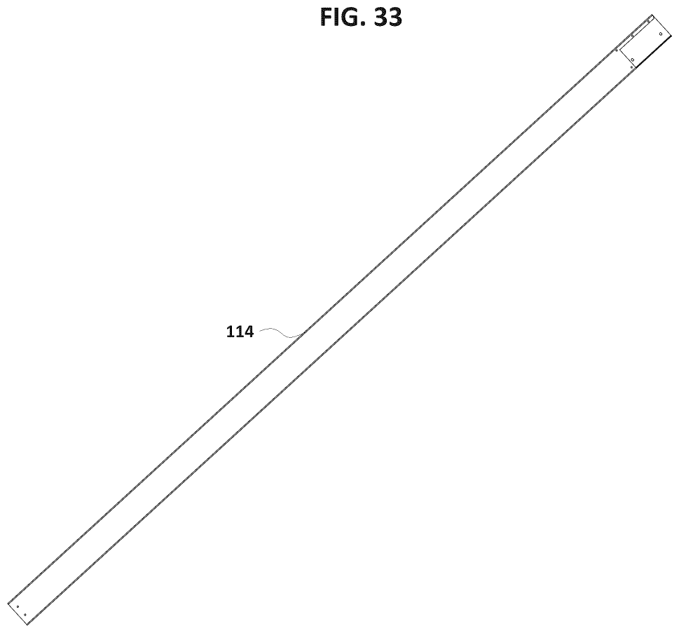

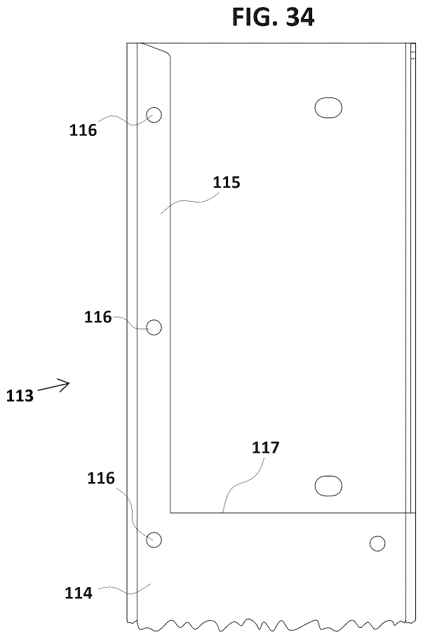

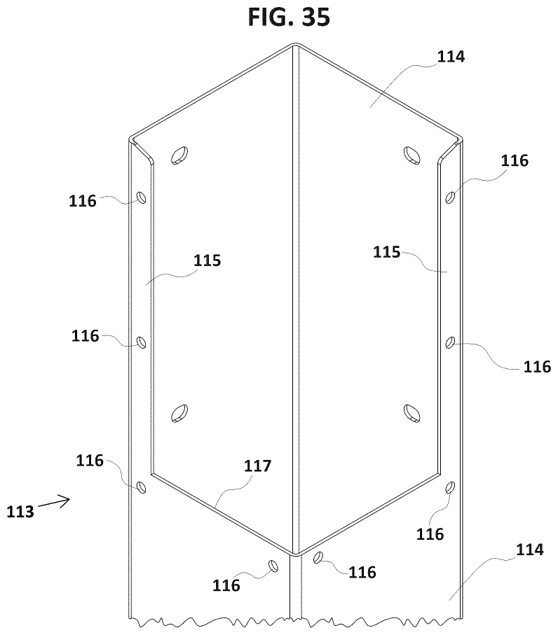

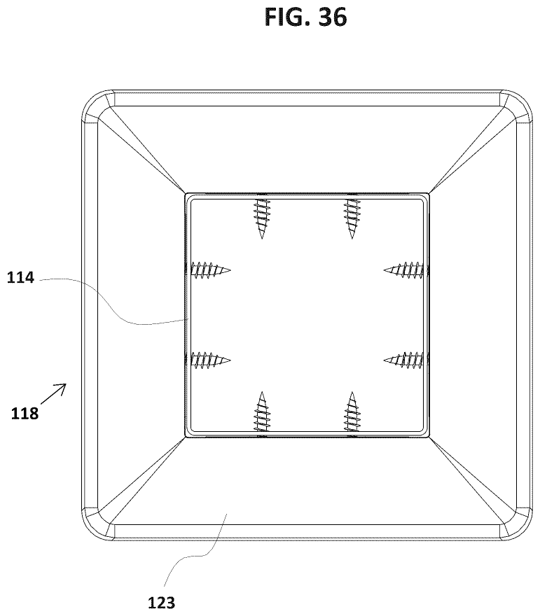

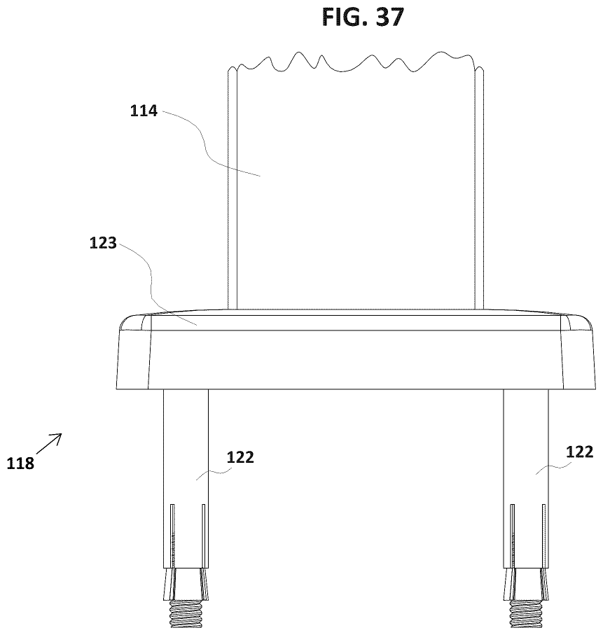

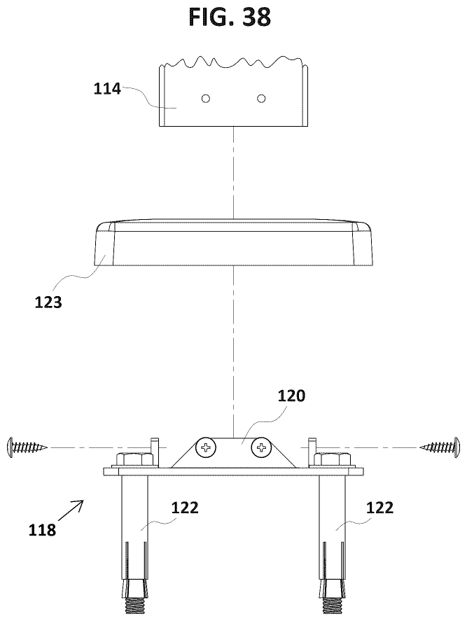

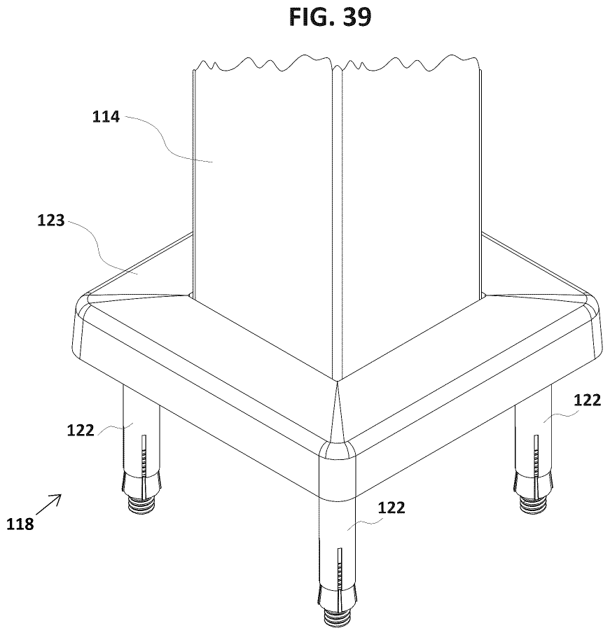

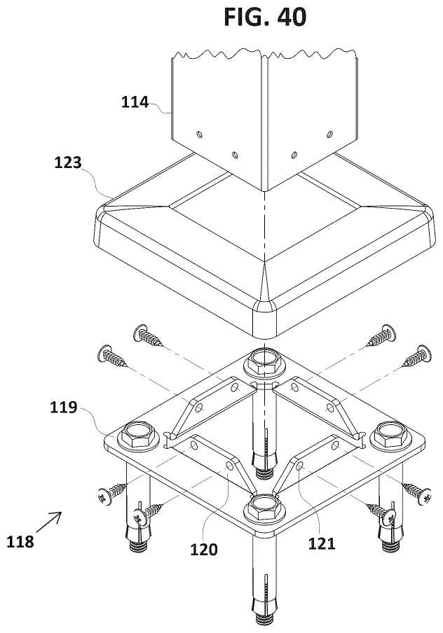

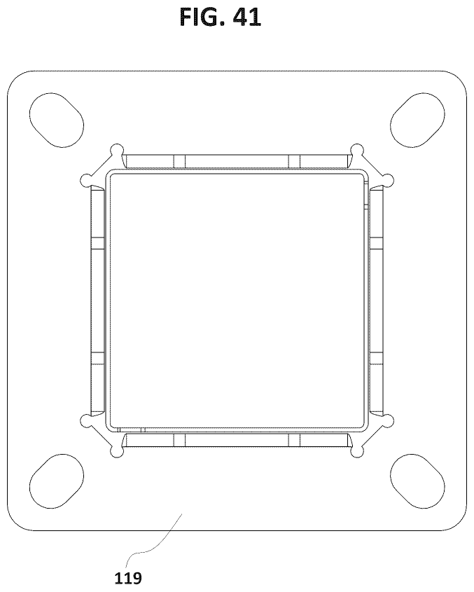

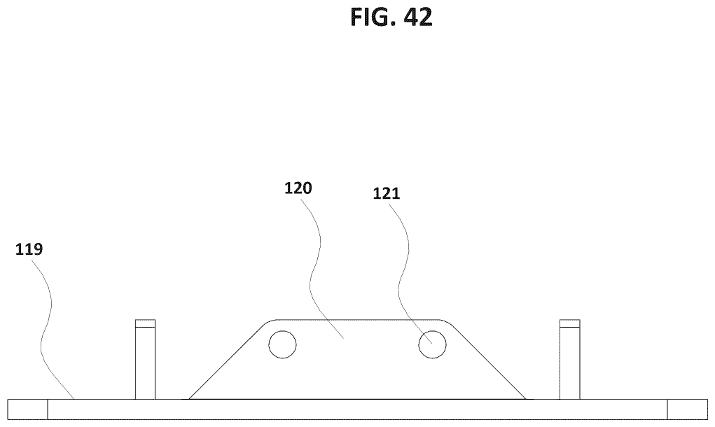

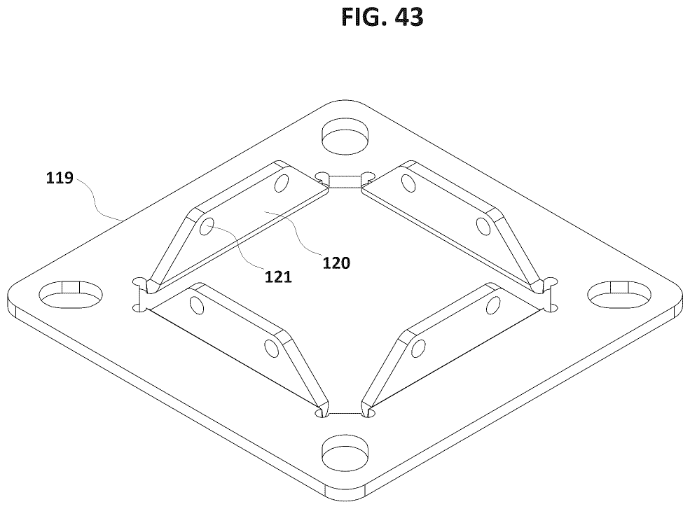

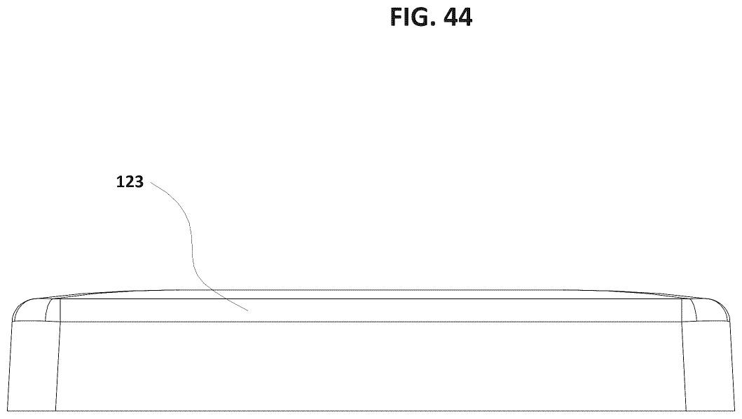

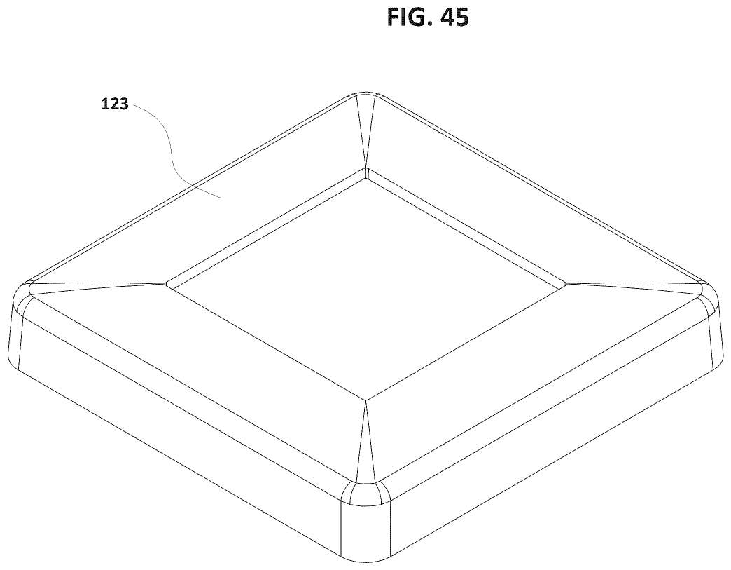

Referring to FIG. 1-FIG. 45, in some embodiments, the five-device-in-one anti-twisting anti-warping anti-vibrating cost-saving production-increasing corner and noise-canceling wind-dissipating louver (for being adapted to pergola, RV, house, solar panel, and concert stage) comprises: Anti-twisting anti-warping cost-saving production-increasing outer corner system 101 comprises (or each including): Anti-twisting anti-warping cost-saving production-increasing outer corner 102, Outer-corner mounting flange 103, and Outer-corner-mounting holes 104; Leaf-filtering-and-breaking cost-saving production-increasing auto-centering inner corner system 105 comprises (or each including): Cost-saving production-increasing inner corner parapet 106, Leaf-filtering-and-breaking cost-saving production-increasing honeycomb grate 107, Inner-corner mounting flange 108, Anti-twisting anti-warping cost-saving production-increasing auto-centering bracket 109, Corner screws 110a, Anti-twisting anti-warping anti-vibrating 90-degree-double-yokes 110b, Corner nuts 111, and Nut-securing holes 112; Double-gutter-supporting-and-locking post system 113 comprises (or each including): Double-gutter-supporting-and-locking post 114, Post-top double-gutter-supporting-and-locking parapet-mounting flange 115, Post-top flange holes 116, and Post-top double-gutter-supporting-and-locking opening 117; Anti-twisting anti-warping 4-opposite-direction-securing post-plate system 118 comprises (or each including): Anti-twisting anti-warping 4-opposite-direction-securing post plate 119, Anti-twisting anti-warping 4-opposite-direction-securing post-mounting flanges 120, Post-plate mounting holes 121, Post-plate ground-securing screws 122, and Post-plate cover 123; Rainwater-shedding rainwater-directing louver systems 124 each including: Rainwater-shedding louver 125, Rainwater-directing walls 126, Overlapping rainwater shield 127, and Noise-deleting cushion 128; Cost-saving production-increasing noise-canceling wind-dissipating louver end systems 129 each including: Cost-saving production-increasing left-side louver end 130, Cost-saving production-increasing right-side louver end 131, Noise-canceling rainwater-draining axle bores 132, Triple wind-dissipating tunnels 133, Cost-saving production-increasing anti-noise louver axles 134, Axle-locking circular dykes 135, Cost-saving production-increasing anti-noise shuttling axles 136, and Quadruple snap-locking tails 137; Automatic-multi-louver-shuttling system 138 including: Automatic-multi-louver-shuttling multi-articulated linkage arm 139, Automatic-multi-louver-shuttling gear-box axle 140, Automatic-multi-louver-shuttling shuttling gear box 141, Automatic-multi-louver-shuttling multi-louver-conjoining control-bar 142, Automatic-multi-louver-shuttling control-bar axle 143a, Automatic-multi-louver-shuttling control-bar axle-screw 143b, Louver-mounted bracket 144a, Louver-mounted axle 144b, Louver-mounted bracket-plate 144c, Automatic multi-louver-shuttling hand-crank axle 145a, Automatic multi-louver-shuttling hand-crank coupler 145b, and Automatic multi-louver-shuttling hand-crank 146; and Cost-saving production-increasing rainwater-shedding leaf-filtering beam systems 147 each including: Cost-saving production-increasing rainwater-shedding leaf-filtering beam 148, Axle-mounting plateau 149, Noise-canceling axle saddle 150, Noise-canceling axle clamp 151, Rainwater-shedding gutter 152, and Leaf-filtering drain-holes 153.

### Material

Referring to FIG. 1-FIG. 45: in some embodiments, Anti-twisting anti-warping cost-saving production-increasing outer corner system 101 may be made of the combined materials of its components. Anti-twisting anti-warping cost-saving production-increasing outer corner 102 may be made of the material of metal or plastic. Outer-corner mounting flange 103 may be made of the material of metal or plastic. Outer-corner-mounting holes 104 may each be made of the material of empty space. Leaf-filtering-and-breaking cost-saving production-increasing auto-centering inner corner system 105 may be made of the combined materials of its components. Cost-saving production-increasing inner corner parapet 106 may be made of the material of metal or plastic. Leaf-filtering-and-breaking cost-saving production-increasing honeycomb grate 107 may be made of the material of metal or plastic. Inner-corner mounting flange 108 may be made of the material of metal or plastic.

In some embodiments, Anti-twisting anti-warping cost-saving production-increasing auto-centering bracket 109 may be made of the material of metal or plastic. Corner screws 110a may each be made of the material of metal or plastic. Anti-twisting anti-warping anti-vibrating 90-degree-double-yokes 110b may each be made of the material of metal or plastic. Corner nuts 111 may each be made of the material of metal or plastic. Nut-securing holes 112 may each be made of the material of empty space. Double-gutter-supporting-and-locking post system 113 may be made of the combined materials of its components. Double-gutter-supporting-and-locking post 114 may be made of the material of metal or plastic.

In some embodiments, Post-top double-gutter-supporting-and-locking parapet-mounting flange 115 may be made of the material of metal or plastic. Post-top flange holes 116 may each be made of the material of empty space. Post-top double-gutter-supporting-and-locking opening 117 may be made of the material of empty space. Anti-twisting anti-warping 4-opposite-direction-securing post-plate system 118 may be made of the combined materials of its components. Anti-twisting anti-warping 4-opposite-direction-securing post plate 119 may be made of the material of metal or plastic.

In some embodiments, Anti-twisting anti-warping 4-opposite-direction-securing post-mounting flanges 120 may each be made of the material of metal or plastic. Post-plate mounting holes 121 may each be made of the material of empty space. Post-plate ground-securing screws 122 may each be made of the material of metal or plastic. Post-plate cover 123 may be made of the material of metal or metal or plastic. Rainwater-shedding rainwater-directing louver systems 124 may each be made of the combined materials of its components.

In some embodiments, Rainwater-shedding louver 125 may be made of the material of metal or plastic. Rainwater-directing walls 126 may each be made of the material of metal or plastic. Overlapping rainwater shield 127 may be made of the material of metal or plastic. Noise-deleting cushion 128 may be made of the material of metal or plastic. Cost-saving production-increasing noise-canceling wind-dissipating louver end systems 129 may each be made of the combined materials of its components. Cost-saving production-increasing left-side louver end 130 may be made of the material of metal or plastic.

In some embodiments, Cost-saving production-increasing right-side louver end 131 may be made of the material of metal or plastic. Noise-canceling rainwater-draining axle bores 132 may each be made of the material of metal or plastic. Triple wind-dissipating tunnels 133 may each be made of the material of metal or plastic. Cost-saving production-increasing anti-noise louver axles 134 may each be made of the material of metal or plastic. Axle-locking circular dykes 135 may each be made of the material of metal or plastic.

In some embodiments, Cost-saving production-increasing anti-noise shuttling axles 136 may each be made of the material of metal or plastic. Quadruple snap-locking tails 137 may each be made of the material of metal or plastic. Automatic-multi-louver-shuttling system 138 may be made of the combined materials of its components. Automatic-multi-louver-shuttling multi-articulated linkage arm 139 may be made of the material of metal or plastic. Automatic-multi-louver-shuttling gear-box axle 140 may be made of the material of metal or plastic. Automatic-multi-louver-shuttling shuttling gear box 141 may be made of the material of metal or plastic. Automatic-multi-louver-shuttling multi-louver-conjoining control-bar 142 may be made of the material of metal or plastic. Automatic-multi-louver-shuttling control-bar axle 143a may be made of the material of metal or plastic. Automatic-multi-louver-shuttling control-bar axle-screw 143b may be made of the material of metal or plastic. Louver-mounted bracket 144a may be made of the material of metal or plastic.

In some embodiments, Louver-mounted axle 144b may be made of the material of metal or plastic. Louver-mounted bracket-plate 144c may be made of the material of metal or plastic. Automatic multi-louver-shuttling hand-crank axle 145a may be made of the material of metal or plastic. Automatic multi-louver-shuttling hand-crank coupler 145b may be made of the material of metal or plastic. Automatic multi-louver-shuttling hand-crank 146 may be made of the material of metal or plastic. Cost-saving production-increasing rainwater-shedding leaf-filtering beam systems 147 may each be made of the combined materials of its components. Cost-saving production-increasing rainwater-shedding leaf-filtering beam 148 may be made of the material of metal or plastic.

In some embodiments, Axle-mounting plateau 149 may be made of the material of metal or plastic. Noise-canceling axle saddle 150 may be made of the material of metal or plastic. Noise-canceling axle clamp 151 may be made of the material of metal or plastic. Rainwater-shedding gutter 152 may be made of the material of metal or plastic. Leaf-filtering drain-holes 153 may each be made of the material of metal or plastic.

SHAPE Referring to FIG. 1-FIG. 45: In some embodiments, Anti-twisting anti-warping cost-saving production-increasing outer corner system 101 may be formed into the combined shapes of its components. Anti-twisting anti-warping cost-saving production-increasing outer corner 102 may be formed into the shape of a cross-section of letter L. Outer-corner mounting flange 103 may be formed into the shape of a rectangle. Outer-corner-mounting holes 104 may each be formed into the shape of a circle or rounded rectangle. Leaf-filtering-and-breaking cost-saving production-increasing auto-centering inner corner system 105 may be formed into the combined shapes of its components. Cost-saving production-increasing inner corner parapet 106 may be formed into the shape of rectangles with opposite-L-shaped cross-sections.

In some embodiments, Leaf-filtering-and-breaking cost-saving production-increasing honeycomb grate 107 may be formed into the shape of a square with hexagonal openings. Inner-corner mounting flange 108 may be formed into the shape of a rectangle. Anti-twisting anti-warping cost-saving production-increasing auto-centering bracket 109 may be formed into the shape of a letter L. Corner screws 110a may each be formed into the shape of a screw. Anti-twisting anti-warping anti-vibrating 90-degree-double-yokes 110b may each be formed into the shape of a flat figure eight. Corner nuts 111 may each be formed into the shape of a nut. Nut-securing holes 112 may each be formed into the shape of a circle.

In some embodiments, Double-gutter-supporting-and-locking post system 113 may be formed into the combined shapes of its components. Double-gutter-supporting-and-locking post 114 may be formed into the shape of a square tube with a square notch cut-out of two sides of the top. Post-top double-gutter-supporting-and-locking parapet-mounting flange 115 may be formed into the shape of a rectangle. Post-top flange holes 116 may each be formed into the shape of a circle. Post-top double-gutter-supporting-and-locking opening 117 may be formed into the shape of a square. Anti-twisting anti-warping 4-opposite-direction-securing post-plate system 118 may be formed into the combined shapes of its components. Anti-twisting anti-warping 4-opposite-direction-securing post plate 119 may be formed into the shape of a flat square.

In some embodiments, Anti-twisting anti-warping 4-opposite-direction-securing post-mounting flanges 120 may each be formed into the shape of a trapezoid. Post-plate mounting holes 121 may each be formed into the shape of a circle. Post-plate ground-securing screws 122 may each be formed into the shape of a screw. Post-plate cover 123 may be formed into the shape of a low box with a square opening. Rainwater-shedding rainwater-directing louver systems 124 may each be formed into the combined shapes of its components. Rainwater-shedding louver 125 may be formed into the shape of a rectangle with curved edge.

In some embodiments, Rainwater-directing walls 126 may each be formed into the shape of a letter L. Overlapping rainwater shield 127 may be formed into the shape of an upside-down letter U. Noise-deleting cushion 128 may be formed into the shape of a nipple. Cost-saving production-increasing noise-canceling wind-dissipating louver end systems 129 may each be formed into the combined shapes of its components. Cost-saving production-increasing left-side louver end 130 may be formed into the shape of a letter C with a left, a central, and a right holes.

In some embodiments, Cost-saving production-increasing right-side louver end 131 may be formed into the shape of a letter C with a left, a central, and a right holes. Noise-canceling rainwater-draining axle bores 132 may each be formed into the shape of a tunnel. Triple wind-dissipating tunnels 133 may each be formed into the shape of an opening. Cost-saving production-increasing anti-noise louver axles 134 may each be formed into the shape of a tube. Axle-locking circular dykes 135 may each be formed into the shape of a ring.

In some embodiments, Cost-saving production-increasing anti-noise shuttling axles 136 may each be formed into the shape of a tube. Quadruple snap-locking tails 137 may each be formed into the shape of multiple rectangles. Automatic-multi-louver-shuttling system 138 may be formed into the combined shapes of its components. Automatic-multi-louver-shuttling multi-articulated linkage arm 139 may be formed into the shape of a pendulum pivotably joined to a flat extension stick. Automatic-multi-louver-shuttling gear-box axle 140 may be formed into the shape of a cylinder. Automatic-multi-louver-shuttling shuttling gear box 141 may be formed into the shape of a square.

In some embodiments, Automatic-multi-louver-shuttling multi-louver-conjoining control-bar 142 may be formed into the shape of an elongated rectangle. Automatic-multi-louver-shuttling control-bar axle 143a may be formed into the shape of a tube. Automatic-multi-louver-shuttling control-bar axle-screw 143b may be formed into the shape of a screw. Louver-mounted bracket 144a may be formed into the shape of a letter C. Louver-mounted axle 144b may be formed into the shape of a tube. Louver-mounted bracket-plate 144c may be formed into the shape of a letter C. Automatic multi-louver-shuttling hand-crank axle 145a may be formed into the shape of a tube. Automatic multi-louver-shuttling hand-crank coupler 145b may be formed into the shape of a tube. Automatic multi-louver-shuttling hand-crank 146 may be formed into the shape of a letter S.

In some embodiments, Cost-saving production-increasing rainwater-shedding leaf-filtering beam systems 147 may each be formed into the combined shapes of its components. Cost-saving production-increasing rainwater-shedding leaf-filtering beam 148 may be formed into the shape of a letter U. Axle-mounting plateau 149 may be formed into the shape of an upside-down letter U. Noise-canceling axle saddle 150 may be formed into the shape of a letter C. Noise-canceling axle clamp 151 may be formed into the shape of a letter A. Rainwater-shedding gutter 152 may be formed into the shape of a letter U. Leaf-filtering drain-holes 153 may each be formed into the shape of a circular opening.

### Connection

Referring to FIG. 1-FIG. 45: In some embodiments, Anti-twisting anti-warping cost-saving production-increasing outer corner system 101 has the combined connections of its components. Anti-twisting anti-warping cost-saving production-increasing outer corner 102 may be formed to outer-corner mounting flange 103. Outer-corner mounting flange 103 may be secured to cost-saving production-increasing inner corner parapet 106. Outer-corner-mounting holes 104 may be respectively drilled into outer-corner mounting flange 103.

In some embodiments, Leaf-filtering-and-breaking cost-saving production-increasing auto-centering inner corner system 105 has the combined connections of its components. Cost-saving production-increasing inner corner parapet 106 may be formed to leaf-filtering-and-breaking cost-saving production-increasing honeycomb grate 107. Leaf-filtering-and-breaking cost-saving production-increasing honeycomb grate 107 may be formed within anti-twisting anti-warping cost-saving production-increasing auto-centering bracket 109. Inner-corner mounting flange 108 may be formed to cost-saving production-increasing inner corner parapet 106. Anti-twisting anti-warping cost-saving production-increasing auto-centering bracket 109 may be formed to cost-saving production-increasing inner corner parapet 106.

In some embodiments, Corner screws 110a may be respectively inserted through anti-twisting anti-warping anti-vibrating 90-degree-double-yoke 110b and screwed into cost-saving production-increasing inner corner parapet 106. Anti-twisting anti-warping anti-vibrating 90-degree-double-yokes 110b may be respectively fit around corner screws 110a. Corner nuts 111 may be respectively secured to corner screws 110a. Nut-securing holes 112 may be respectively drilled into cost-saving production-increasing inner corner parapet 106 and cupped around corner nuts 111.

In some embodiments, Double-gutter-supporting-and-locking post system 113 has the combined connections of its components. Double-gutter-supporting-and-locking post 114 may be secured to cost-saving production-increasing inner corner parapet 106 and anti-twisting anti-warping 4-opposite-direction-securing post-mounting flanges 120. Post-top double-gutter-supporting-and-locking parapet-mounting flange 115 may be formed to double-gutter-supporting-and-locking post 114. Post-top flange holes 116 may be respectively drilled into post-top double-gutter-supporting-and-locking parapet-mounting flange 115. Post-top double-gutter-supporting-and-locking opening 117 may be formed into double-gutter-supporting-and-locking post 114.

In some embodiments, Anti-twisting anti-warping 4-opposite-direction-securing post-plate system 118 has the combined connections of its components. Anti-twisting anti-warping 4-opposite-direction-securing post plate 119 may be formed to anti-twisting anti-warping 4-opposite-direction-securing post-mounting flanges 120. Anti-twisting anti-warping 4-opposite-direction-securing post-mounting flanges 120 may be respectively secured to double-gutter-supporting-and-locking post 114. Post-plate mounting holes 121 may be respectively drilled into anti-twisting anti-warping 4-opposite-direction-securing post-mounting flanges 120. Post-plate ground-securing screws 122 may be respectively inserted through anti-twisting anti-warping 4-opposite-direction-securing post plate 119 and into a surface (for example, a ground surface, a patio surface, etc.).

In some embodiments, Post-plate cover 123 may be place around the bottom of double-gutter-supporting-and-locking post 114 and over anti-twisting anti-warping 4-opposite-direction-securing post plate 119 and post-plate ground-securing screws 122. Rainwater-shedding rainwater-directing louver systems 124 has the combined connections of its components. Rainwater-shedding louver 125 may be secured between cost-saving production-increasing left-side louver end 130 and cost-saving production-increasing right-side louver end 131. Rainwater-directing walls 126 may be respectively formed to rainwater-shedding louver 125. Overlapping rainwater shield 127 may be formed to rainwater-shedding louver 125. Noise-deleting cushion 128 may be snap-fit into rainwater-shedding louver 125. Cost-saving production-increasing noise-deleting wind-dissipating louver end systems 129 has the combined connections of its components. Cost-saving production-increasing left-side louver end 130 may be secured to the left end of rainwater-shedding louver 125.

In some embodiments, Cost-saving production-increasing right-side louver end 131 may be secured to the right end of rainwater-shedding louver 125. Noise-canceling rainwater-draining axle bores 132 may be respectively formed within cost-saving production-increasing anti-noise louver axles 134. Triple wind-dissipating tunnels 133 may be respectively formed in cost-saving production-increasing left-side louver end 130 and in cost-saving production-increasing right-side louver end 131. Cost-saving production-increasing anti-noise louver axles 134 may be respectively formed to cost-saving production-increasing left-side louver end 130 and cost-saving production-increasing right-side louver end 131. Axle-locking circular dykes 135 may be respectively formed to the axle ends of cost-saving production-increasing anti-noise louver axle 134. Cost-saving production-increasing anti-noise shuttling axles 136 may be respectively formed to cost-saving production-increasing left-side louver end 130 and cost-saving production-increasing right-side louver end 131. Quadruple snap-locking tails 137 may be respectively formed to cost-saving production-increasing left-side louver end 130 and cost-saving production-increasing right-side louver end 131.

In some embodiments, Automatic-multi-louver-rotating system 138 has the combined connections of its components. Automatic-multi-louver-shuttling multi-articulated linkage arm 139 may be secured to automatic-multi-louver-shuttling gear-box axle 140 and to louver-mounted bracket-plate 144c (at its two opposite linkage-arm ends, respectively). Automatic-multi-louver-shuttling gear-box axle 140 may be secured to automatic-multi-louver-shuttling shuttling gear box 141 and automatic-multi-louver-shuttling multi-articulated linkage arm 139. Automatic-multi-louver-shuttling shuttling gear box 141 may be secured to automatic-multi-louver-shuttling gear-box axle 140 and automatic-multi-louver-shuttling control-bar axle 143a. Automatic-multi-louver-shuttling multi-louver-conjoining control-bar 142 may be pivotably secured to automatic-multi-louver-shuttling control-bar axle 143a, cost-saving production-increasing anti-noise shuttling axle 136 and automatic-multi-louver-shuttling control-bar axle 143a. Automatic-multi-louver-shuttling control-bar axle 143a is secured to louver-mounted bracket 144a. Automatic-multi-louver-shuttling control-bar axle-screw 143b may be fit through automatic-multi-louver-shuttling multi-louver-conjoining control-bar 142 and into automatic-multi-louver-shuttling control-bar axle 143a. Louver-mounted bracket 144a may be secured to rainwater-shedding louver 125. Louver-mounted axle 144b may be secured to louver-mounted bracket 144a. Louver-mounted bracket-plate 144c may be secured to louver-mounted bracket 144a.

In some embodiments, Automatic multi-louver-shuttling hand-crank axle 145a may be rotatably secured to automatic multi-louver-shuttling hand-crank coupler 145b and automatic-multi-louver-shuttling shuttling gear box 141. Automatic multi-louver-shuttling hand-crank coupler 145b is secured to automatic multi-louver-shuttling hand-crank axle 145a. Automatic multi-louver-shuttling hand-crank 146 may be twistably and releasably secured to automatic multi-louver-shuttling hand-crank coupler 145b. Cost-saving production-increasing rainwater-shedding leaf-filtering beam systems 147 has the combined connections of its components. Cost-saving production-increasing rainwater-shedding leaf-filtering beam 148 may be secured between two of double-gutter-supporting-and-locking posts 114. Axle-mounting plateau 149 may be formed to cost-saving production-increasing rainwater-shedding leaf-filtering beam 148. Noise-canceling axle saddle 150 may be secured to axle-mounting plateau 149. Noise-canceling axle clamp 151 may be secured to noise-canceling axle saddle 150. Rainwater-shedding gutter 152 may be formed to cost-saving production-increasing rainwater-shedding leaf-filtering beam 148. Leaf-filtering drain-holes 153 may be respectively drilled into rainwater-shedding gutter 152.

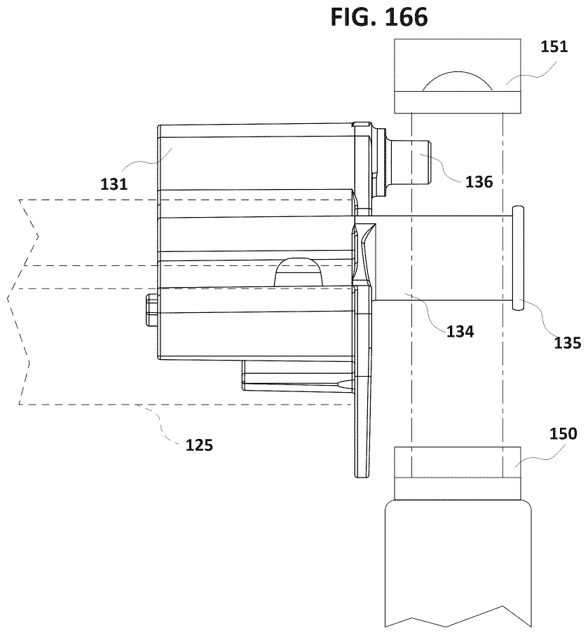

FUNCTION Referring to FIG. 46-FIG. 166: In some embodiments, Anti-twisting anti-warping cost-saving production-increasing outer corner system 101 may be for performing the combined functions of its components. Anti-twisting anti-warping cost-saving production-increasing outer corner 102 may be for: Providing anti-twisting and anti-warping reverse tension to retain the original shape and size of the five-device-in-one anti-twisting anti-warping anti-vibrating cost-saving production-increasing corner and noise-canceling wind-dissipating louver in the directions of arrows 154, and 155 (see FIG. 14, and FIG. 57); Saving cost by being injection-molded in a single piece; and Increasing production capabilities by being injection-molded in a single piece. Outer-corner mounting flange 103 may be for: Providing an area for securing anti-twisting anti-warping cost-saving production-increasing outer corner 102 to cost-saving production-increasing inner corner parapet 106. Outer-corner-mounting holes 104 may be respectively for: Providing places for corner screws 110a to be inserted. Leaf-filtering-and-breaking cost-saving production-increasing auto-centering inner corner system 105 may be for performing the combined functions of its components.

In some embodiments, Cost-saving production-increasing inner corner parapet 106 may be for: Being used to support a pergola or an RV gutter to shed rainwater therefrom in the direction of arrow 156 (see FIG. 3, FIG. 4, FIG. 46, and FIG. 47); Being used to support a concert stage gutter to shed rainwater from a concert stage in the direction of arrow 157 (see FIG. 5, and FIG. 48); Being used to support a house gutter to shed rainwater from a house in the direction of arrow 158 (see FIG. 6, and FIG. 49); Being used to support a solar panel gutter to shed rainwater from a solar panel in the direction of arrow 159 (see FIG. 7, and FIG. 50); Being used to support an awning when attached to a building (see FIG. 8, and FIG. 51); Saving cost by being injection molded in a single piece; and Increasing production capabilities by being injection molded in a single piece. Leaf-filtering-and-breaking cost-saving production-increasing honeycomb grate 107 may be for: Filtering leaves and other debris from getting inside double-gutter-supporting-and-locking post 114 (see FIG. 12, FIG. 13, FIG. 55, and FIG. 56); Breaking up leaves and other debris to prevent large leaves from getting into double-gutter-supporting-and-locking post 114 in the direction of arrow 160 (see FIG. 12, FIG. 13, FIG. 55, and FIG. 56); Securing a solar panel (see FIG. 9 and FIG. 52); Securing an outdoor speaker (see FIG. 10 and FIG. 53); Securing an outdoor light for illuminating through leaf-filtering-and-breaking cost-saving production-increasing honeycomb grate 107 (see FIG. 11 and FIG. 54); Saving cost by being injection molded in a single piece; and Increasing production capabilities by being injection molded in a single piece. Inner-corner mounting flange 108 may be for: Securing cost-saving production-increasing inner corner parapet 106 to double-gutter-supporting-and-locking post 114. Anti-twisting anti-warping cost-saving production-increasing auto-centering bracket 109 may be for: Providing anti-twisting and anti-warping reverse tension to retain the original shape and size of the five-device-in-one anti-twisting anti-warping anti-vibrating cost-saving production-increasing corner and noise-canceling wind-dissipating louver in the directions of arrows 154, and 155 (see FIG. 14 and FIG. 57); Auto-centering cost-saving production-increasing inner corner parapet 106 into the top of double-gutter-supporting-and-locking post 114 Saving cost by being injection molded in a single piece; and Increasing production capabilities by being injection molded in a single piece.

In some embodiments, Corner screws 110a may be respectively for: Securing cost-saving production-increasing inner corner parapet 106 to double-gutter-supporting-and-locking post 114. Anti-twisting anti-warping anti-vibrating 90-degree-double-yokes 110b may be respectively for: Providing anti-twisting and anti-warping reverse tension to retain the original shape and size of the five-device-in-one anti-twisting anti-warping anti-vibrating cost-saving production-increasing corner and noise-canceling wind-dissipating louver in the directions of arrows 154, and 155 (see FIG. 14 and FIG. 57); and Providing anti-vibrating by cushioning corner screws 110a when attached to cost-saving production-increasing inner corner parapet 106. Corner nuts 111 may be respectively for: Securing corner screws 110a. Nut-securing holes 112 may be respectively for: Locking corner nuts 111 from spinning when corner screws 110a may be installed.

In some embodiments, Double-gutter-supporting-and-locking post system 113 may be for performing the combined functions of its components. Double-gutter-supporting-and-locking post 114 may be for: Supporting an RV gutter to shed rainwater from an RV in the direction of arrow 156 (see FIG. 4 and FIG. 47); Supporting a concert stage gutter to shed rainwater from a concert stage in the direction of arrow 157 (see FIG. 5 and FIG. 48); Supporting a house gutter to shed rainwater from a house in the direction of arrow 158 (see FIG. 6 and FIG. 49); Supporting a solar panel gutter to shed rainwater from a solar panel in the direction of arrow 159 (see FIG. 7 and FIG. 50); and Supporting an awning when attached to a building (see FIG. 8 and FIG. 51).

In some embodiments, Post-top double-gutter-supporting-and-locking parapet-mounting flange 115 may be for: Supporting an RV gutter to shed rainwater from an RV in the direction of arrow 156 (see FIG. 4 and FIG. 47); Supporting a concert stage gutter to shed rainwater from a concert stage in the direction of arrow 157 (see FIG. 5 and FIG. 48); Supporting a house gutter to shed rainwater from a house in the direction of arrow 158 (see FIG. 6 and FIG. 49); Supporting a solar panel gutter to shed rainwater from a solar panel in the direction of arrow 159 (see FIG. 7 and FIG. 50); and Supporting an awning when attached to a building (see FIG. 8 and FIG. 51).

In some embodiments, Post-top flange holes 116 Providing places for corner screws 110a to secure cost-saving production-increasing inner corner parapet 106 to double-gutter-supporting-and-locking post 114 Post-top double-gutter-supporting-and-locking opening 117 may be for: Providing a location for anti-twisting anti-warping cost-saving production-increasing auto-centering bracket 109 to be inserted and secured.

In some embodiments, Anti-twisting anti-warping 4-opposite-direction-securing post-plate system 118 may be for performing the combined functions of its components. Anti-twisting anti-warping 4-opposite-direction-securing post plate 119 may be for: Providing anti-twisting and anti-warping reverse tension to retain the original shape and size of the five-device-in-one anti-twisting anti-warping anti-vibrating cost-saving production-increasing corner and noise-canceling wind-dissipating louver in the directions of arrows 154, and 155 (see FIG. 14 and FIG. 57); and Stabilizing double-gutter-supporting-and-locking post 114.

In some embodiments, Anti-twisting anti-warping 4-opposite-direction-securing post-mounting flanges 120 may be respectively for: Providing anti-twisting and anti-warping reverse tension to retain the original shape and size of the five-device-in-one anti-twisting anti-warping anti-vibrating cost-saving production-increasing corner and noise-canceling wind-dissipating louver in the directions of arrows 154, and 155 (see FIG. 14 and FIG. 57); Securing double-gutter-supporting-and-locking post 114 to anti-twisting anti-warping 4-opposite-direction-securing post plate 119.

In some embodiments, Post-plate mounting holes 121 may be respectively for: Providing a location for anti-twisting anti-warping 4-opposite-direction-securing post-mounting flanges 120 to be secured by screws to double-gutter-supporting-and-locking post 114. Post-plate ground-securing screws 122 may be respectively for: Securing anti-twisting anti-warping 4-opposite-direction-securing post plate 119 to a ground surface.

In some embodiments, post-plate cover 123 may be for: Securely covering anti-twisting anti-warping 4-opposite-direction-securing post plate 119 and Post-plate ground-securing screws 122. Rainwater-shedding rainwater-directing louver systems 124 may be for performing the combined functions of its components. Rainwater-shedding louver 125 may be for: Blocking rain, snow, or sunshine when closed.

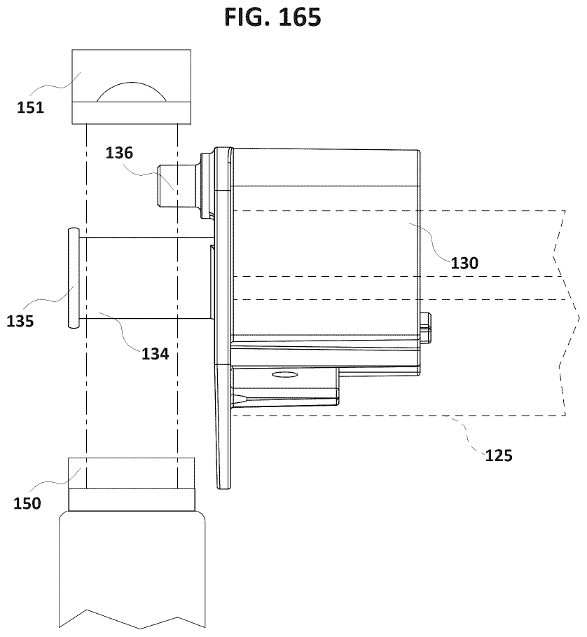

In some embodiments, directing rainwater to rainwater-shedding gutter 152 in the direction of arrow 161 (see FIG. 165-FIG. 167). Rainwater-directing walls 126 may be respectively for: Directing rainwater to rainwater-shedding gutter 152 in the direction of arrow 161 (see FIG. 165-FIG. 167). Overlapping rainwater shield 127 may be for: Covering gaps between adjacent rainwater-shedding louvers 125 when closed.

In some embodiments, Noise-deleting cushion 128 may be for: Preventing unwanted noise when closed. Cost-saving production-increasing noise-deleting wind-dissipating louver end systems 129 may be for performing the combined functions of its components. Cost-saving production-increasing left-side louver end 130 may be for: Saving cost by being injection molded in a single piece, eliminating unnecessary hardware; and Increasing production by being injection molded in a single piece, eliminating unnecessary hardware.

In some embodiments, Cost-saving production-increasing right-side louver end 131 may be for: Saving cost by being injection molded in a single piece, eliminating unnecessary hardware; and Increasing production by being injection molded in a single piece, eliminating unnecessary hardware. Noise-canceling rainwater-draining axle bores 132 may be respectively for: Draining rainwater away from rainwater-shedding louver 125 in the directions of arrows 162a-162d (see FIG. 61-FIG. 64); and Dissipating wind away from rainwater-shedding louver 125 in the directions of arrows 162a-162d (see FIG. 61-FIG. 64). Triple wind-dissipating tunnels 133 may be respectively for: Draining rainwater away from rainwater-shedding louver 125 in the directions of arrows 163a-163d (see FIG. 61-FIG. 64); and Dissipating wind away from rainwater-shedding louver 125 in the directions of arrows 163a-163d (see FIG. 61-FIG. 64).

In some embodiments, Cost-saving production-increasing anti-noise louver axles 134 may be respectively for: Saving cost by being injection molded in a single piece, eliminating unnecessary hardware; Increasing production by being injection molded in a single piece, eliminating unnecessary hardware; and Providing location for cost-saving production-increasing left-side louver end 130 or cost-saving production-increasing right-side louver end 131 to pivotably rotate in the direction of arrow 164 (see FIG. 113, FIG. 114, FIG. 116, and FIG. 117).

In some embodiments, Noise-cancelling when rotated between noise-canceling axle saddle 150 and noise-canceling axle clamp 151 in the direction of arrow 164 (see FIG. 113, FIG. 114, FIG. 116, and FIG. 117). Axle-locking circular dykes 135 may be respectively for: Securing cost-saving production-increasing anti-noise louver axle 134 within noise-canceling axle saddle 150 and noise-canceling axle clamp 151.

In some embodiments, Cost-saving production-increasing anti-noise shuttling axles 136 may be respectively for: Saving cost by being injection molded in a single piece, eliminating unnecessary hardware; and Increasing production by being injection molded in a single piece, eliminating unnecessary hardware; Providing location for automatic-multi-louver-shuttling multi-louver-conjoining control-bar 142 to be pivotably attached in the direction of arrow 165 (see FIG. 115 and FIG. 116) In some embodiments, Quadruple snap-locking tails 137 may be respectively for: Saving cost by being injection molded in a single piece, eliminating unnecessary hardware; Increasing production by being injection molded in a single piece, eliminating unnecessary hardware; and Snap-locking to rainwater-shedding louver 125 without need for hardware.

In some embodiments, Automatic-multi-louver-rotating system 138 may be for performing the combined functions of its components. Automatic-multi-louver-shuttling multi-articulated linkage arm 139 may be for: Working in conjunction with automatic-multi-louver-shuttling shuttling gear box 141 to open and close rainwater-shedding rainwater-directing louver systems 124. Automatic-multi-louver-shuttling gear-box axle 140 may be for: Transferring motion generated from automatic-multi-louver-shuttling shuttling gear box 141 to engage automatic-multi-louver-shuttling multi-articulated linkage arm 139.

In some embodiments, automatic-multi-louver-shuttling shuttling gear box 141 may be for: Providing motion to open and close rainwater-shedding rainwater-directing louver systems 124. Automatic-multi-louver-shuttling multi-louver-conjoining control-bar 142 may be for: Conjoining multiple cost-saving production-increasing anti-noise shuttling axles 136 to allow multiple rainwater-shedding rainwater-directing louver systems 124 to be opened and closed simultaneously.

In some embodiments, Automatic-multi-louver-shuttling control-bar axle 143a may be for: Transferring motion generated from automatic multi-louver-shuttling hand-crank 146 to engage automatic-multi-louver-shuttling shuttling gear box 141 in the direction of arrow 166 (see FIG. 115-FIG. 117). Automatic-multi-louver-shuttling control-bar axle-screw 143b may be for: Securing automatic-multi-louver-shuttling multi-louver-conjoining control-bar 142 to multiple cost-saving production-increasing anti-noise shuttling axles 136. Louver-mounted bracket 144a may be for: Providing location onto rainwater-shedding louver 125 to engage automatic-multi-louver-rotating system 138.

In some embodiments, Louver-mounted axle 144b may be for: Providing a means for automatic-multi-louver-rotating system 138 to be rotated. Louver-mounted bracket-plate 144c may be for: Covering end of rainwater-shedding louver 125. Automatic multi-louver-shuttling hand-crank axle 145a may be for: Transferring motion generated from automatic multi-louver-shuttling hand-crank 146 to engage automatic-multi-louver-shuttling shuttling gear box 141 in the direction of arrow 166 (see FIG. 115-FIG. 117).

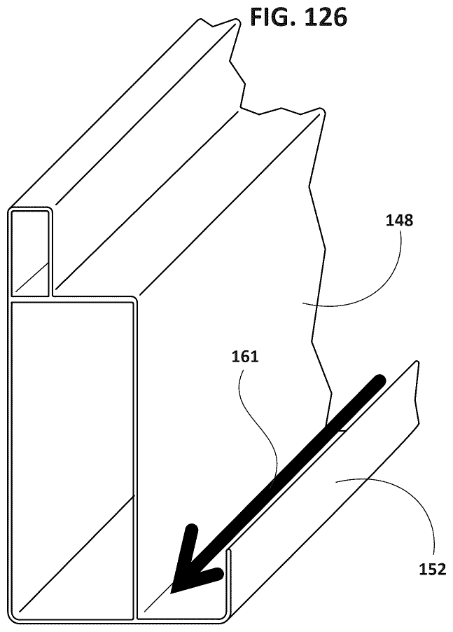

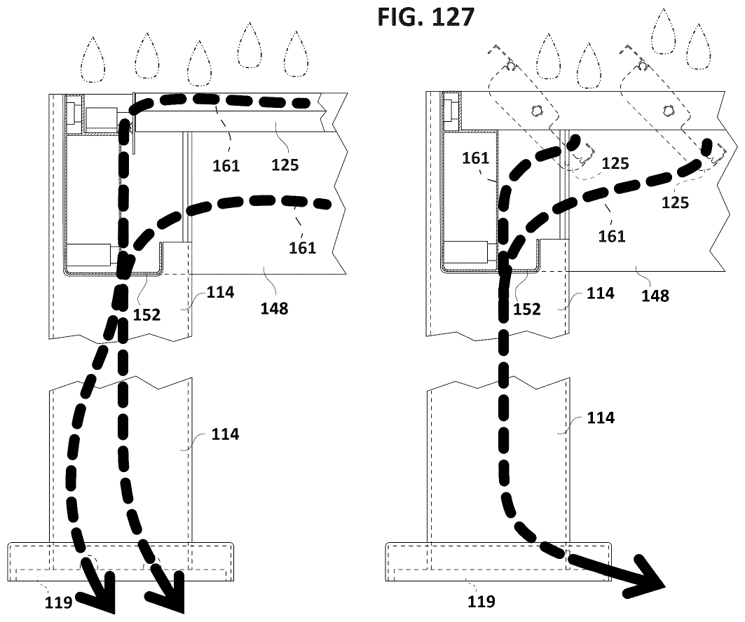

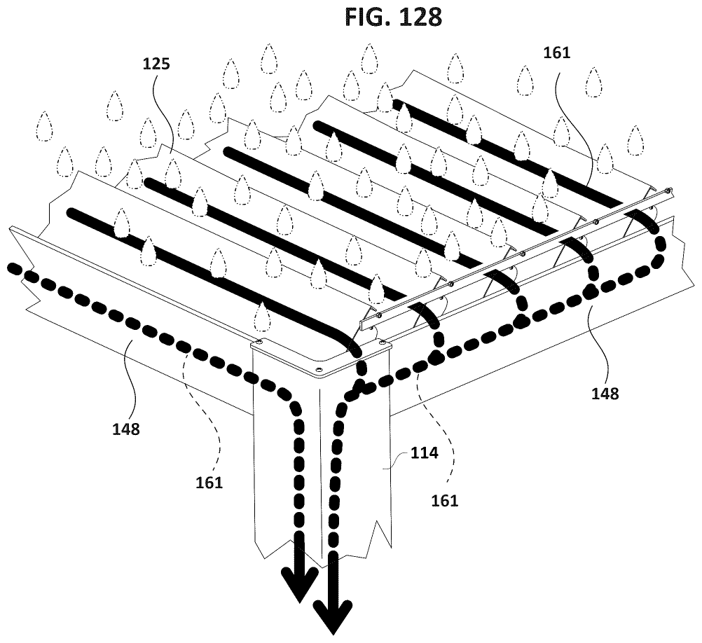

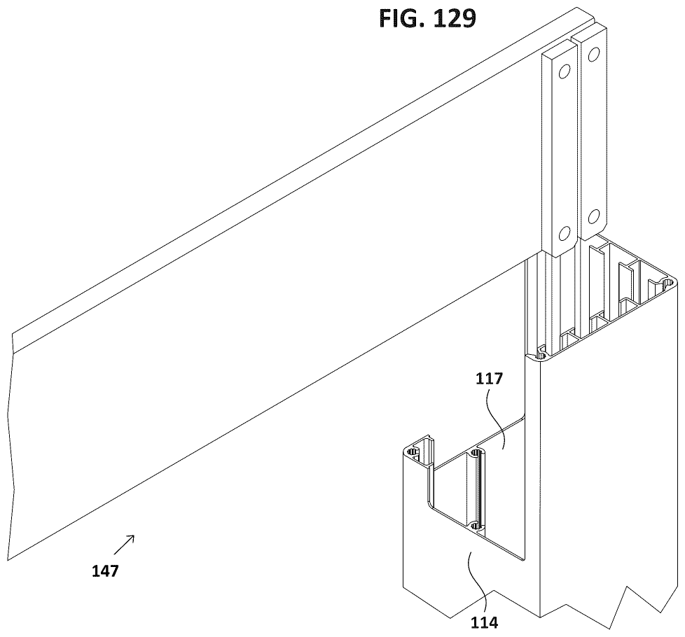

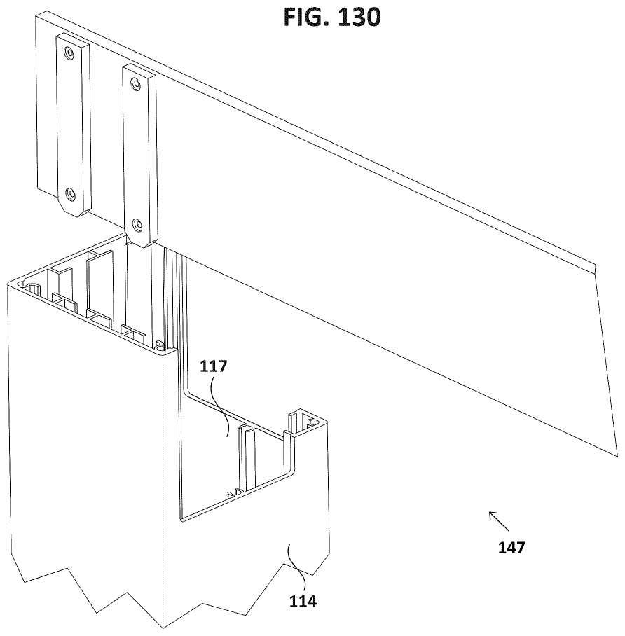

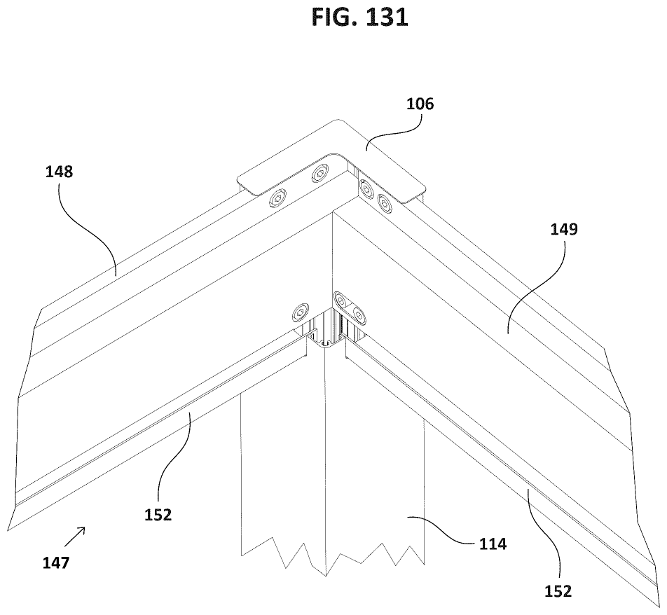

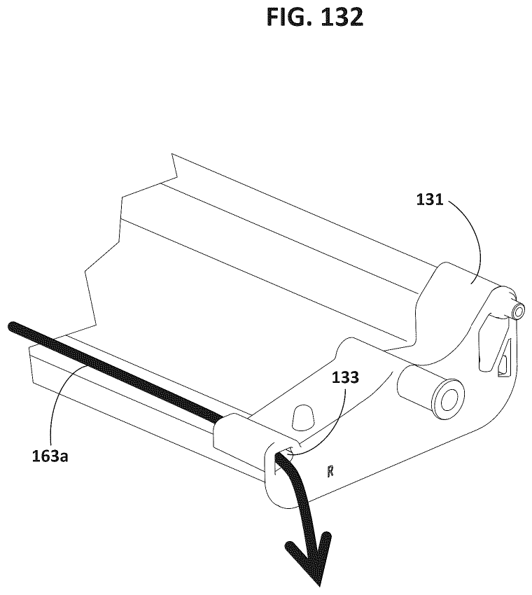

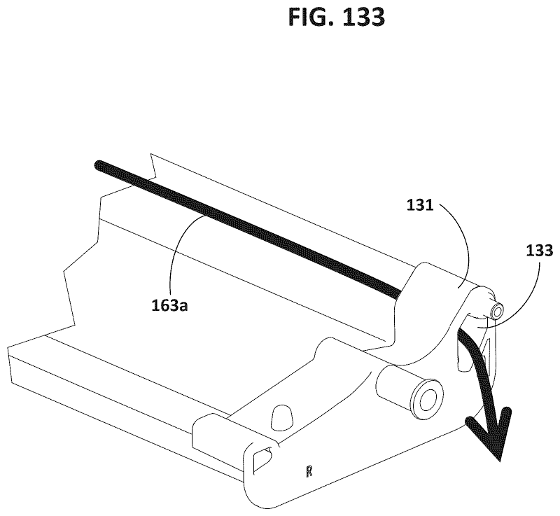

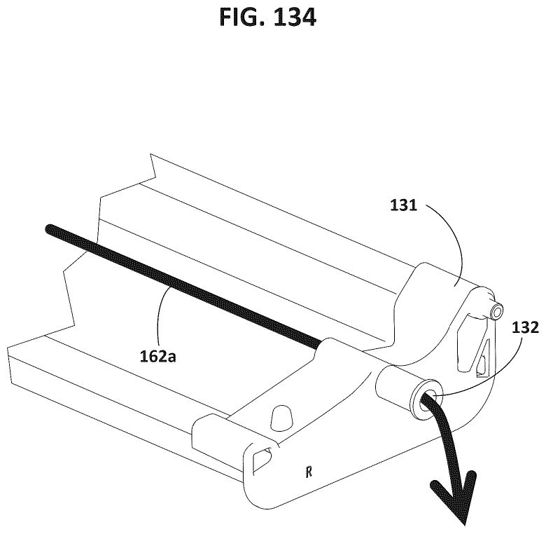

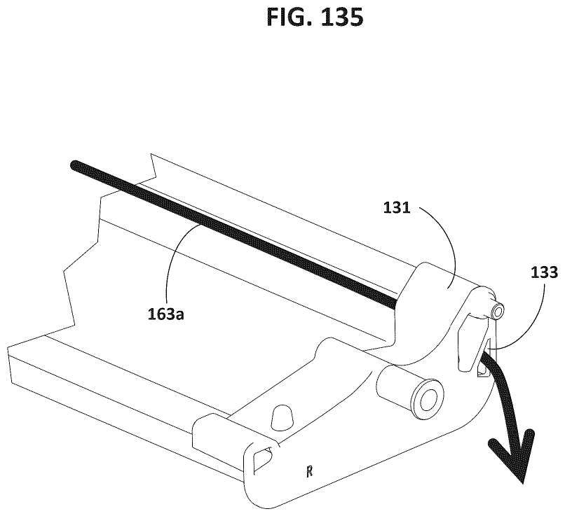

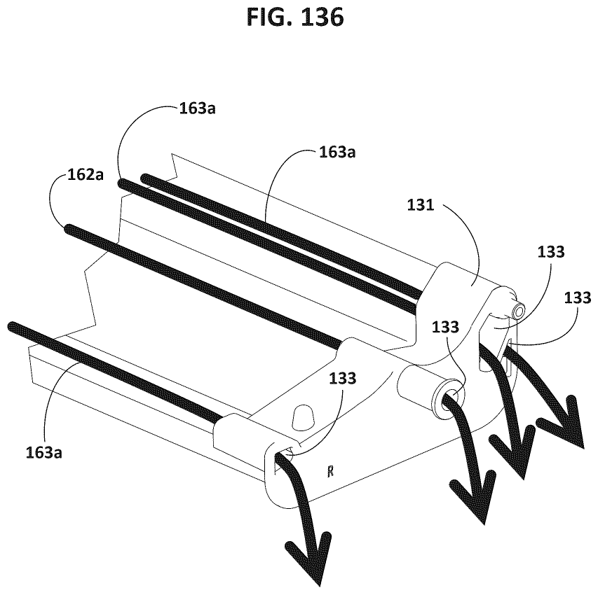

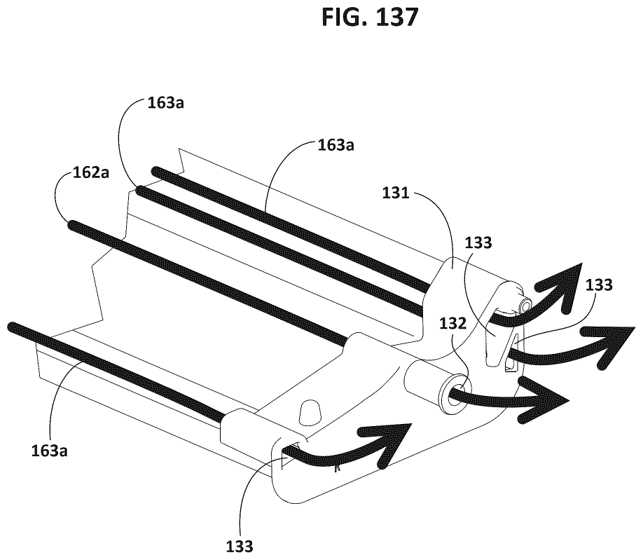

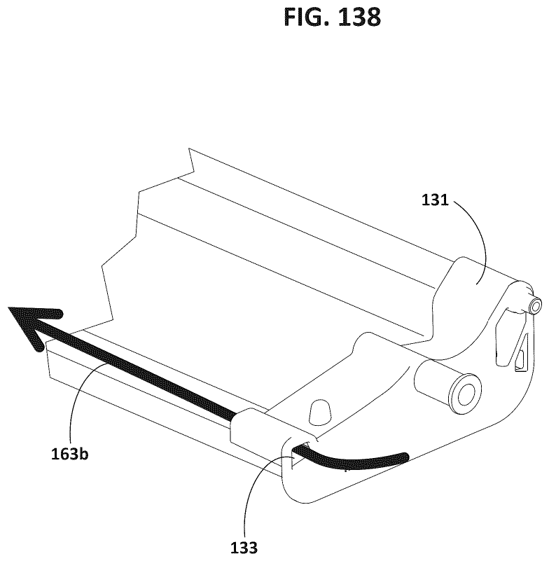

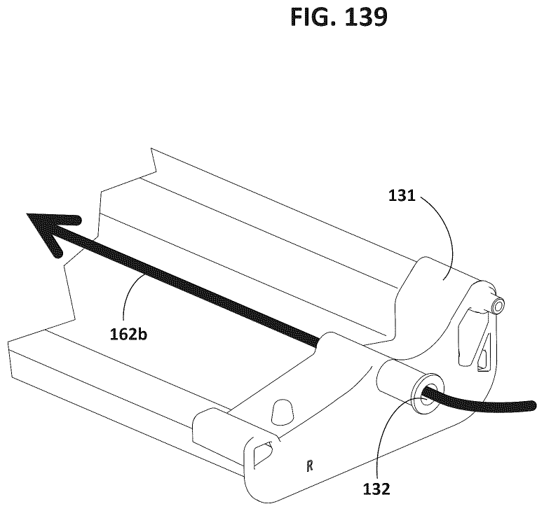

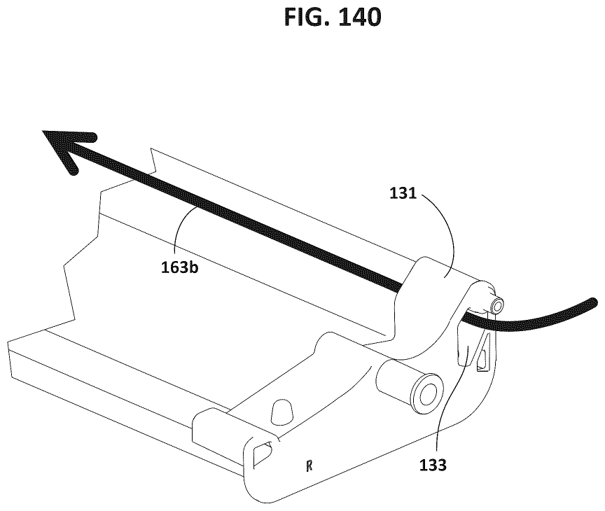

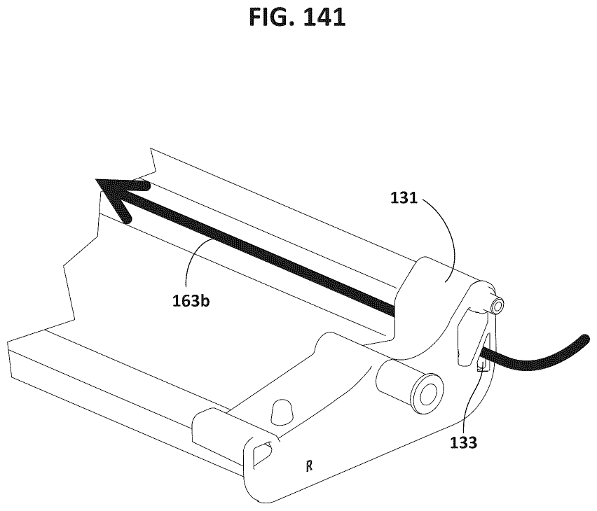

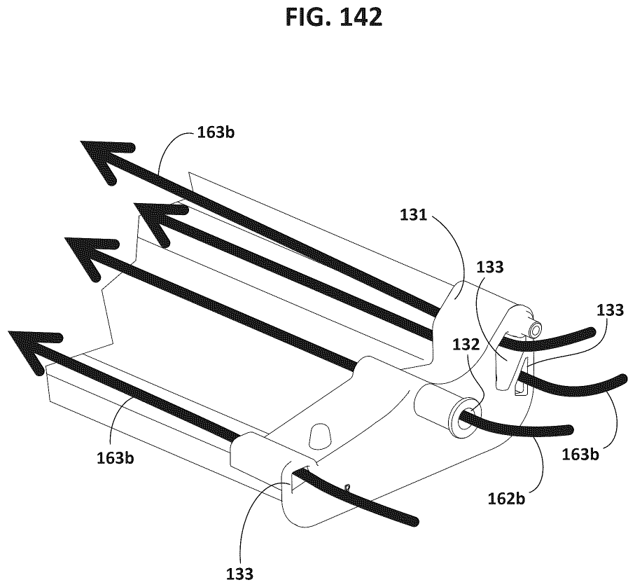

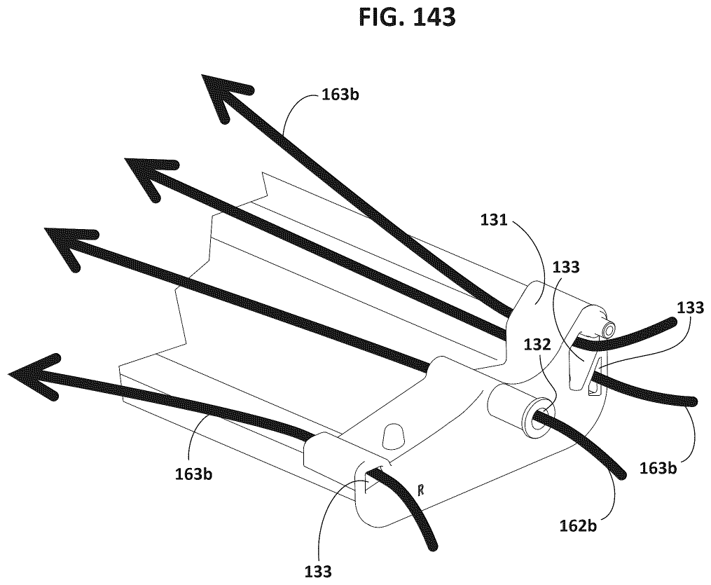

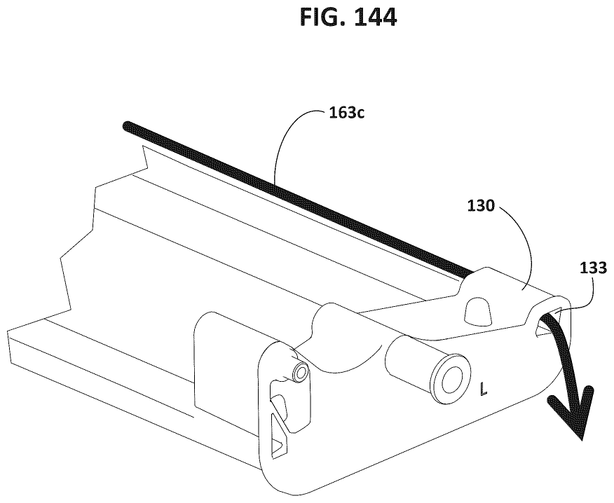

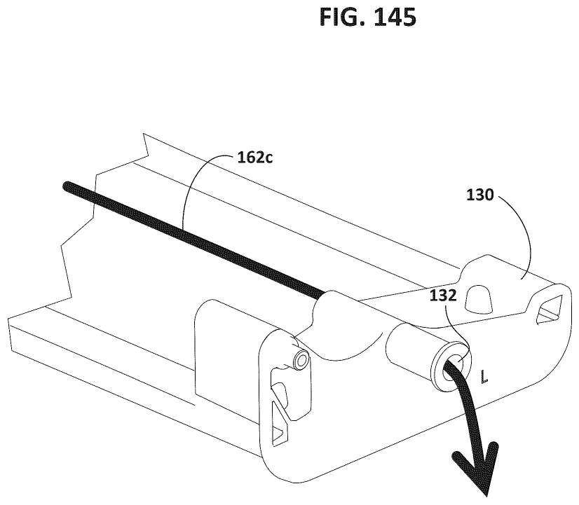

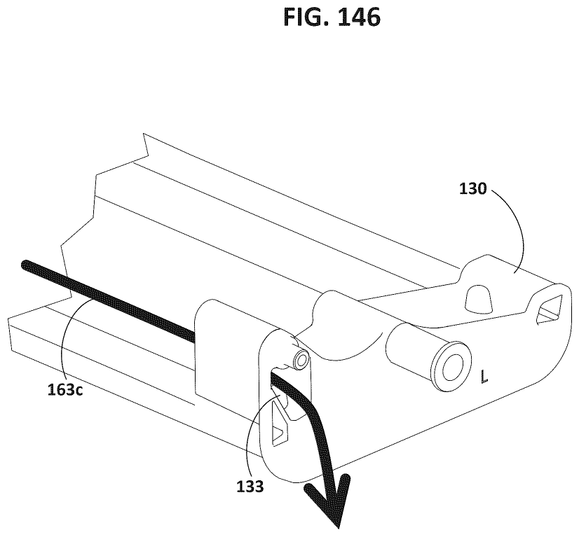

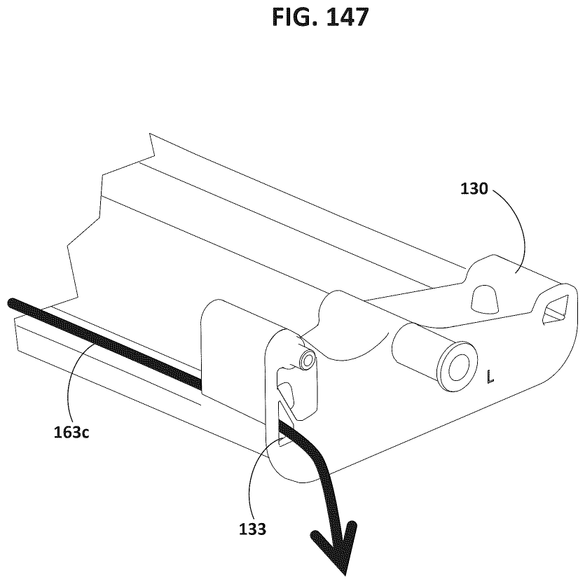

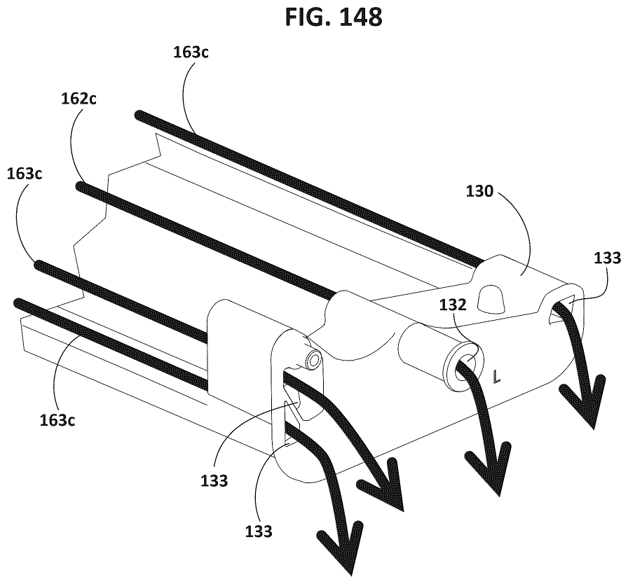

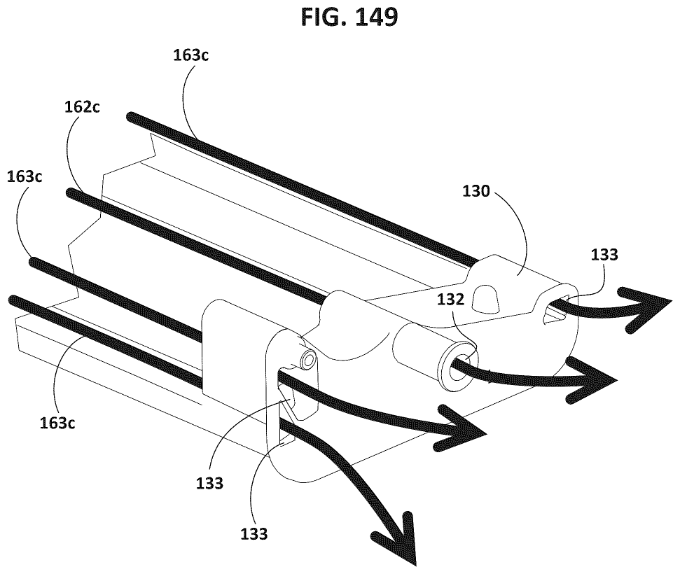

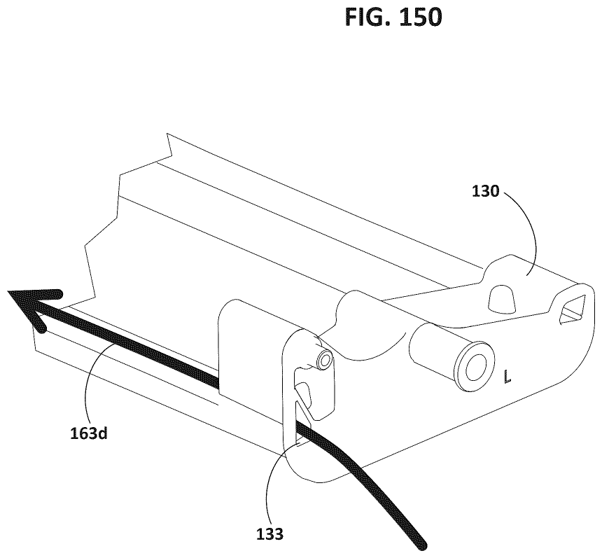

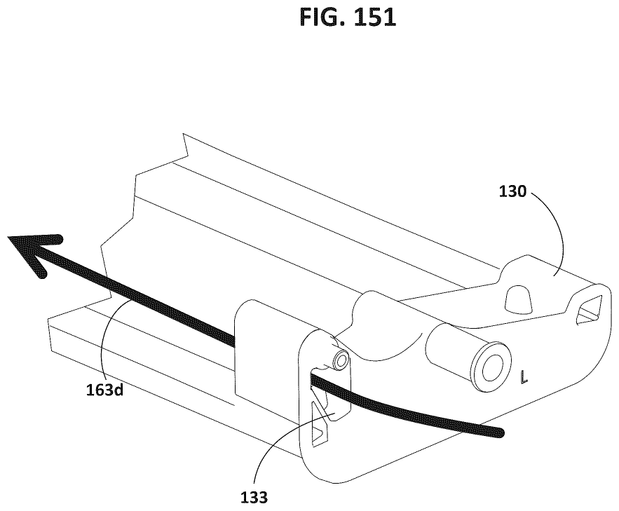

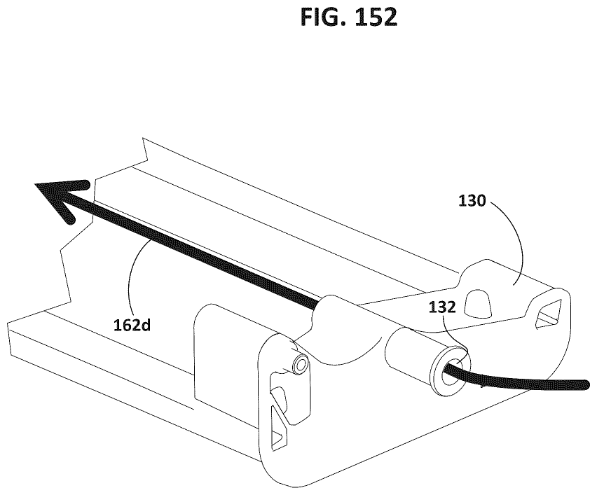

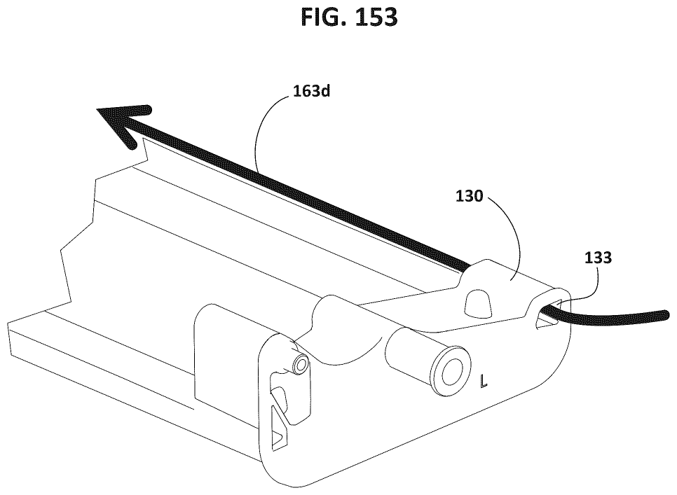

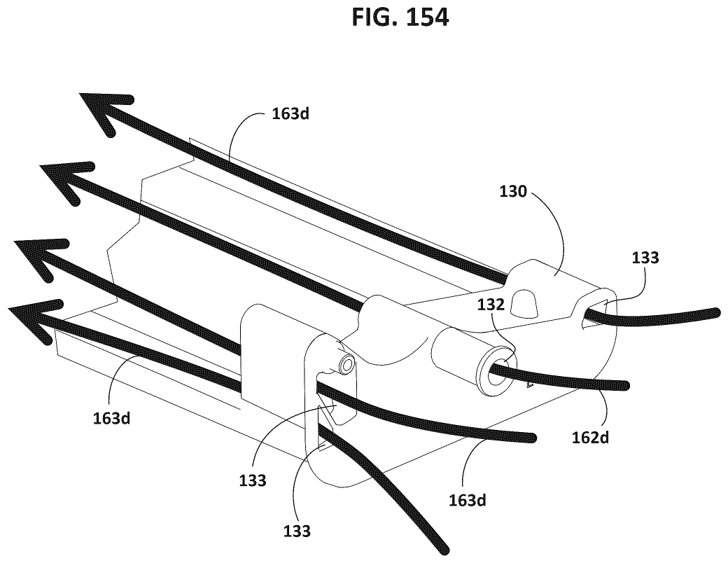

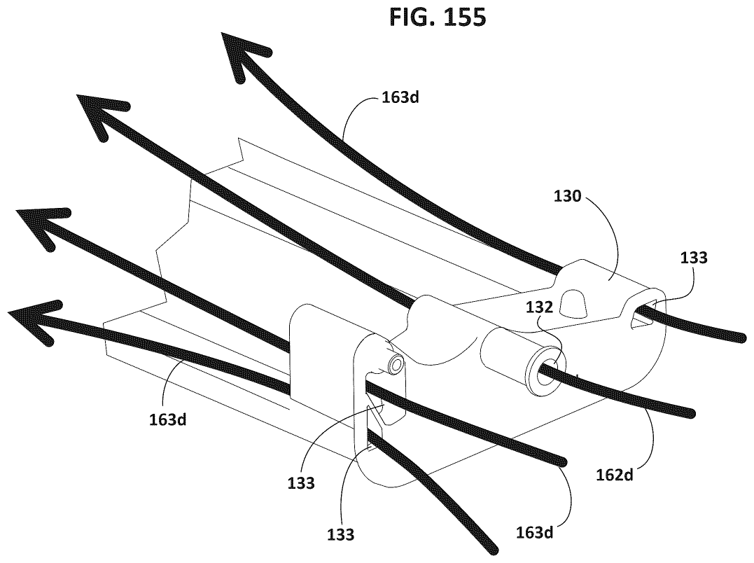

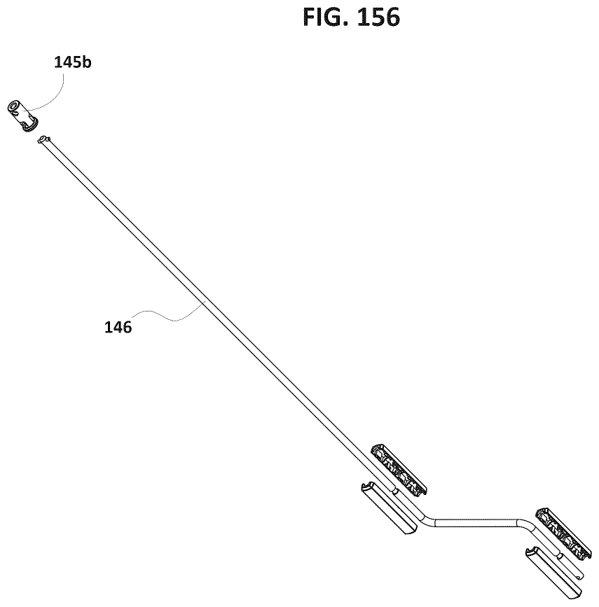

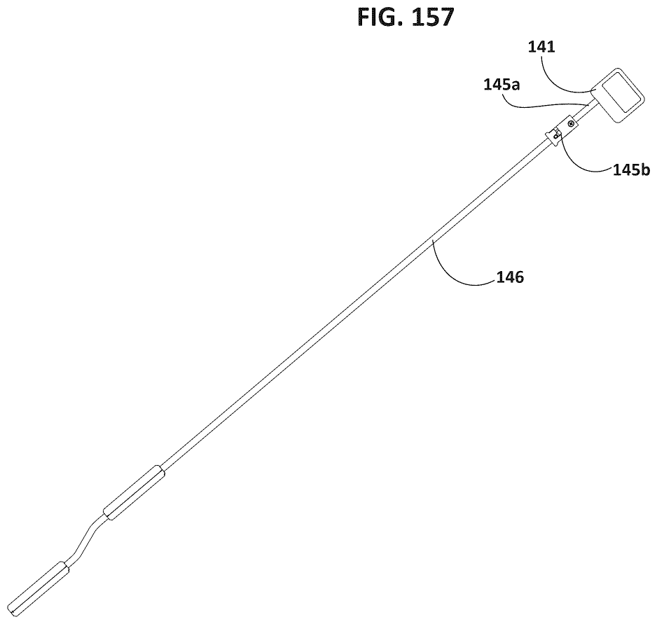

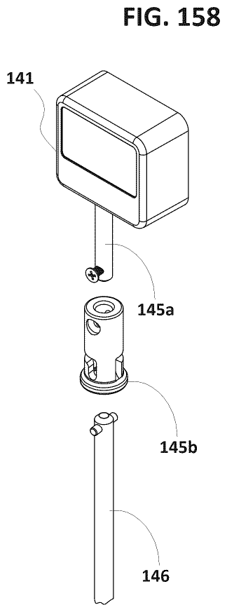

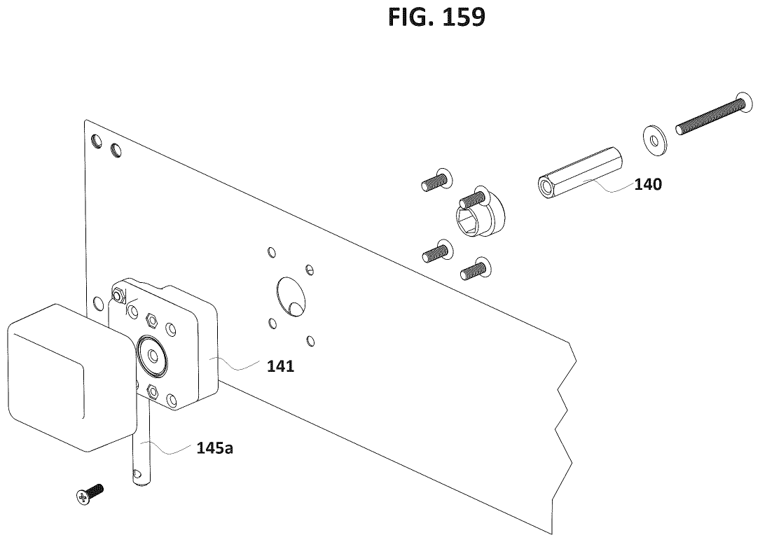

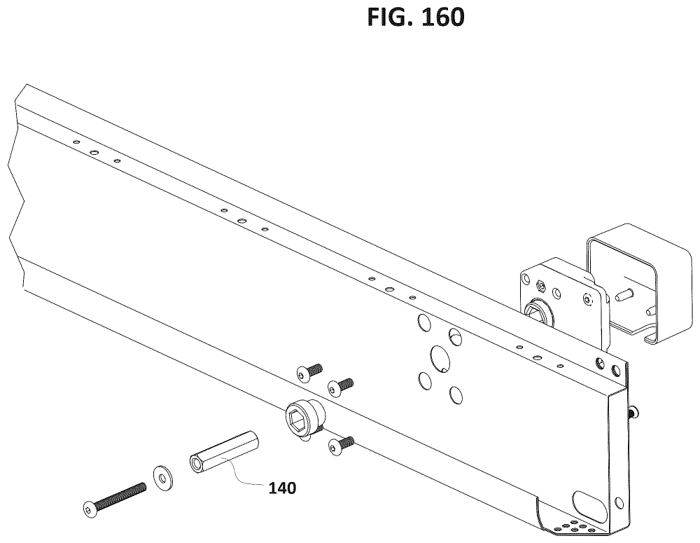

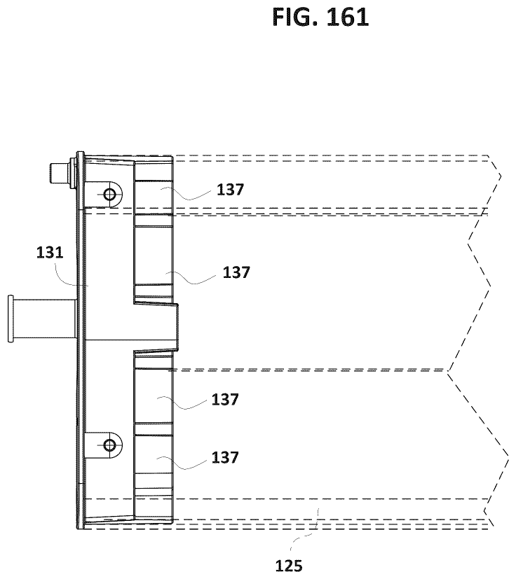

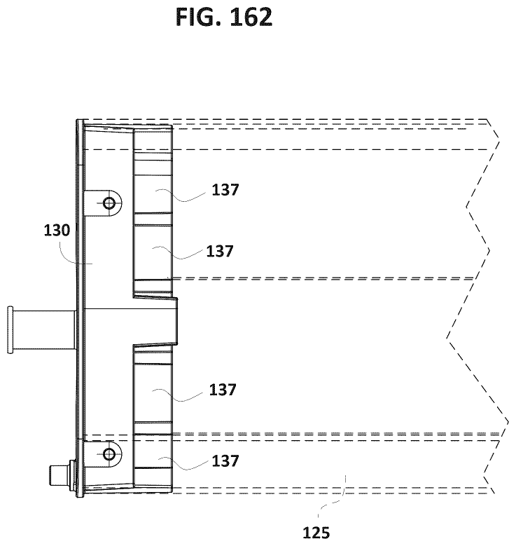

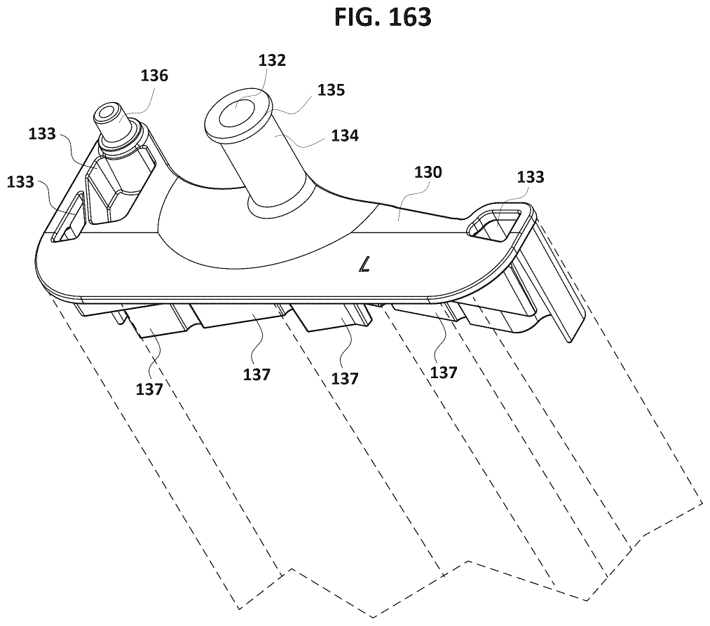

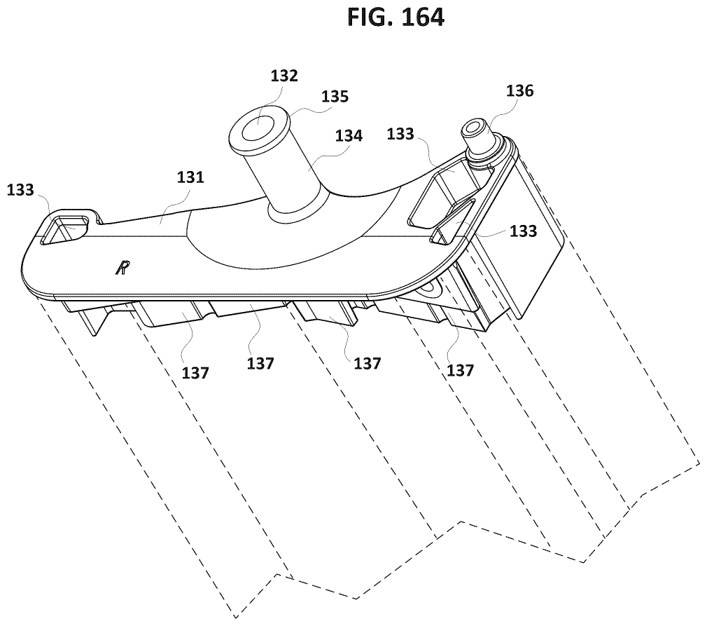

In some embodiments, Automatic multi-louver-shuttling hand-crank coupler 145b may be for: Coupling automatic multi-louver-shuttling hand-crank 146 to automatic multi-louver-shuttling hand-crank axle 145a. Automatic multi-louver-shuttling hand-crank 146 may be for: Providing manual energy needed to engage automatic-multi-louver-rotating system 138 to open and close rainwater-shedding rainwater-directing louver systems 124 in the directions of arrows 164-166 (see FIG. 113-FIG. 117). Cost-saving production-increasing rainwater-shedding leaf-filtering beam systems 147 may be for performing the combined functions of its components. Cost-saving production-increasing rainwater-shedding leaf-filtering beam 148 may be for: Directing rainwater from rainwater-shedding rainwater-directing louver systems 124 to double-gutter-supporting-and-locking post 114 in the direction of arrow 161 (see FIG. 126-FIG. 128).

In some embodiments, Axle-mounting plateau 149 may be for: Providing location for noise-canceling axle saddle 150 to be installed. Noise-canceling axle saddle 150 may be for: Securing cost-saving production-increasing left-side louver end 130, cost-saving production-increasing right-side louver end 131, and louver-mounted axle 144b; and Noise-cancelling when cost-saving production-increasing anti-noise louver axle 134 may be rotated therein in the direction of arrow 164 (see FIG. 113, FIG. 114, FIG. 116, and FIG. 117).

In some embodiments, Noise-canceling axle clamp 151 may be for: Securing cost-saving production-increasing left-side louver end 130, cost-saving production-increasing right-side louver end 131, and louver-mounted axle 144b; and Noise-cancelling when cost-saving production-increasing anti-noise louver axles 134 may be rotated therein in the direction of arrow 164 (see FIG. 113, FIG. 114, FIG. 116, and FIG. 117). Rainwater-shedding gutter 152 may be for: Directing rainwater from rainwater-shedding rainwater-directing louver systems 124 to double-gutter-supporting-and-locking post 114 in the direction of arrow 161 (see FIG. 126-FIG. 128). Leaf-filtering drain-holes 153 may be respectively for: Filtering leaves and other debris from accumulated rainwater from rainwater-shedding rainwater-directing louver systems 124.

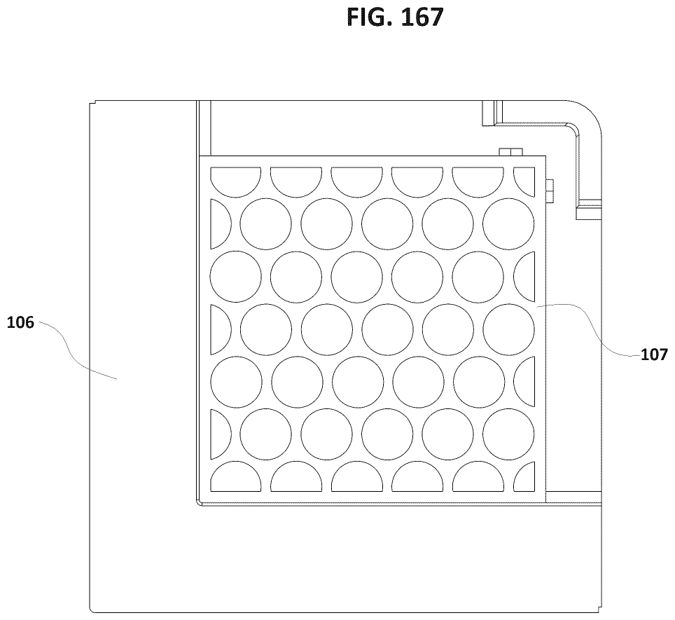

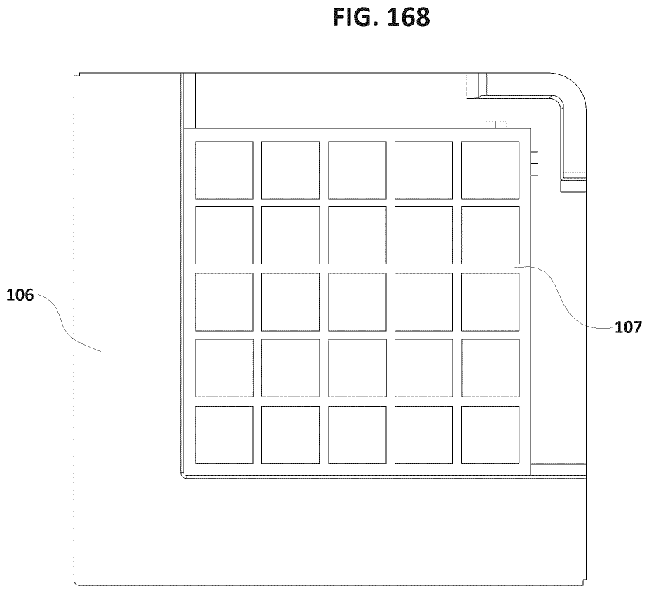

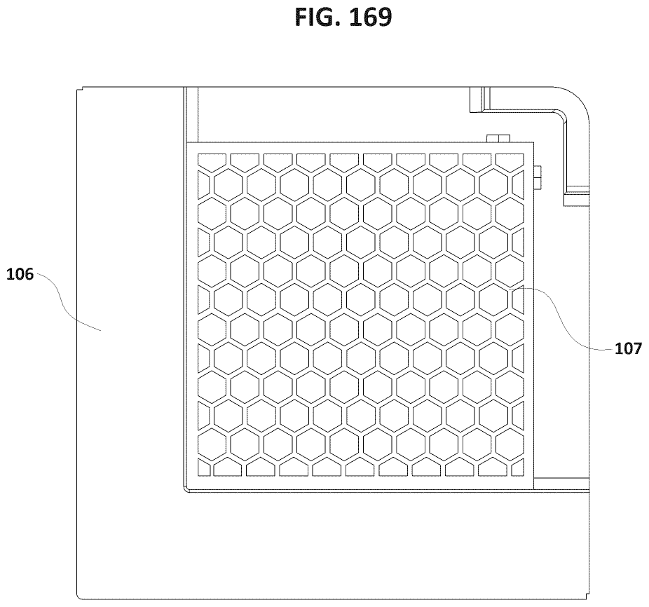

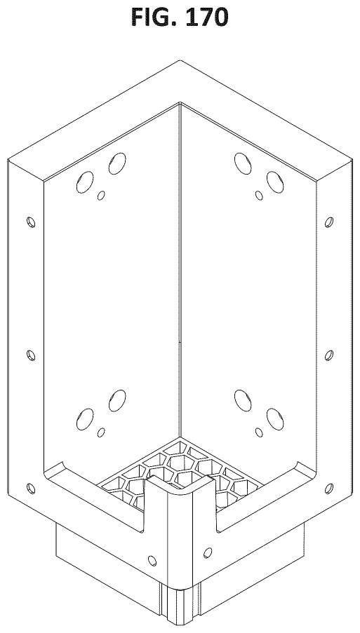

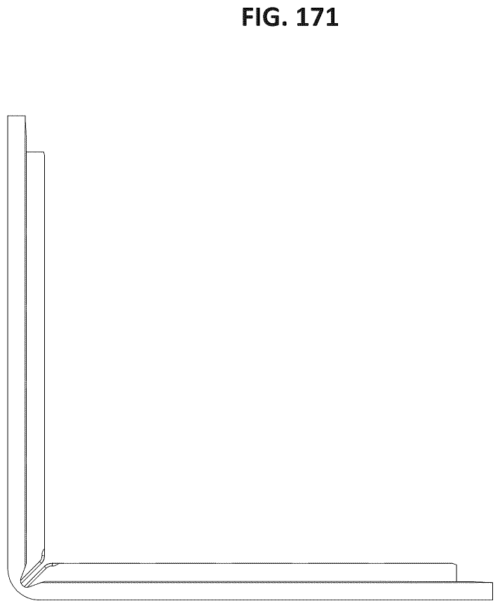

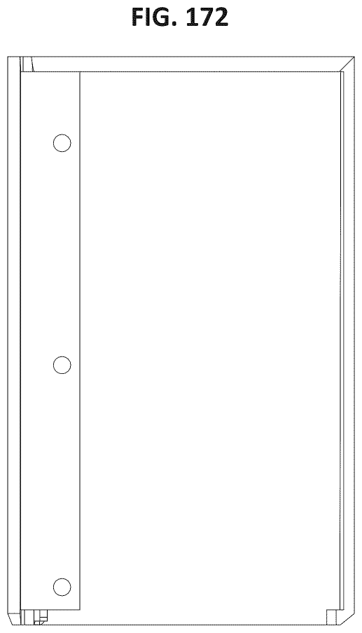

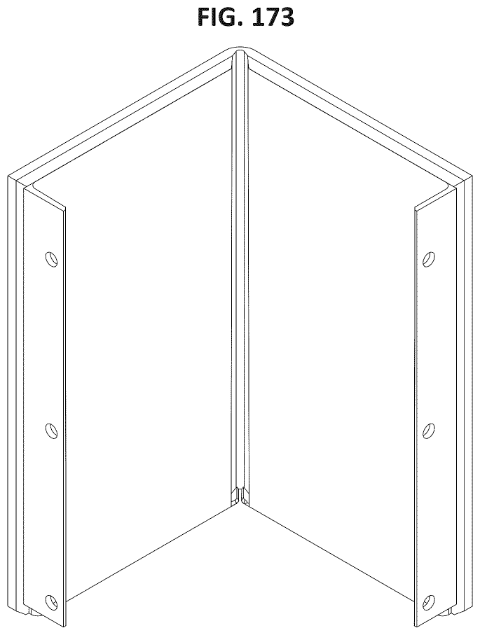

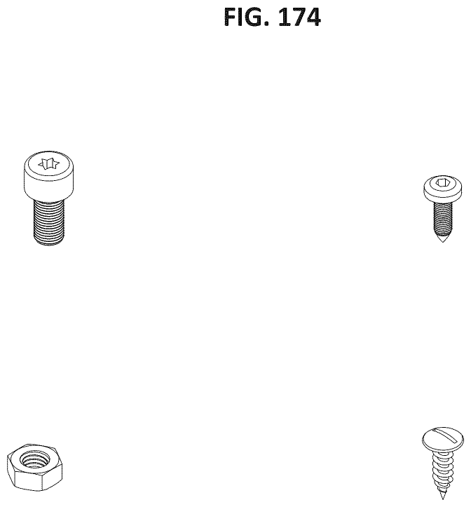

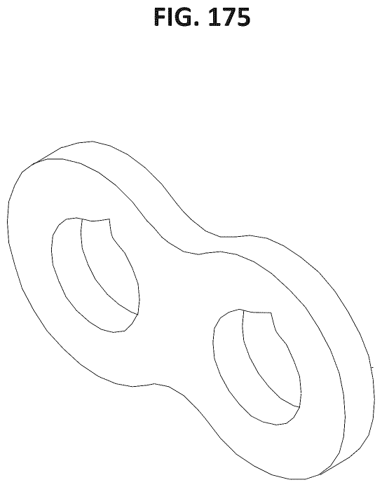

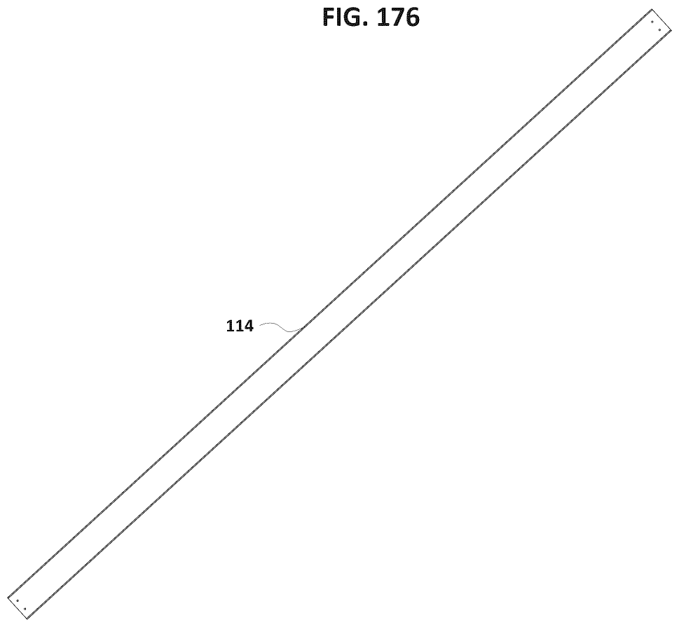

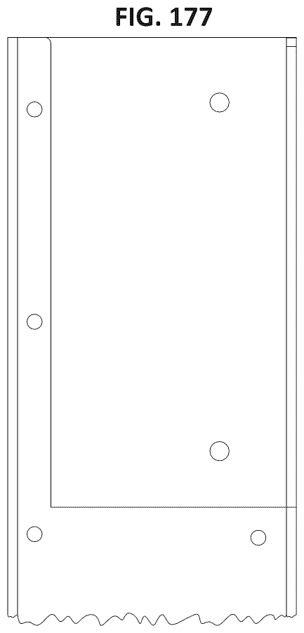

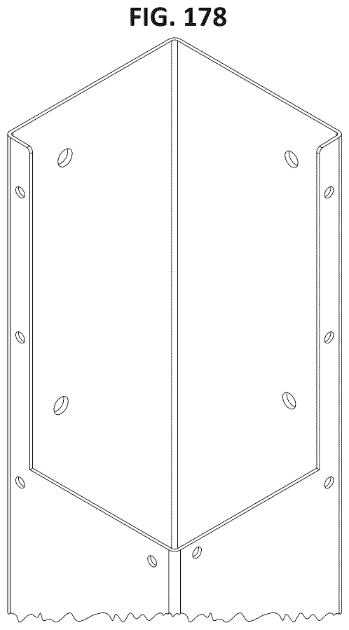

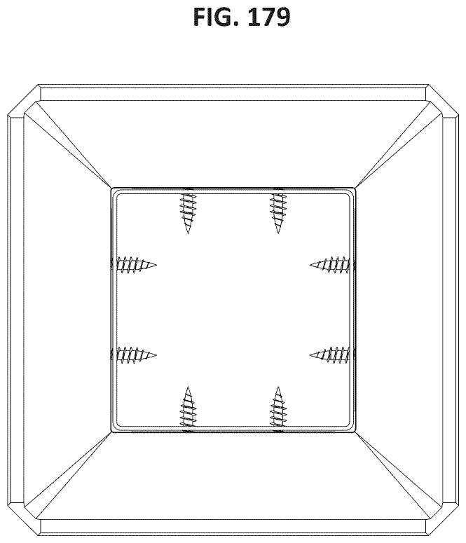

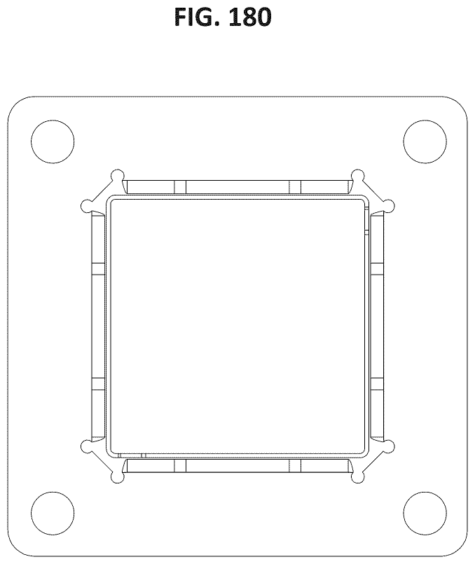

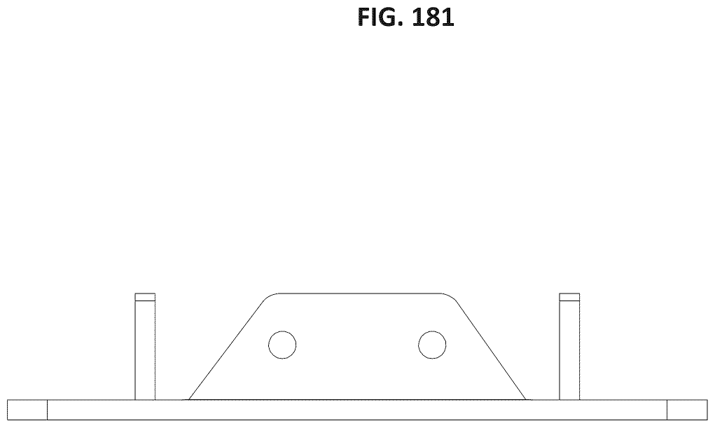

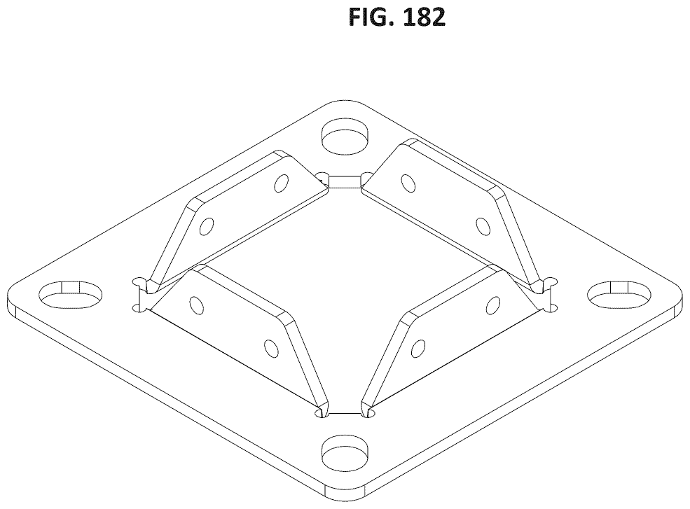

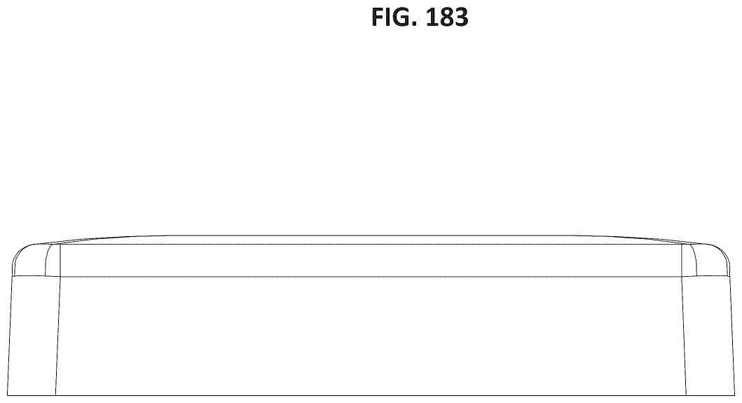

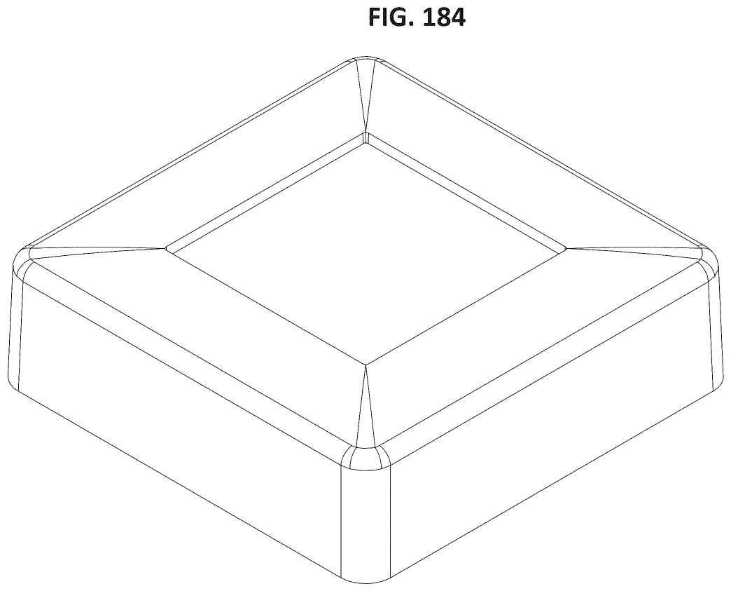

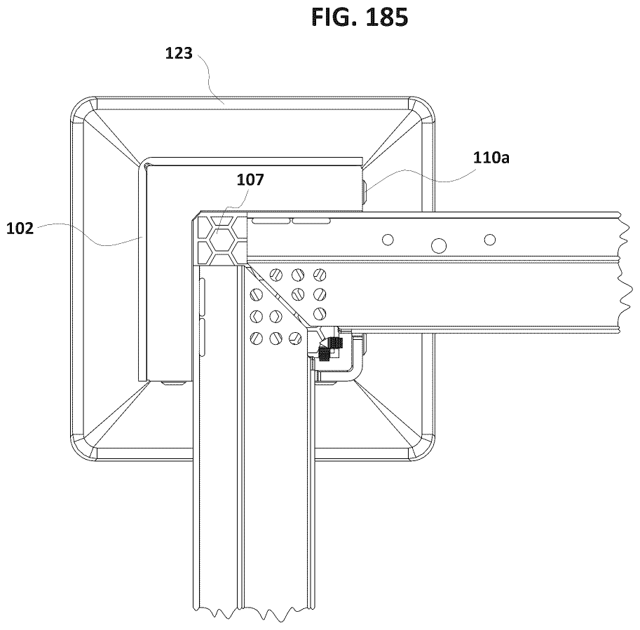

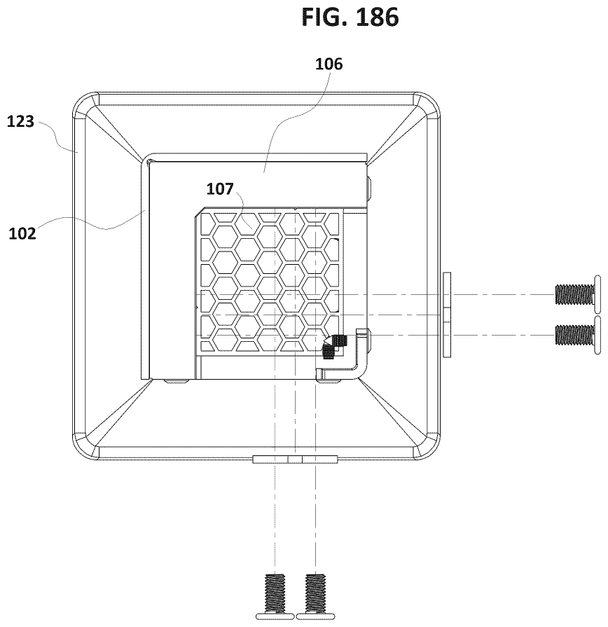

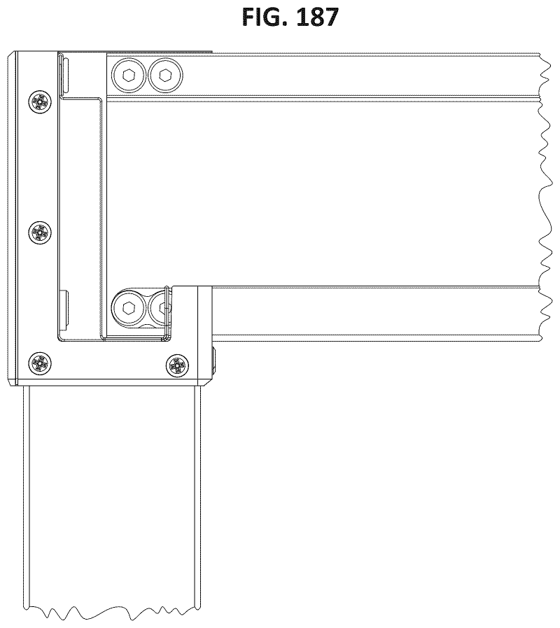

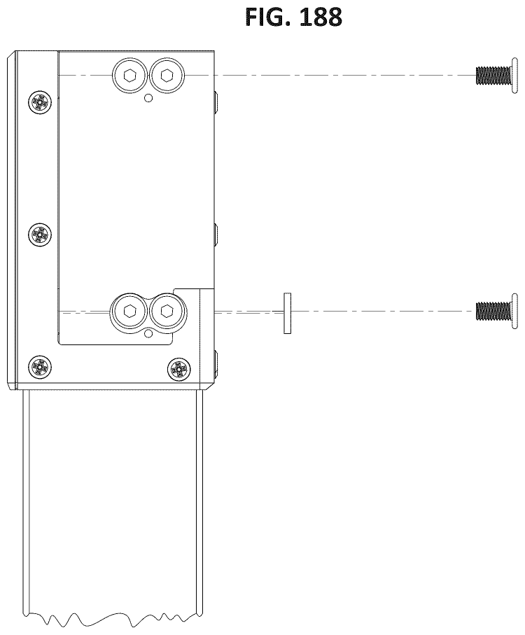

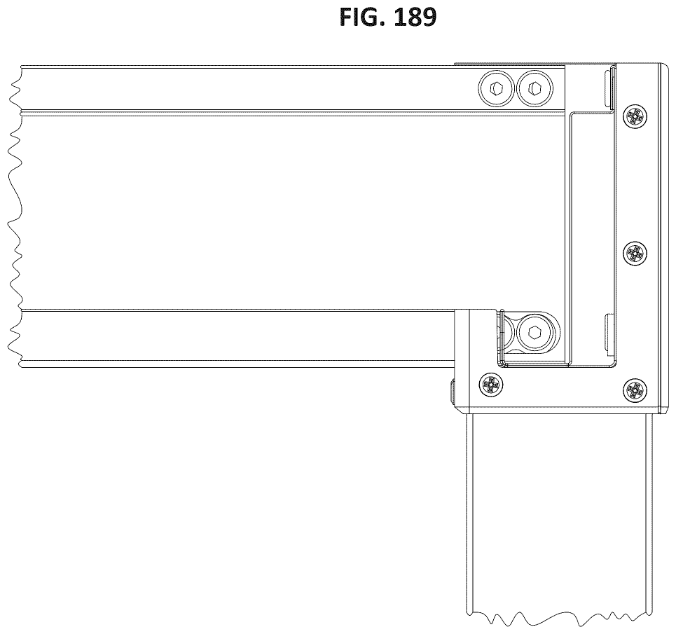

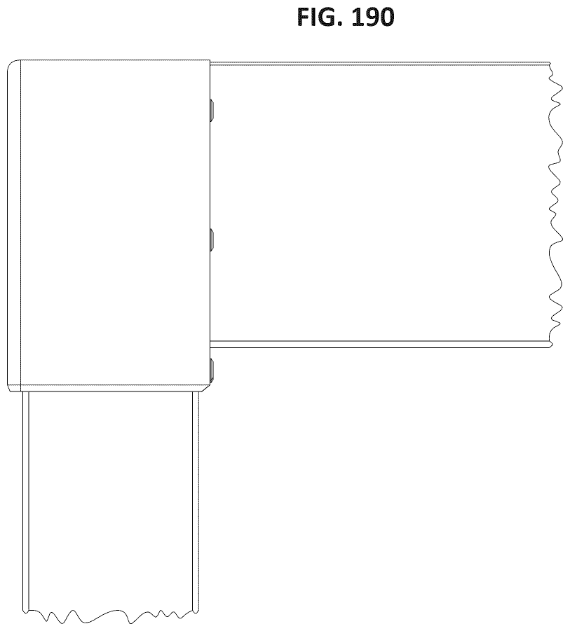

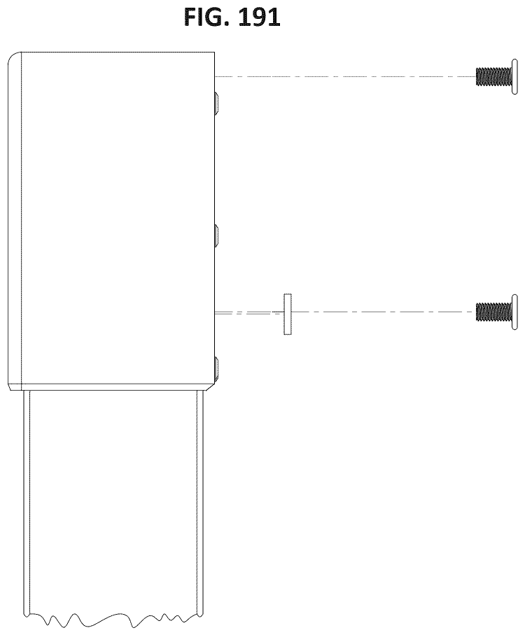

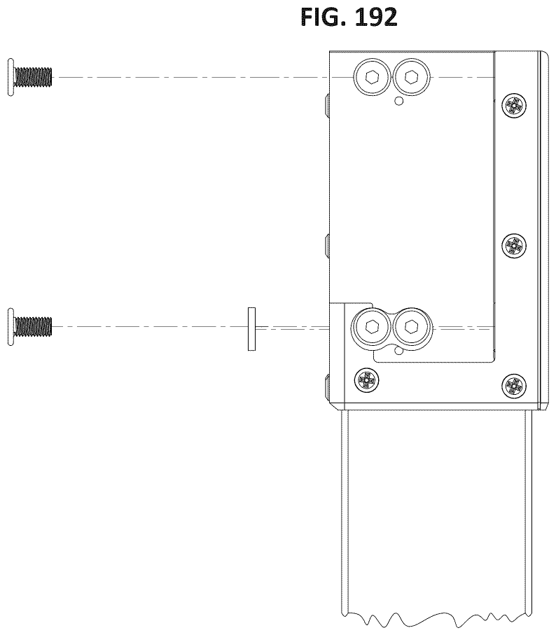

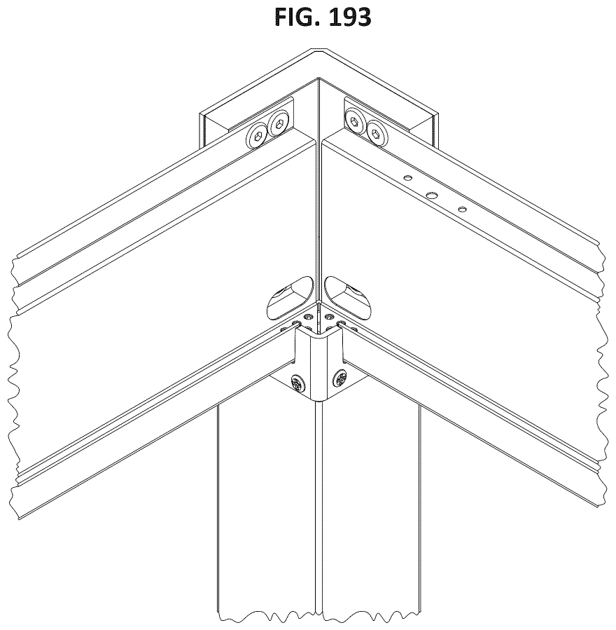

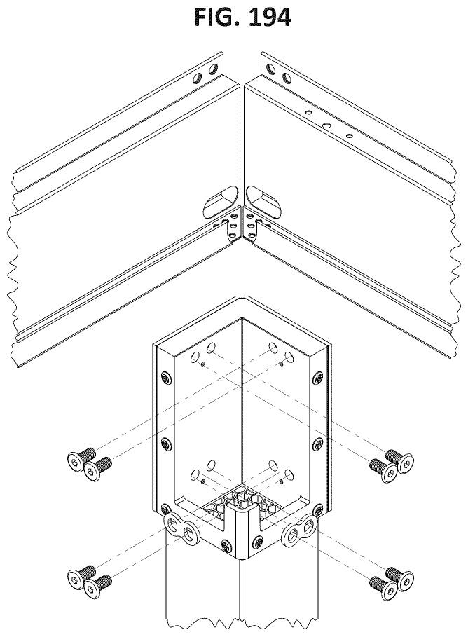

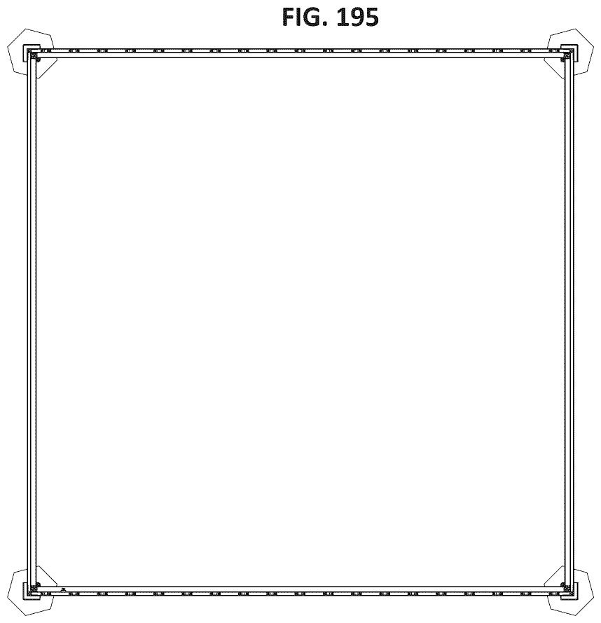

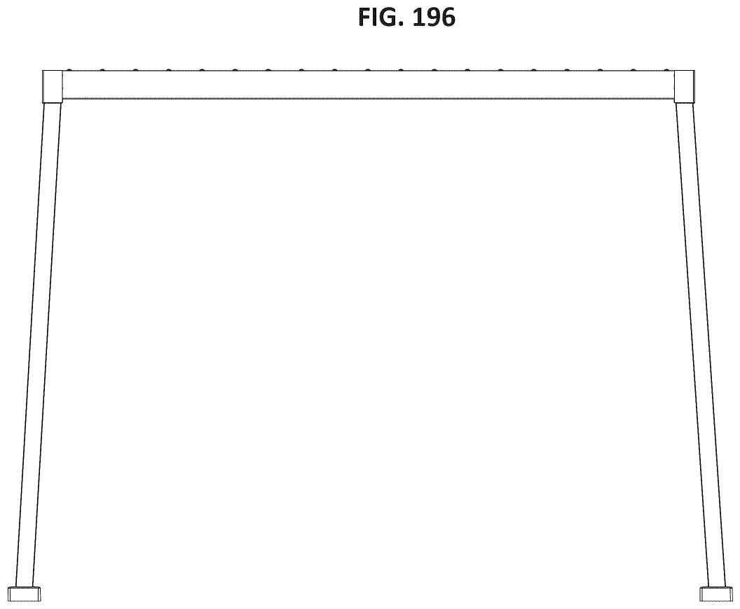

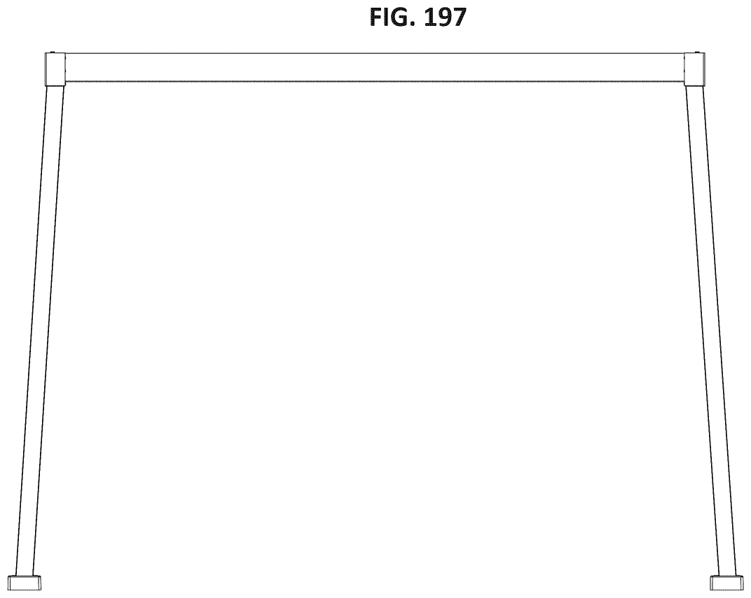

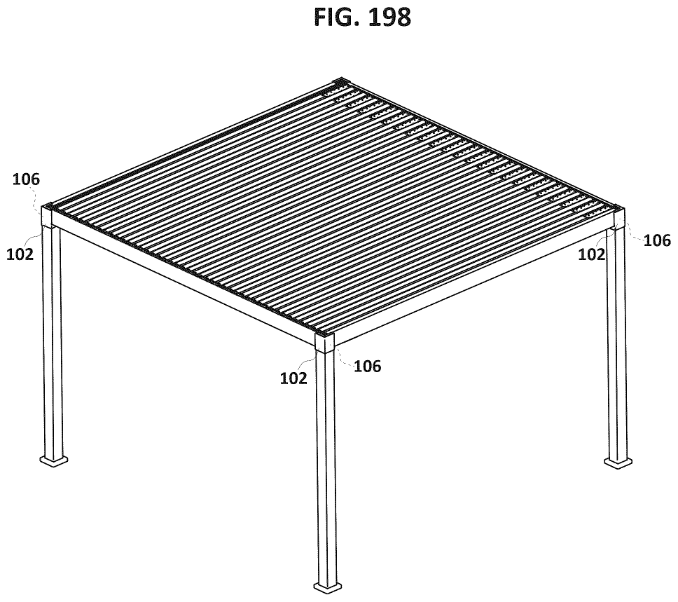

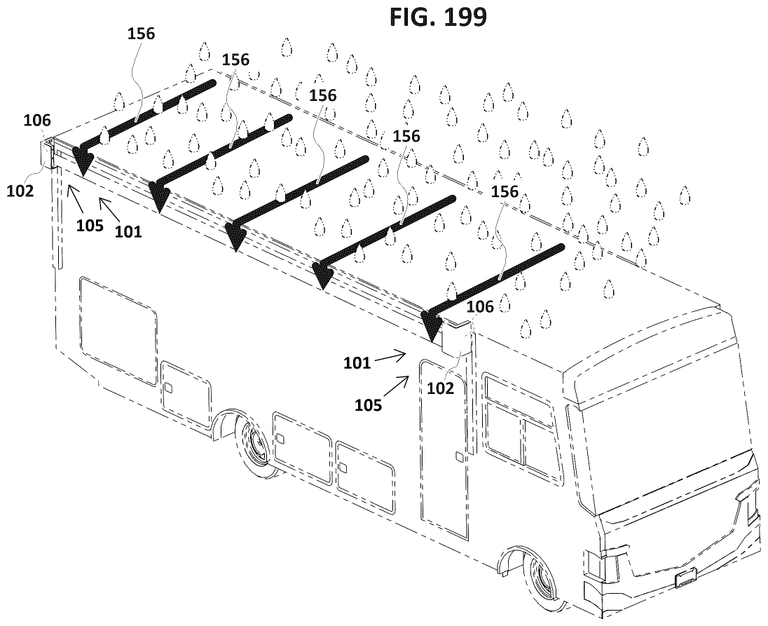

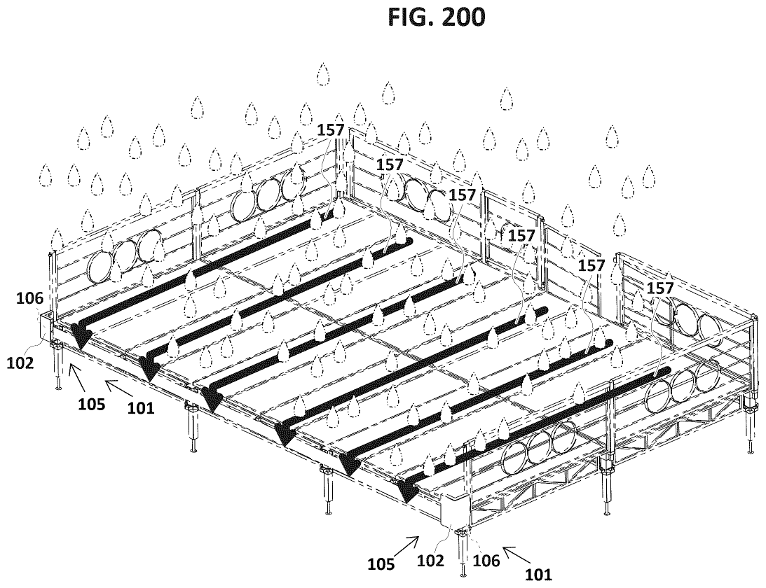

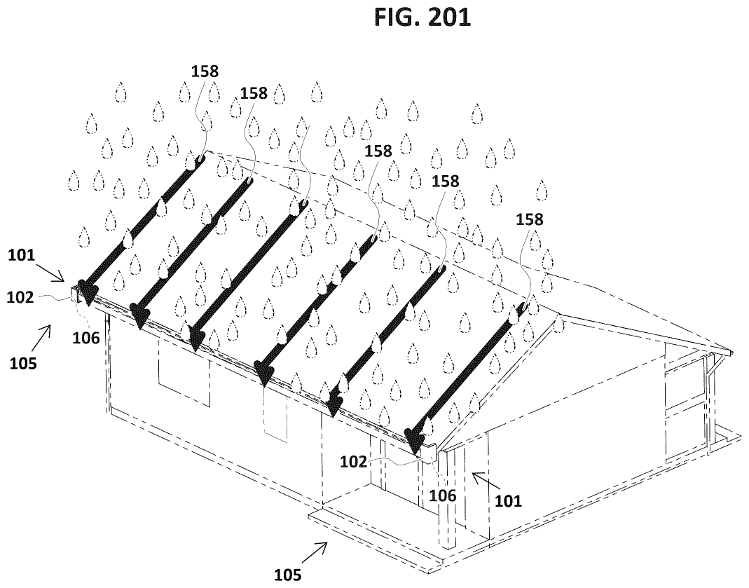

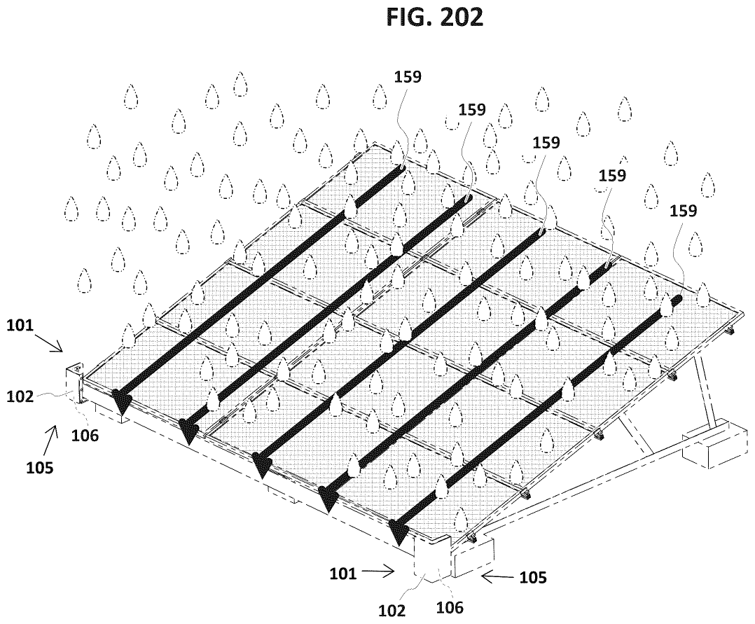

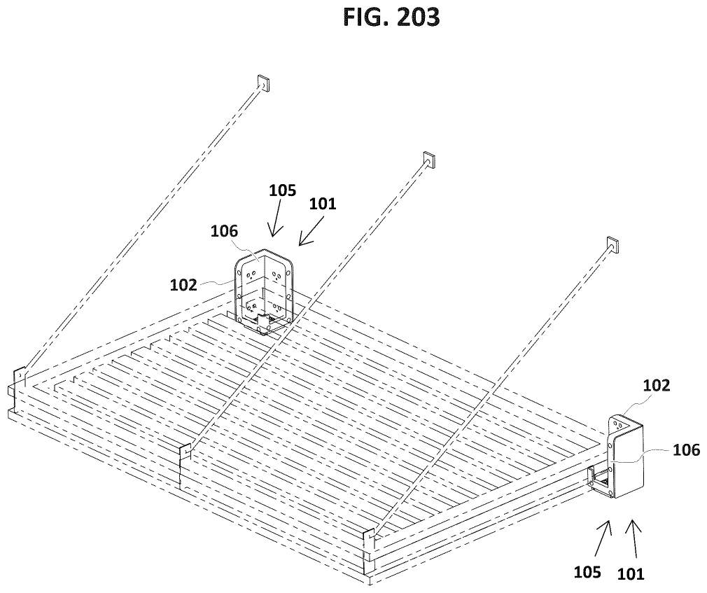

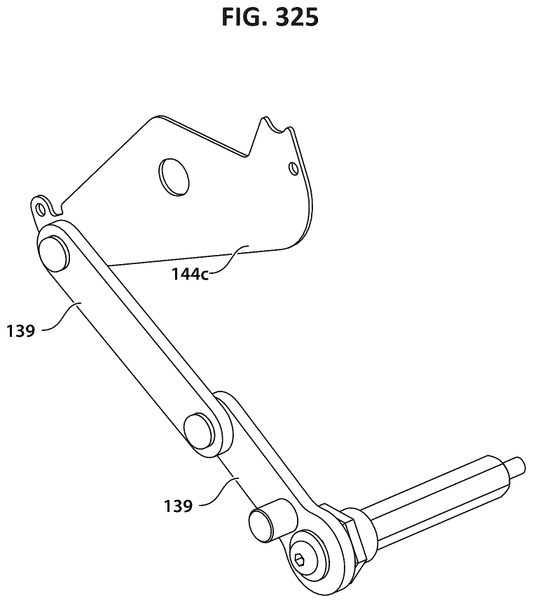

VARIATION Referring to FIG. 167-FIG. 325: In some embodiments, Any component of the five-device-in-one anti-twisting anti-warping anti-vibrating cost-saving production-increasing corner and noise-canceling wind-dissipating louver can have any shape and size. Any component of the five-device-in-one anti-twisting anti-warping anti-vibrating cost-saving production-increasing corner and noise-canceling wind-dissipating louver can be made of any material(s). FIG. 167 FIG. 198 illustrate equivalent variations of the five-device-in-one anti-twisting anti-warping anti-vibrating cost-saving production-increasing corner and noise-canceling wind-dissipating louver. FIG. 199-FIG. 202 illustrate equivalent applications of the five-device-in-one anti-twisting anti-warping anti-vibrating cost-saving production-increasing corner and noise-canceling wind-dissipating louver (being used to support a gutter to shed water from an RV, concert stage, house, and solar panel in the directions of arrows 156, 157, 158, and 159, respectively). FIG. 203 illustrates an equivalent application of the five-device-in-one anti-twisting anti-warping anti-vibrating cost-saving production-increasing corner and noise-canceling wind-dissipating louver being used to support an awning when attached to a building.

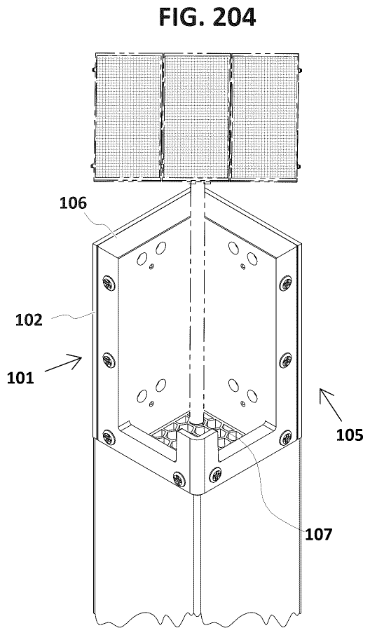

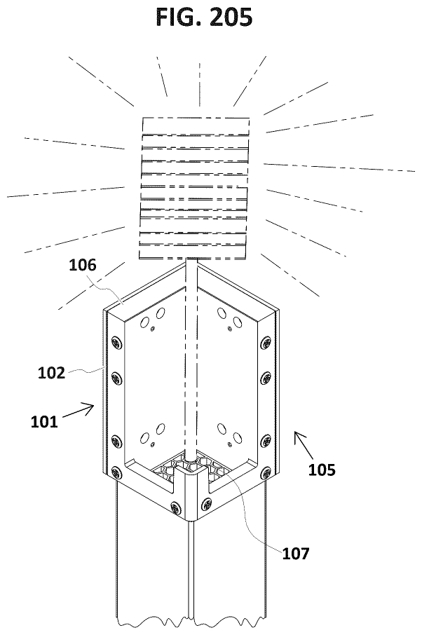

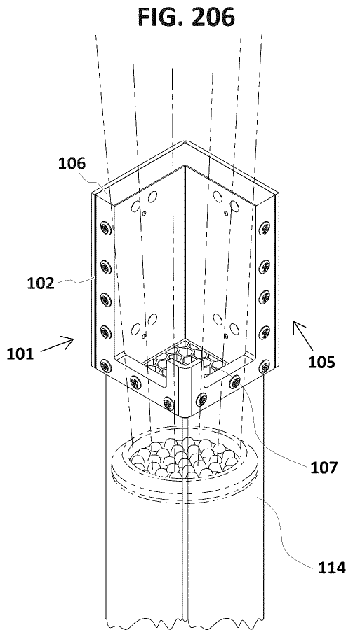

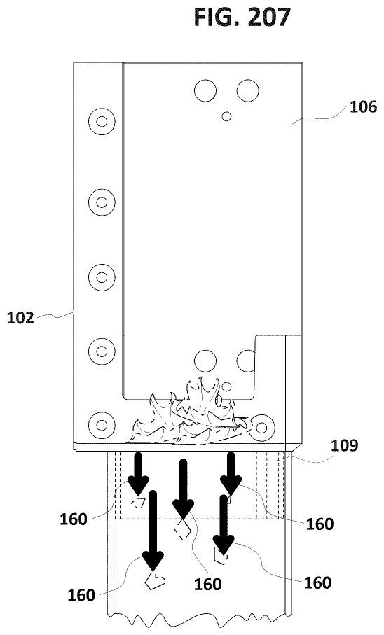

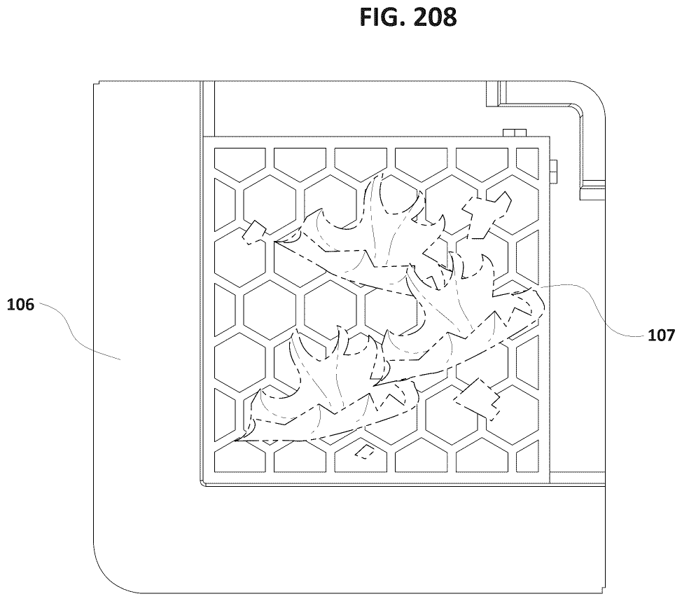

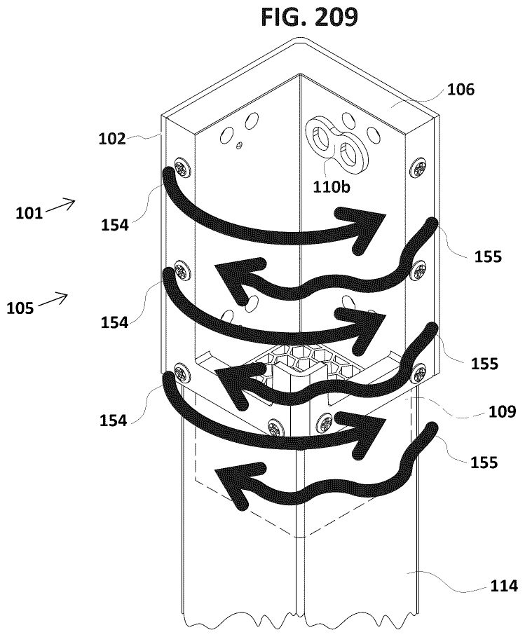

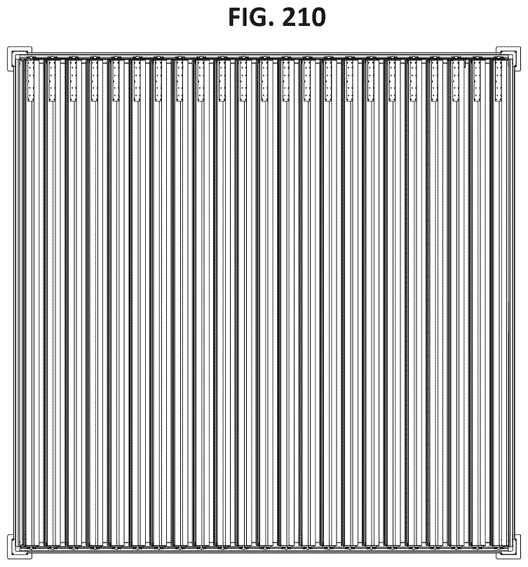

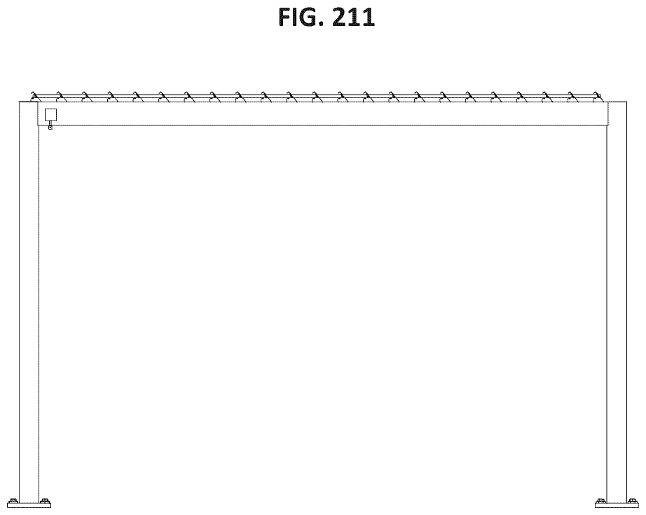

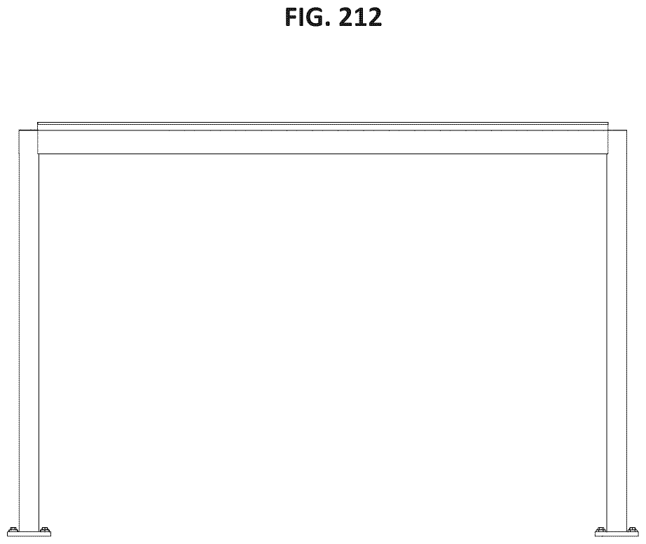

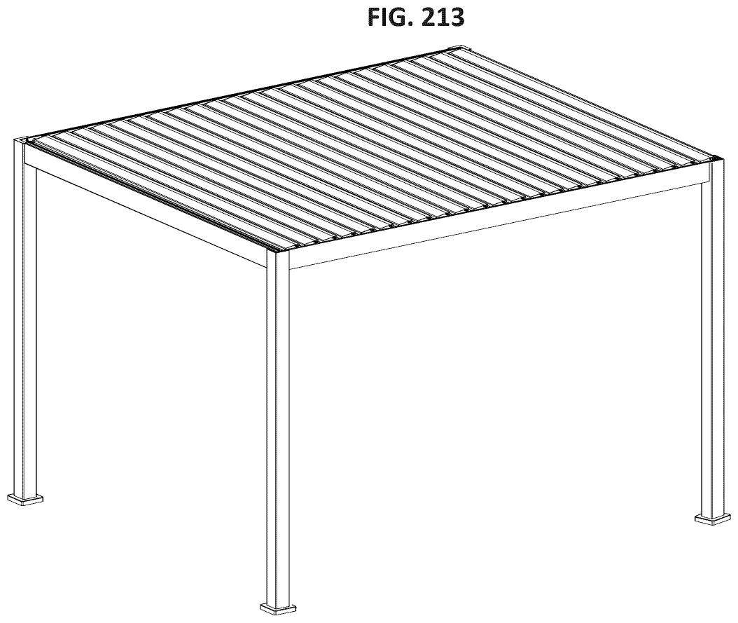

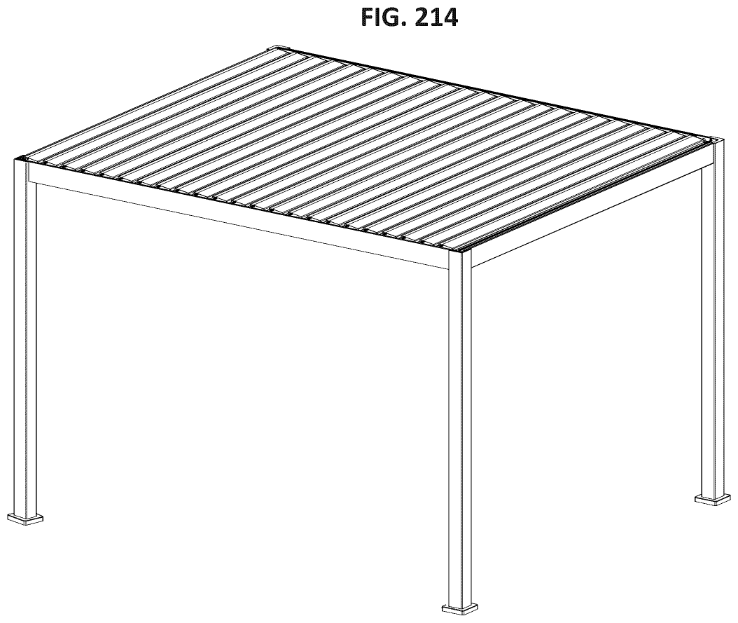

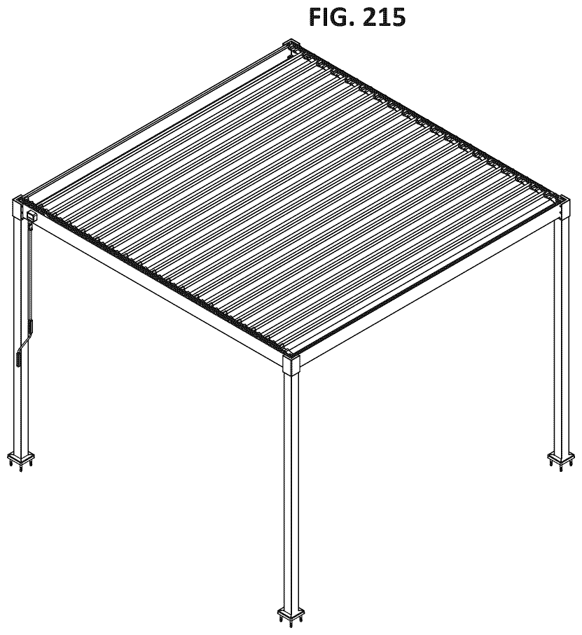

FIG. 204-208 illustrate equivalent applications of leaf-filtering-and-breaking cost-saving production-increasing honeycomb grate 107 being used to support a solar panel, an outdoor speaker, an outdoor light, and being used to filter leaves and other debris. FIG. 209 illustrates equivalent applications of anti-twisting anti-warping cost-saving production-increasing auto-centering bracket 109 providing anti-twisting and anti-warping abilities to retain original shape and size of the five-device-in-one anti-twisting anti-warping anti-vibrating cost-saving production-increasing corner and noise-canceling wind-dissipating louver. FIG. 210-FIG. 215 illustrate equivalent variations of the five-device-in-one anti-twisting anti-warping anti-vibrating cost-saving production-increasing corner and noise-canceling wind-dissipating louver.

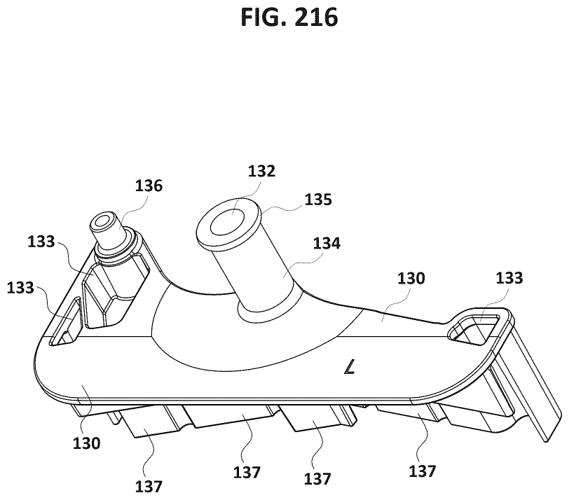

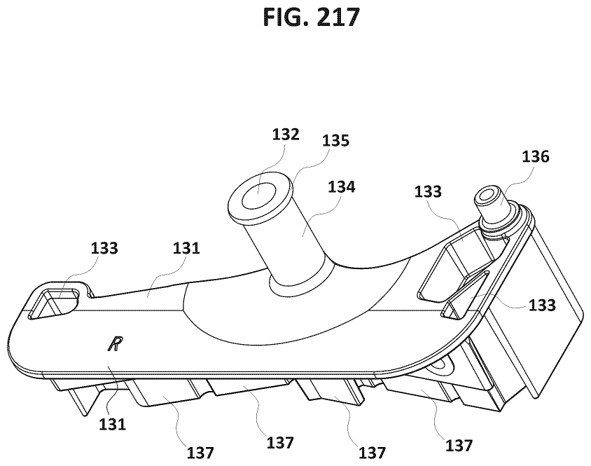

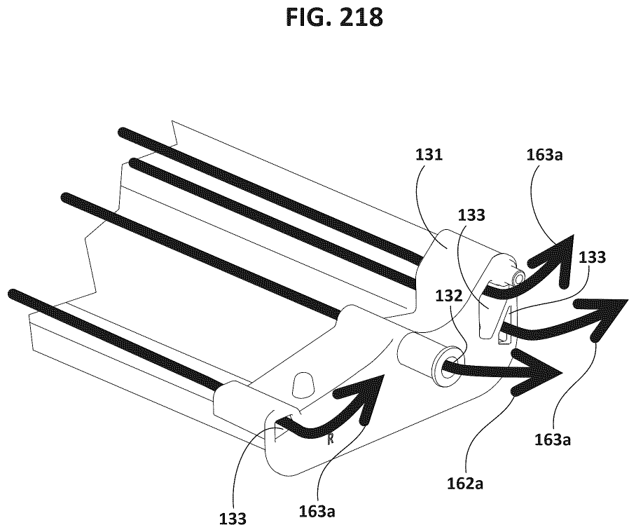

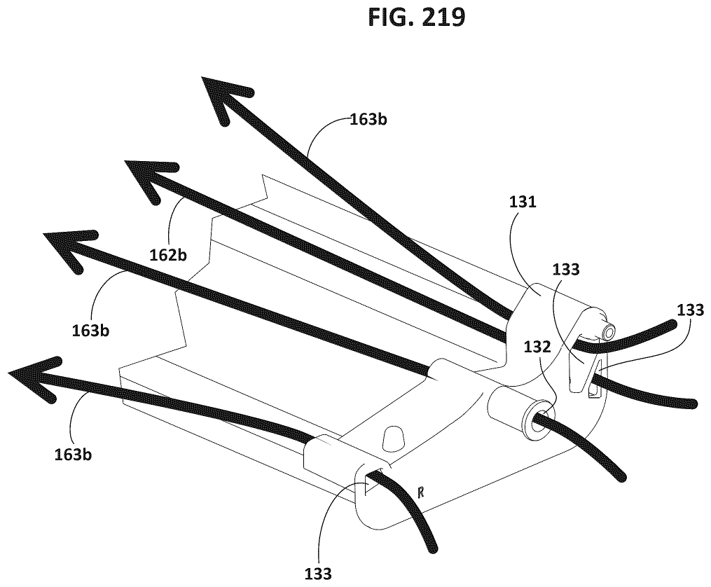

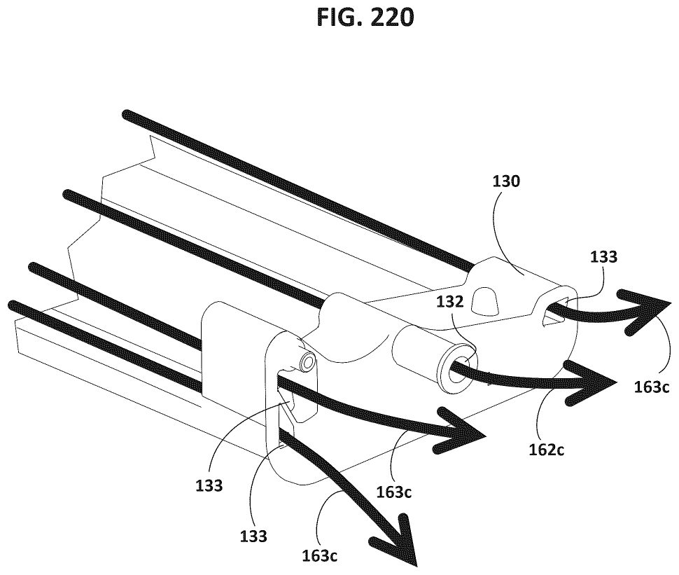

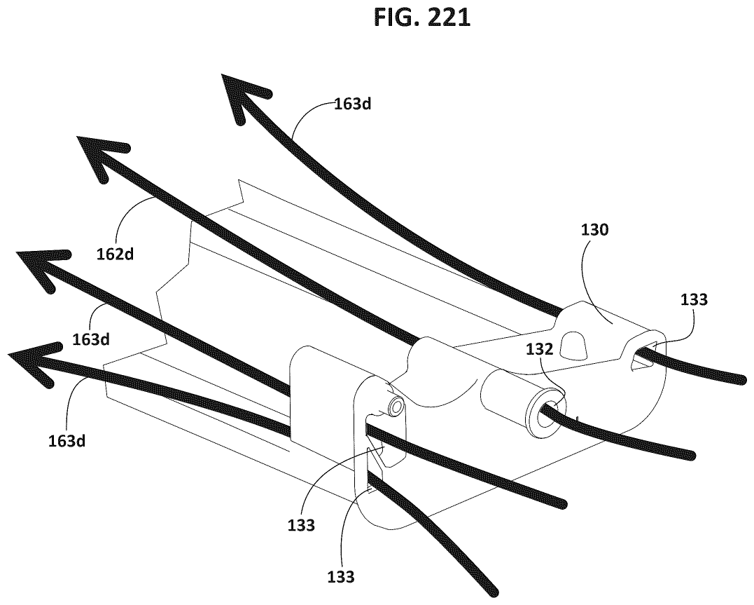

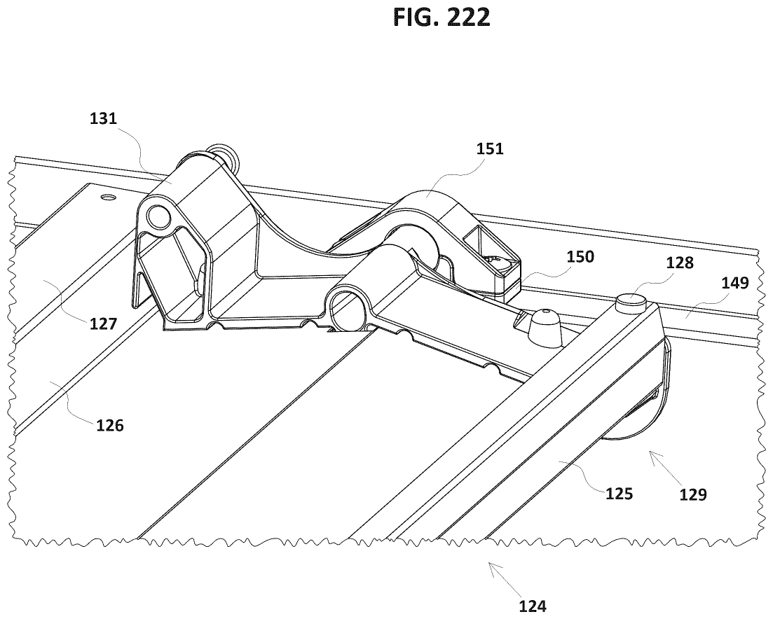

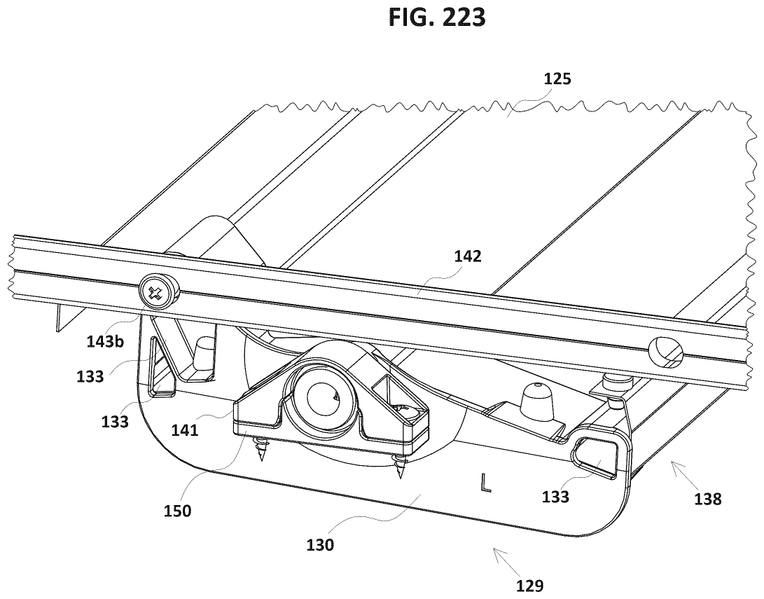

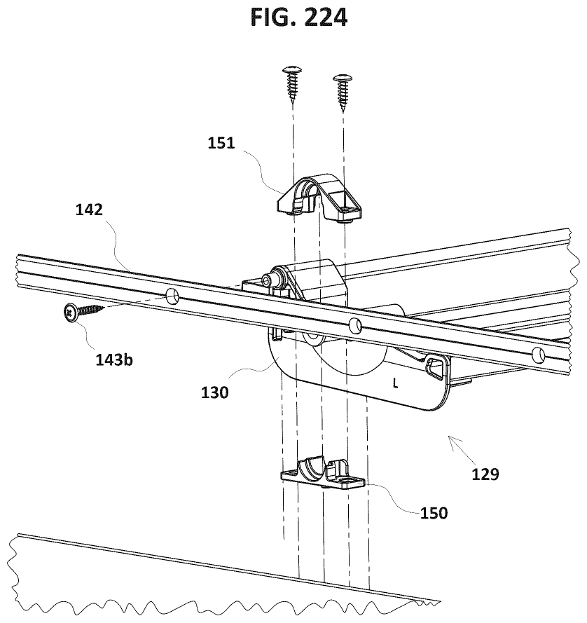

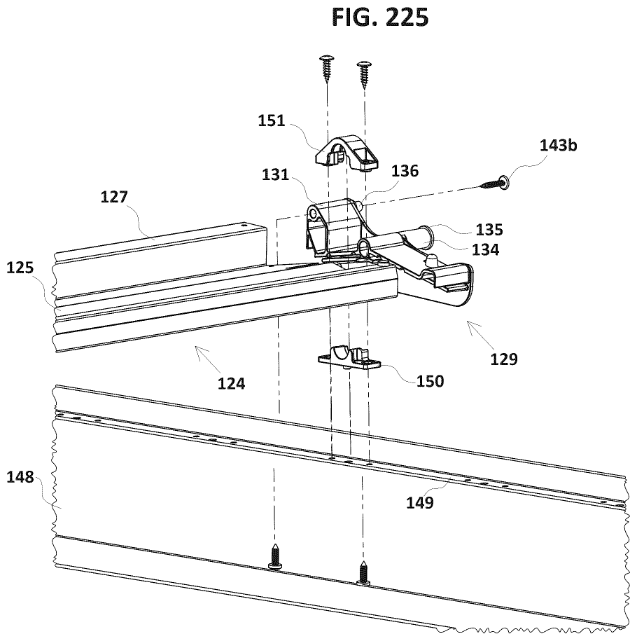

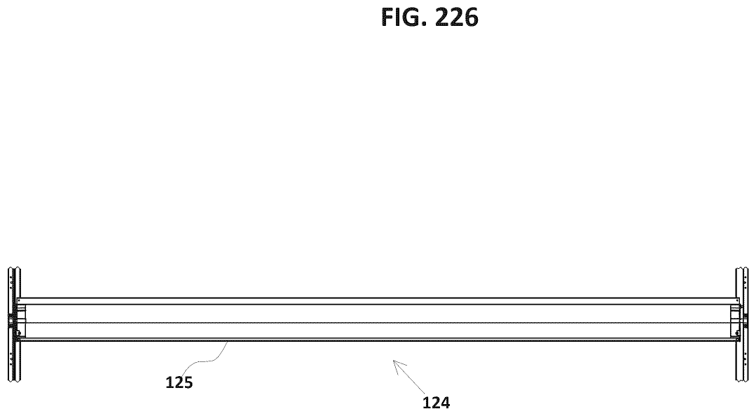

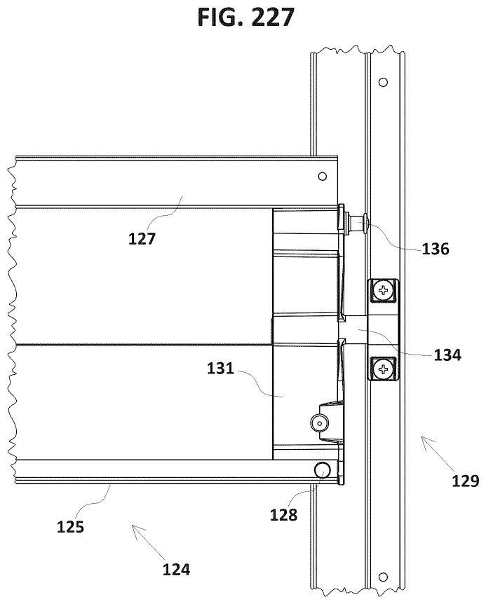

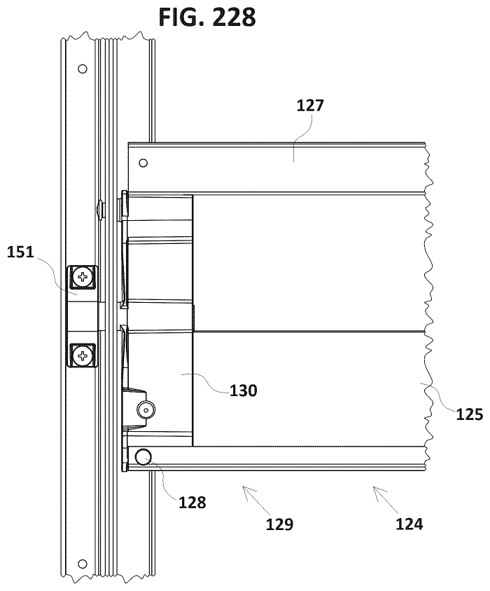

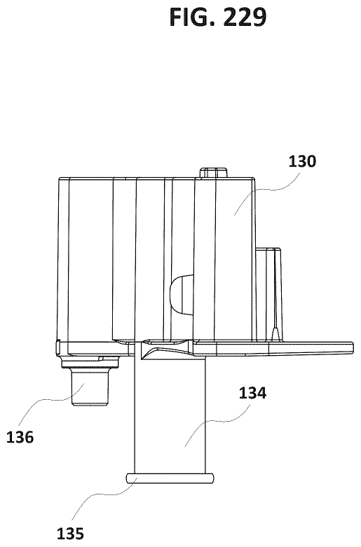

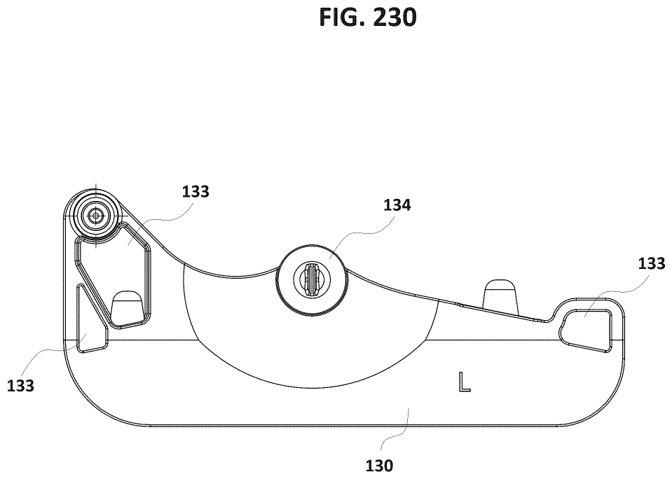

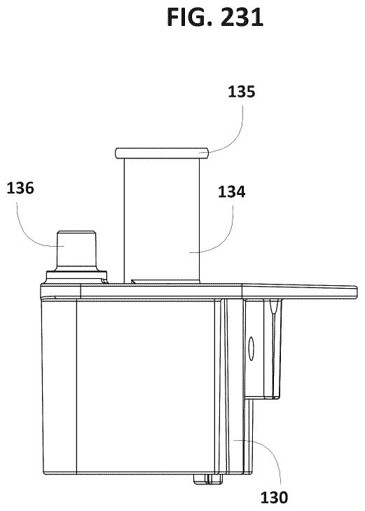

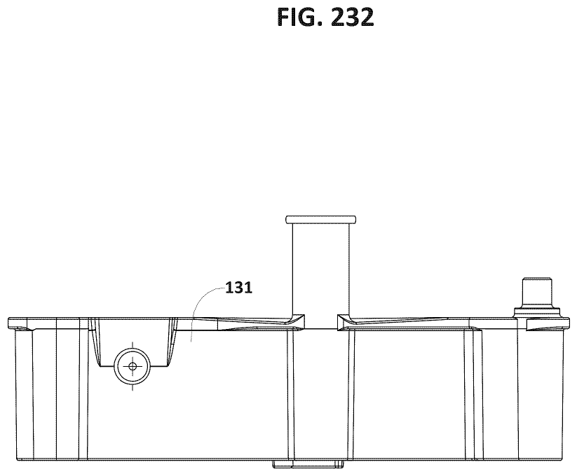

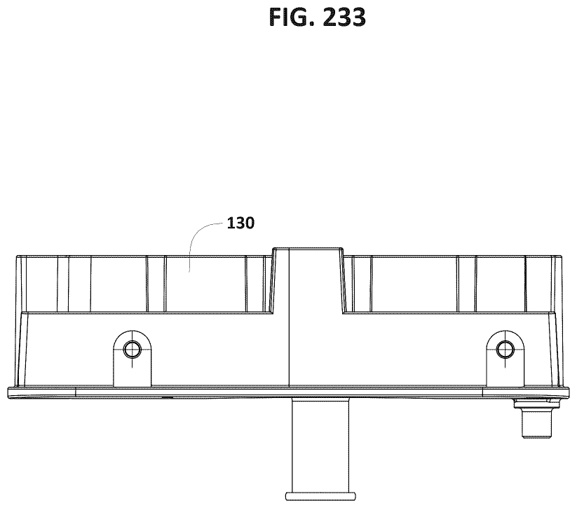

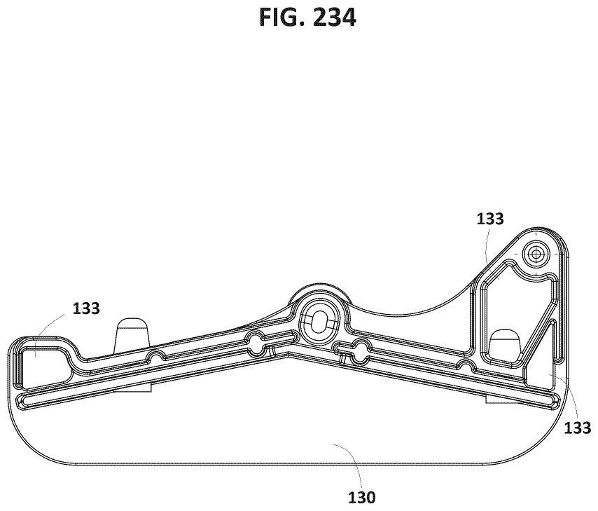

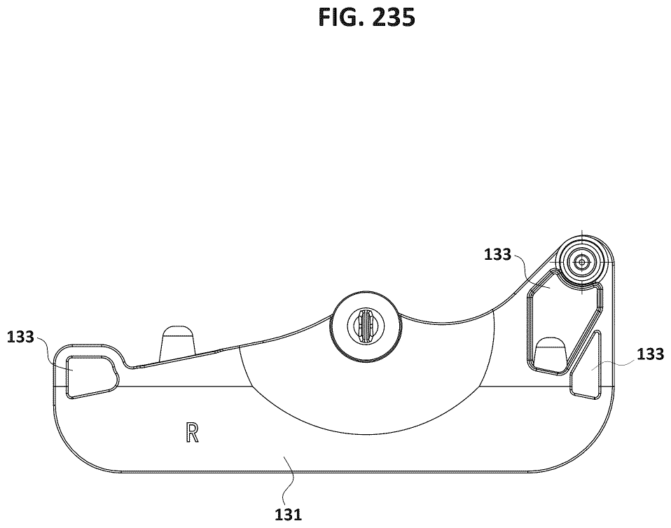

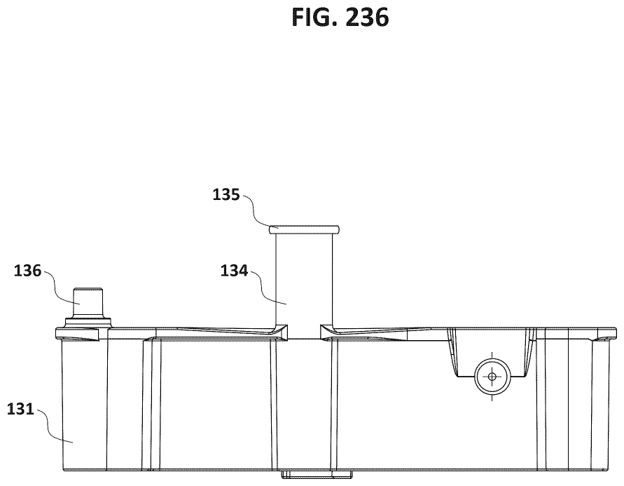

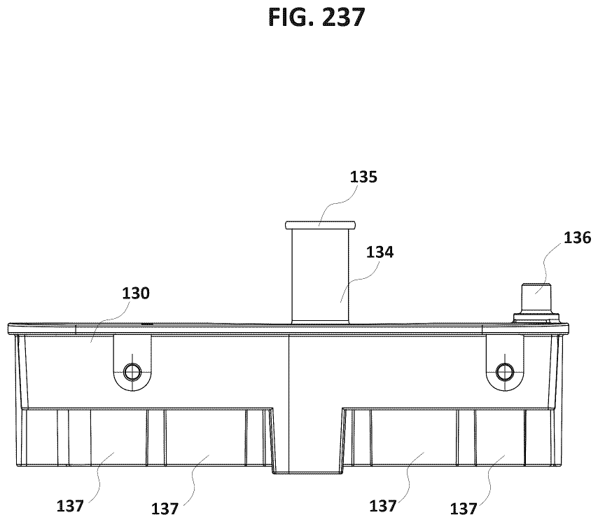

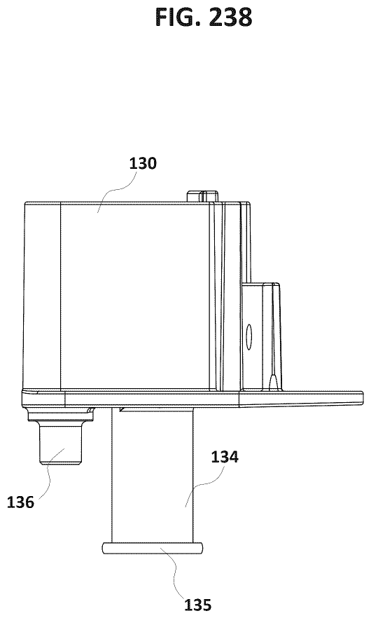

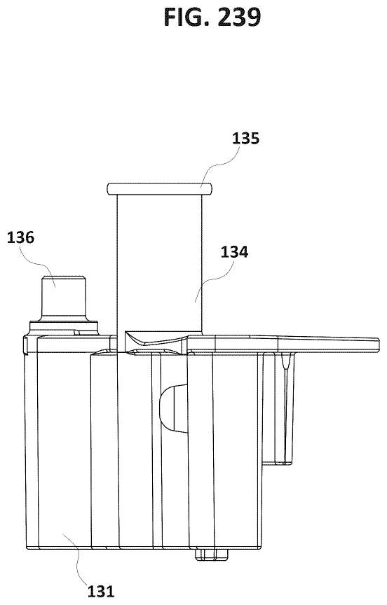

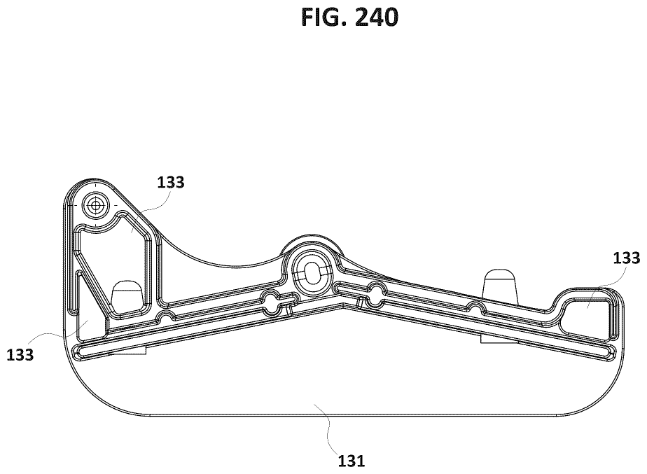

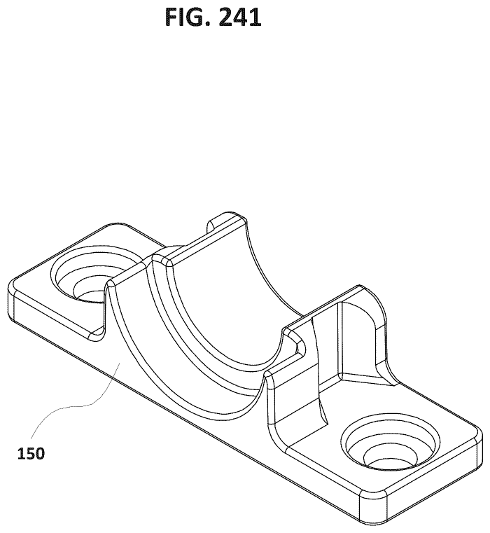

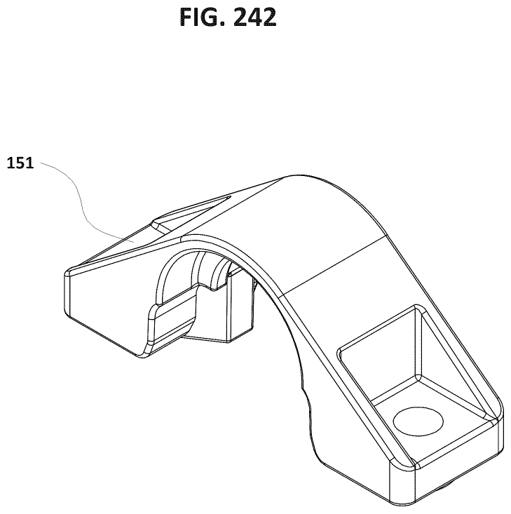

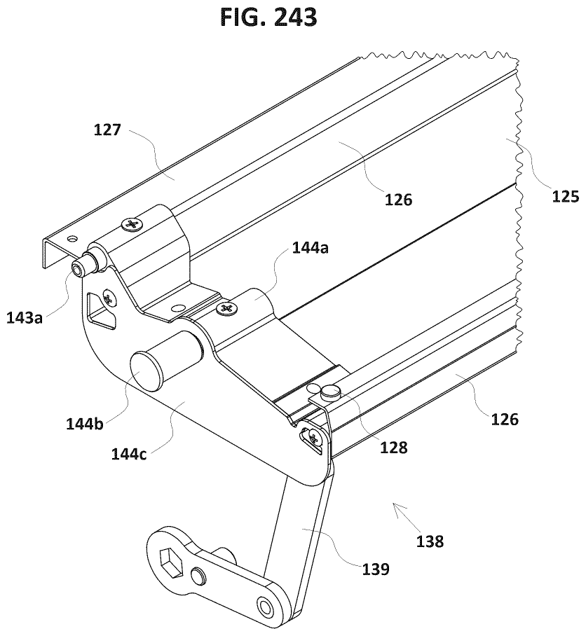

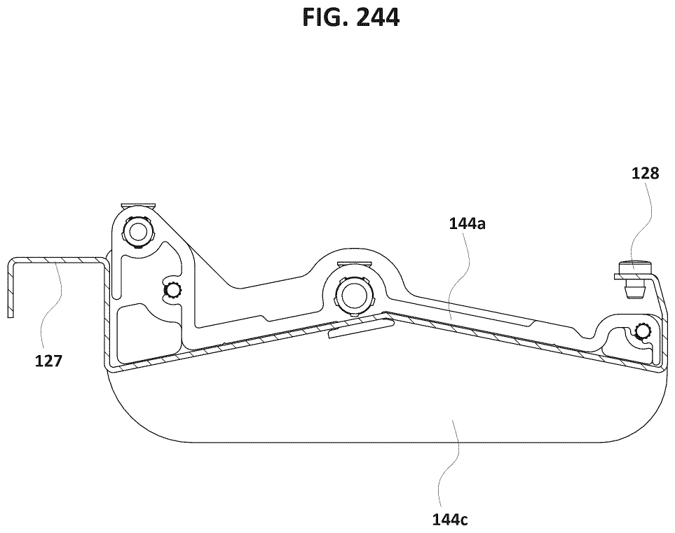

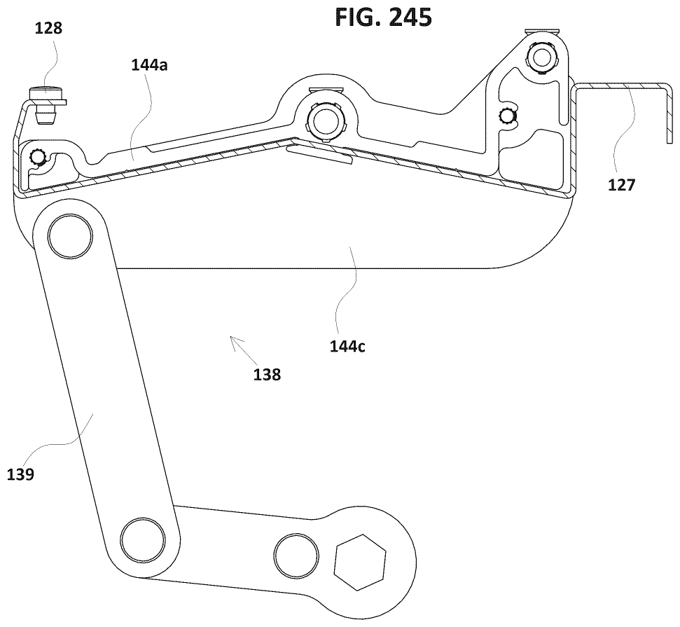

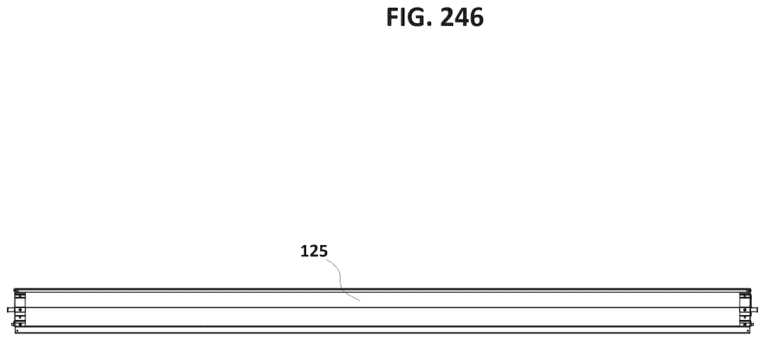

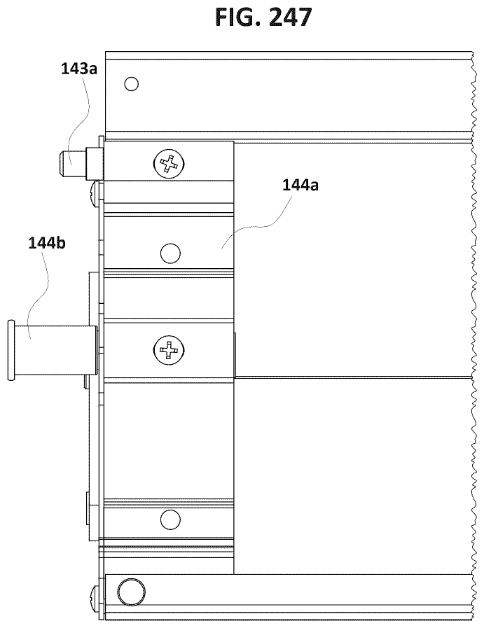

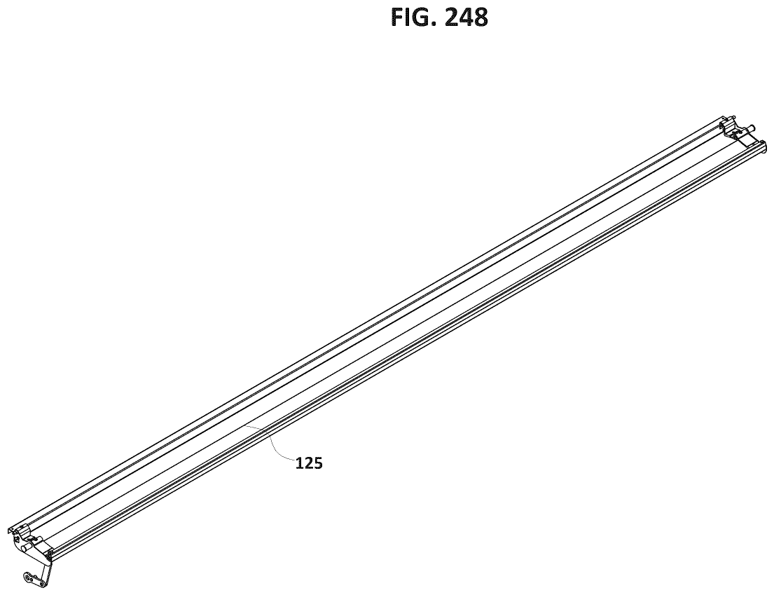

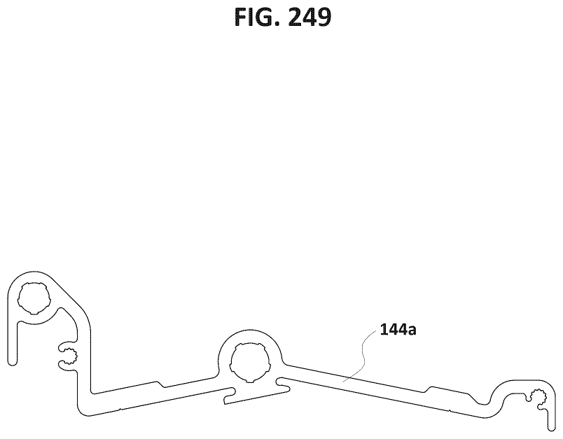

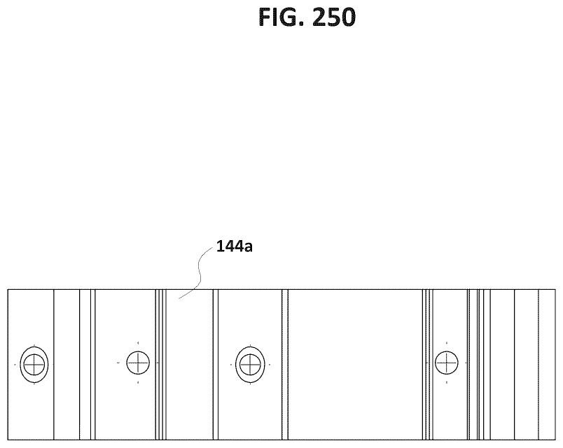

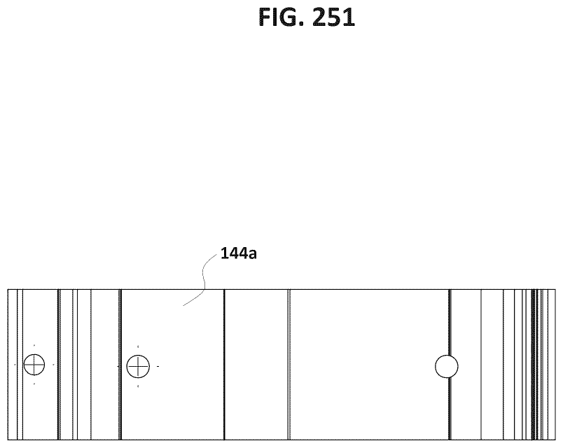

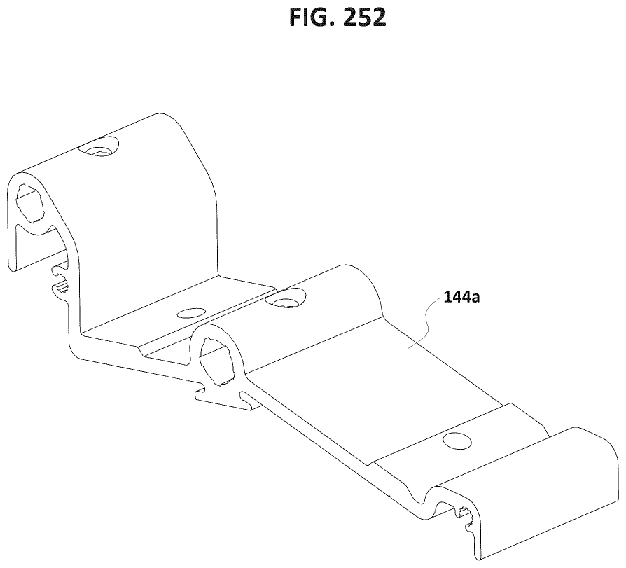

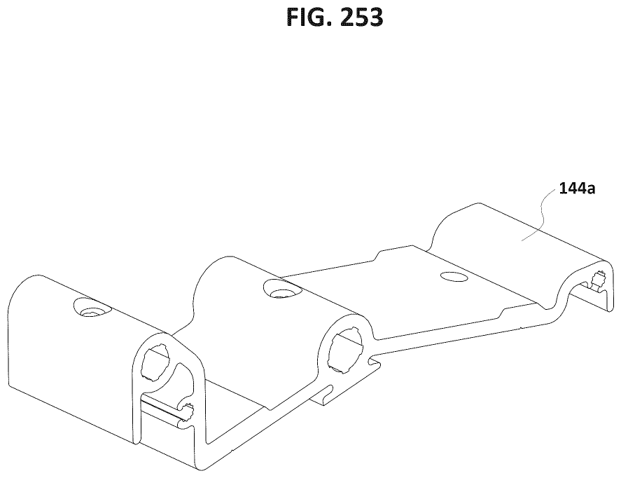

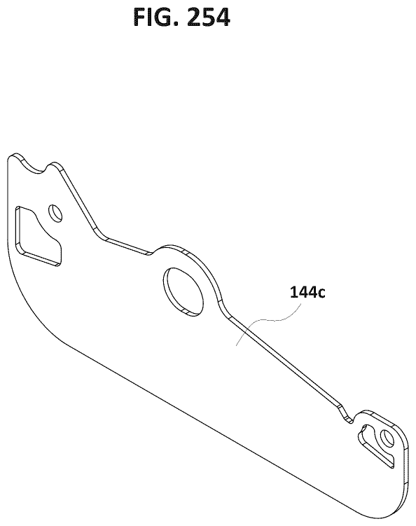

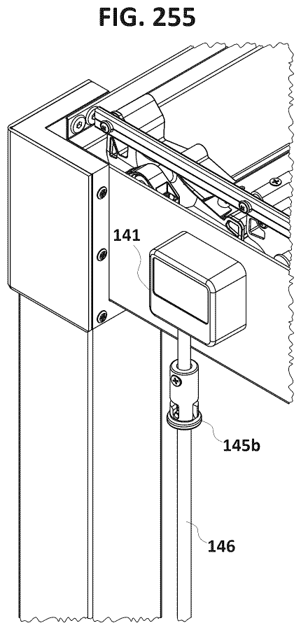

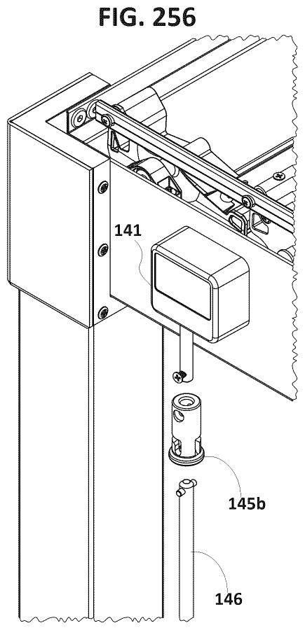

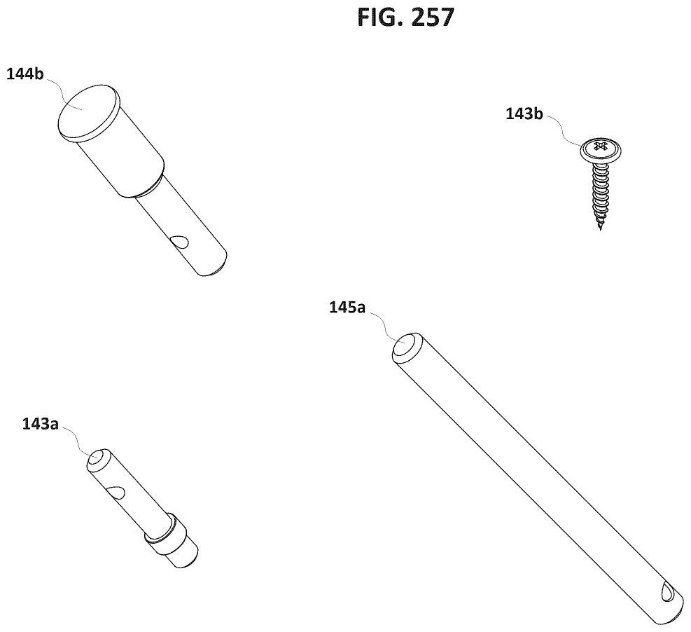

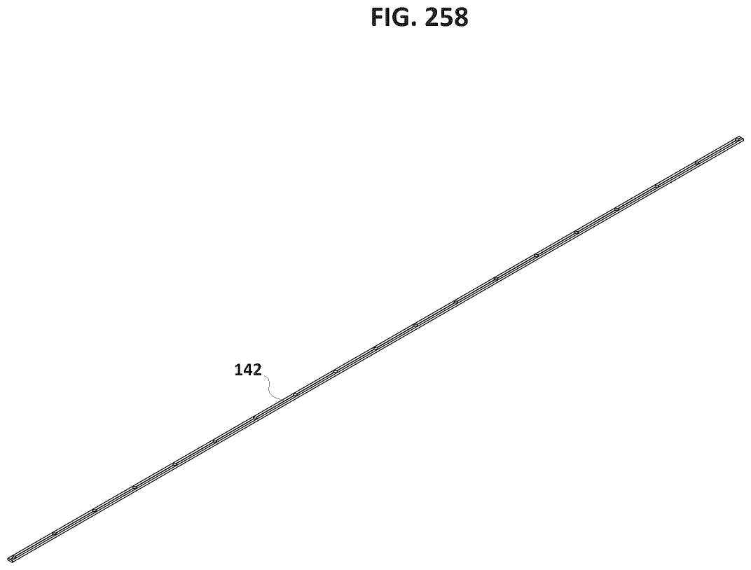

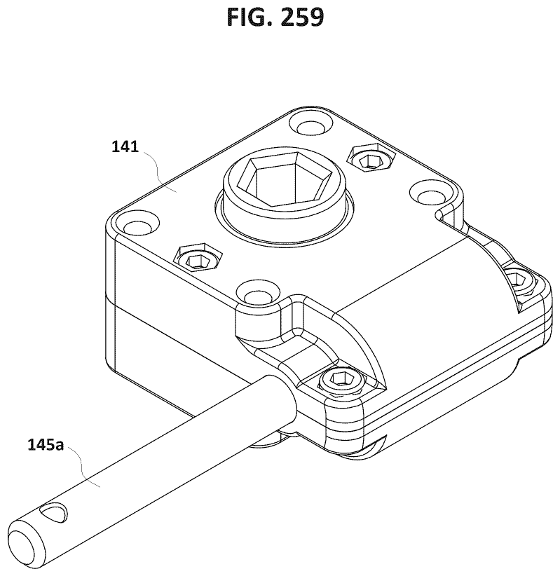

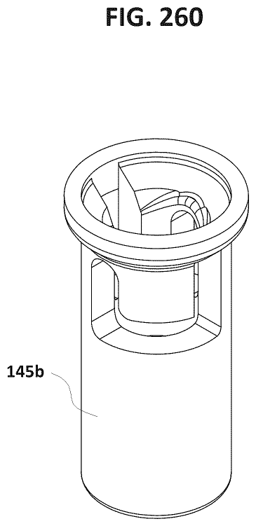

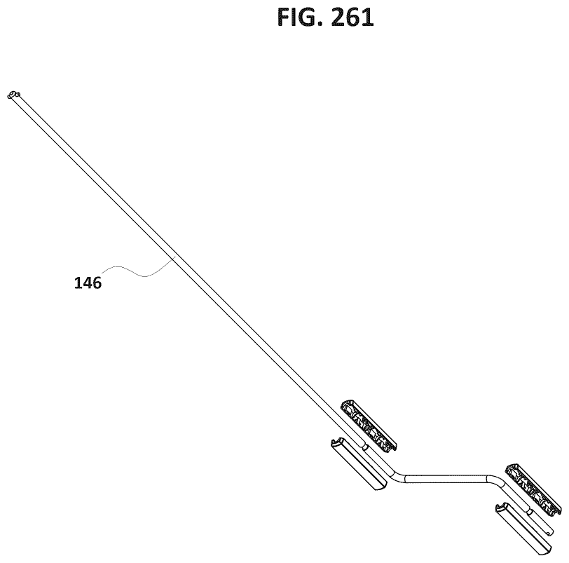

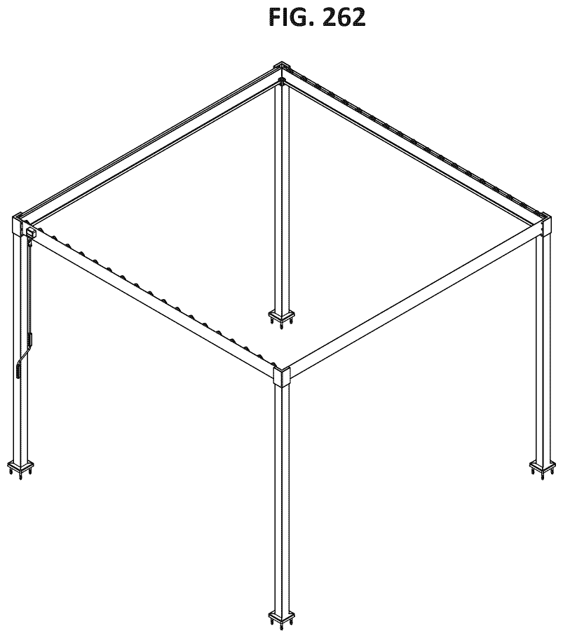

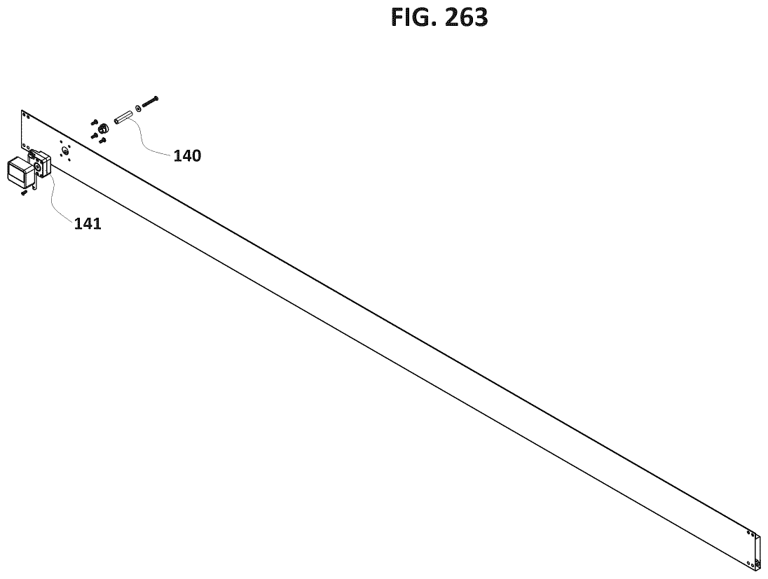

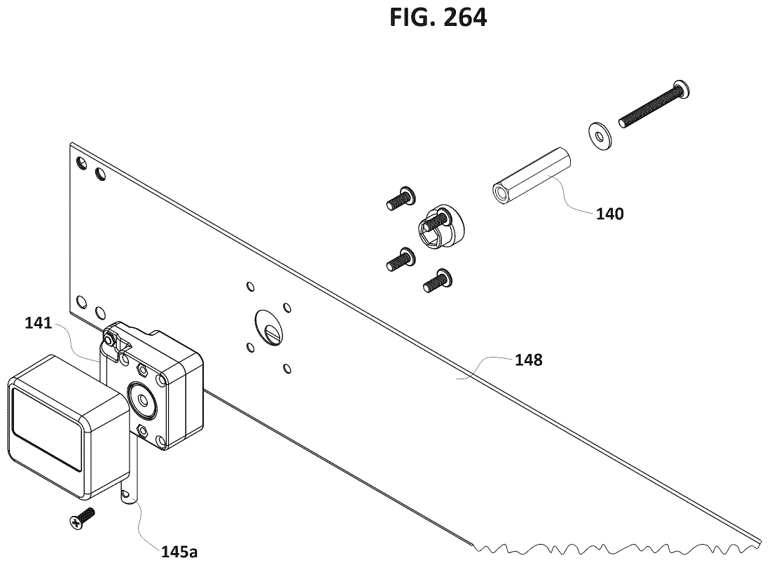

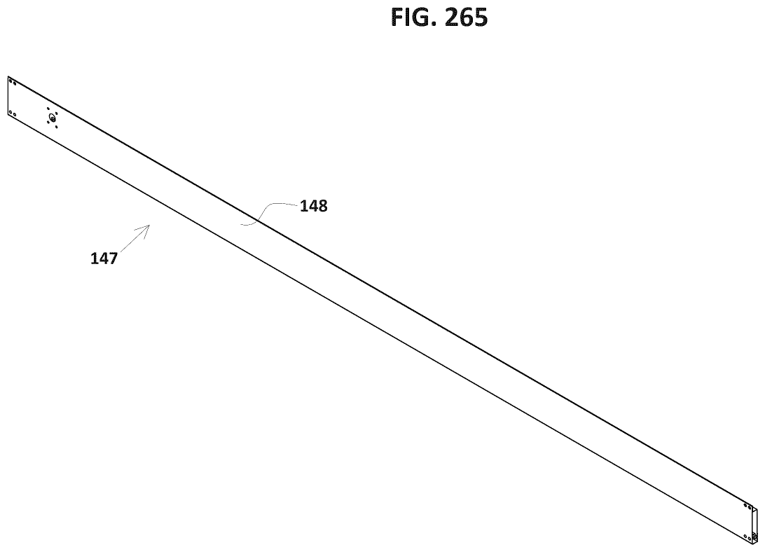

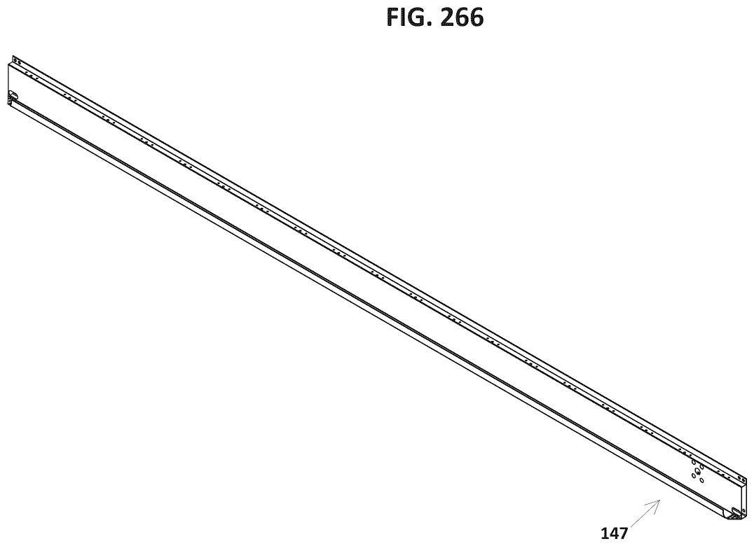

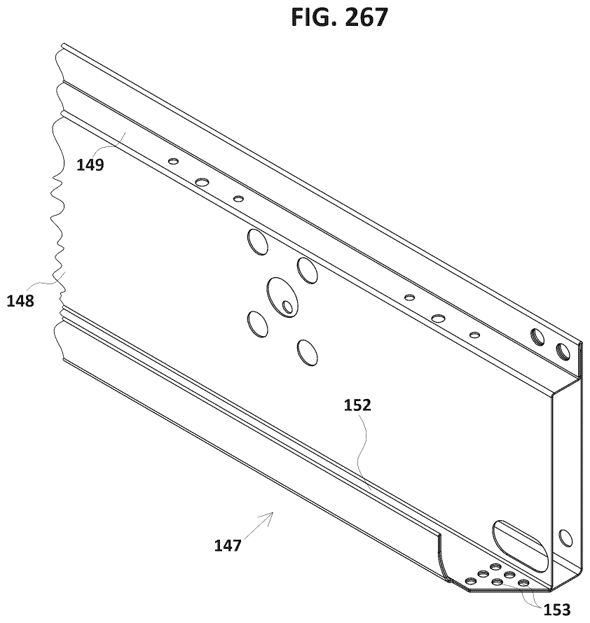

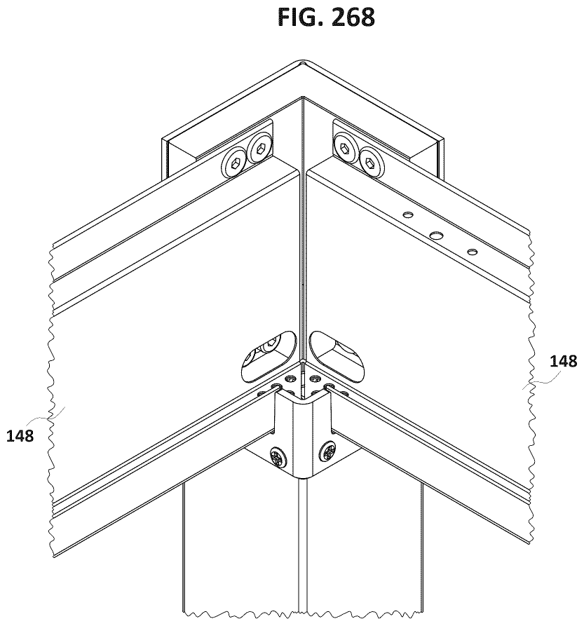

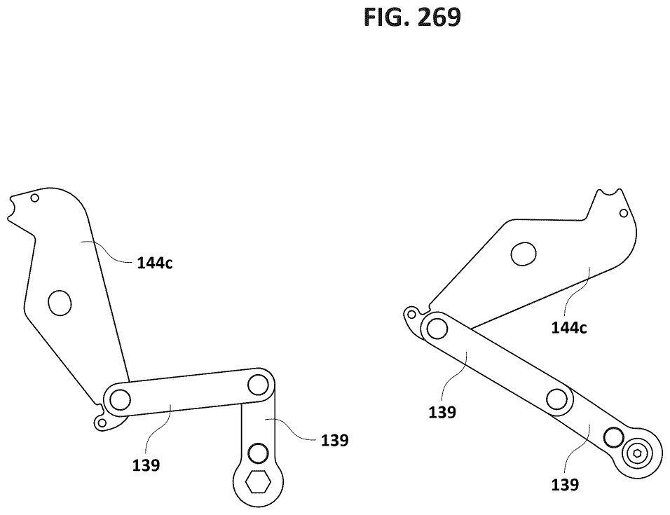

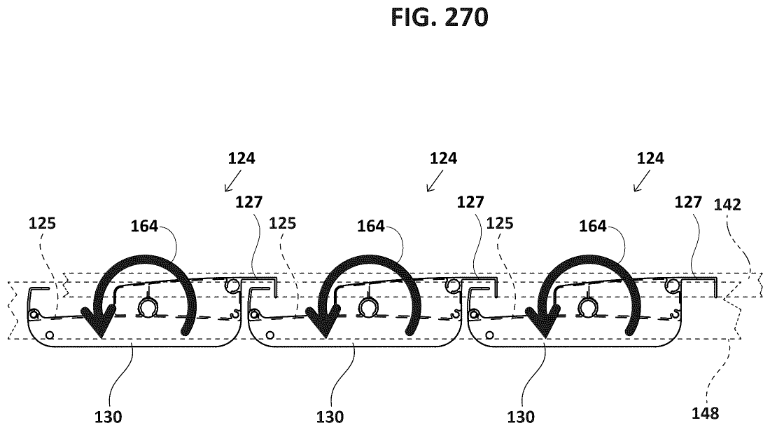

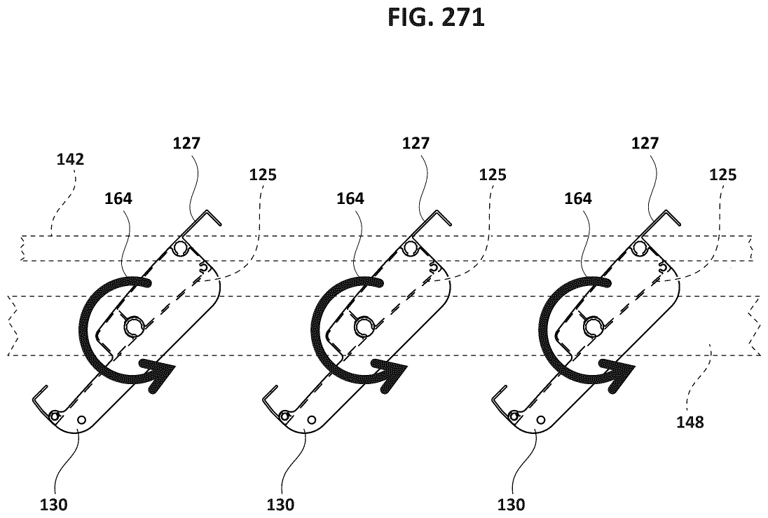

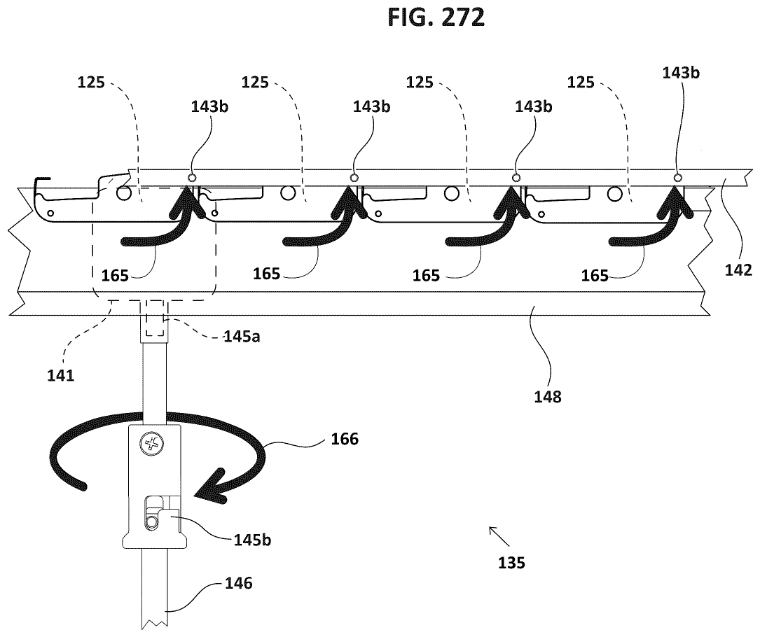

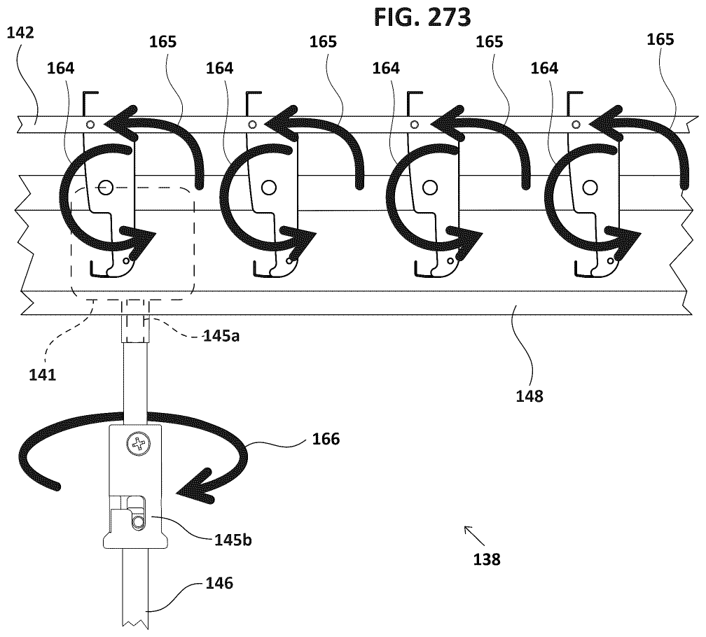

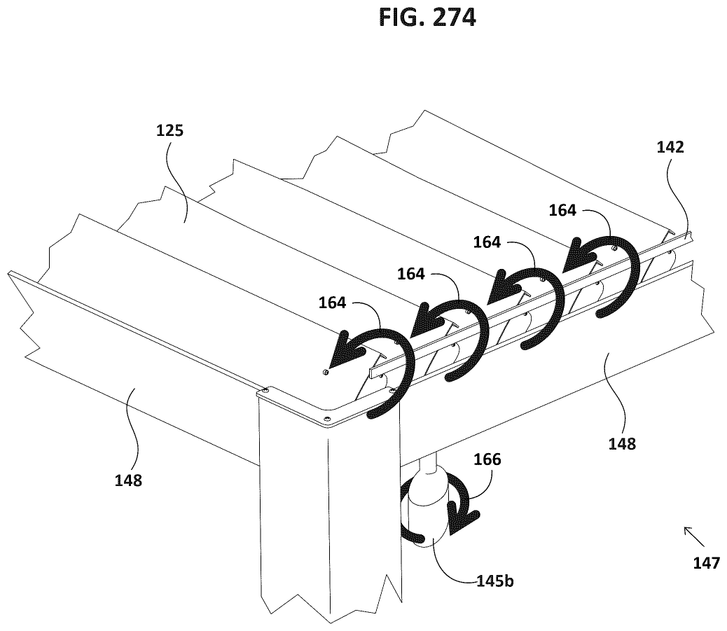

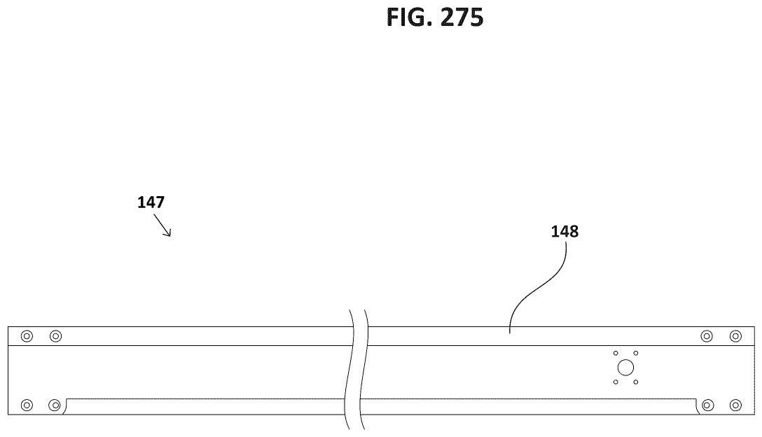

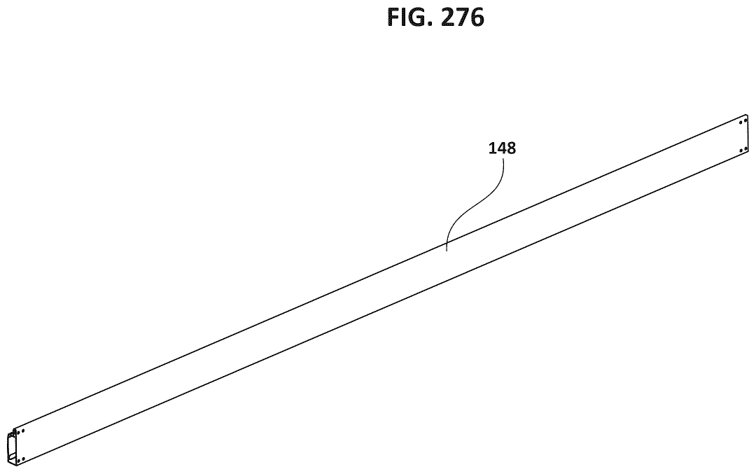

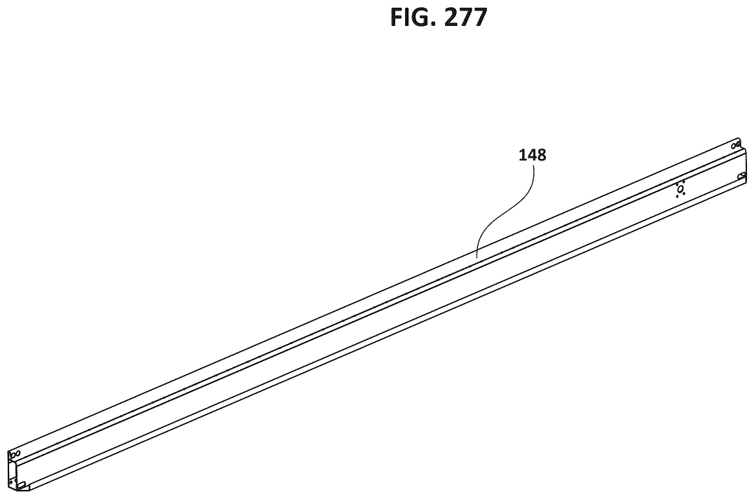

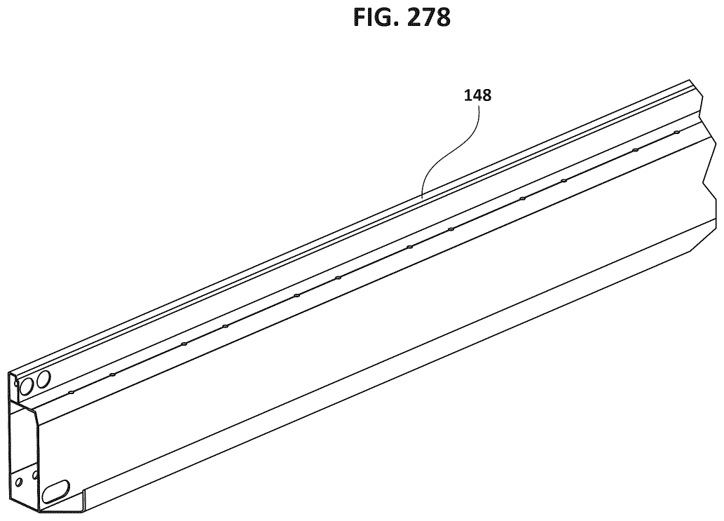

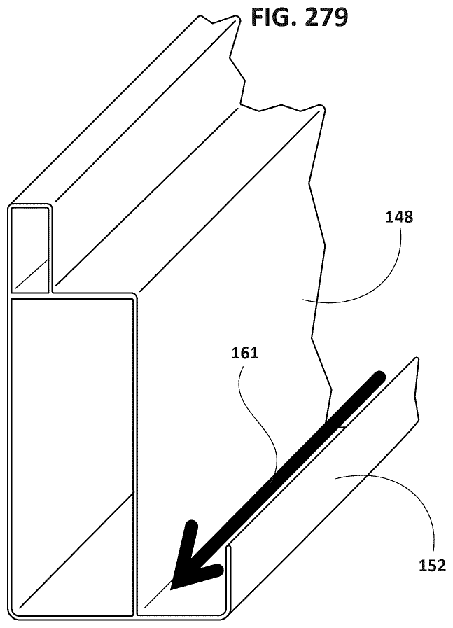

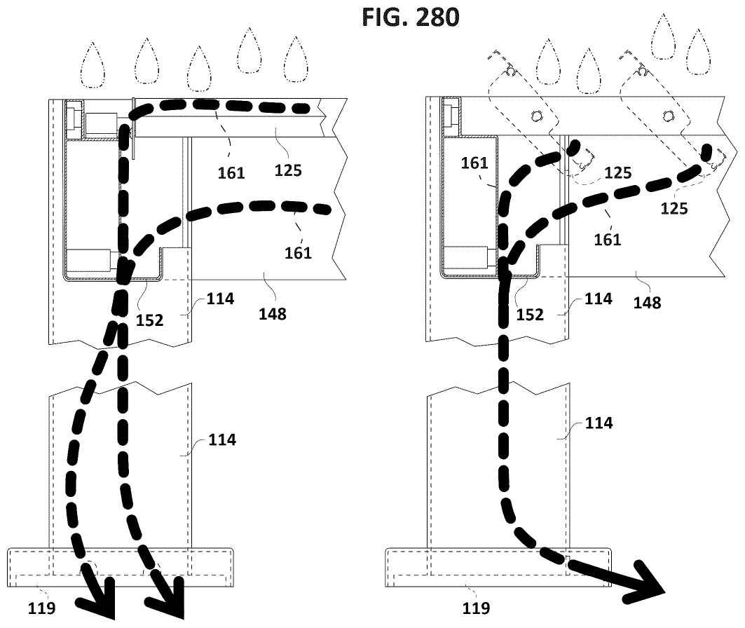

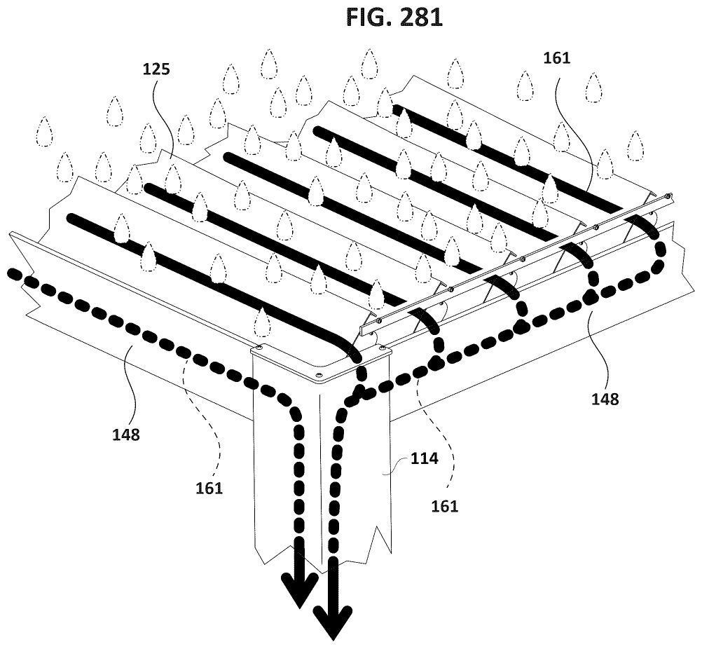

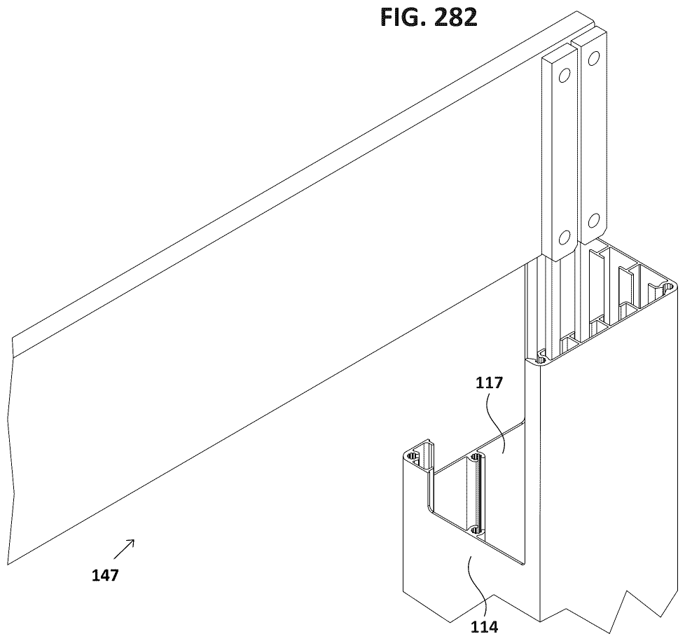

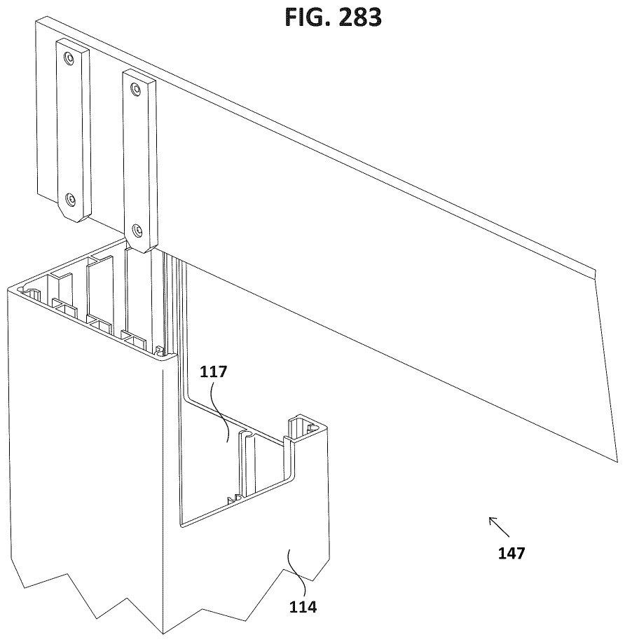

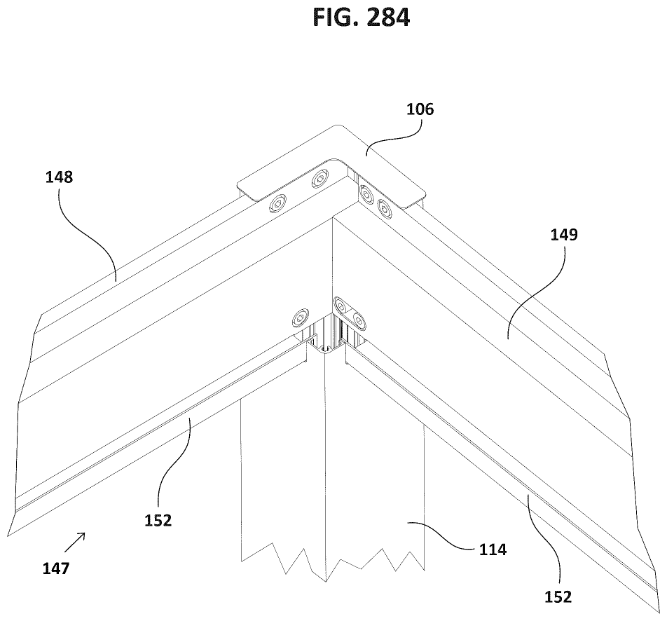

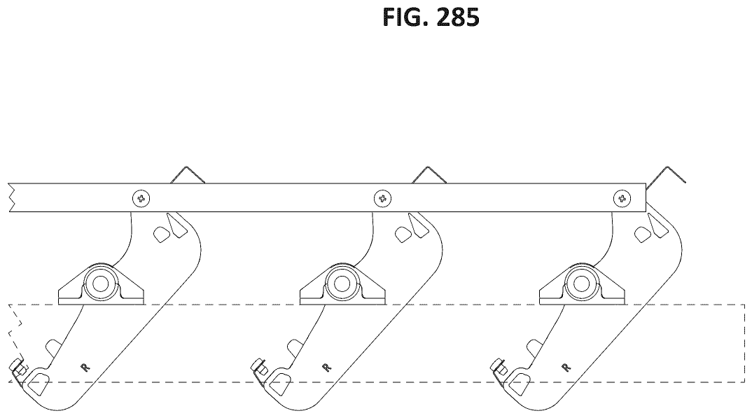

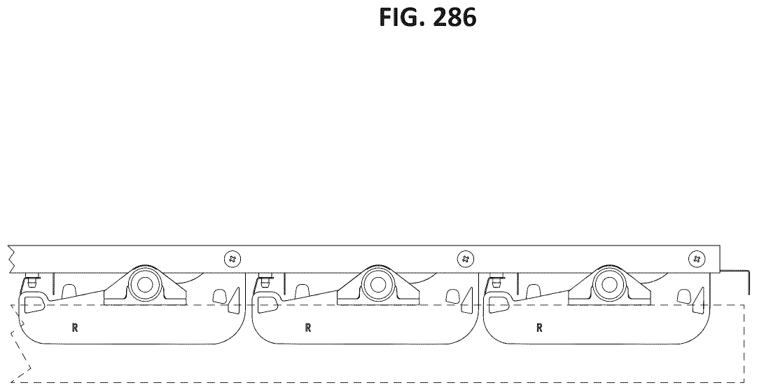

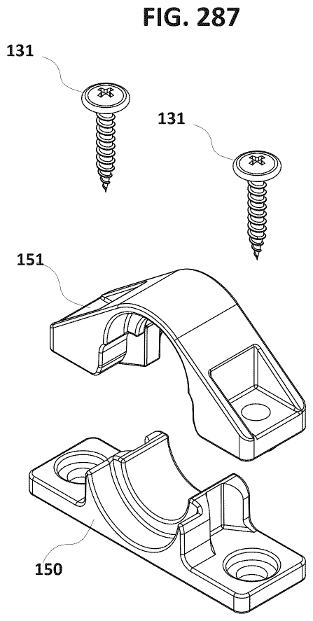

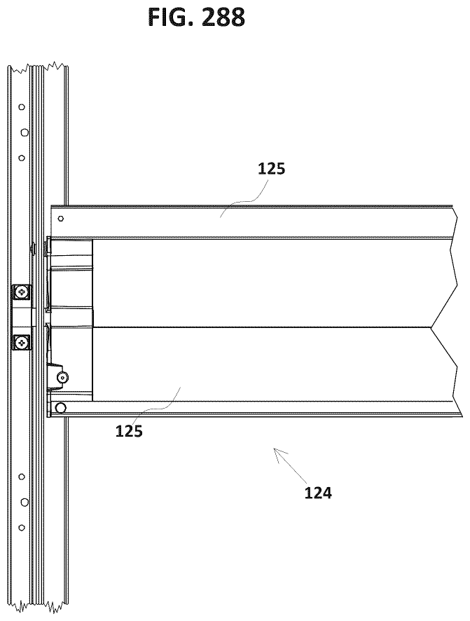

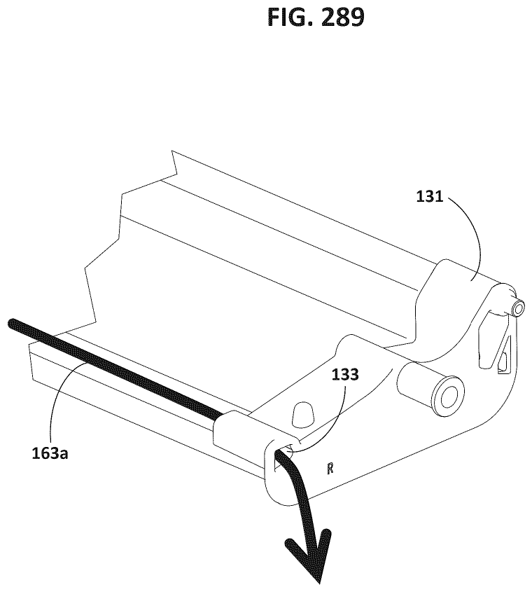

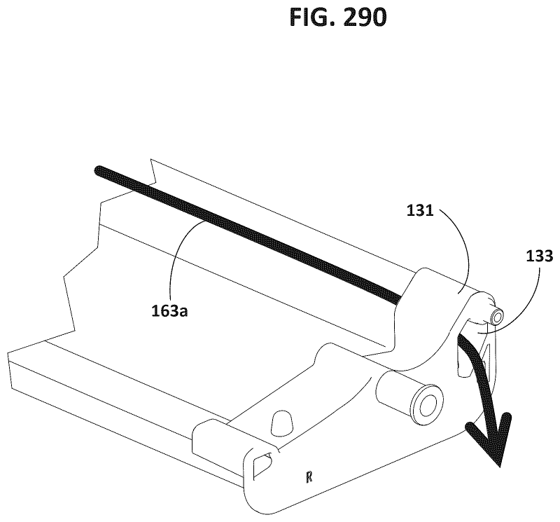

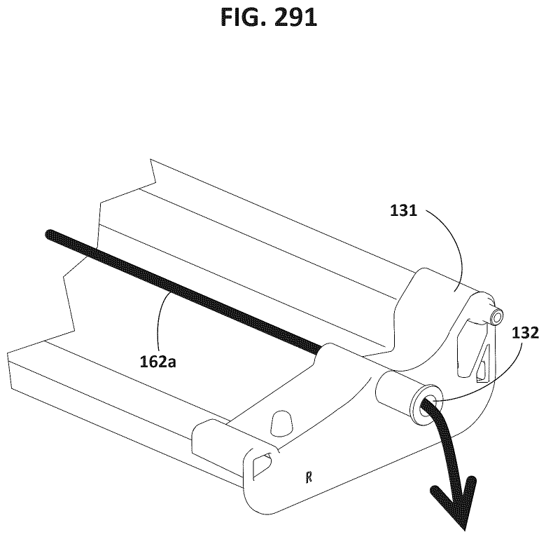

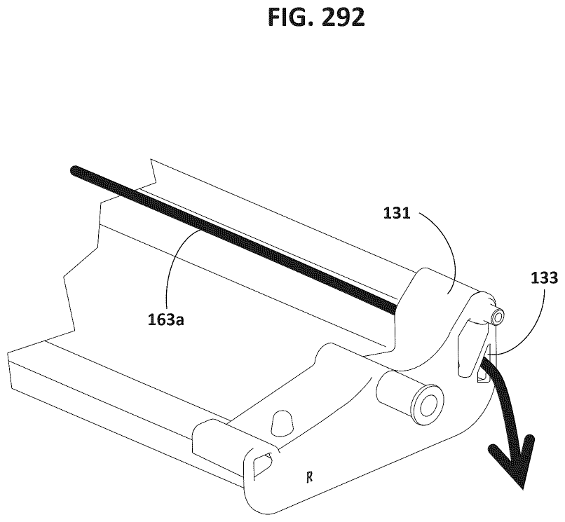

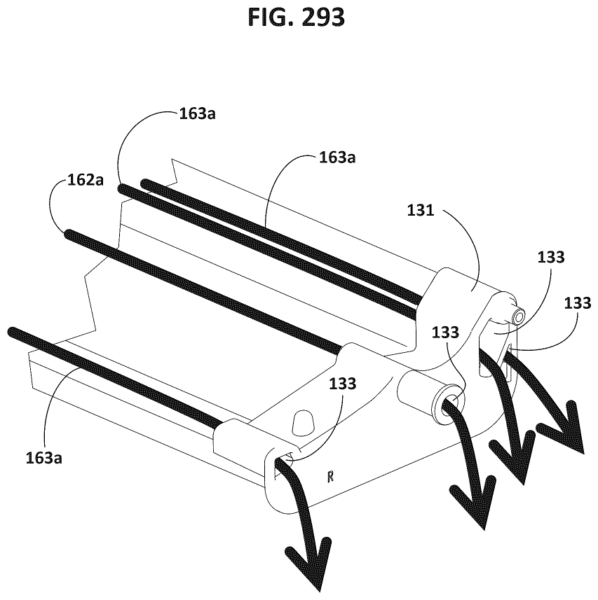

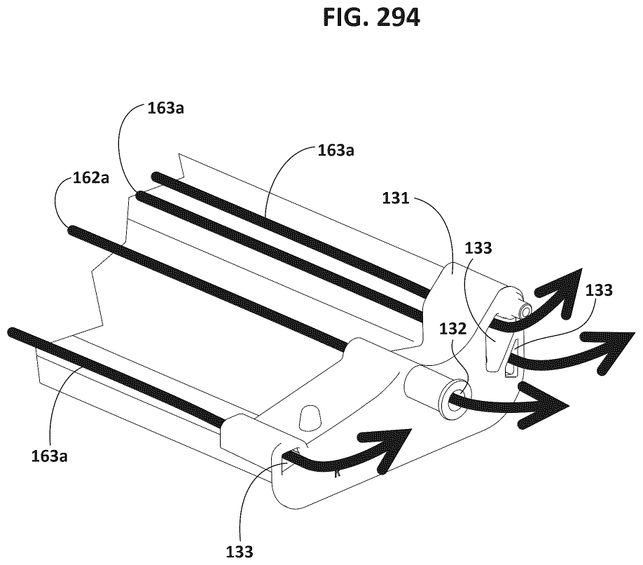

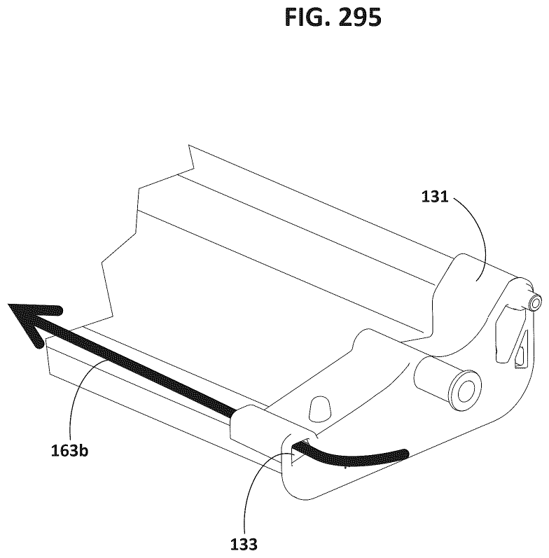

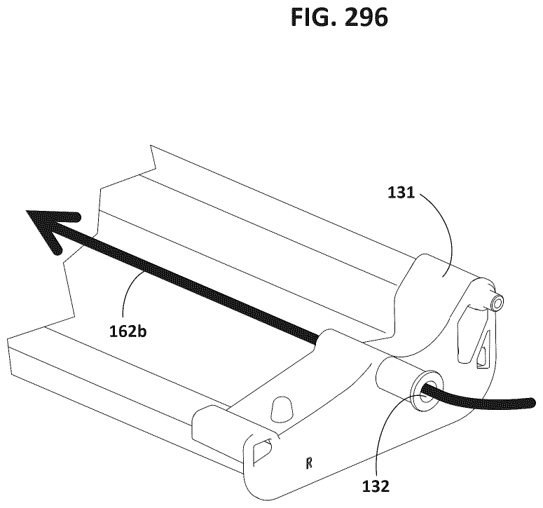

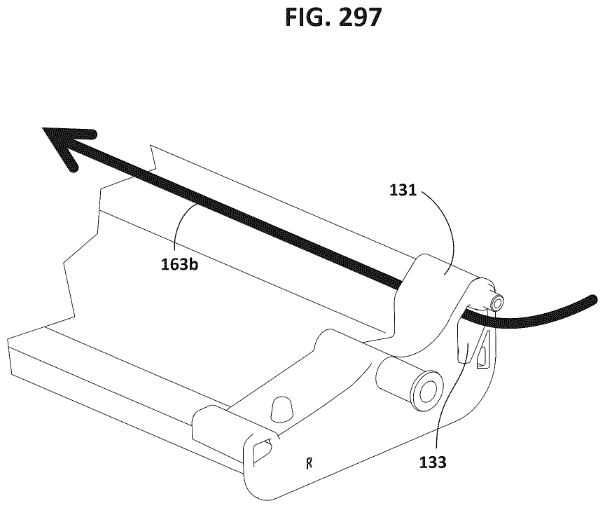

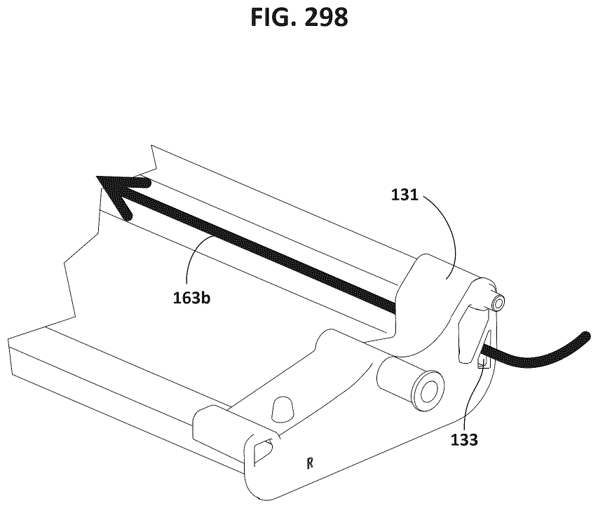

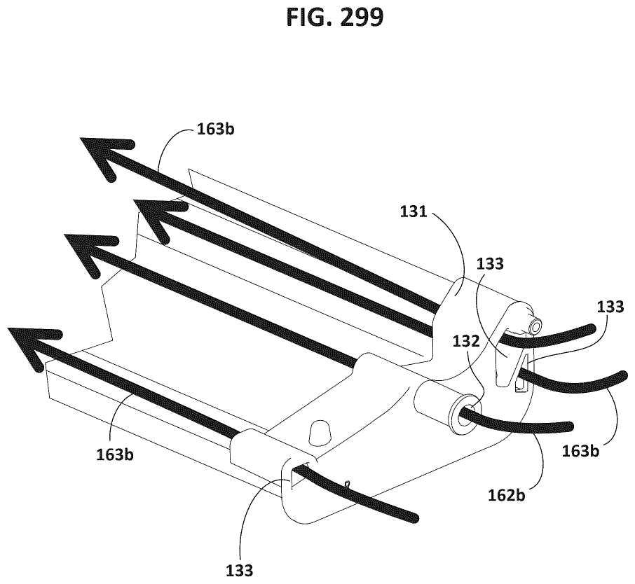

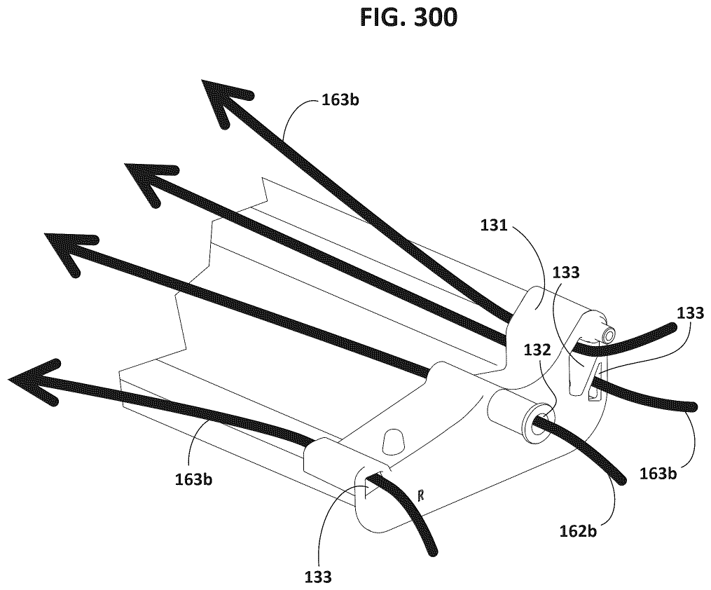

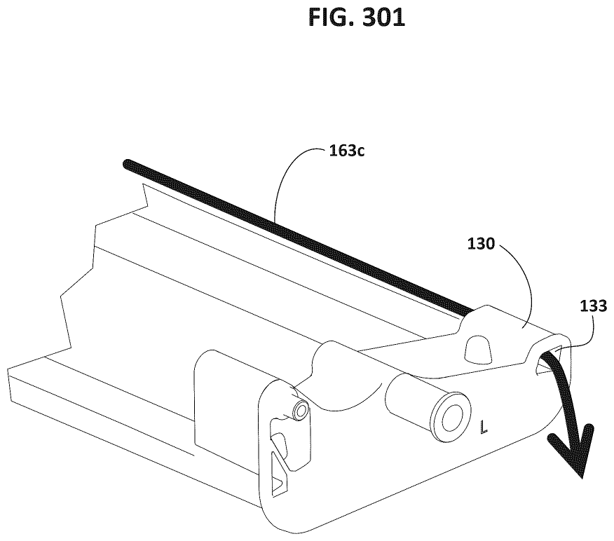

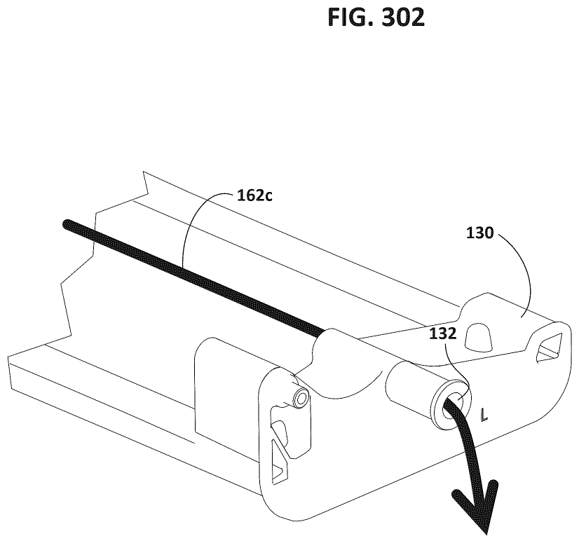

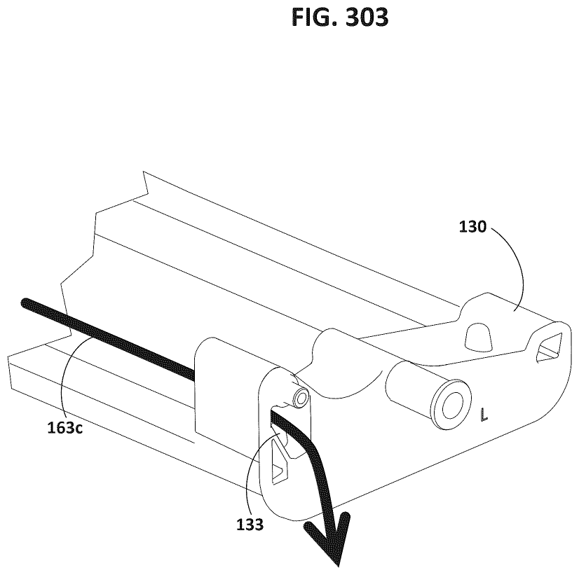

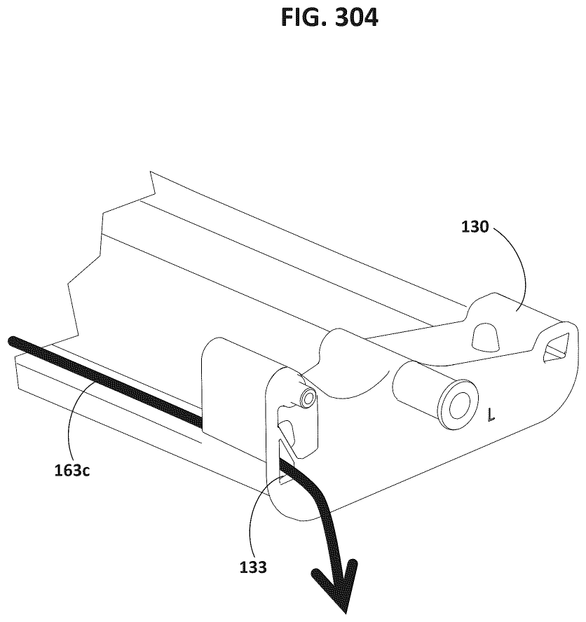

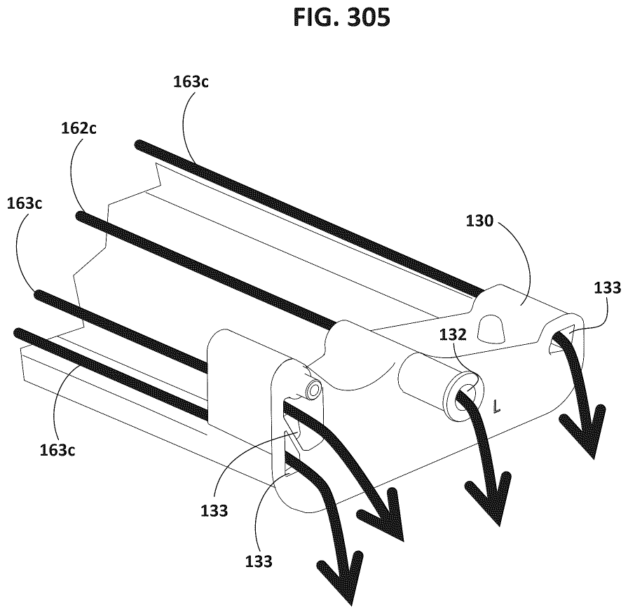

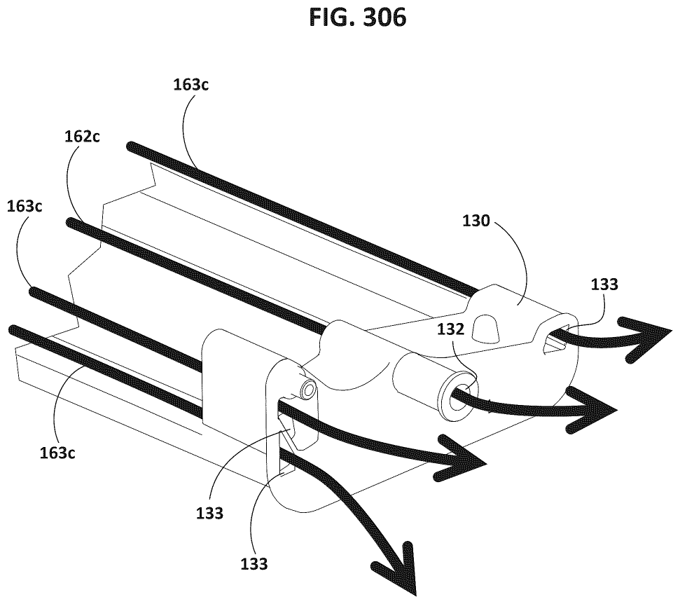

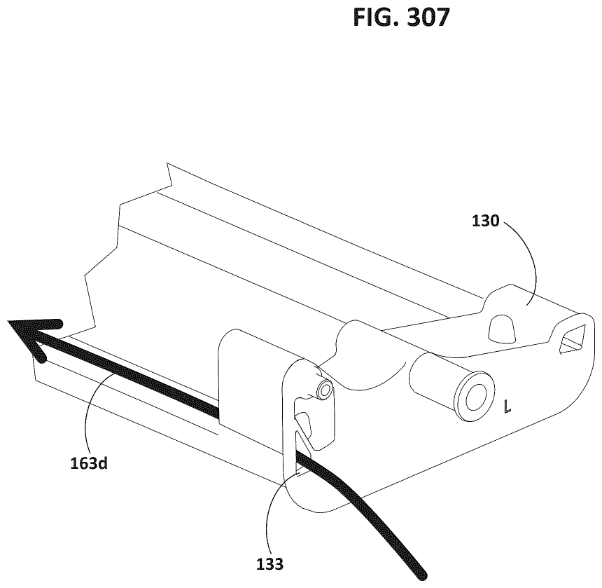

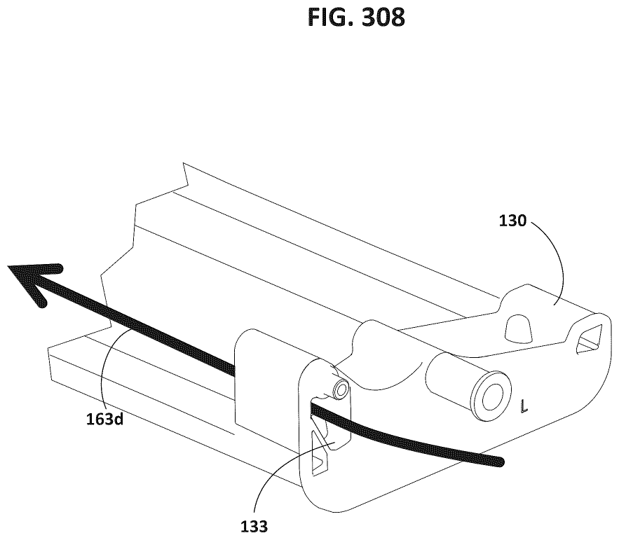

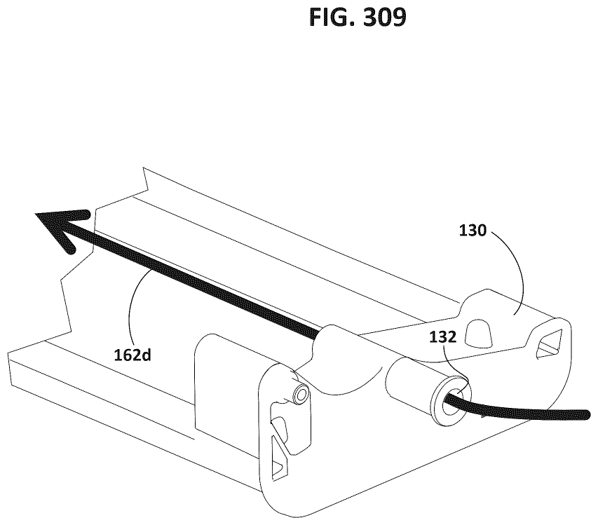

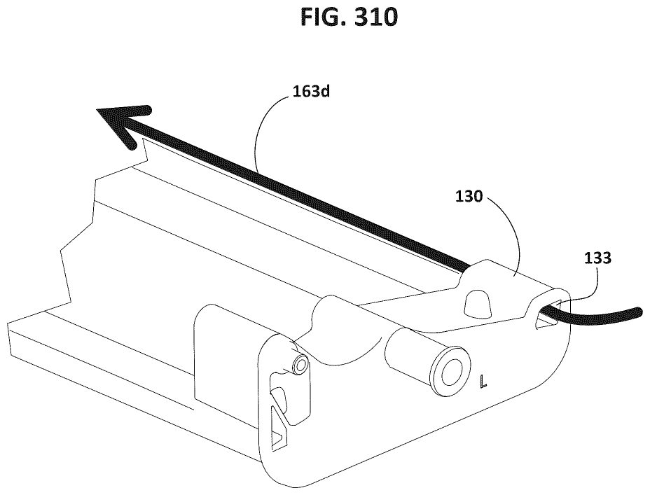

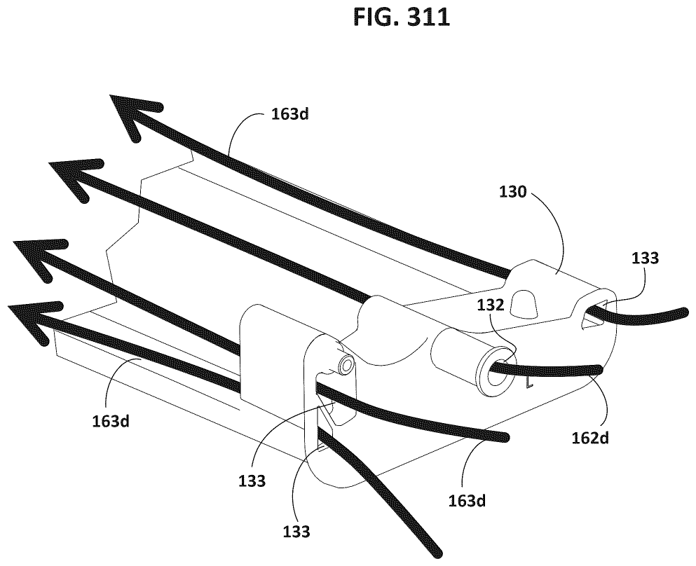

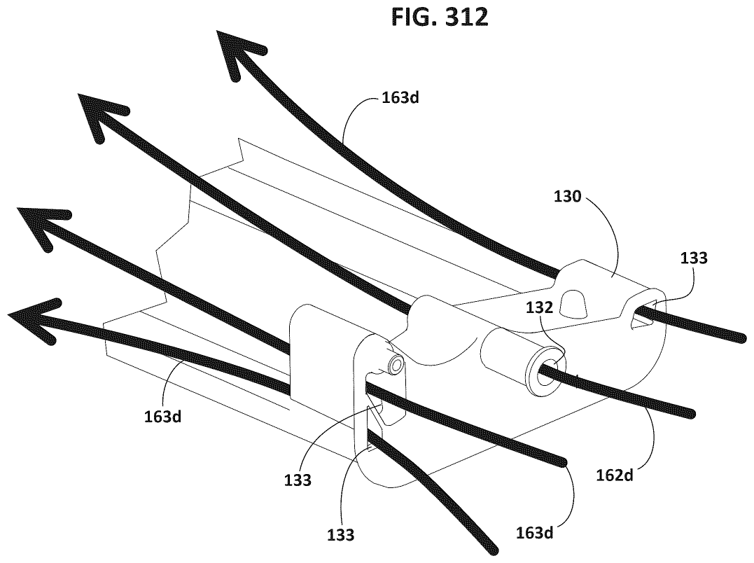

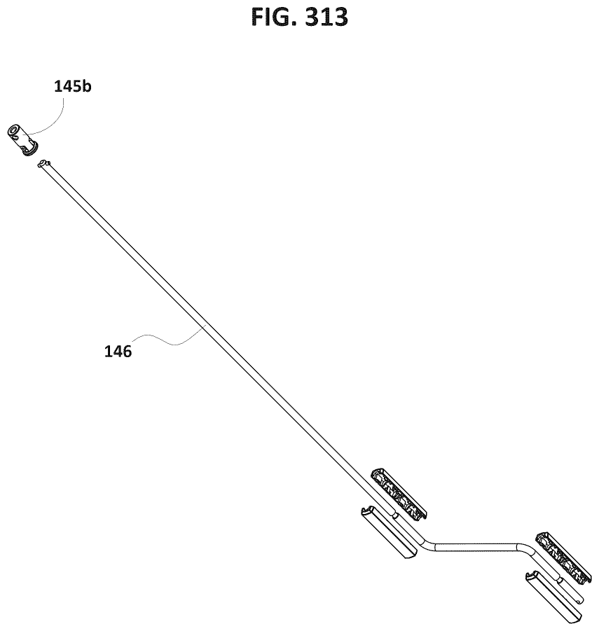

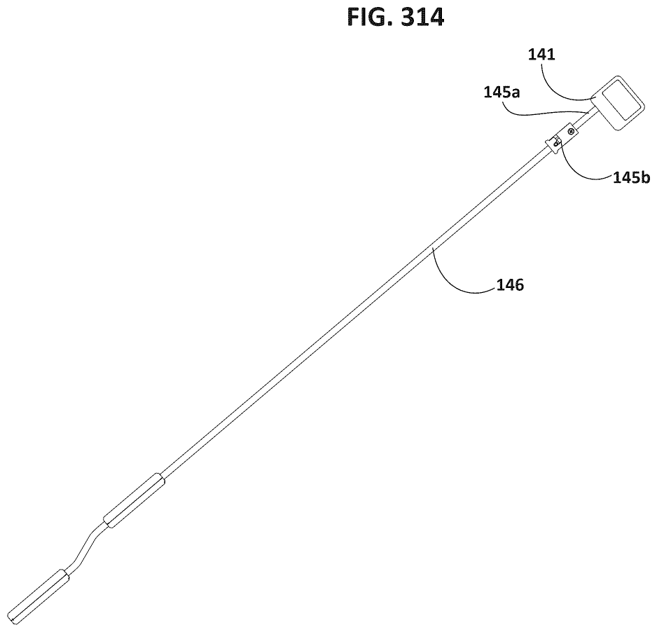

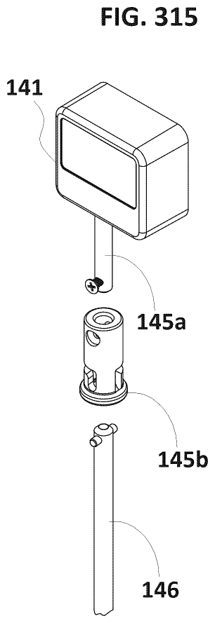

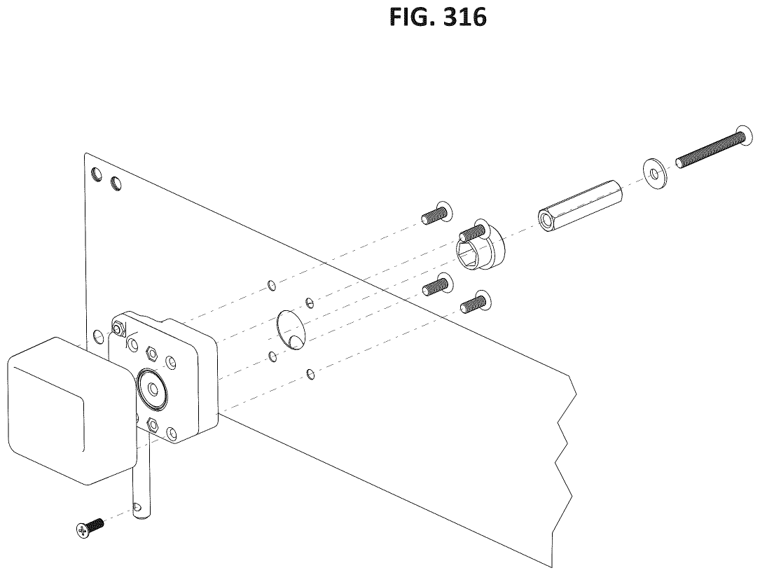

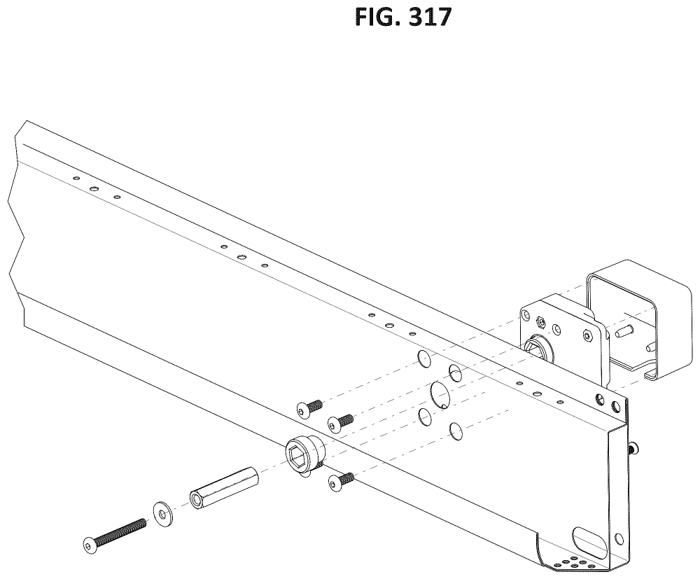

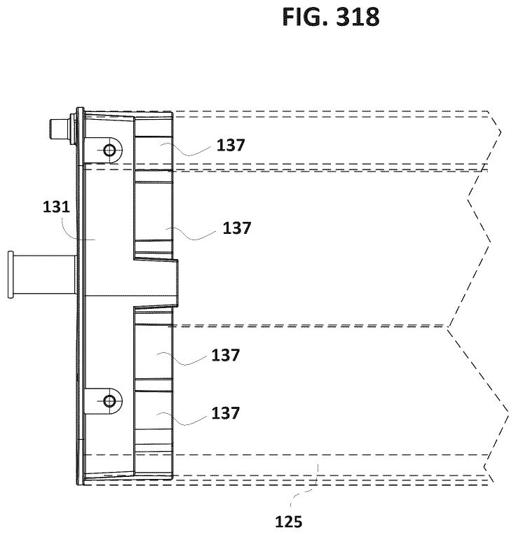

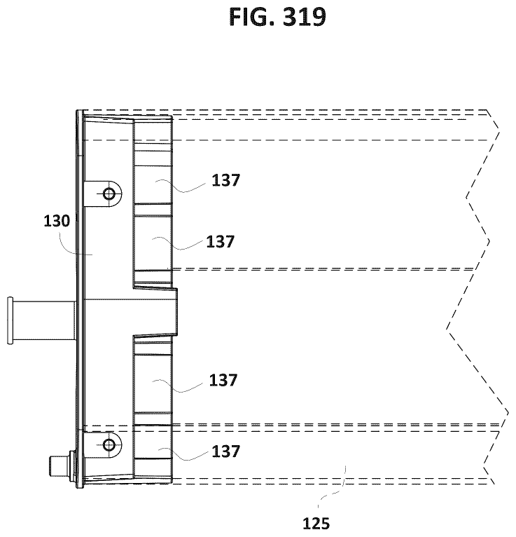

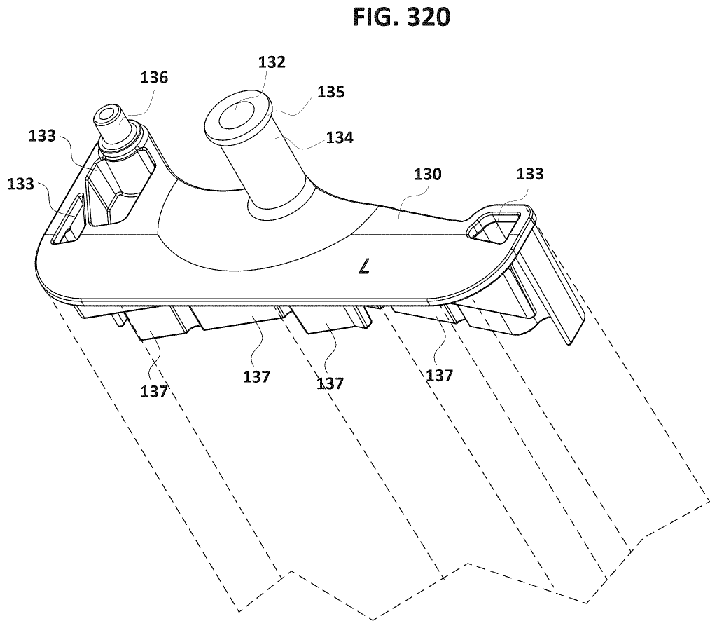

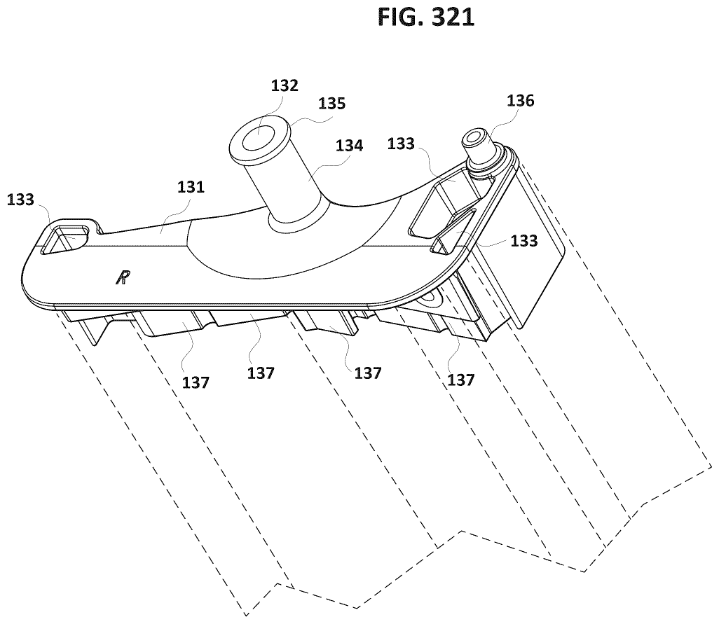

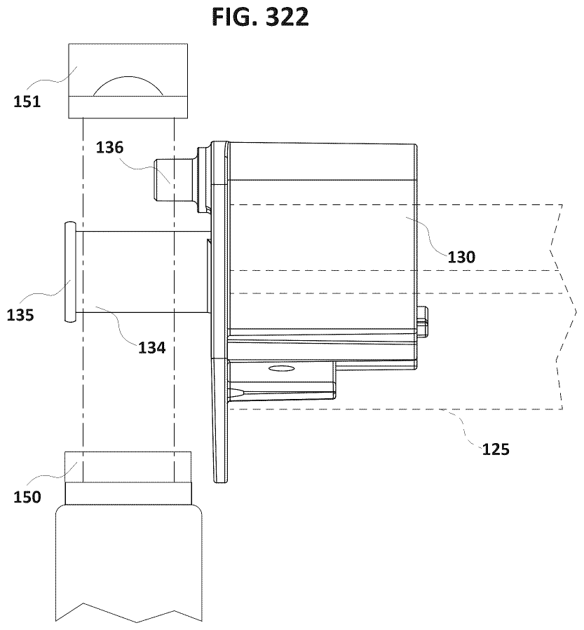

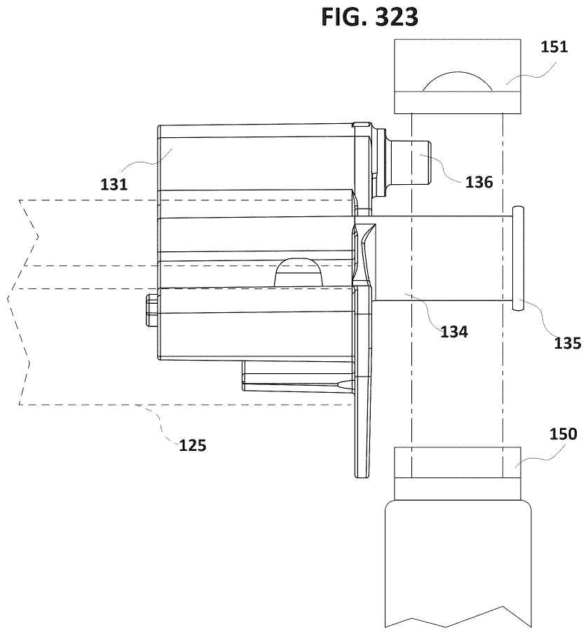

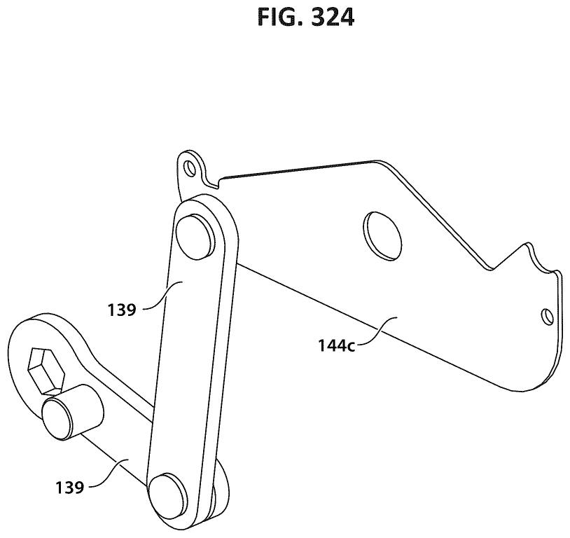

FIG. 216-FIG. 269 illustrate equivalent variations of components of five-device-in-one anti-twisting anti-warping anti-vibrating cost-saving production-increasing corner and noise-canceling wind-dissipating louver. FIG. 270-FIG. 325 illustrate equivalent applications of the five-device-in-one anti-twisting anti-warping anti-vibrating cost-saving production-increasing corner and noise-canceling wind-dissipating louver.

An embodiment substantially departs from the conventional concepts and designs of the prior art. In doing so, some embodiments provide a five-device-in-one anti-twisting anti-warping anti-vibrating cost-saving production-increasing corner and noise-canceling wind-dissipating louver (for being adapted to pergola, RV, house, solar panel, and concert stage), having many new and significant features, functions, and advantages, which overcome all the disadvantages of the prior art, as follows:
1) It is an object of an embodiment to provide the five-device-in-one anti-twisting anti-warping anti-vibrating cost-saving production-increasing corner and noise-canceling wind-dissipating louver, having anti-twisting anti-warping cost-saving production-increasing outer corner 102. Therefore, the five-device-in-one anti-twisting anti-warping anti-vibrating cost-saving production-increasing corner and noise-canceling wind-dissipating louver are: Capable of providing anti-twisting and anti-warping reverse tension to retain the original shape and size of the five-device-in-one anti-twisting anti-warping anti-vibrating cost-saving production-increasing corner and noise-canceling wind-dissipating louver in the directions of arrows 154, and 155 (see FIG. 14, and FIG. 57); Capable of saving cost by being injection-molded in a single piece; and Capable of increasing production capabilities by being injection-molded in a single piece.
2) It is another object of an embodiment to provide the five-device-in-one anti-twisting anti-warping anti-vibrating cost-saving production-increasing corner and noise-canceling wind-dissipating louver, having cost-saving production-increasing inner corner parapet 106. Therefore, the five-device-in-one anti-twisting anti-warping anti-vibrating cost-saving production-increasing corner and noise-canceling wind-dissipating louver are: Capable of being used to support a pergola or an RV gutter to shed rainwater therefrom in the direction of arrow 156 (see FIG. 3, FIG. 4, FIG. 46, and FIG. 47); Capable of being used to support a concert stage gutter to shed rainwater from a concert stage in the direction of arrow 157 (see FIG. 5, and FIG. 48); Capable of being used to support a house gutter to shed rainwater from a house in the direction of arrow 158 (see FIG. 6, and FIG. 49); Capable of being used to support a solar panel gutter to shed rainwater from a solar panel in the direction of arrow 159 (see FIG. 7, and FIG. 50); Capable of being used to support an awning when attached to a building (see FIG. 8, and FIG. 51); Capable of saving cost by being injection molded in a single piece; and Capable of increasing production capabilities by being injection molded in a single piece.
3) It is still another object of an embodiment to provide the five-device-in-one anti-twisting anti-warping anti-vibrating cost-saving production-increasing corner and noise-canceling wind-dissipating louver, having leaf-filtering-and-breaking cost-saving production-increasing honeycomb grate 107. Therefore, the five-device-in-one anti-twisting anti-warping anti-vibrating cost-saving production-increasing corner and noise-canceling wind-dissipating louver are: Capable of filtering leaves and other debris from getting inside double-gutter-supporting-and-locking post 114 (see FIG. 12, FIG. 13, FIG. 55, and FIG. 56); Capable of breaking up leaves and other debris to prevent large leaves from getting into double-gutter-supporting-and-locking post 114 in the direction of arrow 160 (see FIG. 12, FIG. 13, FIG. 55, and FIG. 56); Capable of securing a solar panel (see FIG. 9, and FIG. 52); Capable of securing an outdoor speaker (see FIG. 10, and FIG. 53); Capable of securing an outdoor light for illuminating through leaf-filtering-and-breaking cost-saving production-increasing honeycomb grate 107 (see FIG. 11, and FIG. 54); Capable of saving cost by being injection molded in a single piece; and Capable of increasing production capabilities by being injection molded in a single piece.
4) It is a further object of an embodiment to provide the five-device-in-one anti-twisting anti-warping anti-vibrating cost-saving production-increasing corner and noise-canceling wind-dissipating louver, having anti-twisting anti-warping anti-vibrating 90-degree-double-yokes 110b. Therefore, the five-device-in-one anti-twisting anti-warping anti-vibrating cost-saving production-increasing corner and noise-canceling wind-dissipating louver are: Capable of anti-vibrating while in use by cushioning cost-saving production-increasing inner corner parapet 106 (see FIG. 14, and FIG. 22); and Capable of absorbing vibrations caused by wind while in use.
5) It is a further object of an embodiment to provide the five-device-in-one anti-twisting anti-warping anti-vibrating cost-saving production-increasing corner and noise-canceling wind-dissipating louver, having double-gutter-supporting-and-locking post 114. Therefore, the five-device-in-one anti-twisting anti-warping anti-vibrating cost-saving production-increasing corner and noise-canceling wind-dissipating louver are: Capable of supporting an RV gutter to shed rainwater from an RV in the direction of arrow 156 (see FIG. 4, and FIG. 47); Capable of supporting a concert stage gutter to shed rainwater from a concert stage in the direction of arrow 157 (see FIG. 5, and FIG. 48); Capable of supporting a house gutter to shed rainwater from a house in the direction of arrow 158 (see FIG. 6, and FIG. 49); Capable of supporting a solar panel gutter to shed rainwater from a solar panel in the direction of arrow 159 (see FIG. 7, and FIG. 50); and Capable of supporting an awning when attached to a building (see FIG. 8, and FIG. 51).
6) It is another further object of an embodiment to provide the five-device-in-one anti-twisting anti-warping anti-vibrating cost-saving production-increasing corner and noise-canceling wind-dissipating louver, having post-top double-gutter-supporting-and-locking parapet-mounting flange 115. Therefore, the five-device-in-one anti-twisting anti-warping anti-vibrating cost-saving production-increasing corner and noise-canceling wind-dissipating louver are: Capable of supporting an RV gutter to shed rainwater from an RV in the direction of arrow 156 (see FIG. 4, and FIG. 47); Capable of supporting a concert stage gutter to shed rainwater from a concert stage in the direction of arrow 157 (see FIG. 5, and FIG. 48); Capable of supporting a house gutter to shed rainwater from a house in the direction of arrow 158 (see FIG. 6, and FIG. 49); Capable of supporting a solar panel gutter to shed rainwater from a solar panel in the direction of arrow 159 (see FIG. 7, and FIG. 50); and Capable of supporting an awning when attached to a building (see FIG. 8, and FIG. 51).

It is yet another further object of an embodiment to provide the five-device-in-one anti-twisting anti-warping anti-vibrating cost-saving production-increasing corner and noise-canceling wind-dissipating louver, having anti-twisting anti-warping 4-opposite-direction-securing post-mounting flanges 120. Therefore, the five-device-in-one anti-twisting anti-warping anti-vibrating cost-saving production-increasing corner and noise-canceling wind-dissipating louver are: Capable of providing anti-twisting and anti-warping reverse tension to retain the original shape and size of the five-device-in-one anti-twisting anti-warping anti-vibrating cost-saving production-increasing corner and noise-canceling wind-dissipating louver in the directions of arrows 154, and 155 (see FIG. 14, and FIG. 57); Capable of securing double-gutter-supporting-and-locking post 114 to anti-twisting anti-warping 4-opposite-direction-securing post plate 119.

It is still yet another further object of an embodiment to provide the five-device-in-one anti-twisting anti-warping anti-vibrating cost-saving production-increasing corner and noise-canceling wind-dissipating louver, having cost-saving production-increasing left-side louver end 130. Therefore, the five-device-in-one anti-twisting anti-warping anti-vibrating cost-saving production-increasing corner and noise-canceling wind-dissipating louver are: Capable of saving cost by being injection molded in a single piece, eliminating unnecessary hardware; and Capable of increasing production by being injection molded in a single piece, eliminating unnecessary hardware.

It is still yet another further object of an embodiment to provide the five-device-in-one anti-twisting anti-warping anti-vibrating cost-saving production-increasing corner and noise-canceling wind-dissipating louver, having cost-saving production-increasing right-side louver end 131. Therefore, the five-device-in-one anti-twisting anti-warping anti-vibrating cost-saving production-increasing corner and noise-canceling wind-dissipating louver are: Capable of saving cost by being injection molded in a single piece, eliminating unnecessary hardware; and Capable of increasing production by being injection molded in a single piece, eliminating unnecessary hardware.

It is still yet another further object of an embodiment to provide the five-device-in-one anti-twisting anti-warping anti-vibrating cost-saving production-increasing corner and noise-canceling wind-dissipating louver, having noise-canceling rainwater-draining axle bore 132. Therefore, the five-device-in-one anti-twisting anti-warping anti-vibrating cost-saving production-increasing corner and noise-canceling wind-dissipating louver are: Capable of draining rainwater away from rainwater-shedding louver 125 in the directions of arrows 162a and 162b (see FIG. 61-FIG. 64); and Capable of dissipating wind away from rainwater-shedding louver 125 in the directions of arrows 162a and 162b (see FIG. 61-FIG. 64).

It is still yet another further object of an embodiment to provide the five-device-in-one anti-twisting anti-warping anti-vibrating cost-saving production-increasing corner and noise-canceling wind-dissipating louver, having triple wind-dissipating tunnels 133. Therefore, the five-device-in-one anti-twisting anti-warping anti-vibrating cost-saving production-increasing corner and noise-canceling wind-dissipating louver are: Capable of draining rainwater away from rainwater-shedding louver 125 in the directions of arrows 163a-163d (see FIG. 61-FIG. 64); and Capable of dissipating wind away from rainwater-shedding louver 125 in the directions of arrows 163a-163d (see FIG. 61-FIG. 64).

It is still yet another further object of an embodiment to provide the five-device-in-one anti-twisting anti-warping anti-vibrating cost-saving production-increasing corner and noise-canceling wind-dissipating louver, having cost-saving production-increasing anti-noise louver axle 134. Therefore, the five-device-in-one anti-twisting anti-warping anti-vibrating cost-saving production-increasing corner and noise-canceling wind-dissipating louver are: Capable of saving cost by being injection molded in a single piece, eliminating unnecessary hardware; Capable of increasing production by being injection molded in a single piece, eliminating unnecessary hardware; and Capable of providing location for cost-saving production-increasing left-side louver end 130 or cost-saving production-increasing right-side louver end 131 to pivotably rotate in the direction of arrow 164 (see FIG. 113, FIG. 114, FIG. 116, and FIG. 117). Capable of noise-cancelling when rotated between noise-canceling axle saddle 150 and noise-canceling axle clamp 151 in the direction of arrow 164 (see FIG. 113, FIG. 114, FIG. 116, and FIG. 117).

It is still yet another further object of an embodiment to provide the five-device-in-one anti-twisting anti-warping anti-vibrating cost-saving production-increasing corner and noise-canceling wind-dissipating louver, having cost-saving production-increasing anti-noise shuttling axle 136. Therefore, the five-device-in-one anti-twisting anti-warping anti-vibrating cost-saving production-increasing corner and noise-canceling wind-dissipating louver are: Capable of saving cost by being injection molded in a single piece, eliminating unnecessary hardware; and Capable of increasing production by being injection molded in a single piece, eliminating unnecessary hardware; Capable of providing location for automatic-multi-louver-shuttling multi-louver-conjoining control-bar 142 to be pivotably attached in the direction of arrow 165 (see FIG. 115 and FIG. 116) It is still yet another further object of an embodiment to provide the five-device-in-one anti-twisting anti-warping anti-vibrating cost-saving production-increasing corner and noise-canceling wind-dissipating louver, having quadruple snap-locking tails 137.

Therefore, the five-device-in-one anti-twisting anti-warping anti-vibrating cost-saving production-increasing corner and noise-canceling wind-dissipating louver are: Capable of saving cost by being injection molded in a single piece, eliminating unnecessary hardware; Capable of increasing production by being injection molded in a single piece, eliminating unnecessary hardware; and Capable of snap-locking to rainwater-shedding louver 125 without need for hardware.

One or more elements or aspects or steps, or any portion(s) thereof, from one or more of any of the systems and methods described herein may be combined with one or more elements or aspects or steps, or any portion(s) thereof, from one or more of any of the other systems and methods described herein and combinations thereof, to form one or more additional implementations and/or claims of the present disclosure.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The inventions and embodiments described herein are only examples. Each element of the inventions and embodiments described herein may be combined with any other element of the inventions and embodiments described herein unless otherwise indicated.

1-20. (canceled)

21. A louver configured to be used in a pergola, wherein the louver comprises:
an elongated louver body with a bottom wall having a left louver end and, in the longitudinal direction thereof opposite to the left louver end, a right louver end,
a first side wall arranged at one of the longitudinal sides of the elongated bottom wall, and a second side wall arranged at another one of the longitudinal sides of the elongated bottom wall, wherein the elongated bottom wall, the first side wall and the second side wall are configured to define a channel to direct water towards at least one of the left louver end and the right louver end of the elongated bottom wall, and
a louver-mounted bracket configured to be secured to the elongated louver body, and to allow the louver to be connected to the pergola,
wherein the louver-mounted bracket is provided with a snap-locking tail and the elongated louver body is provided with a complementary snap-locking receptacle, wherein the snap-locking tail and the complementary snap-locking receptacle are configured to cooperate to form a snap-lock for locking the louver-mounted bracket to the elongated louver body.

22. A louver according to claim 21, wherein the complementary snap-locking receptacle is provided at the bottom wall of the elongated louver body at or near at least one of the left louver end and the right louver end.

23. A louver according to claim 22, wherein the complementary snap-locking receptacle comprises a snap-lock opening extending from the at least one of the left louver end and the right louver end and configured for receiving the snap-locking tail at least partially.

24. A louver according to claim 21, wherein the louver-mounted bracket comprises at least one fixating portion configured to be pushed against and/or at least partially into the elongated louver body in a direction substantially transverse thereto.

25. A louver according to claim 21, further comprising a louver-mounted axle connected to or configured to be connected to the louver-mounted bracket, wherein the louver-mounted axle is configured to allow the louver to be connected to the pergola in a rotatable manner.

26. A louver according to claim 25, further comprising a louver-mounted bracket-plate arranged at or configured to be arranged at the louver-mounted bracket in such manner that the louver-mounted bracket-plate extends substantially traverse to the elongated bottom wall, and wherein the louver-mounted axle extends through the louver-mounted bracket-plate.

27. A louver according to claim 26, wherein the louver-mounted bracket-plate is arranged to the louver-mounted bracket such that the louver-mounted bracket-plate extends above and below the louver-mounted bracket when seen in a direction perpendicular to the louver-mounted bracket-plate, and/or wherein the louver-mounted bracket-plate has the shape of a letter C.

28. A louver according to claim 27, wherein the louver-mounted bracket-plate is provided with one or more openings, wherein the one or more openings are arranged at a level above the bottom wall and/or wherein the lower edge of the one or more openings is equal to the bottom wall.

29. A louver according to claim 28, wherein the one or more openings are located near the first side wall and/or the second side wall.

30. A louver according to claim 21, further comprising a control-bar axle arranged at the louver-mounted bracket, which control-bar axle extends in a direction substantially parallel to the bottom wall.

31. A louver according to claim 21, wherein the first side wall is provided with a shield projection arranged at the end thereof facing away from the bottom, wherein the shield projection extends traverse to the first side wall in a direction towards the second side wall.

32. A louver according to claim 21, further comprising a cushion configured to preventing undesired noise from occurring resulting from contact with a neighboring louver.

33. A louver according to claim 21, wherein the cushion is arranged at the shield projection.

34. A louver according to claim 22, wherein the cushion is snap-fit into the shield projection, and/or is made from metal or plastic.

35. A louver according to claim 21, wherein the second side wall is provided with an overlapping shield arranged at the end thereof facing away from the bottom wall, wherein the overlapping shield extends traverse to the second side wall in a direction away from the first side wall, wherein the overlapping shield is configured to be placed over the first side wall of a neighboring louver.

36. A louver according to claim 21, wherein the bottom wall is bent is such manner that the center of the bottom wall is located at a higher level than the longitudinal sides thereof.

37. A louver according to claim 21, wherein the bottom wall of the louver is made of metal and the louver-mounted bracket is made of plastic, or vice versa.

38. A louver system configured to be used in a steel pergola, wherein the louver system comprises a louver according to claim 21.

39. A pergola comprising a louver system according to claim 18.
